(19) United States
(12) Patent Application Publication
(10) Pub. No.: US 2026/0133051 A1
(43) Pub. Date: May 14, 2026

(54) GEOSYNCHRONIZATION OF AN AERIAL IMAGE USING LOCALIZING MULTIPLE FEATURES

(71) Applicant: Edgy Bees Ltd., HERZLIYA (IL)

(72) Inventors: Menashe HASKIN, Kfar Vitkin (IL); Gil GILAD, Tel Aviv (IL)

(21) Appl. No.: 18/875,926

(22) PCT Filed: Jun. 15, 2023
(86) PCT No.: PCT/IL2023/050627

§ 371 Date: Dec. 17, 2024

Related U.S. Application Data
(60) Provisional application No. 63/400,457, filed on Aug. 24, 2022.

(51) Int. Cl. G01C 21/00; G06F 16/29; G06F 16/587; G06V 10/46; G06V 20/17

(52) U.S. Cl. CPC G01C 21/3852; G06F 16/29; G06F 16/587; G06V 10/46; G06V 20/17

(57) ABSTRACT

A georegistration (a.k.a. georectification) of an image captured by a camera in an aerial vehicle, such as a satellite, is based on identifying multiple features using descriptor sets, and sending to a ground station only the descriptors of the identified features and the associated locations in the captured image, without sending of the captured image itself, thus requiring a low communication bandwidth. Using a database of geosynchronized reference images, the ground station uses the received descriptors sets and the associated image locations to localize the features on a selected geosynchronized reference image from the database, and forms a mapping function that map any locations in the captured image to geographical coordinates on Earth. The mapping may be used to geosynchronize an additional feature identified in the aerial vehicle, or to geo synchronize a region that may be cropped from the captured image and sent to the ground station.

### RELATED APPLICATIONS

This patent application claims the benefit of U.S. Provisional Application Ser. No. 63/400,457 that was filed on Aug. 24, 2020, which is hereby incorporated herein by reference.

### TECHNICAL FIELD

This disclosure generally relates to an apparatus and method for georegistration by identifying objects or features in an image captured by a camera in an aerial or airborne vehicle, and in particular for improving georegistration accuracy while reducing communication bandwidth by sending data regarding objects and features in an image from a satellite to a ground station, to be georegistered therein.

### BACKGROUND

Unless otherwise indicated herein, the materials described in this section are not prior art to the claims in this application and are not admitted to be prior art by inclusion in this section.

Digital photography is described in an article by Robert Berdan (downloaded from ‘canadianphotographer.com’ preceded by ‘www.’) entitled: “Digital Photography Basics for Beginners”, and in a guide published on April 2004 by Que Publishing (ISBN: 0-7897-3120-7) entitled: “Absolute Beginner's Guide to Digital Photography” authored by Joseph Ciaglia et al., which are both incorporated in their entirety for all purposes as if fully set forth herein.

A digital camera 10 shown in FIG. 1 may be a digital still camera that converts captured image into an electric signal upon a specific control or can be a video camera, wherein the conversion between captured images to the electronic signal is continuous (e.g., 24 frames per second). The camera 10 is preferably a digital camera, wherein the video or still images are converted using an electronic image sensor 12. The digital camera 10 includes a lens 11 (or a few lenses) for focusing the received light centered around an optical axis 8 (referred to herein as a line-of-sight) onto the small semiconductor image sensor 12. The optical axis 8 is an imaginary line along which there is some degree of rotational symmetry in the optical system, and typically passes through the center of curvature of the lens 11 and commonly coincides with the axis of the rotational symmetry of the sensor 12. The image sensor 12 commonly includes a panel with a matrix of tiny light-sensitive diodes (photocells), converting the image light to electric charges and then to electric signals, thus creating a video picture or a still image by recording the light intensity. Charge-Coupled Devices (CCD) and CMOS (Complementary Metal-Oxide-Semiconductor) are commonly used as light-sensitive diodes. Linear or area arrays of light-sensitive elements may be used, and the light-sensitive sensors may support monochrome (black & white), color, or both. For example, the CCD sensor KAI-2093 Image Sensor 1920 (H)×1080 (V) Interline CCD Image Sensor or KAF-50100 Image Sensor 8176 (H)×6132 (V) Full-Frame CCD Image Sensor can be used, available from the Image Sensor Solutions, Eastman Kodak Company, Rochester, New York.

An image processor block 13 receives the analog signal from the image sensor 12. The Analog Front End (AFE) in the block 13 filters, amplifies, and digitizes the signal, using an analog-to-digital (A/D) converter. The AFE further provides Correlated Double Sampling (CDS) and provides a gain control to accommodate varying illumination conditions. In the case of a CCD-based sensor 12, a CCD AFE (Analog Front End) component may be used between the digital image processor 13 and the sensor 12. Such an AFE may be based on VSP2560 ‘CCD Analog Front End for Digital Cameras’ available from Texas Instruments Incorporated of Dallas, Texas, U.S.A. The block 13 further contains a digital image processor, which receives the digital data from the AFE, and processes this digital representation of the image to handle various industry standards, and executes various computations and algorithms. Preferably, additional image enhancements may be performed by the block 13 such as generating greater pixel density or adjusting color balance, contrast, and luminance. Further, the block 13 may perform other data management functions and processing on the raw digital image data. Commonly, the timing relationship of the vertical/horizontal reference signals and the pixel clock are also handled in this block. Digital Media System-on-Chip device TMS320DM357 available from Texas Instruments Incorporated of Dallas, Texas, U.S.A. is an example of a device implementing in a single chip (and associated circuitry) part or all of the image processor 13, part or all of a video compressor 14 and part or all of a transceiver 15. In addition to a lens or lens system, color filters may be placed between the imaging optics and the photosensor array 12 to achieve desired color manipulation.

The processing block 13 converts the raw data received from the photosensor array 12 (which can be any internal camera format, including before or after Bayer translation) into a color-corrected image in a standard image file format. The camera 10 further comprises a connector 19, and a transmitter or a transceiver 15 is disposed between the connector 19 and the image processor 13. The transceiver 15 may further include isolation magnetic components (e.g., transformer-based), balancing, surge protection, and other suitable components required for providing a proper and standard interface via the connector 19. In the case of connecting to a wired medium, the connector 19 further contains protection circuitry for accommodating transients, over-voltage, lightning, and any other protection means for reducing or eliminating the damage from an unwanted signal over the wired medium. A band-pass filter may also be used for passing only the required communication signals, and for rejecting or stopping other signals in the described path. A transformer may be used for isolating and reducing common-mode interferences. Further, a wiring driver and wiring receivers may be used to transmit and receive the appropriate level of signal to and from the wired medium. An equalizer may also be used to compensate for any frequency-dependent characteristics of the wired medium.

Other image processing functions performed by the image processor 13 may include adjusting color balance, gamma and luminance, filtering pattern noise, filtering noise using Wiener filter, changing zoom factors, recropping, applying enhancement filters, applying smoothing filters, applying subject-dependent filters, and applying coordinate transformations. Other enhancements in the image data may include applying mathematical algorithms to generate greater pixel density or adjusting color balance, contrast, and/or luminance.

The image processing may further include an algorithm for motion detection by comparing the current image with a reference image and counting the number of different pixels, where the image sensor 12 or the digital camera 10 are assumed to be in a fixed location and thus assumed to capture the same image. Since images naturally differ due to factors such as varying lighting, camera flicker, and CCD dark currents, pre-processing is useful to reduce the number of false positive alarms. More complex algorithms are necessary to detect motion when the camera itself is moving, or when the motion of a specific object must be detected in a field containing another movement that can be ignored. Further, the video or image processing may us, or be based on, the algorithms and techniques disclosed in the book entitled: “Handbook of Image & Video Processing”, edited by Al Bovik, by Academic Press, ISBN: 0-12-119790-5, which is incorporated in its entirety for all purposes as if fully set forth herein.

A controller 18, located within the camera device or module 10, may be based on a discrete logic or an integrated device, such as a processor, microprocessor, or microcomputer, and may include a general-purpose device or may be a special purpose processing device, such as an ASIC, PAL, PLA, PLD, Field Programmable Gate Array (FPGA), Gate Array, or any other customized or programmable device. In the case of a programmable device as well as in other implementations, a memory is required. The controller 18 commonly includes a memory that may include a static RAM (random Access Memory), dynamic RAM, flash memory, ROM (Read Only Memory), or any other data storage medium. The memory may include data, programs, and/or instructions, and any other software or firmware executable by the processor. Control logic can be implemented in hardware or software, such as firmware stored in the memory. The controller 18 controls and monitors the device's operation, such as initialization, configuration, interface, and commands.

The digital camera device or module 10 requires power for its described functions, such as for capturing, storing, manipulating, or transmitting the image. A dedicated power source may be used such as a battery or a dedicated connection to an external power source via connector 19. The power supply may contain a DC/DC converter. In another embodiment, the power supply is power fed from the AC power supply via an AC plug and a cord and thus may include an AC/DC converter, for converting the AC power (commonly 115 VAC/60 Hz or 220 VAC/50 Hz) into the required DC voltage or voltages. Such power supplies are known in the art and typically involve converting 120 or 240 volt AC supplied by a power utility company to a well-regulated lower voltage DC for electronic devices. In one embodiment, the power supply is typically integrated into a single device or circuit for sharing common circuits. Further, the power supply may include a boost converter, such as a buck-boost converter, charge pump, inverter, and regulators as known in the art, as required for conversion of one form of electrical power to another desired form and voltage. While the power supply (either separated or integrated) can be an integral part and housed within the camera 10 enclosure, it may be enclosed as a separate housing connected via cable to the camera 10 assembly. For example, a small outlet plug-in step-down transformer shape can be used (also known as wall-wart, “power brick”, “plug pack”, “plug-in adapter”, “adapter block”, “domestic mains adapter”, “power adapter”, or AC adapter). Further, the power supply may be a linear or switching type.

Various formats that can be used to represent the captured image are TIFF (Tagged Image File Format), RAW format, AVI, DV, MOV, WMV, MP4, DCF (Design Rule for Camera Format), ITU-T H.261, ITU-T H.263, ITU-T H.264, ITU-T CCIR 601, ASF, Exif (Exchangeable Image File Format), and DPOF (Digital Print Order Format) standards. In many cases, video data is compressed before transmission, to allow its transmission over a reduced bandwidth transmission system. The video compressor 14 (or video encoder) shown in FIG. 1 is disposed between the image processor 13 and the transceiver 15, allowing for compression of the digital video signal before its transmission over a cable or over-the-air. In some cases, compression may not be required, hence obviating the need for the compressor 14. Such compression can be lossy or lossless types. Common compression algorithms are JPEG (Joint Photographic Experts Group) and MPEG (Moving Picture Experts Group). The above and other image or video compression techniques can make use of intraframe compression commonly based on registering the differences between parts of a single frame or a single image. Interframe compression can further be used for video streams, based on registering differences between frames. Other examples of image processing include run length encoding and delta modulation. Further, the image can be dynamically dithered to allow the displayed image to appear to have higher resolution and quality.

The single lens or a lens array 11 is positioned to collect optical energy representative of a subject or scenery, and to focus the optical energy onto the photosensor array 12. Commonly, the photosensor array 12 is a matrix of photosensitive pixels, which generates an electric signal that is representative of the optical energy directed at the pixel by the imaging optics. The captured image (still images or part of video data) may be stored in a memory 17, which may be volatile or non-volatile memory, and may be a built-in or removable media. Many stand-alone cameras use SD format, while a few use CompactFlash or other types. An LCD or TFT miniature display 16 typically serves as an Electronic ViewFinder (EVF) where the image captured by the lens is electronically displayed. The image on this display is used to assist in aiming the camera at the scene to be photographed. The sensor records the view through the lens; the view is then processed, and finally projected on a miniature display, which is viewable through the eyepiece. Electronic viewfinders are used in digital still cameras and in video cameras. Electronic viewfinders can show additional information, such as an image histogram, focal ratio, camera settings, battery charge, and remaining storage space. The display 16 may further display images captured earlier that are stored in the memory 17.

A digital camera is described in U.S. Pat. No. 6,897,891 to Itsukaichi entitled: “Computer System Using a Camera That is Capable of Inputting Moving Picture or Still Picture Data”, in U.S. Patent Application Publication No. 2007/0195167 to Ishiyama entitled: “Image Distribution System, Image Distribution Server, and Image Distribution Method”, in U.S. Patent Application Publication No. 2009/0102940 to Uchida entitled: “Imaging Device and imaging Control Method”, and in U.S. Pat. No. 5,798,791 to Katayama et al. entitled: “Multieye Imaging Apparatus”, which are all incorporated in their entirety for all purposes as if fully set forth herein.

A digital camera capable of being set to implement the function of a card reader or camera is disclosed in U.S. Patent Application Publication 2002/0101515 to Yoshida et al. entitled: “Digital camera and Method of Controlling Operation of Same”, which is incorporated in its entirety for all purposes as if fully set forth herein. When the digital camera capable of being set to implement the function of a card reader or camera is connected to a computer via a USB, the computer is notified of the function to which the camera has been set. When the computer and the digital camera are connected by the USB, a device request is transmitted from the computer to the digital camera. Upon receiving the device request, the digital camera determines whether its operation at the time of the USB connection is that of a card reader or PC camera. Information indicating the result of the determination is incorporated in a device descriptor, which the digital camera then transmits to the computer. Based on the device descriptor, the computer detects the type of operation to which the digital camera has been set. The driver that supports this operation is loaded and the relevant commands are transmitted from the computer to the digital camera.

A prior art example of a portable electronic camera connectable to a computer is disclosed in U.S. Pat. No. 5,402,170 to Parulski et al. entitled: “Hand-Manipulated Electronic Camera Tethered to a Personal Computer”, a digital electronic camera that accepts various types of input/output cards or memory cards is disclosed in U.S. Pat. No. 7,432,952 to Fukuoka entitled: “Digital Image Capturing Device having an Interface for Receiving a Control Program”, and the use of a disk drive assembly for transferring images out of an electronic camera is disclosed in U.S. Pat. No. 5,138,459 to Roberts et al., entitled: “Electronic Still Video Camera with Direct Personal Computer (PC) Compatible Digital Format Output”, which are all incorporated in their entirety for all purposes as if fully set forth herein. A camera with human face detection means is disclosed in U.S. Pat. No. 6,940,545 to Ray et al., entitled: “Face Detecting Camera and Method”, and in U.S. Patent Application Publication No. 2012/0249768 to Binder entitled: “System and Method for Control Based on Face or Hand Gesture Detection”, which are both incorporated in their entirety for all purposes as if fully set forth herein. A digital still camera is described in an Application Note No. AN1928/D (Revision 0-20 Feb. 2001) by Freescale Semiconductor, Inc. entitled: “Roadrunner—Modular digital still camera reference design”, which is incorporated in its entirety for all purposes as if fully set forth herein.

An imaging method is disclosed in U.S. Pat. No. 8,773,509 to Pan entitled: “Imaging Device, Imaging Method and Recording Medium for Adjusting Imaging Conditions of Optical Systems Based on Viewpoint Images”, which is incorporated in its entirety for all purposes as if fully set forth herein. The method includes: calculating an amount of parallax between a reference optical system and an adjustment target optical system; setting coordinates of an imaging condition evaluation region corresponding to the first viewpoint image outputted by the reference optical system; calculating coordinates of an imaging condition evaluation region corresponding to the second viewpoint image outputted by the adjustment target optical system, based on the set coordinates of the imaging condition evaluation region corresponding to the first viewpoint image, and on the calculated amount of parallax; and adjusting imaging conditions of the reference optical system and the adjustment target optical system, based on image data in the imaging condition evaluation region corresponding to the first viewpoint image, at the set coordinates, and on image data in the imaging condition evaluation region corresponding to the second viewpoint image, at the calculated coordinates, and outputting the viewpoint images in the adjusted imaging conditions.

A portable hand-holdable digital camera is described in Patent Cooperation Treaty (PCT) International Publication Number WO 2012/013914 by Adam LOMAS entitled: “Portable Hand-Holdable Digital Camera with Range Finder”, which is incorporated in its entirety for all purposes as if fully set forth herein. The digital camera comprises a camera housing having a display, a power button, a shoot button, a flash unit, and a battery compartment; capture means for capturing an image of an object in two-dimensional form and for outputting the captured two-dimensional image to the display; first range finder means including a zoomable lens unit supported by the housing for focusing on an object and calculation means for calculating a first distance of the object from the lens unit and thus a distance between points on the captured two-dimensional image viewed and selected on the display; and second range finder means including an emitted-beam range finder on the housing for separately calculating a second distance of the object from the emitted-beam range finder and for outputting the second distance to the calculation means of the first range finder means for combination therewith to improve distance determination accuracy.

A camera that receives light from a field of view, produces signals representative of the received light, and intermittently reads the signals to create a photographic image is described in U.S. Pat. No. 5,189,463 to Axelrod et al. entitled: “Camera Aiming Mechanism and Method”, which is incorporated in its entirety for all purposes as if fully set forth herein. The intermittent reading results in intermissions between readings. The invention also includes a radiant energy source that works with the camera. The radiant energy source produces a beam of radiant energy and projects the beam during intermissions between readings. The beam produces a light pattern on an object within or near the camera's field of view, thereby identifying at least a part of the field of view. The radiant energy source is often a laser and the radiant energy beam is often a laser beam. A detection mechanism that detects the intermissions and produces a signal that causes the radiant energy source to project the radiant energy beam. The detection mechanism is typically an electrical circuit including a re-triggerable multivibrator or another functionally similar component.

Image. A digital image is a numeric representation (normally binary) of a two-dimensional image. Depending on whether the image resolution is fixed, it may be of a vector or raster type. Raster images have a finite set of digital values, called picture elements or pixels. The digital image contains a fixed number of rows and columns of pixels, which are the smallest individual element in an image, holding quantized values that represent the brightness of a given color at any specific point. Typically, the pixels are stored in computer memory as a raster image or raster map, a two-dimensional array of small integers, where these values are commonly transmitted or stored in a compressed form. The raster images can be created by a variety of input devices and techniques, such as digital cameras, scanners, coordinate-measuring machines, seismographic profiling, airborne radar, and more. Common image formats include GIF, JPEG, and PNG.

The Graphics Interchange Format (known by its acronym GIF) is a bitmap image format that supports up to 8 bits per pixel for each image, allowing a single image to reference its palette of up to 256 different colors chosen from the 24-bit RGB color space. It also supports animations and allows a separate palette of up to 256 colors for each frame. GIF images are compressed using the Lempel-Ziv-Welch (LZW) lossless data compression technique to reduce the file size without degrading the visual quality. The GIF (GRAPHICS INTERCHANGE FORMAT) Standard Version 89a is available from www.w3.org/Graphics/GIF/spcc-gif89a.txt.

JPEG (seen most often with the .jpg or .jpeg filename extension) is a commonly used method of lossy compression for digital images, particularly for those images produced by digital photography. The degree of compression can be adjusted, allowing a selectable tradeoff between storage size and image quality and typically achieves 10:1 compression with little perceptible loss in image quality. JPEG/Exif is the most common image format used by digital cameras and other photographic image capture devices, along with JPEG/JFIF. The term “JPEG” is an acronym for the Joint Photographic Experts Group, which created the standard. JPEG/JFIF supports a maximum image size of 65535×65535 pixels—one to four gigapixels (1000 megapixels), depending on the aspect ratio (from panoramic 3:1 to square). JPEG is standardized under as ISO/IEC 10918-1:1994 entitled: “Information technology—Digital compression and coding of continuous-tone still images: Requirements and guidelines”.

Portable Network Graphics (PNG) is a raster graphics file format that supports lossless data compression that was created as an improved replacement for Graphics Interchange Format (GIF), and is commonly used as lossless image compression format on the Internet. PNG supports palette-based images (with palettes of 24-bit RGB or 32-bit RGBA colors), grayscale images (with or without alpha channel), and full-color non-palette-based RGB images (with or without alpha channel). PNG was designed for transferring images on the Internet, not for professional-quality print graphics, and, therefore, does not support non-RGB color spaces such as CMYK. PNG was published as an ISO/IEC15948: 2004 standard entitled: “Information technology—Computer graphics and image processing—Portable Network Graphics (PNG): Functional specification”.

Further, a digital image acquisition system that includes a portable apparatus for capturing digital images and a digital processing component for detecting, analyzing, invoking subsequent image captures, informing the photographer regarding motion blur, and reducing the camera motion blur in an image captured by the apparatus, is described in U.S. Pat. No. 8,244,053 entitled: “Method and Apparatus for Initiating Subsequent Exposures Based on Determination of Motion Blurring Artifacts”, and in U.S. Pat. No. 8,285,067 entitled: “Method Notifying Users Regarding Motion Artifacts Based on Image Analysis”, both to Steinberg et al. which are both incorporated in their entirety for all purposes as if fully set forth herein.

Furthermore, a camera that has the release button, a timer, a memory, and a control part, and the timer measures elapsed time after the depressing of the release button is released, used to prevent a shutter release moment to take a good picture from being missed by shortening time required for focusing when a release button is depressed again, is described in Japanese Patent Application Publication No. JP2008033200 to Hyo Hana entitled: “Camera”, a through-image that is read by a face detection processing circuit, and the face of an object is detected, and is detected again by the face detection processing circuit while half-pressing a shutter button, used to provide an imaging apparatus capable of photographing a quickly moving child without fail, is described in a Japanese Patent Application Publication No. JP2007208922 to Uchida Akihiro entitled: “Imaging Apparatus”, and a digital camera that executes image evaluation processing for automatically evaluating a photographic image (exposure condition evaluation, contrast evaluation, blur or focus blur evaluation), and used to enable an image photographing apparatus such as a digital camera to automatically correct a photographic image, is described in Japanese Patent Application Publication No. JP2006050494 to Kita Kazunori entitled: “Image Photographing Apparatus”, which are all incorporated in their entirety for all purposes as if fully set forth herein.

Gyroscope. A gyroscope is a device commonly used for measuring or maintaining orientation and angular velocity. It is typically based on a spinning wheel or disc in which the axis of rotation is free to assume any orientation by itself. When rotating, the orientation of this axis is unaffected by tilting or rotation of the mounting, according to the conservation of angular momentum. Gyroscopes based on other operating principles also exist, such as the microchip-packaged MEMS gyroscopes found in electronic devices, solid-state ring lasers, fiber-optic gyroscopes, and the extremely sensitive quantum gyroscope. MEMS gyroscopes are popular in some consumer electronics, such as smartphones.

A gyroscope is typically a wheel mounted in two or three gimbals, which are pivoted supports that allow the rotation of the wheel about a single axis. A set of three gimbals, one mounted on the other with orthogonal pivot axes, may be used to allow a wheel mounted on the innermost gimbal to have an orientation remaining independent of the orientation, in space, of its support. In the case of a gyroscope with two gimbals, the outer gimbal, which is the gyroscope frame, is mounted to pivot about an axis in its own plane determined by the support. This outer gimbal possesses one degree of rotational freedom and its axis possesses none. The inner gimbal is mounted in the gyroscope frame (outer gimbal) so as to pivot about an axis in its own plane that is always perpendicular to the pivotal axis of the gyroscope frame (outer gimbal). This inner gimbal has two degrees of rotational freedom. The axle of the spinning wheel defines the spin axis. The rotor is constrained to spin about an axis, which is always perpendicular to the axis of the inner gimbal, so the rotor possesses three degrees of rotational freedom and its axis possesses two. The wheel responds to a force applied to the input axis by a reaction force to the output axis. A gyroscope flywheel will roll or resist about the output axis depending upon whether the output gimbals are of a free or fixed configuration. Examples of some free-output-gimbal devices would be the attitude reference gyroscopes used to sense or measure the pitch, roll, and yaw attitude angles in a spacecraft or aircraft.

Accelerometer. An accelerometer is a device that measures proper acceleration, typically being the acceleration (or rate of change of velocity) of a body in its own instantaneous rest frame. Single- and multi-axis models of the accelerometer are available to detect the magnitude and direction of the proper acceleration, as a vector quantity, and can be used to sense orientation (because the direction of weight changes), coordinate acceleration, vibration, shock, and falling in a resistive medium (a case where the proper acceleration changes, since it starts at zero, then increases). Micro-machined Microelectromechanical Systems (MEMS) accelerometers are increasingly present in portable electronic devices and video game controllers, to detect the position of the device or provide game input. Conceptually, an accelerometer behaves as a damped mass on a spring. When the accelerometer experiences an acceleration, the mass is displaced to the point that the spring is able to accelerate the mass at the same rate as the casing. The displacement is then measured to give the acceleration.

In commercial devices, piezoelectric, piezoresistive, and capacitive components are commonly used to convert mechanical motion into an electrical signal. Piezoelectric accelerometers rely on piezoceramics (e.g., lead zirconate titanate) or single crystals (e.g., quartz, tourmaline). They are unmatched in terms of their upper-frequency range, low packaged weight, and high-temperature range. Piezoresistive accelerometers are preferred in high shock applications. Capacitive accelerometers typically use a silicon micro-machined sensing element. Their performance is superior in the low-frequency range and they can be operated in servo mode to achieve high stability and linearity. Modern accelerometers are often small micro electro-mechanical systems (MEMS), and are the simplest MEMS devices possible, consisting of little more than a cantilever beam with a proof mass (also known as seismic mass). Damping results from the residual gas sealed in the device. As long as the Q-factor is not too low, damping does not result in a lower sensitivity. Most micromechanical accelerometers operate in-plane, that is, they are designed to be sensitive only to a direction in the plane of the die. By integrating two devices perpendicularly on a single die a two-axis accelerometer can be made. By adding another out-of-plane device, three axes can be measured. Such a combination may have a much lower misalignment error than three discrete models combined after packaging.

A laser accelerometer comprises a frame having three orthogonal input axes and multiple proof masses, each proof mass having a predetermined blanking surface. A flexible beam supports each proof mass. The flexible beam permits the movement of the proof mass on the input axis. A laser light source provides a light ray. The laser source is characterized to have a transverse field characteristic having a central null intensity region. A mirror transmits a ray of light to a detector. The detector is positioned to be centered on the light ray and responds to the transmitted light ray intensity to provide an intensity signal. The intensity signal is characterized to have a magnitude related to the intensity of the transmitted light ray. The proof mass blanking surface is centrally positioned within and normal to the light ray null intensity region to provide increased blanking of the light ray in response to transverse movement of the mass on the input axis. The proof mass deflects the flexible beam and moves the blanking surface in a direction transverse to the light ray to partially blank the light beam in response to acceleration in the direction of the input axis. A control responds to the intensity signal to apply a restoring force to restore the proof mass to a central position and provides an output signal proportional to the restoring force.

A motion sensor may include one or more accelerometers, which measure the absolute acceleration or the acceleration relative to freefall. For example, one single-axis accelerometer per axis may be used, requiring three such accelerometers for three-axis sensing. The motion sensor may be a single or multi-axis sensor, detecting the magnitude and direction of the acceleration as a vector quantity, and thus can be used to sense orientation, acceleration, vibration, shock, and falling. The motion sensor output may be analog or digital signals, representing the measured values. The motion sensor may be based on a piezoelectric accelerometer that utilizes the piezoelectric effect of certain materials to measure dynamic changes in mechanical variables (e.g., acceleration, vibration, and mechanical shock). Piezoelectric accelerometers commonly rely on piezoceramics (e.g., lead zirconate titanate) or single crystals (e.g., Quartz, Tourmaline). An example of a MEMS motion sensor is LIS302DL manufactured by STMicroelectronics NV and described in Data-sheet LIS302DL STMicroelectronics NV, ‘MEMS motion sensor 3-axis—±2 g/±8 g smart digital output “piccolo” accelerometer’, Rev. 4, October 2008, which is incorporated in its entirety for all purposes as if fully set forth herein.

Alternatively or in addition, the motion sensor may be based on an electrical tilt and vibration switch or any other electromechanical switch, such as the sensor described in U.S. U.S. Pat. No. 7,326,866 to Whitmore et al. entitled: “Omnidirectional Tilt and vibration sensor”, which is incorporated in its entirety for all purposes as if fully set forth herein. An example of an electromechanical switch is SQ-SEN-200 available from SignalQuest, Inc. of Lebanon, NH, USA, described in the data-sheet ‘DATASHEET SQ-SEN-200 Omnidirectional Tilt and Vibration Sensor’ Updated 2009 Aug. 3, which is incorporated in its entirety for all purposes as if fully set forth herein. Other types of motion sensors may be equally used, such as devices based on piezoelectric, piezo-resistive, and capacitive components, to convert the mechanical motion into an electrical signal. Using an accelerometer to control is disclosed in U.S. Pat. No. 7,774,155 to Sato et al. entitled: “Accelerometer-Based Controller”, which is incorporated in its entirety for all purposes as if fully set forth herein.

IMU. The Inertial Measurement Unity (IMU) is an integrated sensor package that combines multiple accelerometers and gyros to produce a three-dimensional measurement of both specific force and angular rate, with respect to an inertial reference frame, such as the Earth-Centered Inertial (ECI) reference frame. Specific force is a measure of acceleration relative to free-fall. Subtracting the gravitational acceleration results in a measurement of actual coordinate acceleration. Angular rate is a measure of rate of rotation. Typically, IMU includes the combination of only a 3-axis accelerometer combined with a 3-axis gyro. An onboard processor, memory, and temperature sensor may be included to provide a digital interface, unit conversion, and to apply a sensor calibration model. An IMU may include one or more motion sensors.

An Inertial Measurement Unit (IMU) further measures and reports a body's specific force, angular rate, and sometimes the magnetic field surrounding the body, using a combination of accelerometers and gyroscopes, sometimes also magnetometers. IMUs are typically used to maneuver aircraft, including Unmanned Aerial Vehicles (UAVs), among many others, and spacecraft, including satellites and landers. The IMU is the main component of inertial navigation systems used in aircraft, spacecraft, watercraft, drones, UAVs, and guided missiles among others. In this capacity, the data collected from the IMU's sensors allows a computer to track a craft's position, using a method known as dead reckoning.

An inertial measurement unit works by detecting the current rate of acceleration using one or more accelerometers, and detects changes in rotational attributes like pitch, roll, and yaw using one or more gyroscopes. Typical IMU also includes a magnetometer, mostly to assist calibration against orientation drift. Inertial navigation systems contain IMUs that have angular and linear accelerometers (for changes in position); some IMUs include a gyroscopic element (for maintaining an absolute angular reference). Angular accelerometers measure how the vehicle is rotating in space. Generally, there is at least one sensor for each of the three axes: pitch (nose up and down), yaw (nose left and right), and roll (clockwise or counter-clockwise from the cockpit). Linear accelerometers measure non-gravitational accelerations of the vehicle. Since it can move in three axes (up & down, left & right, forward & back), there is a linear accelerometer for each axis. The three gyroscopes are commonly placed in a similar orthogonal pattern, measuring rotational position in reference to an arbitrarily chosen coordinate system. A computer continually calculates the vehicle's current position. First, for each of the six degrees of freedom (x,y,z, and θx, θy, and θz), it integrates over time the sensed acceleration, together with an estimate of gravity, to calculate the current velocity. Then it integrates the velocity to calculate the current position.

An example of an IMU is a module Part Number LSM9DS1 available from STMicroelectronics NV headquartered in Geneva, Switzerland, and described in a datasheet published on March 2015 and entitled: “LSM9DSI—iNEMO inertial module: 3D accelerometer, 3D gyroscope, 3D magnetometer”, which is incorporated in its entirety for all purposes as if fully set forth herein. Another example of an IMU is unit Part Number STIM300 available from Sensonor AS, headquartered in Horten, Norway, and is described in a datasheet dated October 2015 [TS1524 rev. 20] entitled: “ButterflyGyro™—STIM300 Intertia Measurement Unit”, which is incorporated in its entirety for all purposes as if fully set forth herein.

GPS. The Global Positioning System (GPS) is a space-based radio navigation system owned by the United States government and operated by the United States Air Force. It is a global navigation satellite system that provides geolocation and time information to a GPS receiver anywhere on or near the Earth where there is an unobstructed line of sight to four or more GPS satellites. The GPS system does not require the user to transmit any data, and it operates independently of any telephonic or internet reception, though these technologies can enhance the usefulness of the GPS positioning information. The GPS system provides critical positioning capabilities to military, civil, and commercial users around the world. The United States government created the system, maintains it, and makes it freely accessible to anyone with a GPS receiver. In addition to GPS, other systems are in use or under development, mainly because of a potential denial of access by the US government. The Russian Global Navigation Satellite System (GLONASS) was developed contemporaneously with GPS, but suffered from incomplete coverage of the globe until the mid-2000s. GLONASS can be added to GPS devices, making more satellites available and enabling positions to be fixed more quickly and accurately, to within two meters. There are also the European Union Galileo positioning system, China's BeiDou Navigation Satellite System, and India's NAVIC.

The Indian Regional Navigation Satellite System (IRNSS) with an operational name of NAVIC (“sailor” or “navigator” in Sanskrit, Hindi, and many other Indian languages, which also stands for NA Vigation with Indian Constellation) is an autonomous regional satellite navigation system, that provides accurate real-time positioning and timing services. It covers India and a region extending 1,500 km (930 mi) around it, with plans for further extension. NAVIC signals will consist of a Standard Positioning Service and a Precision Service. Both will be carried on L5 (1176.45 MHz) and S-band (2492.028 MHz). The SPS signal will be modulated by a 1 MHz BPSK signal. The navigation signals themselves would be transmitted in the S-band frequency (2-4 GHZ) and broadcast through a phased array antenna to maintain the required coverage and signal strength. The satellites would weigh approximately 1,330 kg and their solar panels generate 1,400 watts. A messaging interface is embedded in the NavIC system. This feature allows the command center to send warnings to a specific geographic area. For example, fishermen using the system can be warned about a cyclone.

The GPS concept is based on time and the known position of specialized satellites, which carry very stable atomic clocks that are synchronized with one another and to ground clocks, and any drift from true time maintained on the ground is corrected daily. The satellite locations are known with great precision. GPS receivers have clocks as well; however, they are usually not synchronized with true time and are less stable. GPS satellites continuously transmit their current time and position, and a GPS receiver monitors multiple satellites and solves equations to determine the precise position of the receiver and its deviation from true time. At a minimum, four satellites must be in view of the receiver for it to compute four unknown quantities (three position coordinates and clock deviation from satellite time).

Each GPS satellite continually broadcasts a signal (carrier wave with modulation) that includes: (a) A pseudorandom code (sequence of ones and zeros) that is known to the receiver. By time-aligning, a receiver-generated version and the receiver-measured version of the code, the Time-of-Arrival (TOA) of a defined point in the code sequence, called an epoch, can be found in the receiver clock time scale. (b) A message that includes the Time-of-Transmission (TOT) of the code epoch (in GPS system time scale) and the satellite position at that time. Conceptually, the receiver measures the TOAs (according to its own clock) of four satellite signals. From the TOAs and the TOTs, the receiver forms four Time-Of-Flight (TOF) values, which are (given the speed of light) approximately equivalent to receiver-satellite range differences. The receiver then computes its three-dimensional position and clock deviation from the four TOFs. In practice, the receiver position (in three-dimensional Cartesian coordinates with origin at the Earth's center) and the offset of the receiver clock relative to the GPS time are computed simultaneously, using the navigation equations to process the TOFs. The receiver's Earth-centered solution location is usually converted to latitude, longitude, and height relative to an ellipsoidal Earth model. The height may then be further converted to a height relative to the geoid (e.g., EGM96) (essentially, mean sea level). These coordinates may be displayed, e.g., on a moving map display, and/or recorded and/or used by some other system (e.g., a vehicle guidance system).

Although usually not formed explicitly in the receiver processing, the conceptual Time-Differences-of-Arrival (TDOAs) define the measurement geometry. Each TDOA corresponds to a hyperboloid of revolution. The line connecting the two satellites involved (and its extensions) forms the axis of the hyperboloid. The receiver is located at the point where three hyperboloids intersect.

In a typical GPS operation as a navigator, four or more satellites must be visible to obtain an accurate result. The solution of the navigation equations gives the position of the receiver along with the difference between the time kept by the receiver's on-board clock and the true time-of-day, thereby eliminating the need for a more precise and possibly impractical receiver-based clock. Applications for GPS such as time transfer, traffic signal timing, and synchronization of cell phone base stations, make use of this cheap and highly accurate timing. Some GPS applications use this time for display, or, other than for the basic position calculations, do not use it at all. Although four satellites are required for normal operation, fewer apply in special cases. If one variable is already known, a receiver can determine its position using only three satellites. For example, a ship or aircraft may have a known elevation. Some GPS receivers may use additional clues or assumptions such as reusing the last known altitude, dead reckoning, inertial navigation, or including information from the vehicle computer, to give a (possibly degraded) position when fewer than four satellites are visible.

The GPS level of performance is described in the 4th Edition of a document published September 2008 by the U.S. Department of Defense (DoD) entitled: “GLOBAL POSITIONING SYSTEM—STANDARD POSITIONING SERVICE PERFORMANCE STANDARD”, which is incorporated in its entirety for all purposes as if fully set forth herein. The GPS is described in a book by Jean-Marie_Zogg (dated 26 Mar. 2002) published by u-blox AG (of CH-8800 Thalwil, Switzerland) [Doc Id GPS-X-02007] entitled: “GPS Basics—Introduction to the system—Application overview”, and in a book by El-Rabbany, Ahmed published 2002 by ARTECH HOUSE, INC. [ISBN 1-58053-183-1] entitled: “Introduction to GPS: the Global Positioning System”, which are both incorporated in their entirety for all purposes as if fully set forth herein. Methods and systems for enhancing line records with Global Positioning System coordinates are disclosed in in U.S. Pat. No. 7,932,857 to Ingman et al., entitled: “GPS for communications facility records”, which is incorporated in its entirety for all purposes as if fully set forth herein. Global Positioning System information is acquired and a line record is assembled for an address using the Global Positioning System information.

GNSS stands for Global Navigation Satellite System, and is the standard generic term for satellite navigation systems that provide autonomous geo-spatial positioning with global coverage. The GPS is an example of GNSS. GNSS-1 is the first generation system and is the combination of existing satellite navigation systems (GPS and GLONASS), with Satellite Based Augmentation Systems (SBAS) or Ground Based Augmentation Systems (GBAS). In the United States, the satellite-based component is the Wide Area Augmentation System (WAAS), in Europe it is the European Geostationary Navigation Overlay Service (EGNOS), and in Japan it is the Multi-Functional Satellite Augmentation System (MSAS). Ground-based augmentation is provided by systems like the Local Area Augmentation System (LAAS). GNSS-2 is the second generation of systems that independently provides a full civilian satellite navigation system, exemplified by the European Galileo positioning system. These systems will provide the accuracy and integrity monitoring necessary for civil navigation; including aircraft. This system consists of L1 and L2 frequencies (in the L band of the radio spectrum) for civil use and L5 for system integrity. Development is also in progress to provide GPS with civil use L2 and L5 frequencies, making it a GNSS-2 system.

An example of global GNSS-2 is the GLONASS (GLObal NAvigation Satellite System) operated and provided by the formerly Soviet, and now Russia, and is a space-based satellite navigation system that provides a civilian radio-navigation-satellite service and is also used by the Russian Aerospace Defence Forces. The full orbital constellation of 24 GLONASS satellites enables full global coverage. Other core GNSS are Galileo (European Union) and Compass (China). The Galileo positioning system is operated by The European Union and European Space Agency. Galileo became operational on 15 Dec. 2016 (global Early Operational Capability (EOC), and the system of 30 MEO satellites was originally scheduled to be operational in 2010. Galileo is expected to be compatible with the modernized GPS system. The receivers will be able to combine the signals from both Galileo and GPS satellites to greatly increase the accuracy. Galileo is expected to be in full service in 2020 and at a substantially higher cost. The main modulation used in Galileo Open Service signal is the Composite Binary Offset Carrier (CBOC) modulation. An example of regional GNSS is China's Beidou. China has indicated they plan to complete the entire second generation Beidou Navigation Satellite System (BDS or BeiDou-2, formerly known as COMPASS), by expanding current regional (Asia-Pacific) service into global coverage by 2020. The BeiDou-2 system is proposed to consist of 30 MEO satellites and five geostationary satellites.

Wireless. Any embodiment herein may be used in conjunction with one or more types of wireless communication signals and/or systems, for example, Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (RTM), Global Positioning System (GPS), Wi-Fi, Wi-Max, ZigBec™, Ultra-Wideband (UWB), Global System for Mobile communication (GSM), 2G, 2.5G, 3G, 3.5G, Enhanced Data rates for GSM Evolution (EDGE), or the like. Any wireless network or wireless connection herein may be operating substantially in accordance with existing IEEE 802.11, 802.11a, 802.11b, 802.11g, 802.11k, 802.11n, 802.11r, 802.16, 802.16d, 802.16c, 802.20, 802.21 standards and/or future versions and/or derivatives of the above standards. Further, a network element (or a device) herein may consist of, be part of, or include, a cellular radio-telephone communication system, a cellular telephone, a wireless telephone, a Personal Communication Systems (PCS) device, a PDA device that incorporates a wireless communication device, or a mobile/portable Global Positioning System (GPS) device. Further, wireless communication may be based on wireless technologies that are described in Chapter 20: “Wireless Technologies” of the publication number 1-587005-001-3 by Cisco Systems, Inc. (July 1999) entitled: “Internetworking Technologies Handbook”, which is incorporated in its entirety for all purposes as if fully set forth herein. Wireless technologies and networks are further described in a book published 2005 by Pearson Education, Inc. William Stallings [ISBN: 0-13-191835-4] entitled: “Wireless Communications and Networks—second Edition”, which is incorporated in its entirety for all purposes as if fully set forth herein.

Wireless networking typically employs an antenna (a.k.a. aerial), which is an electrical device that converts electric power into radio waves, and vice versa, connected to a wireless radio transceiver. In transmission, a radio transmitter supplies an electric current oscillating at radio frequency to the antenna terminals, and the antenna radiates the energy from the current as electromagnetic waves (radio waves). In reception, an antenna intercepts some of the power of an electromagnetic wave in order to produce a low-voltage at its terminals that is applied to a receiver to be amplified. Typically an antenna consists of an arrangement of metallic conductors (elements), electrically connected (often through a transmission line) to the receiver or transmitter. An oscillating current of electrons forced through the antenna by a transmitter will create an oscillating magnetic field around the antenna elements, while the charge of the electrons also creates an oscillating electric field along the elements. These time-varying fields radiate away from the antenna into space as a moving transverse electromagnetic field wave. Conversely, during reception, the oscillating electric and magnetic fields of an incoming radio wave exert force on the electrons in the antenna elements, causing them to move back and forth, creating oscillating currents in the antenna. Antennas can be designed to transmit and receive radio waves in all horizontal directions equally (omnidirectional antennas), or preferentially in a particular direction (directional or high gain antennas). In the latter case, an antenna may also include additional elements or surfaces with no electrical connection to the transmitter or receiver, such as parasitic elements, parabolic reflectors, or horns, which serve to direct the radio waves into a beam or other desired radiation pattern.

ISM. The Industrial, Scientific and Medical (ISM) radio bands are radio bands (portions of the radio spectrum) reserved internationally for the use of radio frequency (RF) energy for industrial, scientific and medical purposes other than telecommunications. In general, communications equipment operating in these bands must tolerate any interference generated by ISM equipment, and users have no regulatory protection from ISM device operation. The ISM bands are defined by the ITU-R in 5.138, 5.150, and 5.280 of the Radio Regulations. Individual countries use of the bands designated in these sections may differ due to variations in national radio regulations. Because communication devices using the ISM bands must tolerate any interference from ISM equipment, unlicensed operations are typically permitted to use these bands, since unlicensed operation typically needs to be tolerant of interference from other devices anyway. The ISM bands share allocations with unlicensed and licensed operations; however, due to the high likelihood of harmful interference, licensed use of the bands is typically low. In the United States, uses of the ISM bands are governed by Part 18 of the Federal Communications Commission (FCC) rules, while Part 15 contains the rules for unlicensed communication devices, even those that share ISM frequencies. In Europe, the ETSI is responsible for governing ISM bands.

Commonly used ISM bands include a 2.45 GHz band (also known as 2.4 GHz band) that includes the frequency band between 2.400 GHz and 2.500 GHz, a 5.8 GHz band that includes the frequency band 5.725-5.875 GHZ, a 24 GHz band that includes the frequency band 24.000-24.250 GHZ, a 61 GHz band that includes the frequency band 61.000-61.500 GHz, a 122 GHz band that includes the frequency band 122.000-123.000 GHZ, and a 244 GHz band that includes the frequency band 244.000-246.000 GHZ.

ZigBee. ZigBee is a standard for a suite of high-level communication protocols using small, low-power digital radios based on an IEEE 802 standard for Personal Area Network (PAN). Applications include wireless light switches, electrical meters with in-home displays, and other consumer and industrial equipment that require a short-range wireless transfer of data at relatively low rates. The technology defined by the ZigBee specification is intended to be simpler and less expensive than other WPANs, such as Bluetooth. ZigBee is targeted at Radio-Frequency (RF) applications that require a low data rate, long battery life, and secure networking. ZigBee has a defined rate of 250 kbps suited for periodic or intermittent data or a single signal transmission from a sensor or input device.

ZigBee builds upon the physical layer and medium access control defined in IEEE standard 802.15.4 (2003 version) for low-rate WPANs. The specification further discloses four main components: network layer, application layer, ZigBee Device Objects (ZDOs), and manufacturer-defined application objects, which allow for customization and favor total integration. The ZDOs are responsible for several tasks, which include the keeping of device roles, management of requests to join a network, device discovery, and security. Because ZigBee nodes can go from sleep to active mode in 30 ms or less, the latency can be low and devices can be responsive, particularly compared to Bluetooth wake-up delays, which are typically around three seconds. ZigBee nodes can sleep most of the time, thus the average power consumption can be lower, resulting in longer battery life.

There are three defined types of ZigBee devices: ZigBee Coordinator (ZC), ZigBee Router (ZR), and ZigBee End Device (ZED). ZigBee Coordinator (ZC) is the most capable device and forms the root of the network tree and might bridge to other networks. There is exactly one defined ZigBee coordinator in each network since it is the device that started the network originally. It can store information about the network, including acting as the Trust Center & repository for security keys. ZigBee Router (ZR) may be running an application function as well as may be acting as an intermediate router, passing on data from other devices. ZigBee End Device (ZED) contains functionality to talk to a parent node (either the coordinator or a router). This relationship allows the node to be asleep a significant amount of time, thereby giving long battery life. A ZED requires the least amount of memory and therefore can be less expensive to manufacture than a ZR or ZC.

The protocols build on recent algorithmic research (Ad-hoc On-demand Distance Vector, neuRFon) to automatically construct a low-speed ad-hoc network of nodes. In most large network instances, the network will be a cluster of clusters. It can also form a mesh or a single cluster. The current ZigBee protocols support beacon and non-beacon enabled networks. In non-beacon-enabled networks, an unslotted CSMA/CA channel access mechanism is used. In this type of network, ZigBee Routers typically have their receivers continuously active, requiring a more robust power supply. However, this allows for heterogeneous networks in which some devices receive continuously, while others only transmit when an external stimulus is detected.

In beacon-enabled networks, the special network nodes called ZigBee Routers transmit periodic beacons to confirm their presence to other network nodes. Nodes may sleep between the beacons, thus lowering their duty cycle and extending their battery life. Beacon intervals depend on the data rate; they may range from 15.36 milliseconds to 251.65824 seconds at 250 Kbit/s, from 24 milliseconds to 393.216 seconds at 40 Kbit/s, and from 48 milliseconds to 786.432 seconds at 20 Kbit/s. In general, the ZigBee protocols minimize the time the radio is on to reduce power consumption. In beaconing networks, nodes only need to be active while a beacon is being transmitted. In non-beacon-enabled networks, power consumption is decidedly asymmetrical: some devices are always active while others spend most of their time sleeping.

Except for the Smart Energy Profile 2.0, current ZigBee devices conform to the IEEE 802.15.4-2003 Low-Rate Wireless Personal Area Network (LR-WPAN) standard. The standard specifies the lower protocol layers—the PHYsical layer (PHY), and the Media Access Control (MAC) portion of the Data Link Layer (DLL). The basic channel access mode is “Carrier Sense, Multiple Access/Collision Avoidance” (CSMA/CA), that is, the nodes talk in the same way that people converse; they briefly check to see that no one is talking before they start. There are three notable exceptions to the use of CSMA. Beacons are sent on a fixed time schedule, and do not use CSMA. Message acknowledgments also do not use CSMA. Finally, devices in Beacon Oriented networks that have low latency real-time requirements may also use Guaranteed Time Slots (GTS), which by definition do not use CSMA.

Z-Wave. Z-Wave is a wireless communications protocol by the Z-Wave Alliance (http://www.z-wave.com) designed for home automation, specifically for remote control applications in residential and light commercial environments. The technology uses a low-power RF radio embedded or retrofitted into home electronics devices and systems, such as lighting, home access control, entertainment systems, and household appliances. Z-Wave communicates using a low-power wireless technology designed specifically for remote control applications. Z-Wave operates in the sub-gigahertz frequency range, around 900 MHz. This band competes with some cordless telephones and other consumer electronics devices but avoids interference with WiFi and other systems that operate on the crowded 2.4 GHz band. Z-Wave is designed to be easily embedded in consumer electronics products, including battery-operated devices such as remote controls, smoke alarms, and security sensors.

Z-Wave is a mesh networking technology where each node or device on the network is capable of sending and receiving control commands through walls or floors, and uses intermediate nodes to route around household obstacles or radio dead spots that might occur in the home. Z-Wave devices can work individually or in groups, and can be programmed into scenes or events that trigger multiple devices, either automatically or via remote control. The Z-wave radio specifications include bandwidth of 9,600 bit/s or 40 Kbit/s, fully interoperable, GFSK modulation, and a range of approximately 100 feet (or 30 meters) assuming “open air” conditions, with reduced range indoors depending on building materials, etc. The Z-Wave radio uses the 900 MHz ISM band: 908.42 MHz (United States); 868.42 MHz (Europe); 919.82 MHz (Hong Kong); and 921.42 MHz (Australia/New Zealand).

Z-Wave uses a source-routed mesh network topology and has one or more master controllers that control routing and security. The devices can communicate to another by using intermediate nodes to actively route around, and circumvent household obstacles or radio dead spots that might occur. A message from node A to node C can be successfully delivered even if the two nodes are not within range, providing that a third node B can communicate with nodes A and C. If the preferred route is unavailable, the message originator will attempt other routes until a path is found to the “C” node. Therefore, a Z-Wave network can span much farther than the radio range of a single unit; however, with several of these hops, a delay may be introduced between the control command and the desired result. In order for Z-Wave units to be able to route unsolicited messages, they cannot be in sleep mode. Therefore, most battery-operated devices are not designed as repeater units. A Z-Wave network can consist of up to 232 devices with the option of bridging networks if more devices are required.

WWAN. Any wireless network herein may be a Wireless Wide Area Network (WWAN) such as a wireless broadband network, and the WWAN port may be an antenna and the WWAN transceiver may be a wireless modem. The wireless network may be a satellite network, the antenna may be a satellite antenna, and the wireless modem may be a satellite modem. The wireless network may be a WiMAX network such as according to, compatible with, or based on, IEEE 802.16-2009, the antenna may be a WiMAX antenna, and the wireless modem may be a WiMAX modem. The wireless network may be a cellular telephone network, the antenna may be a cellular antenna, and the wireless modem may be a cellular modem. The cellular telephone network may be a Third Generation (3G) network, and may use UMTS W-CDMA, UMTS HSPA, UMTS TDD, CDMA2000 1×RTT, CDMA2000 EV-DO, or GSM EDGE-Evolution. The cellular telephone network may be a Fourth Generation (4G) network and may use or be compatible with HSPA+, Mobile WiMAX, LTE, LTE-Advanced, MBWA, or may be compatible with, or based on, IEEE 802.20-2008.

WLAN. Wireless Local Area Network (WLAN), is a popular wireless technology that makes use of the Industrial, Scientific and Medical (ISM) frequency spectrum. In the US, three of the bands within the ISM spectrum are the A band, 902-928 MHz; the B band, 2.4-2.484 GHZ (a.k.a. 2.4 GHz); and the C band, 5.725-5.875 GHz (a.k.a. 5 GHZ). Overlapping and/or similar bands are used in different regions such as Europe and Japan. In order to allow interoperability between equipment manufactured by different vendors, few WLAN standards have evolved, as part of the IEEE 802.11 standard group, branded as WiFi (www.wi-fi.org). IEEE 802.11b describes a communication using the 2.4 GHz frequency band and supporting communication rate of 11 Mb/s, IEEE 802.11a uses the 5 GHz frequency band to carry 54 MB/s and IEEE 802.11g uses the 2.4 GHz band to support 54 Mb/s. The WiFi technology is further described in a publication entitled: “WiFi Technology” by Telecom Regulatory Authority, published on July 2003, which is incorporated in its entirety for all purposes as if fully set forth herein. The IEEE 802 defines an ad-hoc connection between two or more devices without using a wireless access point: the devices communicate directly when in range. An ad hoc network offers peer-to-peer layout and is commonly used in situations such as a quick data exchange or a multiplayer LAN game because the setup is easy and an access point is not required.

A node/client with a WLAN interface is commonly referred to as STA (Wireless Station/Wireless client). The STA functionality may be embedded as part of the data unit, or may be a dedicated unit, referred to as a bridge, coupled to the data unit. While STAs may communicate without any additional hardware (ad-hoc mode), such a network usually involves Wireless Access Point (a.k.a. WAP or AP) as a mediation device. The WAP implements the Basic Stations Set (BSS) and/or ad-hoc mode based on Independent BSS (IBSS). STA, client, bridge, and WAP will be collectively referred to hereon as WLAN unit. Bandwidth allocation for IEEE 802.11g wireless in the U.S. allows multiple communication sessions to take place simultaneously, where eleven overlapping channels are defined spaced 5 MHz apart, spanning from 2412 MHz as the center frequency for channel number 1, via channel 2 centered at 2417 MHz and 2457 MHz as the center frequency for channel number 10, up to channel 11 centered at 2462 MHz. Each channel bandwidth is 22 MHz, symmetrically (+/−11 MHz) located around the center frequency. In the transmission path, first, the baseband signal (IF) is generated based on the data to be transmitted, using 256 QAM (Quadrature Amplitude Modulation) based OFDM (Orthogonal Frequency Division Multiplexing) modulation technique, resulting in a 22 MHz (single channel wide) frequency band signal. The signal is then up-converted to the 2.4 GHz (RF) and placed in the center frequency of the required channel, and transmitted to the air via the antenna. Similarly, the receiving path comprises a received channel in the RF spectrum, down-converted to the baseband (IF) wherein the data is then extracted.

In order to support multiple devices and use a permanent solution, a Wireless Access Point (WAP) is typically used. A Wireless Access Point (WAP, or Access Point-AP) is a device that allows wireless devices to connect to a wired network using Wi-Fi, or related standards. The WAP usually connects to a router (via a wired network) as a standalone device, but can also be an integral component of the router itself. Using Wireless Access Point (AP) allows users to add devices that access the network with little or no cables. A WAP normally connects directly to a wired Ethernet connection, and the AP then provides wireless connections using radio frequency links for other devices to utilize that wired connection. Most APs support the connection of multiple wireless devices to one wired connection. Wireless access typically involves special security considerations, since any device within a range of the WAP can attach to the network. The most common solution is wireless traffic encryption. Modern access points come with built-in encryption such as Wired Equivalent Privacy (WEP) and Wi-Fi Protected Access (WPA), typically used with a password or a passphrase. Authentication in general, and a WAP authentication in particular, is used as the basis for authorization, which determines whether a privilege may be granted to a particular user or process, privacy, which keeps information from becoming known to non-participants, and non-repudiation, which is the inability to deny having done something that was authorized to be done based on the authentication. An authentication in general, and a WAP authentication in particular, may use an authentication server that provides a network service that applications may use to authenticate the credentials, usually account names and passwords of their users. When a client submits a valid set of credentials, it receives a cryptographic ticket that it can subsequently be used to access various services. Authentication algorithms include passwords, Kerberos, and public key encryption.

Prior art technologies for data networking may be based on single carrier modulation techniques, such as AM (Amplitude Modulation), FM (Frequency Modulation), and PM (Phase Modulation), as well as bit encoding techniques such as QAM (Quadrature Amplitude Modulation) and QPSK (Quadrature Phase Shift Keying). Spread spectrum technologies, to include both DSSS (Direct Sequence Spread Spectrum) and FHSS (Frequency Hopping Spread Spectrum) are known in the art. Spread spectrum commonly employs Multi-Carrier Modulation (MCM) such as OFDM (Orthogonal Frequency Division Multiplexing). OFDM and other spread spectrum are commonly used in wireless communication systems, particularly in WLAN networks.

Bluetooth. Bluetooth is a wireless technology standard for exchanging data over short distances (using short-wavelength UHF radio waves in the ISM band from 2.4 to 2.485 GHZ) from fixed and mobile devices, and building personal area networks (PANs). It can connect several devices, overcoming problems of synchronization. A Personal Area Network (PAN) may be according to, compatible with, or based on, Bluetooth™ or IEEE 802.15.1-2005 standard. A Bluetooth controlled electrical appliance is described in U.S. Patent Application No. 2014/0159877 to Huang entitled: “Bluetooth Controllable Electrical Appliance”, and an electric power supply is described in U.S. Patent Application No. 2014/0070613 to Garb et al. entitled: “Electric Power Supply and Related Methods”, which are both incorporated in their entirety for all purposes as if fully set forth herein. Any Personal Area Network (PAN) may be according to, compatible with, or based on, Bluetooth™ or IEEE 802.15.1-2005 standard. A Bluetooth controlled electrical appliance is described in U.S. Patent Application No. 2014/0159877 to Huang entitled: “Bluetooth Controllable Electrical Appliance”, and an electric power supply is described in U.S. Patent Application No. 2014/0070613 to Garb et al. entitled: “Electric Power Supply and Related Methods”, which are both incorporated in their entirety for all purposes as if fully set forth herein.

Bluetooth operates at frequencies between 2402 and 2480 MHz, or 2400 and 2483.5 MHz including guard bands 2 MHz wide at the bottom end and 3.5 MHz wide at the top. This is in the globally unlicensed (but not unregulated) Industrial, Scientific and Medical (ISM) 2.4 GHz short-range radio frequency band. Bluetooth uses a radio technology called frequency-hopping spread spectrum. Bluetooth divides transmitted data into packets, and transmits each packet on one of 79 designated Bluetooth channels. Each channel has a bandwidth of 1 MHz. It usually performs 800 hops per second, with Adaptive Frequency-Hopping (AFH) enabled. Bluetooth low energy uses 2 MHz spacing, which accommodates 40 channels. Bluetooth is a packet-based protocol with a master-slave structure. One master may communicate with up to seven slaves in a piconet. All devices share the master's clock. Packet exchange is based on the basic clock, defined by the master, which ticks at 312.5 us intervals. Two clock ticks make up a slot of 625 us, and two slots make up a slot pair of 1250 us. In the simple case of single-slot packets the master transmits in even slots and receives in odd slots. The slave, conversely, receives in even slots and transmits in odd slots. Packets may be 1, 3 or 5 slots long, but in all cases the master's transmission begins in even slots and the slave's in odd slots.

A master Bluetooth device can communicate with a maximum of seven devices in a piconet (an ad-hoc computer network using Bluetooth technology), though not all devices reach this maximum. The devices can switch roles, by agreement, and the slave can become the master (for example, a headset initiating a connection to a phone necessarily begins as master—as initiator of the connection—but may subsequently operate as slave). The Bluetooth Core Specification provides for the connection of two or more piconets to form a scatternet, in which certain devices simultaneously play the master role in one piconet and the slave role in another. At any given time, data can be transferred between the master and one other device (except for the little-used broadcast mode). The master chooses which slave device to address; typically, it switches rapidly from one device to another in a round-robin fashion. Since it is the master that chooses which slave to address, whereas a slave is supposed to listen in each receive slot, being a master is a lighter burden than being a slave. Being a master of seven slaves is possible; being a slave of more than one master is difficult.

Bluetooth Low Energy. Bluetooth low energy (Bluetooth LE, BLE, marketed as Bluetooth Smart) is a wireless personal area network technology designed and marketed by the Bluetooth Special Interest Group (SIG) aimed at novel applications in the healthcare, fitness, beacons, security, and home entertainment industries. Compared to Classic Bluetooth, Bluetooth Smart is intended to provide considerably reduced power consumption and cost while maintaining a similar communication range. Bluetooth low energy is described in a Bluetooth SIG published Dec. 2, 2014 standard Covered Core Package version: 4.2, entitled: “Master Table of Contents & Compliance Requirements-Specification Volume 0”, and in an article published 2012 in Sensors [ISSN 1424-8220] by Carles Gomez et al. [Sensors 2012, 12, 11734-11753; doi:10.3390/s120211734] entitled: “Overview and Evaluation of Bluetooth Low Energy: An Emerging Low-Power Wireless Technology”, which are both incorporated in their entirety for all purposes as if fully set forth herein.

Bluetooth Smart technology operates in the same spectrum range (the 2.400 GHZ-2.4835 GHZ ISM band) as Classic Bluetooth technology, but uses a different set of channels. Instead of the Classic Bluetooth 79 1-MHz channels, Bluetooth Smart has 40 2-MHz channels. Within a channel, data is transmitted using Gaussian frequency shift modulation, similar to Classic Bluetooth's Basic Rate scheme. The bit rate is 1 Mbit/s, and the maximum transmit power is 10 mW. Bluetooth Smart uses frequency hopping to counteract narrowband interference problems. Classic Bluetooth also uses frequency hopping but the details are different; as a result, while both FCC and ETSI classify Bluetooth technology as an FHSS scheme, Bluetooth Smart is classified as a system using digital modulation techniques or a direct-sequence spread spectrum. All Bluetooth Smart devices use the Generic Attribute Profile (GATT). The application programming interface offered by a Bluetooth Smart aware operating system will typically be based around GATT concepts.

Cellular. Cellular telephone network may be according to, compatible with, or may be based on, a Third Generation (3G) network that uses UMTS W-CDMA, UMTS HSPA, UMTS TDD, CDMA2000 1×RTT, CDMA2000 EV-DO, or GSM EDGE-Evolution. The cellular telephone network may be a Fourth Generation (4G) network that uses HSPA+, Mobile WiMAX, LTE, LTE-Advanced, MBWA, or may be based on or compatible with IEEE 802.20-2008.

Compression. Data compression, also known as source coding and bit-rate reduction, involves encoding information using fewer bits than the original representation. Compression can be either lossy, or lossless. Lossless compression reduces bits by identifying and eliminating statistical redundancy, so that no information is lost in lossless compression. Lossy compression reduces bits by identifying unnecessary information and removing it. The process of reducing the size of a data file is commonly referred to as a data compression. A compression is used to reduce resource usage, such as data storage space, or transmission capacity. Data compression is further described in a Carnegie Mellon University chapter entitled: “Introduction to Data Compression” by Guy E. Blelloch, dated Jan. 31, 2013, which is incorporated in its entirety for all purposes as if fully set forth herein.

In a scheme involving lossy data compression, some loss of information is acceptable. For example, dropping of a nonessential detail from a data can save storage space. Lossy data compression schemes may be informed by research on how people perceive the data involved. For example, the human eye is more sensitive to subtle variations in luminance than it is to variations in color. JPEG image compression works in part by rounding off nonessential bits of information. There is a corresponding trade-off between preserving information and reducing size. A number of popular compression formats exploit these perceptual differences, including those used in music files, images, and video.

Lossy image compression is commonly used in digital cameras, to increase storage capacities with minimal degradation of picture quality. Similarly, DVDs use the lossy MPEG-2 Video codec for video compression. In lossy audio compression, methods of psychoacoustics are used to remove non-audible (or less audible) components of the audio signal. Compression of human speech is often performed with even more specialized techniques, speech coding, or voice coding, is sometimes distinguished as a separate discipline from audio compression. Different audio and speech compression standards are listed under audio codecs. Voice compression is used in Internet telephony, for example, and audio compression is used for CD ripping and is decoded by audio player.

Lossless data compression algorithms usually exploit statistical redundancy to represent data more concisely without losing information, so that the process is reversible. Lossless compression is possible because most real-world data have statistical redundancy. The Lempel-Ziv (LZ) compression methods are among the most popular algorithms for lossless storage. DEFLATE is a variation on LZ optimized for decompression speed and compression ratio, and is used in PKZIP, Gzip and PNG. The LZW (Lempel-Ziv-Welch) method is commonly used in GIF images, and is described in IETF RFC 1951. The LZ methods use a table-based compression model where table entries are substituted for repeated strings of data. For most LZ methods, this table is generated dynamically from earlier data in the input. The table itself is often Huffman encoded (e.g., SHRI, LZX). Typical modern lossless compressors use probabilistic models, such as prediction by partial matching.

Lempel-Ziv-Welch (LZW) is an example of lossless data compression algorithm created by Abraham Lempel, Jacob Ziv, and Terry Welch. The algorithm is simple to implement, and has the potential for very high throughput in hardware implementations. It was the algorithm of the widely used Unix file compression utility compress, and is used in the GIF image format. The LZW and similar algorithms are described in U.S. Pat. No. 4,464,650 to Eastman et al. entitled: “Apparatus and Method for Compressing Data Signals and Restoring the Compressed Data Signals”, in U.S. Pat. No. 4,814,746 to Miller et al. entitled: “Data Compression Method”, and in U.S. Pat. No. 4,558,302 to Welch entitled: “High Speed Data Compression and Decompression Apparatus and Method”, which are all incorporated in their entirety for all purposes as if fully set forth herein.

Image/video. Any content herein may consist of, be part of, or include, an image or a video content. A video content may be in a digital video format that may be based on one out of: TIFF (Tagged Image File Format), RAW format, AVI, DV, MOV, WMV, MP4, DCF (Design Rule for Camera Format), ITU-T H.261, ITU-T H.263, ITU-T H.264, ITU-T CCIR 601, ASF, Exif (Exchangeable Image File Format), and DPOF (Digital Print Order Format) standards. An intraframe or interframe compression may be used, and the compression may be a lossy or a non-lossy (lossless) compression, that may be based on a standard compression algorithm, which may be one or more out of JPEG (Joint Photographic Experts Group) and MPEG (Moving Picture Experts Group), ITU-T H.261, ITU-T H.263, ITU-T H.264 and ITU-T CCIR 601.

Video. The term ‘video’ typically pertains to numerical or electrical representation or moving visual images, commonly referring to recording, reproducing, displaying, or broadcasting the moving visual images. Video, or a moving image in general, is created from a sequence of still images called frames, and by recording and then playing back frames in quick succession, an illusion of movement is created. Video can be edited by removing some frames and combining sequences of frames, called clips, together in a timeline. A Codec, short for ‘coder-decoder’, describes the method in which video data is encoded into a file and decoded when the file is played back. Most video is compressed during encoding, and so the terms codec and compressor are often used interchangeably. Codecs can be lossless or lossy, where lossless codecs are higher quality than lossy codecs, but produce larger file sizes. Transcoding is the process of converting from one codec to another. Common codecs include DV-PAL, HDV, H.264, MPEG-2, and MPEG-4. Digital video is further described in Adobe Digital Video Group publication updated and enhanced March 2004, entitled: “A Digital Video Primer—An introduction to DV production, post-production, and delivery”, which is incorporated in its entirety for all purposes as if fully set forth herein.

Digital video data typically comprises a series of frames, including orthogonal bitmap digital images displayed in rapid succession at a constant rate, measured in Frames-Per-Second (FPS). In interlaced video each frame is composed of two halves of an image (referred to individually as fields, two consecutive fields compose a full frame), where the first half contains only the odd-numbered lines of a full frame, and the second half contains only the even-numbered lines.

Many types of video compression exist for serving digital video over the internet, and on optical disks. The file sizes of digital video used for professional editing are generally not practical for these purposes, and the video requires further compression with codecs such as Sorenson, H.264, and more recently, Apple ProRes especially for HD. Currently widely used formats for delivering video over the internet are MPEG-4, Quicktime, Flash, and Windows Media. Other PCM based formats include CCIR 601 commonly used for broadcast stations, MPEG-4 popular for online distribution of large videos and video recorded to flash memory, MPEG-2 used for DVDs, Super-VCDs, and many broadcast television formats, MPEG-1 typically used for video CDs, and H.264 (also known as MPEG-4 Part 10 or AVC) commonly used for Blu-ray Discs and some broadcast television formats.

The term ‘Standard Definition’ (SD) describes the frame size of a video, typically having either a 4:3 or 16:9 frame aspect ratio. The SD PAL standard defines 4:3 frame size and 720×576 pixels, (or 768×576 if using square pixels), while SD web video commonly uses a frame size of 640×480 pixels. Standard-Definition Television (SDTV) refers to a television system that uses a resolution that is not considered to be either high-definition television (1080i, 1080p, 1440p, 4K UHDTV, and 8K UHD) or enhanced-definition television (EDTV 480p). The two common SDTV signal types are 576i, with 576 interlaced lines of resolution, derived from the European-developed PAL and SECAM systems, and 480i based on the American National Television System Committee NTSC system. In North America, digital SDTV is broadcast in the same 4:3 aspect ratio as NTSC signals with widescreen content being center cut. However, in other parts of the world that used the PAL or SECAM color systems, standard-definition television is now usually shown with a 16:9 aspect ratio. Standards that support digital SDTV broadcast include DVB, ATSC, and ISDB.

The term ‘High-Definition’ (HD) refers multiple video formats, which use different frame sizes, frame rates and scanning methods, offering higher resolution and quality than standard-definition. Generally, any video image with considerably more than 480 horizontal lines (North America) or 576 horizontal lines (Europe) is considered high-definition, where 720 scan lines is commonly the minimum. HD video uses a 16:9 frame aspect ratio and frame sizes that are 1280×720 pixels (used for HD television and HD web video), 1920×1080 pixels (referred to as full-HD or full-raster), or 1440×1080 pixels (full-HD with non-square pixels).

High definition video (prerecorded and broadcast) is defined by the number of lines in the vertical display resolution, such as 1,080 or 720 lines, in contrast to regular digital television (DTV) using 480 lines (upon which NTSC is based, 480 visible scanlines out of 525) or 576 lines (upon which PAL/SECAM are based, 576 visible scanlines out of 625). HD is further defined by the scanning system being progressive scanning (p) or interlaced scanning (i). Progressive scanning (p) redraws an image frame (all of its lines) when refreshing each image, for example 720p/1080p. Interlaced scanning (i) draws the image field every other line or “odd numbered” lines during the first image refresh operation, and then draws the remaining “even numbered” lines during a second refreshing, for example 1080i. Interlaced scanning yields greater image resolution if a subject is not moving, but loses up to half of the resolution, and suffers “combing” artifacts when a subject is moving. HD video is further defined by the number of frames (or fields) per second (Hz), where in Europe 50 Hz (60 Hz in the USA) television broadcasting system is common. The 720p60 format is 1,280×720 pixels, progressive encoding with 60 frames per second (60 Hz). The 1080i50/1080i60 format is 1920×1080 pixels, interlaced encoding with 50/60 fields, (50/60 Hz) per second.

Currently common HD modes are defined as 720p, 1080i, 1080p, and 1440p. Video mode 720p relates to frame size of 1,280×720 (W×H) pixels, 921,600 pixels per image, progressive scanning, and frame rates of 23.976, 24, 25, 29.97, 30, 50, 59.94, 60, or 72 Hz. Video mode 1080i relates to frame size of 1,920×1,080 (W×H) pixels, 2,073,600 pixels per image, interlaced scanning, and frame rates of 25 (50 fields/s), 29.97 (59.94 fields/s), or 30 (60 fields/s) Hz. Video mode 1080p relates to frame size of 1,920×1,080 (W×H) pixels, 2,073,600 pixels per image, progressive scanning, and frame rates of 24 (23.976), 25, 30 (29.97), 50, or 60 (59.94) Hz. Similarly, video mode 1440p relates to frame size of 2,560×1,440 (W×H) pixels, 3,686,400 pixels per image, progressive scanning, and frame rates of 24 (23.976), 25, 30 (29.97), 50, or 60 (59.94) Hz. Digital video standards are further described in a published 2009 primer by Tektronix® entitled: “A Guide to Standard and High-Definition Digital Video Measurements”, which is incorporated in its entirety for all purposes as if fully set forth herein.

MPEG-4. MPEG-4 is a method of defining compression of audio and visual (AV) digital data, designated as a standard for a group of audio and video coding formats, and related technology by the ISO/IEC Moving Picture Experts Group (MPEG) (ISO/IEC JTC1/SC29/WG11) under the formal standard ISO/IEC 14496—‘Coding of audio-visual objects’. Typical uses of MPEG-4 include compression of AV data for the web (streaming media) and CD distribution, voice (telephone, videophone) and broadcast television applications. MPEG-4 provides a series of technologies for developers, for various service-providers and for end users, as well as enabling developers to create multimedia objects possessing better abilities of adaptability and flexibility to improve the quality of such services and technologies as digital television, animation graphics, the World Wide Web and their extensions. Transporting of MPEG-4 is described in IETF RFC 3640, entitled: “RTP Payload Format for Transport of MPEG-4 Elementary Streams”, which is incorporated in its entirety for all purposes as if fully set forth herein. The MPEG-4 format can perform various functions such as multiplexing and synchronizing data, associating with media objects for efficiently transporting via various network channels. MPEG-4 is further described in a white paper published 2005 by The MPEG Industry Forum (Document Number mp-in-40182), entitled: “Understanding MPEG-4: Technologies, Advantages, and Markets—An MPEGIF White Paper”, which is incorporated in its entirety for all purposes as if fully set forth herein.

H.264. H.264 (a.k.a. MPEG-4 Part 10, or Advanced Video Coding (MPEG-4 AVC)) is a commonly used video compression format for the recording, compression, and distribution of video content. H.264/MPEG-4 AVC is a block-oriented motion-compensation-based video compression standard ITU-T H.264, developed by the ITU-T Video Coding Experts Group (VCEG) together with the ISO/IEC JTC1 Moving Picture Experts Group (MPEG), defined in the ISO/IEC MPEG-4 AVC standard ISO/IEC 14496-10—MPEG-4 Part 10—‘Advanced Video Coding’. H.264 is widely used by streaming internet sources, such as videos from Vimeo, YouTube, and the iTunes Store, web software such as the Adobe Flash Player and Microsoft Silverlight, and also various HDTV broadcasts over terrestrial (ATSC, ISDB-T. DVB-T or DVB-T2), cable (DVB-C), and satellite (DVB-S and DVB-S2). H.264 is further described in a Standards Report published in IEEE Communications Magazine, August 2006, by Gary J. Sullivan of Microsoft Corporation, entitled: “The H.264/MPEG4 Advanced Video Coding Standard and its Applications”, and further in IETF RFC 3984 entitled: “RTP Payload Format for H.264 Video”, which are both incorporated in their entirety for all purposes as if fully set forth herein.

VCA. Video Content Analysis (VCA), also known as video content analytics, is the capability of automatically analyzing video to detect and determine temporal and spatial events. VCA deals with the extraction of metadata from raw video to be used as components for further processing in applications such as search, summarization, classification or event detection. The purpose of video content analysis is to provide extracted features and identification of structure that constitute building blocks for video retrieval, video similarity finding, summarization and navigation. Video content analysis transforms the audio and image stream into a set of semantically meaningful representations. The ultimate goal is to extract structural and semantic content automatically, without any human intervention, at least for limited types of video domains. Algorithms to perform content analysis include those for detecting objects in video, recognizing specific objects, persons, locations, detecting dynamic events in video, associating keywords with image regions or motion. VCA is used in a wide range of domains including entertainment, health-care, retail, automotive, transport, home automation, flame and smoke detection, safety and security. The algorithms can be implemented as software on general purpose machines, or as hardware in specialized video processing units.

Many different functionalities can be implemented in VCA. Video Motion Detection is one of the simpler forms where motion is detected with regard to a fixed background scene. More advanced functionalities include video tracking and egomotion estimation. Based on the internal representation that VCA generates in the machine, it is possible to build other functionalities, such as identification, behavior analysis or other forms of situation awareness. VCA typically relies on good input video, so it is commonly combined with video enhancement technologies such as video denoising, image stabilization, unsharp masking and super-resolution. VCA is described in a publication entitled: “An introduction to video content analysis—industry guide” published August 2016 as Form No. 262 Issue 2 by British Security Industry Association (BSIA), and various content based retrieval systems are described in a paper entitled: “Overview of Existing Content Based Video Retrieval Systems” by Shripad A. Bhat, Omkar V. Sardessai, Prectesh P. Kunde and Sarvesh S. Shirodkar of the Department of Electronics and Telecommunication Engineering, Goa College of Engineering, Farmagudi Ponda Goa, published February 2014 in ISSN No: 2309-4893 International Journal of Advanced Engineering and Global Technology Vol-2, Issue-2, which are both incorporated in their entirety for all purposes as if fully set forth herein.

Any image processing herein may further include video enhancement such as video denoising, image stabilization, unsharp masking, and super-resolution. Further, the image processing may include a Video Content Analysis (VCA), where the video content is analyzed to detect and determine temporal events based on multiple images, and is commonly used for entertainment, healthcare, retail, automotive, transport, home automation, safety and security. The VCA functionalities include Video Motion Detection (VMD), video tracking, and egomotion estimation, as well as identification, behavior analysis, and other forms of situation awareness. A dynamic masking functionality involves blocking a part of the video signal based on the video signal itself, for example because of privacy concerns. The egomotion estimation functionality involves the determining of the location of a camera or estimating the camera motion relative to a rigid scene, by analyzing its output signal. Motion detection is used to determine the presence of a relevant motion in the observed scene, while an object detection is used to determine the presence of a type of object or entity, for example, a person or car, as well as fire and smoke detection. Similarly, face recognition and Automatic Number Plate Recognition may be used to recognize, and therefore possibly identify persons or cars. Tamper detection is used to determine whether the camera or the output signal is tampered with, and video tracking is used to determine the location of persons or objects in the video signal, possibly with regard to an external reference grid. A pattern is defined as any form in an image having discernible characteristics that provide a distinctive identity when contrasted with other forms. Pattern recognition may also be used, for ascertaining differences, as well as similarities, between patterns under observation and partitioning the patterns into appropriate categories based on these perceived differences and similarities; and may include any procedure for correctly identifying a discrete pattern, such as an alphanumeric character, as a member of a predefined pattern category. Further, the video or image processing may use, or be based on, the algorithms and techniques disclosed in the book entitled: “Handbook of Image & Video Processing”, edited by Al Bovik, published by Academic Press, [ISBN: 0-12-119790-5], and in the book published by Wiley-Interscience [ISBN: 13-978-0-471-71998-4] (2005) by Tinku Acharya and Ajoy K. Ray entitled: “Image Processing—Principles and Applications”, which are both incorporated in their entirety for all purposes as if fully set forth herein.

Egomotion. Eegomotion is defined as the 3D motion of a camera within an environment, and typically refers to estimating a camera's motion relative to a rigid scene. An example of egomotion estimation would be estimating a car's moving position relative to lines on the road or street signs being observed from the car itself. The estimation of egomotion is important in autonomous robot navigation applications. The goal of estimating the egomotion of a camera is to determine the 3D motion of that camera within the environment using a sequence of images taken by the camera. The process of estimating a camera's motion within an environment involves the use of visual odometry techniques on a sequence of images captured by the moving camera. This is typically done using feature detection to construct an optical flow from two image frames in a sequence generated from either single cameras or stereo cameras. Using stereo image pairs for each frame helps reduce error and provides additional depth and scale information.

Features are detected in the first frame, and then matched in the second frame. This information is then used to make the optical flow field for the detected features in those two images. The optical flow field illustrates how features diverge from a single point, the focus of expansion. The focus of expansion can be detected from the optical flow field, indicating the direction of the motion of the camera, and thus providing an estimate of the camera motion. There are other methods of extracting egomotion information from images as well, including a method that avoids feature detection and optical flow fields and directly uses the image intensities.

The computation of sensor motion from sets of displacement vectors obtained from consecutive pairs of images is described in a paper by Wilhelm Burger and Bir Bhanu entitled: “Estimating 3-D Egomotion from Perspective Image Sequences”, published in IEEE TRANSACTIONS ON PATTERN ANALYSIS AND MACHINE INTELLIGENCE, VOL. 12, NO. 11, November 1990, which is incorporated in its entirety for all purposes as if fully set forth herein. The problem is investigated with emphasis on its application to autonomous robots and land vehicles. First, the effects of 3-D camera rotation and translation upon the observed image are discussed and in particular the concept of the Focus-Of-Expansion (FOE). It is shown that locating the FOE precisely is difficult when displacement vectors are corrupted by noise and errors. A more robust performance can be achieved by computing a 2-D region of possible FOE-locations (termed the fuzzy FOE) instead of looking for a single-point FOE. The shape of this FOE-region is an explicit indicator for the accuracy of the result. It has been shown elsewhere that given the fuzzy FOE, a number of powerful inferences about the 3-D scene structure and motion become possible. This paper concentrates on the aspects of computing the fuzzy FOE and shows the performance of a particular algorithm on real motion sequences taken from a moving autonomous land vehicle.

Robust methods for estimating camera egomotion in noisy, real-world monocular image sequences in the general case of unknown observer rotation and translation with two views and a small baseline are described in a paper by Andrew Jaegle, Stephen Phillips, and Kostas Daniilidis of the University of Pennsylvania, Philadelphia, PA, U.S.A. entitled: “Fast, Robust, Continuous Monocular Egomotion Computation”, downloaded from the Internet on January 2019, which is incorporated in its entirety for all purposes as if fully set forth herein. This is a difficult problem because of the nonconvex cost function of the perspective camera motion equation and because of non-Gaussian noise arising from noisy optical flow estimates and scene non-rigidity. To address this problem, we introduce the expected residual likelihood method (ERL), which estimates confidence weights for noisy optical flow data using likelihood distributions of the residuals of the flow field under a range of counterfactual model parameters. We show that ERL is effective at identifying outliers and recovering appropriate confidence weights in many settings. We compare ERL to a novel formulation of the perspective camera motion equation using a lifted kernel, a recently proposed optimization framework for joint parameter and confidence weight estimation with good empirical properties. We incorporate these strategies into a motion estimation pipeline that avoids falling into local minima. We find that ERL outperforms the lifted kernel method and baseline monocular egomotion estimation strategies on the challenging KITTI dataset, while adding almost no runtime cost over baseline egomotion methods.

Six algorithms for computing egomotion from image velocities are described and evaluated in a paper by Tina Y. Tian, Carlo Tomasi, and David J. Heeger of the Department of Psychology and Computer Science Department of Stanford University, Stanford, CA 94305, entitled: “Comparison of Approaches to Egomotion Computation”, downloaded from the Internet on January 2019, which is incorporated in its entirety for all purposes as if fully set forth herein. Various benchmarks are established for quantifying bias and sensitivity to noise, and for quantifying the convergence properties of those algorithms that require numerical search. The simulation results reveal some interesting and surprising results. First, it is often written in the literature that the egomotion problem is difficult because translation (e.g., along the X-axis) and rotation (e.g., about the Y-axis) produce similar image velocities. It was found, to the contrary, that the bias and sensitivity of our six algorithms are totally invariant with respect to the axis of rotation. Second, it is also believed by some that fixating helps to make the egomotion problem easier. It was found, to the contrary, that fixating does not help when the noise is independent of the image velocities. Fixation does help if the noise is proportional to speed, but this is only for the trivial reason that the speeds are slower under fixation. Third, it is widely believed that increasing the field of view will yield better performance, and it was found, to the contrary, that this is not necessarily true.

A system for estimating ego-motion of a moving camera for detection of independent moving objects in a scene is described in U.S. Pat. No. 10,089,549 to Cao et al. entitled: “Valley search method for estimating ego-motion of a camera from videos”, which is incorporated in its entirety for all purposes as if fully set forth herein. For consecutive frames in a video captured by a moving camera, a first ego-translation estimate is determined between the consecutive frames from a first local minimum. From a second local minimum, a second ego-translation estimate is determined. If the first ego-translation estimate is equivalent to the second ego-translation estimate, the second ego-translation estimate is output as the optimal solution. Otherwise, a cost function is minimized to determine an optimal translation until the first ego-translation estimate is equivalent to the second ego-translation estimate, and an optimal solution is output. Ego-motion of the camera is estimated using the optimal solution, and independent moving objects are detected in the scene.

A system for compensating for ego-motion during video processing is described in U.S. Patent Application Publication No. 2018/0225833 to Cao et al. entitled: “Efficient hybrid method for ego-motion from videos captured using an aerial camera”, which is incorporated in its entirety for all purposes as if fully set forth herein. The system generates an initial estimate of camera ego-motion of a moving camera for consecutive image frame pairs of a video of a scene using a projected correlation method, the camera configured to capture the video from a moving platform. An optimal estimation of camera ego-motion is generated using the initial estimate as an input to a valley search method or an alternate line search method. All independent moving objects are detected in the scene using the described hybrid method at superior performance compared to existing methods while saving computational cost.

A method for estimating ego motion of an object moving on a surface is described in U.S. Patent Application Publication No. 2015/0086078 to Sibiryakov entitled: “Method for estimating ego motion of an object”, which is incorporated in its entirety for all purposes as if fully set forth herein. The method including generating at least two composite top view images of the surface on the basis of video frames provided by at least one onboard video camera of the object moving on the surface; performing a region matching between consecutive top view images to extract global motion parameters of the moving object; calculating the ego motion of the moving object from the extracted global motion parameters of the moving object.

Thermal camera. Thermal imaging is a method of improving visibility of objects in a dark environment by detecting the objects infrared radiation and creating an image based on that information. Thermal imaging, near-infrared illumination, and low-light imaging are the three most commonly used night vision technologies. Unlike the other two methods, thermal imaging works in environments without any ambient light. Like near-infrared illumination, thermal imaging can penetrate obscurants such as smoke, fog and haze. All objects emit infrared energy (heat) as a function of their temperature, and the infrared energy emitted by an object is known as its heat signature. In general, the hotter an object is, the more radiation it emits. A thermal imager (also known as a thermal camera) is essentially a heat sensor that is capable of detecting tiny differences in temperature. The device collects the infrared radiation from objects in the scene and creates an electronic image based on information about the temperature differences. Because objects are rarely precisely the same temperature as other objects around them, a thermal camera can detect them and they will appear as distinct in a thermal image.

A thermal camera, also known as thermographic camera, is a device that forms a heat zone image using infrared radiation, similar to a common camera that forms an image using visible light. Instead of the 400-700 nanometer range of the visible light camera, infrared cameras operate in wavelengths as long as 14,000 nm (14 μm). A major difference from optical cameras is that the focusing lenses cannot be made of glass, as glass blocks long-wave infrared light. Typically, the spectral range of thermal radiation is from 7 to 14 mkm. Special materials such as Germanium, calcium fluoride, crystalline silicon or newly developed special type of Chalcogenide glass must be used. Except for calcium fluoride all these materials are quite hard but have high refractive index (n=4 for germanium) which leads to very high Fresnel reflection from uncoated surfaces (up to more than 30%). For this reason, most of the lenses for thermal cameras have antireflective coatings.

LIDAR. Light Detection And Ranging—LIDAR—also known as Lidar, LiDAR or LADAR (sometimes Light Imaging, Detection, And Ranging), is a surveying technology that measures distance by illuminating a target with a laser light. Lidar is popularly used as a technology to make high-resolution maps, with applications in geodesy, geomatics, archacology, geography, geology, geomorphology, seismology, forestry, atmospheric physics, Airborne Laser Swath Mapping (ALSM) and laser altimetry, as well as laser scanning or 3D scanning, with terrestrial, airborne and mobile applications. Lidar typically uses ultraviolet, visible, or near infrared light to image objects. It can target a wide range of materials, including non-metallic objects, rocks, rain, chemical compounds, aerosols, clouds and even single molecules. A narrow laser-beam can map physical features with very high resolutions; for example, an aircraft can map terrain at 30 cm resolution or better. Wavelengths vary to suit the target: from about 10 micrometers to the UV (approximately 250 nm). Typically, light is reflected via backscattering. Different types of scattering are used for different LIDAR applications: most commonly Rayleigh scattering. Mie scattering, Raman scattering, and fluorescence. Based on different kinds of backscattering, the LIDAR can be accordingly referred to as Rayleigh Lidar, Mic Lidar, Raman Lidar, Na/Fc/K Fluorescence Lidar, and so on. Suitable combinations of wavelengths can allow for remote mapping of atmospheric contents by identifying wavelength-dependent changes in the intensity of the returned signal. Lidar has a wide range of applications, which can be divided into airborne and terrestrial types. These different types of applications require scanners with varying specifications based on the data's purpose, the size of the area to be captured, the range of measurement desired, the cost of equipment, and more.

Airborne LIDAR (also airborne laser scanning) is when a laser scanner, while attached to a plane during flight, creates a 3D point cloud model of the landscape. This is currently the most detailed and accurate method of creating digital elevation models, replacing photogrammetry. One major advantage in comparison with photogrammetry is the ability to filter out vegetation from the point cloud model to create a digital surface model where areas covered by vegetation can be visualized, including rivers, paths, cultural heritage sites, etc. Within the category of airborne LIDAR, there is sometimes a distinction made between high-altitude and low-altitude applications, but the main difference is a reduction in both accuracy and point density of data acquired at higher altitudes. Airborne LIDAR may also be used to create bathymetric models in shallow water. Drones are being used with laser scanners, as well as other remote sensors, as a more economical method to scan smaller areas. The possibility of drone remote sensing also eliminates any danger that crews of a manned aircraft may be subjected to in difficult terrain or remote areas. Airborne LIDAR sensors are used by companies in the remote sensing field. They can be used to create a DTM (Digital Terrain Model) or DEM (Digital Elevation Model); this is quite a common practice for larger areas as a plane can acquire 3-4 km wide swaths in a single flyover. Greater vertical accuracy of below 50 mm may be achieved with a lower flyover, even in forests, where it is able to give the height of the canopy as well as the ground elevation. Typically, a GNSS receiver configured over a georeferenced control point is needed to link the data in with the WGS (World Geodetic System).

Terrestrial applications of LIDAR (also terrestrial laser scanning) happen on the Earth's surface and may be stationary or mobile. Stationary terrestrial scanning is most common as a survey method, for example in conventional topography, monitoring, cultural heritage documentation and forensics. The 3D point clouds acquired from these types of scanners can be matched with digital images taken of the scanned area from the scanner's location to create realistic looking 3D models in a relatively short time when compared to other technologies. Each point in the point cloud is given the color of the pixel from the image taken located at the same angle as the laser beam that created the point.

Mobile LIDAR (also mobile laser scanning) is when two or more scanners are attached to a moving vehicle to collect data along a path. These scanners are almost always paired with other kinds of equipment, including GNSS receivers and IMUs. One example application is surveying streets, where power lines, exact bridge heights, bordering trees, etc. all need to be taken into account. Instead of collecting each of these measurements individually in the field with a tachymeter, a 3D model from a point cloud can be created where all of the measurements needed can be made, depending on the quality of the data collected. This eliminates the problem of forgetting to take a measurement, so long as the model is available, reliable and has an appropriate level of accuracy.

Autonomous vehicles use LIDAR for obstacle detection and avoidance to navigate safely through environments. Cost map or point cloud outputs from the LIDAR sensor provide the necessary data for robot software to determine where potential obstacles exist in the environment and where the robot is in relation to those potential obstacles. LIDAR sensors are commonly used in robotics or vehicle automation. The very first generations of automotive adaptive cruise control systems used only LIDAR sensors.

LIDAR technology is being used in robotics for the perception of the environment as well as object classification. The ability of LIDAR technology to provide three-dimensional elevation maps of the terrain, high precision distance to the ground, and approach velocity can enable safe landing of robotic and manned vehicles with a high degree of precision. LiDAR has been used in the railroad industry to generate asset health reports for asset management and by departments of transportation to assess their road conditions. LIDAR is used in Adaptive Cruise Control (ACC) systems for automobiles. Systems use a LIDAR device mounted on the front of the vehicle, such as the bumper, to monitor the distance between the vehicle and any vehicle in front of it. In the event the vehicle in front slows down or is too close, the ACC applies the brakes to slow the vehicle. When the road ahead is clear, the ACC allows the vehicle to accelerate to a speed preset by the driver. Any apparatus herein, which may be any of the systems, devices, modules, or functionalities described herein, may be integrated with, or used for, Light Detection And Ranging (LIDAR), such as airborne, terrestrial, automotive, or mobile LIDAR.

SAR. Synthetic-Aperture Radar (SAR) is a form of radar that is used to create two-dimensional images or three-dimensional reconstructions of objects, such as landscapes, by using the motion of the radar antenna over a target region to provide finer spatial resolution than conventional stationary beam-scanning radars. SAR is typically mounted on a moving platform, such as an aircraft or spacecraft, and has its origins in an advanced form of Side Looking Airborne Radar (SLAR). The distance the SAR device travels over a target during the period when the target scene is illuminated creates the large synthetic antenna aperture (the size of the antenna). Typically, the larger the aperture, the higher the image resolution will be, regardless of whether the aperture is physical (a large antenna) or synthetic (a moving antenna)—this allows SAR to create high-resolution images with comparatively small physical antennas. For a fixed antenna size and orientation, objects which are further away remain illuminated longer—therefore SAR has the property of creating larger synthetic apertures for more distant objects, which results in a consistent spatial resolution over a range of viewing distances. To create a SAR image, successive pulses of radio waves are transmitted to “illuminate” a target scene, and the echo of each pulse is received and recorded. The pulses are transmitted and the echoes received using a single beam-forming antenna, with wavelengths of a meter down to several millimeters. As the SAR device on board the aircraft or spacecraft moves, the antenna location relative to the target changes with time. Signal processing of the successive recorded radar echoes allows the combining of the recordings from these multiple antenna positions. This process forms the synthetic antenna aperture and allows the creation of higher-resolution images than would otherwise be possible with a given physical antenna. SAR is capable of high-resolution remote sensing, independent of flight altitude, and independent of weather, as SAR can select frequencies to avoid weather-caused signal attenuation. SAR has day and night imaging capability as illumination is provided by the SAR. SAR images have wide applications in remote sensing and mapping of surfaces of the Earth and other planets.

A synthetic-aperture radar is an imaging radar mounted on an instant moving platform, where Electromagnetic waves are transmitted sequentially, the echoes are collected, and the system electronics digitizes and stores the data for subsequent processing. As transmission and reception occur at different times, they map to different small positions. The well-ordered combination of the received signals builds a virtual aperture that is much longer than the physical antenna width. That is the source of the term “synthetic aperture,” giving it the property of an imaging radar. The range direction is perpendicular to the flight track and perpendicular to the azimuth direction, which is also known as the along-track direction because it is in line with the position of the object within the antenna's field of view. The 3D processing is done in two stages. The azimuth and range direction are focused for the generation of 2D (azimuth-range) high-resolution images, after which a Digital Elevation Model (DEM) is used to measure the phase differences between complex images, which is determined from different look angles to recover the height information. This height information, along with the azimuth-range coordinates provided by 2-D SAR focusing, gives the third dimension, which is the elevation. The first step requires only standard processing algorithms, for the second step, additional pre-processing such as image co-registration and phase calibration is used.

Applied methods for forest monitoring and biomass estimation that has been developed to address pressing needs in the development of operational forest monitoring services are described in a book edited by Africa Ixmucane Flores-Anderson; Kelsey E. Herndon; and Rajesh Bahadur Thapa; Emil Cherrington, published April 2019 [DOI: 10.25966/nr2c-s697] entitled: “The SAR Handbook: Comprehensive Methodologies for Forest Monitoring and Biomass Estimation Book”, which is incorporated in its entirety for all purposes as if fully set forth herein. Despite the existence of SAR technology with all-weather capability for over 30 years, the applied use of this technology for operational purposes has proven difficult. This handbook seeks to provide understandable, easy-to-assimilate technical material to remote sensing specialists that may not have expertise on SAR but are interested in leveraging SAR technology in the forestry sector. This introductory chapter explains the needs of regional stakeholders that initiated the development of this SAR handbook and the generation of applied training materials. It also explains the primary objectives of this handbook. To generate this applied content on a topic that is usually addressed from a research point of view, the authors followed a unique approach that involved the global SERVIR network. This process ensured that the content covered in this handbook actually addresses the needs of users attempting to apply cutting-edge scientific SAR processing and analysis methods. Intended users of this handbook include, but are not limited to forest and environmental managers and local scientists already working with satellite remote sensing datasets for forest monitoring.

A Synthetic Aperture Radar (SAR) that provides high-resolution, day-and-night and weather-independent images for a multitude of applications ranging from geoscience and climate change research, environmental and Earth system monitoring, 2-D and 3-D mapping, change detection, 4-D mapping (space and time), security-related applications up to planetary exploration, is described in a tutorial by Gerhard Krieger, Irena Hajnsek, and Konstantinos P. Papathanass, published March 2013 in IEEE Geoscience and remote sensing magazine [2168-6831/13/$31.00@2013] entitled: “A Tutorial on Synthetic Aperture Radar”, which is incorporated in its entirety for all purposes as if fully set forth herein. This paper provides first a tutorial about the SAR principles and theory, followed by an overview of established techniques like polarimetry, interferometry and differential interferometry as well as of emerging techniques (e.g., polarimetric SAR interferometry, tomography and holographic tomography). Several application examples including the associated parameter inversion modeling are provided for each case. The paper also describes innovative technologies and concepts like digital beamforming, Multiple-Input Multiple-Output (MIMO) and bi- and multi-static configurations which are suitable means to fulfill the increasing user requirements. The paper concludes with a vision for SAR remote sensing.

Background information and hands-on processing exercises on the main concepts of Synthetic Aperture Radar (SAR) remote sensing are provides in chapter 2 entitled: “CHAPTER 2 Spaceborne Synthetic Aperture Radar: Principles, Data Access, and Basic Processing Techniques” of a book by Franz Meyer, which is incorporated in its entirety for all purposes as if fully set forth herein. After a short introduction on the peculiarities of the SAR image acquisition process, the remainder of this chapter is dedicated to supporting the reader in interpreting the often unfamiliar-looking SAR imagery. It describes how the appearance of a SAR image is influenced by sensor parameters (such as signal polarization and wavelength) as well as environmental factors (such as soil moisture and surface roughness). A comprehensive list of past, current, and planned SAR sensors is included to provide the reader with an overview of available SAR datasets. For each of these sensors, the main imaging properties are described and their most relevant applications listed. An explanation of SAR data types and product levels with their main uses and information on means of data access concludes the narrative part of this chapter and serves as a lead-in to a set of hands-on data processing techniques. These techniques use public domain software tools to walk the reader through some of the most relevant SAR image processing routines, including geocoding and radiometric terrain correction, interferometric SAR processing, and change detection

Pitch/Roll/Yaw (Spatial orientation and motion). Any device that can move in space, such as an aircraft in flight, is typically free to rotate in three dimensions: yaw-nose left or right about an axis running up and down; pitch-nose up or down about an axis running from wing to wing; and roll-rotation about an axis running from nose to tail, as pictorially shown in FIG. 2. The axes are alternatively designated as vertical, transverse, and longitudinal respectively. These axes move with the vehicle and rotate relative to the Earth along with the craft. These rotations are produced by torques (or moments) about the principal axes. On an aircraft, these are intentionally produced by means of moving control surfaces, which vary the distribution of the net aerodynamic force about the vehicle's center of gravity. Elevators (moving flaps on the horizontal tail) produce pitch, a rudder on the vertical tail produces yaw, and ailerons (flaps on the wings that move in opposing directions) produce roll. On a spacecraft, the moments are usually produced by a reaction control system consisting of small rocket thrusters used to apply asymmetrical thrust on the vehicle. Normal axis, or yaw axis, is an axis drawn from top to bottom, and perpendicular to the other two axes. Parallel to the fuselage station. Transverse axis, lateral axis, or pitch axis, is an axis running from the pilot's left to right in piloted aircraft, and parallel to the wings of a winged aircraft. Parallel to the buttock line. Longitudinal axis, or roll axis, is an axis drawn through the body of the vehicle from tail to nose in the normal direction of flight, or the direction the pilot faces. Parallel to the waterline.

Vertical axis (yaw)—The yaw axis has its origin at the center of gravity and is directed towards the bottom of the aircraft, perpendicular to the wings and to the fuselage reference line. Motion about this axis is called yaw. A positive yawing motion moves the nose of the aircraft to the right. The rudder is the primary control of yaw. Transverse axis (pitch)—The pitch axis (also called transverse or lateral axis) has its origin at the center of gravity and is directed to the right, parallel to a line drawn from wingtip to wingtip. Motion about this axis is called pitch. A positive pitching motion raises the nose of the aircraft and lowers the tail. The elevators are the primary control of pitch. Longitudinal axis (roll)—The roll axis (or longitudinal axis) has its origin at the center of gravity and is directed forward, parallel to the fuselage reference line. Motion about this axis is called roll. An angular displacement about this axis is called bank. A positive rolling motion lifts the left wing and lowers the right wing. The pilot rolls by increasing the lift on one wing and decreasing it on the other. This changes the bank angle. The ailerons are the primary control of bank.

Streaming. Streaming media is multimedia that is constantly received by and presented to an end-user while being delivered by a provider. A client media player can begin playing the data (such as a movie) before the entire file has been transmitted. Distinguishing delivery method from the media distributed applies specifically to telecommunications networks, as most of the delivery systems are either inherently streaming (e.g., radio, television), or inherently non-streaming (e.g., books, video cassettes, audio CDs). Live streaming refers to content delivered live over the Internet, and requires a form of source media (e.g. a video camera, an audio interface, screen capture software), an encoder to digitize the content, a media publisher, and a content delivery network to distribute and deliver the content. Streaming content may be according to, compatible with, or based on, IETF RFC 2550 entitled: “RTP: A Transport Protocol for Real-Time Applications”, IETF RFC 4587 entitled: “RTP Payload Format for H.261 Video Streams”, or IETF RFC 2326 entitled: “Real Time Streaming Protocol (RTSP)”, which are all incorporated in their entirety for all purposes as if fully set forth herein. Video streaming is further described in a published 2002 paper by Hewlett-Packard Company (HP®) authored by John G. Apostolopoulos, Wai-Tian, and Susie J. Wee and entitled: “Video Streaming: Concepts, Algorithms, and Systems”, which is incorporated in its entirety for all purposes as if fully set forth herein.

An audio stream may be compressed using an audio codec such as MP3, Vorbis or AAC, and a video stream may be compressed using a video codec such as H.264 or VP8. Encoded audio and video streams may be assembled in a container bitstream such as MP4, FLV, WebM, ASF or ISMA. The bitstream is typically delivered from a streaming server to a streaming client using a transport protocol, such as MMS or RTP. Newer technologies such as HLS, Microsoft's Smooth Streaming. Adobe's HDS and finally MPEG-DASH have emerged to enable adaptive bitrate (ABR) streaming over HTTP as an alternative to using proprietary transport protocols. The streaming client may interact with the streaming server using a control protocol, such as MMS or RTSP.

Streaming media may use Datagram protocols, such as the User Datagram Protocol (UDP), where the media stream is sent as a series of small packets. However, there is no mechanism within the protocol to guarantee delivery, so if data is lost, the stream may suffer a dropout. Other protocols may be used, such as the Real-time Streaming Protocol (RTSP), Real-time Transport Protocol (RTP) and the Real-time Transport Control Protocol (RTCP). RTSP runs over a variety of transport protocols, while the latter two typically use UDP. Another approach is HTTP adaptive bitrate streaming that is based on HTTP progressive download, designed to incorporate both the advantages of using a standard web protocol, and the ability to be used for streaming even live content is adaptive bitrate streaming. Reliable protocols, such as the Transmission Control Protocol (TCP), guarantee correct delivery of each bit in the media stream, using a system of timeouts and retries, which makes them more complex to implement. Unicast protocols send a separate copy of the media stream from the server to each recipient, and are commonly used for most Internet connections.

Multicasting broadcasts the same copy of the multimedia over the entire network to a group of clients, and may use multicast protocols that were developed to reduce the server/network loads resulting from duplicate data streams that occur when many recipients receive unicast content streams, independently. These protocols send a single stream from the source to a group of recipients, and depending on the network infrastructure and type, the multicast transmission may or may not be feasible. IP Multicast provides the capability to send a single media stream to a group of recipients on a computer network, and a multicast protocol, usually Internet Group Management Protocol, is used to manage delivery of multicast streams to the groups of recipients on a LAN. Peer-to-peer (P2P) protocols arrange for prerecorded streams to be sent between computers, thus preventing the server and its network connections from becoming a bottleneck. HTTP Streaming—(a.k.a. Progressive Download; Streaming) allows for that while streaming content is being downloaded, users can interact with, and/or view it. VOD streaming is further described in a NETFLIX® presentation dated May 2013 by David Ronca, entitled: “A Brief History of Netflix Streaming”, which is incorporated in its entirety for all purposes as if fully set forth herein.

Media streaming techniques are further described in a white paper published October 2005 by Envivio® and authored by Alex MacAulay, Boris Felts, and Yuval Fisher, entitled: “WHITEPAPER—IP Streaming of MPEG-4” Native RTP vs MPEG-2 Transport Stream”, in an overview published 2014 by Apple Inc.—Developer, entitled: “HTTP Live Streaming Overview”, and in a paper by Thomas Stockhammer of Qualcomm Incorporated entitled: “Dynamic Adaptive Streaming over HTTP—Design Principles and Standards”, in a Microsoft Corporation published March 2009 paper authored by Alex Zambelli and entitled: “IIS Smooth Streaming Technical Overview”, in an article by Liang Chen, Yipeng Zhou, and Dah Ming Chiu dated 10 Apr. 2014 entitled: “Smart Streaming for Online Video Services”, in Celtic-Plus publication (downloaded February 2016 from the Internet) referred to as ‘H2B2VS D1 1 1 State-of-the-art V2.0.docx’ entitled: “H2B2VS D1.1.1 Report on the state of the art technologies for hybrid distribution of TV services”, and in a technology brief by Apple Computer, Inc. published March 2005 (Document No. L308280A) entitled: “QuickTime Streaming”, which are all incorporated in their entirety for all purposes as if fully set forth herein.

DSP. A Digital Signal Processor (DSP) is a specialized microprocessor (or a SIP block), with its architecture optimized for the operational needs of digital signal processing, serving the goal of DSPs is usually to measure, filter and/or compress continuous real-world analog signals. Most general-purpose microprocessors can also execute digital signal processing algorithms successfully, but dedicated DSPs usually have better power efficiency thus they are more suitable in portable devices such as mobile phones because of power consumption constraints. DSPs often use special memory architectures that are able to fetch multiple data and/or instructions at the same time. Digital signal processing algorithms typically require a large number of mathematical operations to be performed quickly and repeatedly on a series of data samples. Signals (perhaps from audio or video sensors) are constantly converted from analog to digital, manipulated digitally, and then converted back to analog form. Many DSP applications have constraints on latency; that is, for the system to work, the DSP operation must be completed within some fixed time, and deferred (or batch) processing is not viable. A specialized digital signal processor, however, will tend to provide a lower-cost solution, with better performance, lower latency, and no requirements for specialized cooling or large batteries. The architecture of a digital signal processor is optimized specifically for digital signal processing. Most also support some of the features as an applications processor or microcontroller, since signal processing is rarely the only task of a system. Some useful features for optimizing DSP algorithms are outlined below.

Hardware features visible through DSP instruction sets commonly include hardware modulo addressing, allowing circular buffers to be implemented without having to constantly test for wrapping; a memory architecture designed for streaming data, using DMA extensively and expecting code to be written to know about cache hierarchies and the associated delays; driving multiple arithmetic units may require memory architectures to support several accesses per instruction cycle; separate program and data memories (Harvard architecture), and sometimes concurrent access on multiple data buses; and special SIMD (single instruction, multiple data) operations. Digital signal processing is further described in a book by John G. Proakis and Dimitris G. Manolakis, published 1996 by Prentice-Hall Inc. [ISBN 0-13-394338-9] entitled: “Third Edition—DIGITAL SIGNAL PROCESSING—Principles, Algorithms, and Application”, and in a book by Steven W. Smith entitled: “The Scientist and Engineer's Guide to—Digital Signal Processing—Second Edition”, published by California Technical Publishing [ISBN 0-9960176-7-6], which are both incorporated in their entirety for all purposes as if fully set forth herein.

Neural networks. Neural Networks (or Artificial Neural Networks (ANNs)) are a family of statistical learning models inspired by biological neural networks (the central nervous systems of animals, in particular the brain) and are used to estimate or approximate functions that may depend on a large number of inputs and are generally unknown. Artificial neural networks are generally presented as systems of interconnected “neurons” which send messages to each other. The connections have numeric weights that can be tuned based on experience, making neural nets adaptive to inputs and capable of learning. For example, a neural network for handwriting recognition is defined by a set of input neurons that may be activated by the pixels of an input image. After being weighted and transformed by a function (determined by the network designer), the activations of these neurons are then passed on to other neurons, and this process is repeated until finally, an output neuron is activated, and determines which character was read. Like other machine learning methods-systems that learn from data-neural networks have been used to solve a wide variety of tasks that are hard to solve using ordinary rule-based programming, including computer vision and speech recognition. A class of statistical models is typically referred to as “Neural” if it contains sets of adaptive weights, i.e. numerical parameters that are tuned by a learning algorithm, and capability of approximating non-linear functions from their inputs. The adaptive weights can be thought of as connection strengths between neurons, which are activated during training and prediction. Neural Networks are described in a book by David Kriesel entitled: “A Brief Introduction to Neural Networks” (ZETA2-EN) [downloaded May 2015 from www.dkriesel.com], which is incorporated in its entirety for all purposes as if fully set forth herein. Neural Networks are further described in a book by Simon Haykin published 2009 by Pearson Education, Inc. [ISBN—978-0-13-147139-9] entitled: “Neural Networks and Learning Machines—Third Edition”, which is incorporated in its entirety for all purposes as if fully set forth herein.

Neural networks based techniques may be used for image processing, as described in an article in Engineering Letters, 20:1, EL_20_1_09 (Advance online publication: 27 Feb. 2012) by Juan A. Ramirez-Quintana, Mario I. Cacon-Murguia, and F. Chacon-Hinojos entitled: “Artificial Neural Image Processing Applications: A Survey”, in an article published 2002 by Pattern Recognition Society in Pattern Recognition 35 (2002) 2279-2301 [PII: S0031-3203(01)00178-9] authored by M. Egmont-Petersen, D. de Ridder, and H. Handels entitled: “Image processing with neural networks—a review”, and in an article by Dick de Ridder et al. (of the Utrecht University, Utrecht, The Netherlands) entitled: “Nonlinear image processing using artificial neural networks”, which are all incorporated in their entirety for all purposes as if fully set forth herein.

Neural networks may be used for object detection as described in an article by Christian Szegedy, Alexander Toshev, and Dumitru Erhan (of Google, Inc.) (downloaded July 2015) entitled: “Deep Neural Networks for Object Detection”, in a CVPR2014 paper provided by the Computer Vision Foundation by Dumitru Erhan, Christian Szegedy, Alexander Toshev, and Dragomir Anguelov (of Google, Inc., Mountain-View, California, U.S.A.) (downloaded July 2015) entitled: “Scalable Object Detection using Deep Neural Networks”, and in an article by Shawn McCann and Jim Reesman (both of Stanford University) (downloaded July 2015) entitled: “Object Detection using Convolutional Neural Networks”, which are all incorporated in their entirety for all purposes as if fully set forth herein.

Using neural networks for object recognition or classification is described in an article (downloaded July 2015) by Mehdi Ebady Manaa, Nawfal Turki Obics, and Dr. Tawfiq A. Al-Assadi (of Department of Computer Science, Babylon University), entitled: “Object Classification using neural networks with Gray-level Co-occurrence Matrices (GLCM)”, in a technical report No. IDSIA-01-11 Jan. 2001 published by IDSIA/USI-SUPSI and authored by Dan C. Ciresan et al. entitled: “High-Performance Neural Networks for Visual Object Classification”, in an article by Yuhua Zheng et al. (downloaded July 2015) entitled: “Object Recognition using Neural Networks with Bottom-Up and top-Down Pathways”, and in an article (downloaded July 2015) by Karen Simonyan, Andrea Vedaldi, and Andrew Zisserman (all of Visual Geometry Group, University of Oxford), entitled: “Deep Inside Convolutional Networks: Visualising Image Classification Models and Saliency Maps”, which are all incorporated in their entirety for all purposes as if fully set forth herein.

Using neural networks for object recognition or classification is further described in U.S. Pat. No. 6,018,728 to Spence et al. entitled: “Method and Apparatus for Training a Neural Network to Learn Hierarchical Representations of Objects and to Detect and Classify Objects with Uncertain Training Data”, in U.S. Pat. No. 6,038,337 to Lawrence et al. entitled: “Method and Apparatus for Object Recognition”, in U.S. Pat. No. 8,345,984 to Ji et al. entitled: “3D Convolutional Neural Networks for Automatic Human Action Recognition”, and in U.S. Pat. No. 8,705,849 to Prokhorov entitled: “Method and System for Object Recognition Based on a Trainable Dynamic System”, which are all incorporated in their entirety for all purposes as if fully set forth herein.

Actual ANN implementation may be based on, or may use, the MATLB® ANN described in the User's Guide Version 4 published July 2002 by The MathWorks, Inc. (Headquartered in Natick, MA, U.S.A.) entitled: “Neural Network ToolBox—For Use with MATLAB®” by Howard Demuth and Mark Beale, which is incorporated in its entirety for all purposes as if fully set forth herein. An VHDL IP core that is a configurable feedforward Artificial Neural Network (ANN) for implementation in FPGAs is available (under the Name: artificial_neural_network, created Jun. 2, 2016 and updated Oct. 11, 2016) from OpenCores organization, downloadable from http://opencores.org/. This IP performs full feedforward connections between consecutive layers. All neurons' outputs of a layer become the inputs for the next layer. This ANN architecture is also known as Multi-Layer Perceptron (MLP) when is trained with a supervised learning algorithm. Different kinds of activation functions can be added easily coding them in the provided VHDL template. This IP core is provided in two parts: kernel plus wrapper. The kernel is the optimized ANN with basic logic interfaces. The kernel should be instantiated inside a wrapper to connect it with the user's system buses. Currently, an example wrapper is provided for instantiate it on Xilinx Vivado, which uses AXI4 interfaces for AMBA buses.

Dynamic neural networks are the most advanced in that they dynamically can, based on rules, form new connections and even new neural units while disabling others. In a Feedforward Neural Network (FNN), the information moves in only one direction-forward: From the input nodes data goes through the hidden nodes (if any) and to the output nodes. There are no cycles or loops in the network. Feedforward networks can be constructed from different types of units, e.g. binary McCulloch-Pitts neurons, the simplest example being the perceptron. Contrary to feedforward networks, Recurrent Neural Networks (RNNs) are models with bi-directional data flow. While a feedforward network propagates data linearly from input to output, RNNs also propagate data from later processing stages to earlier stages. RNNs can be used as general sequence processors.

Any ANN herein may be based on, may use, or may be trained or used, using the schemes, arrangements, or techniques described in the book by David Kriesel entitled: “A Brief Introduction to Neural Networks” (ZETA2-EN) [downloaded May 2015 from www.dkriesel.com], in the book by Simon Haykin published 2009 by Pearson Education, Inc. [ISBN—978-0-13-147139-9] entitled: “Neural Networks and Learning Machines—Third Edition”, in the article in Engineering Letters, 20:1, EL_20_1_09 (Advance online publication: 27 Feb. 2012) by Juan A. Ramirez-Quintana, Mario I. Cacon-Murguia, and F. Chacon-Hinojos entitled: “Artificial Neural Image Processing Applications: A Survey”, or in the article entitled: “Image processing with neural networks—a review”, and in the article by Dick de Ridder et al. (of the Utrecht University, Utrecht, The Netherlands) entitled: “Nonlinear image processing using artificial neural networks”.

Any object detection herein using ANN may be based on, may use, or may be trained or used, using the schemes, arrangements, or techniques described in the article by Christian Szegedy, Alexander Toshev, and Dumitru Erhan (of Google, Inc.) entitled: “Deep Neural Networks for Object Detection”, in the CVPR2014 paper provided by the Computer Vision Foundation entitled: “Scalable Object Detection using Deep Neural Networks”, in the article by Shawn McCann and Jim Reesman entitled: “Object Detection using Convolutional Neural Networks”, or in any other document mentioned herein.

Any object recognition or classification herein using ANN may be based on, may use, or may be trained or used, using the schemes, arrangements, or techniques described in the article by Mehdi Ebady Manaa, Nawfal Turki Obies, and Dr. Tawfiq A. Al-Assadi entitled: “Object Classification using neural networks with Gray-level Co-occurrence Matrices (GLCM)”, in the technical report No. IDSIA-01-11 entitled: “High-Performance Neural Networks for Visual Object Classification”, in the article by Yuhua Zheng et al. entitled: “Object Recognition using Neural Networks with Bottom-Up and top-Down Pathways”, in the article by Karen Simonyan, Andrea Vedaldi, and Andrew Zisserman, entitled: “Deep Inside Convolutional Networks: Visualising Image Classification Models and Saliency Maps”, or in any other document mentioned herein.

A logical representation example of a simple feed-forward Artificial Neural Network (ANN) 60 is shown in FIG. 6. The ANN 60 provides three inputs designated as IN #1 62a, IN #2 62b, and IN #3 62c, which connects to three respective neuron units forming an input layer 61a. Each neural unit is linked to some, or to all, of a next layer 61b, with links that may be enforced or inhibit by associating weights as part of the training process. An output layer 61d consists of two neuron units that feeds two outputs OUT #1 63a and OUT #2 63b. Another layer 61c is coupled between the layer 61b and the output layer 61d. The intervening layers 61b and 61c are referred to as hidden layers. While three inputs are exampled in the ANN 60, any number of inputs may be equally used, and while two output are exampled in the ANN 60, any number of outputs may equally be used. Further, the ANN 60 uses four layers, consisting of an input layer, an output layer, and two hidden layers. However, any number of layers may be used. For example, the number of layers may be equal to, or above than, 3, 4, 5, 7, 10, 15, 20, 25, 30, 35, 40, 45, or 50 layers. Similarly, an ANN may have any number below 4, 5, 7, 10, 15, 20, 25, 30, 35, 40, 45, or 50 layers.

DNN. A Deep Neural Network (DNN) is an artificial neural network (ANN) with multiple layers between the input and output layers. For example, a DNN that is trained to recognize dog breeds will go over the given image and calculate the probability that the dog in the image is a certain breed. The user can review the results and select which probabilities the network should display (above a certain threshold, etc.) and return the proposed label. Each mathematical manipulation as such is considered a layer, and complex DNN have many layers, hence the name “deep” networks. DNNs can model complex non-linear relationships. DNN architectures generate compositional models where the object is expressed as a layered composition of primitives. The extra layers enable composition of features from lower layers, potentially modeling complex data with fewer units than a similarly performing shallow network. Deep architectures include many variants of a few basic approaches. Each architecture has found success in specific domains. It is not always possible to compare the performance of multiple architectures, unless they have been evaluated on the same data sets. DNN is described in a book entitled: “Introduction to Deep Learning From Logical Calculus to Artificial Intelligence” by Sandro Skansi [ISSN 1863-7310 ISSN 2197-1781, ISBN 978-3-319-73003-5], published 2018 by Springer International Publishing AG, which is incorporated in its entirety for all purposes as if fully set forth herein.

Deep Neural Networks (DNNs), which employ deep architectures can represent functions with higher complexity if the numbers of layers and units in a single layer are increased. Given enough labeled training datasets and suitable models, deep learning approaches can help humans establish mapping functions for operation convenience. In this paper, four main deep architectures are recalled and other methods (e.g. sparse coding) are also briefly discussed. Additionally, some recent advances in the field of deep learning are described. The purpose of this article is to provide a timely review and introduction on the deep learning technologies and their applications. It is aimed to provide the readers with a background on different deep learning architectures and also the latest development as well as achievements in this area. The rest of the paper is organized as follows. In Sections II-V, four main deep learning architectures, which are Restricted Boltzmann Machines (RBMs), Deep Belief Networks (DBNs), AutoEncoder (AE), and Convolutional Neural Networks (CNNs), are reviewed, respectively. Comparisons are made among these deep architectures and recent developments on these algorithms are discussed. A schematic diagram 60a of an RBM, a schematic diagram 60b of a DBN, and a schematic structure 60c of a CNN are shown in FIG. 6a.

DNNs are typically feedforward networks in which data flows from the input layer to the output layer without looping back. At first, the DNN creates a map of virtual neurons and assigns random numerical values, or “weights”, to connections between them. The weights and inputs are multiplied and return an output between 0 and 1. If the network did not accurately recognize a particular pattern, an algorithm would adjust the weights. That way the algorithm can make certain parameters more influential, until it determines the correct mathematical manipulation to fully process the data. Recurrent neural networks (RNNs), in which data can flow in any direction, are used for applications such as language modeling. Long short-term memory is particularly effective for this use. Convolutional deep neural networks (CNNs) are used in computer vision. CNNs also have been applied to acoustic modeling for Automatic Speech Recognition (ASR).

Since the proposal of a fast-learning algorithm for deep belief networks in 2006, the deep learning techniques have drawn ever-increasing research interests because of their inherent capability of overcoming the drawback of traditional algorithms dependent on hand-designed features. Deep learning approaches have also been found to be suitable for big data analysis with successful applications to computer vision, pattern recognition, speech recognition, natural language processing, and recommendation systems.

Widely-used deep learning architectures and their practical applications are discussed in a paper entitled: “A Survey of Deep Neural Network Architectures and Their Applications” by Weibo Liua, Zidong Wanga, Xiaohui Liua, Nianyin Zengb, Yurong Liuc, and Fuad E. Alsaadid, published December 2016 [DOI: 10.1016/j.neucom.2016.12.038] in Neurocomputing 234, which is incorporated in its entirety for all purposes as if fully set forth herein. An up-to-date overview is provided on four deep learning architectures, namely, autoencoder, convolutional neural network, deep belief network, and restricted Boltzmann machine. Different types of deep neural networks are surveyed and recent progresses are summarized. Applications of deep learning techniques on some selected areas (speech recognition, pattern recognition and computer vision) are highlighted. A list of future research topics is finally given with clear justifications.

RBM. Restricted Boltzmann machine (RBM) is a generative stochastic artificial neural network that can learn a probability distribution over its set of inputs. As their name implies, RBMs are a variant of Boltzmann machines, with the restriction that their neurons must form a bipartite graph: a pair of nodes from each of the two groups of units (commonly referred to as the “visible” and “hidden” units respectively) may have a symmetric connection between them; and there are no connections between nodes within a group. By contrast, “unrestricted” Boltzmann machines may have connections between hidden units. This restriction allows for more efficient training algorithms than are available for the general class of Boltzmann machines, in particular the gradient-based contrastive divergence algorithm. Restricted Boltzmann machines can also be used in deep learning networks. In particular, deep belief networks can be formed by “stacking” RBMs and optionally fine-tuning the resulting deep network with gradient descent and backpropagation

DBN. A Deep Belief Network (DBN) is a generative graphical model, or alternatively a class of deep neural network, composed of multiple layers of latent variables (“hidden units”), with connections between the layers but not between units within each layer. When trained on a set of examples without supervision, a DBN can learn to probabilistically reconstruct its inputs. The layers then act as feature detectors. After this learning step, a DBN can be further trained with supervision to perform classification. DBNs can be viewed as a composition of simple, unsupervised networks such as restricted Boltzmann machines (RBMs) or autoencoders, where each sub-network's hidden layer serves as the visible layer for the next. An RBM is an undirected, generative energy-based model with a “visible” input layer and a hidden layer and connections between but not within layers. This composition leads to a fast, layer-by-layer unsupervised training procedure, where contrastive divergence is applied to each sub-network in turn, starting from the “lowest” pair of layers (the lowest visible layer is a training set).

Dynamic neural networks are the most advanced in that they dynamically can, based on rules, form new connections and even new neural units while disabling others. In a Feedforward Neural Network (FNN), the information moves in only one direction-forward: From the input nodes data goes through the hidden nodes (if any) and to the output nodes. There are no cycles or loops in the network. Feedforward networks can be constructed from different types of units, e.g., binary McCulloch-Pitts neurons, the simplest example being the perceptron. Contrary to feedforward networks, Recurrent Neural Networks (RNNs) are models with bi-directional data flow. While a feedforward network propagates data linearly from input to output, RNNs also propagate data from later processing stages to earlier stages. RNNs can be used as general sequence processors.

A waveform analysis assembly (10) that includes a sensor (12) for detecting physiological electrical and mechanical signals produced by the body is disclosed in U.S. Pat. No. 5,092,343 to Spitzer et al. entitled: “Waveform analysis apparatus and method using neural network techniques”, which is incorporated in its entirety for all purposes as if fully set forth herein. An extraction neural network (22, 22′) will learn a repetitive waveform of the electrical signal, store the waveform in memory (18), extract the waveform from the electrical signal, store the location times of occurrences of the waveform, and subtract the waveform from the electrical signal. Each significantly different waveform in the electrical signal is learned and extracted. A single or multilayer layer neural network (22, 22′) accomplishes the learning and extraction with either multiple passes over the electrical signal or accomplishes the learning and extraction of all waveforms in a single pass over the electrical signal. A reducer (20) receives the stored waveforms and times and reduces them into features characterizing the waveforms. A classifier neural network (36) analyzes the features by classifying them through non-linear mapping techniques within the network representing diseased states and produces results of diseased states based on learned features of the normal and patient groups.

A real-time waveform analysis system that utilizes neural networks to perform various stages of the analysis is disclosed in U.S. Pat. No. 5,751,911 to Goldman entitled: “Real-time waveform analysis using artificial neural networks”, which is incorporated in its entirety for all purposes as if fully set forth herein. The signal containing the waveform is first stored in a buffer and the buffer contents transmitted to a first and second neural network, which have been previously trained to recognize the start point and the end point of the waveform respectively. A third neural network receives the signal occurring between the start and end points and classifies that waveform as comprising either an incomplete waveform, a normal waveform or one of a variety of predetermined characteristic classifications. Ambiguities in the output of the third neural network are arbitrated by a fourth neural network, which may be given additional information, which serves to resolve these ambiguities. In accordance with the preferred embodiment, the present invention is applied to a system analyzing respiratory waveforms of a patient undergoing anesthesia and the classifications of the waveform correspond to normal or various categories of abnormal features functioning in the respiratory signal. The system performs the analysis rapidly enough to be used in real-time systems and can be operated with relatively low-cost hardware and with minimal software development required.

A method for analyzing data is disclosed in U.S. Pat. No. 8,898,093 to Helmsen entitled: “Systems and methods for analyzing data using deep belief networks (DBN) and identifying a pattern in a graph”, which is incorporated in its entirety for all purposes as if fully set forth herein. The method includes generating, using a processing device, a graph from raw data, the graph including a plurality of nodes and edges, deriving, using the processing device, at least one label for each node using a deep belief network, and identifying, using the processing device, a predetermined pattern in the graph based at least in part on the labeled nodes.

Object detection. Object detection (a.k.a. ‘object recognition’) is a process of detecting and finding semantic instances of real-world objects, typically of a certain class (such as humans, buildings, or cars), in digital images and videos. Object detection techniques are described in an article published International Journal of Image Processing (IJIP), Volume 6, Issue June 2012, entitled: “Survey of The Problem of Object Detection In Real Images” by Dilip K. Prasad, and in a tutorial by A. Ashbrook and N. A. Thacker entitled: “Tutorial: Algorithms For 2-dimensional Object Recognition” published by the Imaging Science and Biomedical Engineering Division of the University of Manchester, which are both incorporated in their entirety for all purposes as if fully set forth herein. Various object detection techniques are based on pattern recognition, described in the Computer Vision: March 2000 Chapter 4 entitled: “Pattern Recognition Concepts”, and in a book entitled: “Hands-On Pattern Recognition—Challenges in Machine Learning, Volume I”, published by Microtome Publishing, 2011 (ISBN-13:978-0-9719777-1-6), which are both incorporated in their entirety for all purposes as if fully set forth herein.

Various object detection (or recognition) schemes in general, and face detection techniques in particular, are based on using Haar-like features (Haar wavelets) instead of the usual image intensities. A Haar-like feature considers adjacent rectangular regions at a specific location in a detection window, sums up the pixel intensities in each region, and calculates the difference between these sums. This difference is then used to categorize subsections of an image. Viola-Jones object detection framework, when applied to a face detection using Haar features, is based on the assumption that all human faces share some similar properties, such as the eyes region is darker than the upper checks, and the nose bridge region is brighter than the eyes. The Haar-features are used by the Viola-Jones object detection framework, described in articles by Paul Viola and Michael Jones, such as the International Journal of Computer Vision 2004 article entitled: “Robust Real-Time Face Detection” and in the Accepted Conference on Computer Vision and Pattern Recognition 2001 article entitled: “Rapid Object Detection using a Boosted Cascade of Simple Features”, which are both incorporated in their entirety for all purposes as if fully set forth herein.

Object detection is the problem of localization and classifying a specific object in an image which consists of multiple objects. Typical image classifiers use to carry out the task of detecting an object by scanning the entire image to locate the object. The process of scanning the entire image begins with a pre-defined window which produces a Boolean result that is true if the specified object is present in the scanned section of the image and false if it is not. After scanning the entire image with the window, the size of the window is increased which is used for scanning the image again. Systems like Deformable Parts Model (DPM) uses this technique which is called Sliding Window.

Neural networks based techniques may be used for image processing, as described in an article in Engineering Letters, 20:1, EL_20_1_09 (Advance online publication: 27 Feb. 2012) by Juan A. Ramirez-Quintana, Mario I. Cacon-Murguia, and F. Chacon-Hinojos entitled: “Artificial Neural Image Processing Applications: A Survey”, in an article published 2002 by Pattern Recognition Society in Pattern Recognition 35 (2002) 2279-2301 [PII: S0031-3203(01)00178-9] authored by M. Egmont-Petersen, D. de Ridder, and H. Handels entitled: “Image processing with neural networks—a review”, and in an article by Dick de Ridder et al. (of the Utrecht University, Utrecht, The Netherlands) entitled: “Nonlinear image processing using artificial neural networks”, which are all incorporated in their entirety for all purposes as if fully set forth herein.

Neural networks may be used for object detection as described in an article by Christian Szegedy, Alexander Toshev, and Dumitru Erhan (of Google, Inc.) (downloaded July 2015) entitled: “Deep Neural Networks for Object Detection”, in a CVPR2014 paper provided by the Computer Vision Foundation by Dumitru Erhan, Christian Szegedy, Alexander Toshev, and Dragomir Anguelov (of Google, Inc., Mountain-View, California, U.S.A.) (downloaded July 2015) entitled: “Scalable Object Detection using Deep Neural Networks”, and in an article by Shawn McCann and Jim Reesman (both of Stanford University) (downloaded July 2015) entitled: “Object Detection using Convolutional Neural Networks”, which are all incorporated in their entirety for all purposes as if fully set forth herein.

Using neural networks for object recognition or classification is described in an article (downloaded July 2015) by Mehdi Ebady Manaa, Nawfal Turki Obies, and Dr. Tawfiq A. Al-Assadi (of Department of Computer Science, Babylon University), entitled: “Object Classification using neural networks with Gray-level Co-occurrence Matrices (GLCM)”, in a technical report No. IDSIA-01-11 Jan. 2001 published by IDSIA/USI-SUPSI and authored by Dan C. Ciresan et al. entitled: “High-Performance Neural Networks for Visual Object Classification”, in an article by Yuhua Zheng et al. (downloaded July 2015) entitled: “Object Recognition using Neural Networks with Bottom-Up and top-Down Pathways”, and in an article (downloaded July 2015) by Karen Simonyan, Andrea Vedaldi, and Andrew Zisserman (all of Visual Geometry Group, University of Oxford), entitled: “Deep Inside Convolutional Networks: Visualising Image Classification Models and Saliency Maps”, which are all incorporated in their entirety for all purposes as if fully set forth herein.

Using neural networks for object recognition or classification is further described in U.S. Pat. No. 6,018,728 to Spence et al. entitled: “Method and Apparatus for Training a Neural Network to Learn Hierarchical Representations of Objects and to Detect and Classify Objects with Uncertain Training Data”, in U.S. Pat. No. 6,038,337 to Lawrence et al. entitled: “Method and Apparatus for Object Recognition”, in U.S. Pat. No. 8,345,984 to Ji et al. entitled: “3D Convolutional Neural Networks for Automatic Human Action Recognition”, and in U.S. Pat. No. 8,705,849 to Prokhorov entitled: “Method and System for Object Recognition Based on a Trainable Dynamic System”, which are all incorporated in their entirety for all purposes as if fully set forth herein.

Signal processing using ANN is described in a final technical report No. RL-TR-94-150 published August 1994 by Rome Laboratory, Air force Material Command, Griffiss Air Force Base, New York, entitled: “NEURAL NETWORK COMMUNICATIONS SIGNAL PROCESSING”, which is incorporated in its entirety for all purposes as if fully set forth herein. The technical report describes the program goals to develop and implement a neural network and communications signal processing simulation system for the purpose of exploring the applicability of neural network technology to communications signal processing; demonstrate several configurations of the simulation to illustrate the system's ability to model many types of neural network based communications systems; and use the simulation to identify the neural network configurations to be included in the conceptual design cf a neural network transceiver that could be implemented in a follow-on program.

Actual ANN implementation may be based on, or may use, the MATLB® ANN described in the User's Guide Version 4 published July 2002 by The MathWorks, Inc. (Headquartered in Natick, MA, U.S.A.) entitled: “Neural Network ToolBox—For Use with MATLAB®” by Howard Demuth and Mark Beale, which is incorporated in its entirety for all purposes as if fully set forth herein. An VHDL IP core that is a configurable feedforward Artificial Neural Network (ANN) for implementation in FPGAs is available (under the Name: artificial_neural_network, created Jun. 2, 2016 and updated Oct. 11, 2016) from OpenCores organization, downloadable from http://opencores.org/. This IP performs full feedforward connections between consecutive layers. All neurons' outputs of a layer become the inputs for the next layer. This ANN architecture is also known as Multi-Layer Perceptron (MLP) when is trained with a supervised learning algorithm. Different kinds of activation functions can be added easily coding them in the provided VHDL template. This IP core is provided in two parts: kernel plus wrapper. The kernel is the optimized ANN with basic logic interfaces. The kernel should be instantiated inside a wrapper to connect it with the user's system buses. Currently, an example wrapper is provided for instantiate it on Xilinx Vivado, which uses AXI4 interfaces for AMBA buses.

Dynamic neural networks are the most advanced in that they dynamically can, based on rules, form new connections and even new neural units while disabling others. In a Feedforward Neural Network (FNN), the information moves in only one direction-forward: From the input nodes data goes through the hidden nodes (if any) and to the output nodes. There are no cycles or loops in the network. Feedforward networks can be constructed from different types of units, e.g. binary McCulloch-Pitts neurons, the simplest example being the perceptron. Contrary to feedforward networks, Recurrent Neural Networks (RNNs) are models with bi-directional data flow. While a feedforward network propagates data linearly from input to output, RNNs also propagate data from later processing stages to earlier stages. RNNs can be used as general sequence processors.

CNN. A Convolutional Neural Network (CNN, or ConvNet) is a class of artificial neural network, most commonly applied for analyzing visual imagery. They are also known as shift invariant or Space Invariant Artificial Neural Networks (SIANN), based on the shared-weight architecture of the convolution kernels or filters that slide along input features and provide translation equivariant responses known as feature maps. Counter-intuitively, most convolutional neural networks are only equivariant, as opposed to invariant, to translation CNNs are regularized versions of multilayer perceptrons that typically include fully connected networks, where each neuron in one layer is connected to all neurons in the next layer. Typical ways of regularization, or preventing overfitting, include: penalizing parameters during training (such as weight decay) or trimming connectivity (such as skipped connections or dropout). CNNs approach towards regularization involve taking advantage of the hierarchical pattern in data and assemble patterns of increasing complexity using smaller and simpler patterns embossed in their filters. CNNs use relatively little pre-processing compared to other image classification algorithms. This means that the network learns to optimize the filters (or kernels) through automated learning, whereas in traditional algorithms these filters are hand-engineered. This independence from prior knowledge and human intervention in feature extraction is a major advantage.

Systems and methods that provide a unified end-to-end detection pipeline for object detection that achieves impressive performance in detecting very small and highly overlapped objects in face and car images are presented in U.S. Pat. No. 9,881,234 to Huang et al. entitled: “Systems and methods for end-to-end object detection”, which is incorporated in its entirety for all purposes as if fully set forth herein. Various embodiments of the present disclosure provide for an accurate and efficient one-stage FCN-based object detector that may be optimized end-to-end during training. Certain embodiments train the object detector on a single scale using jitter-augmentation integrated landmark localization information through joint multi-task learning to improve the performance and accuracy of end-to-end object detection. Various embodiments apply hard negative mining techniques during training to bootstrap detection performance. The presented are systems and methods are highly suitable for situations where region proposal generation methods may fail, and they outperform many existing sliding window fashion FCN detection frameworks when detecting objects at small scales and under heavy occlusion conditions.

A technology for multi-perspective detection of objects is disclosed in U.S. Pat. No. 10,706,335 to Gautam et al. entitled: “Multi-perspective detection of objects”, which is incorporated in its entirety for all purposes as if fully set forth herein. The technology may involve a computing system that (i) generates (a) a first feature map based on a first visual input from a first perspective of a scene utilizing at least one first neural network and (b) a second feature map based on a second visual input from a second, different perspective of the scene utilizing at least one second neural network, where the first perspective and the second perspective share a common dimension, (ii) based on the first feature map and a portion of the second feature map corresponding to the common dimension, generates cross-referenced data for the first visual input, (iii) based on the second feature map and a portion of the first feature map corresponding to the common dimension, generates cross-referenced data for the second visual input, and (iv) based on the cross-referenced data, performs object detection on the scene.

A method and a system for implementing neural network models on edge devices in an Internet of Things (IoT) network are disclosed in U.S. Patent Application Publication No. 2020/0380306 to HADA et al. entitled: “System and method for implementing neural network models on edge devices in iot networks”, which is incorporated in its entirety for all purposes as if fully set forth herein. In an embodiment, the method may include receiving a neural network model trained and configured to detect objects from images, and iteratively assigning a new value to each of a plurality of parameters associated with the neural network model to generate a re-configured neural network model in each iteration. The method may further include deploying for a current iteration the re-configured neural network on the edge device. The method may further include computing for the current iteration, a trade-off value based on a detection accuracy associated with the at least one object detected in the image and resource utilization data associated with the edge device, and selecting the re-configured neural network model, based on the trade-off value calculated for the current iteration.

Imagenet. Project ImageNet is an exampler of a pre-trained neural network, described in the website www.image-net.org/(preceded by http://) whose API is described in a web page image-net.org/download-API (preceded by http://), a copy of which is incorporated in its entirety for all purposes as if fully set forth herein. The project is further described in a presentation by Fei-Fei Li and Olga Russakovsky (ICCV 2013) entitled: “Analysis of large Scale Visual Recognition”, in an ImageNet presentation by Fei-Fei Li (of Computer Science Dept., Stanford University) entitled: “Outsourcing, benchmarking, & other cool things”, and in an article (downloaded July 2015) by Alex Krizhevsky, Ilya Sutskever, and Geoffrey E. Hinton (all of University of Toronto) entitled: “ImageNet Classification with Deep Convolutional Neural Networks”, which are both incorporated in their entirety for all purposes as if fully set forth herein.

The ImageNet project is a large visual database designed for use in visual object recognition software research. More than 14 million images have been hand-annotated by the project to indicate what objects are pictured and in at least one million of the images, bounding boxes are also provided. The database of annotations of third-party image URLs is freely available directly from ImageNet, though the actual images are not owned by ImageNet. ImageNet crowdsources its annotation process. Image-level annotations indicate the presence or absence of an object class in an image, such as “there are tigers in this image” or “there are no tigers in this image”. Object-level annotations provide a bounding box around the (visible part of the) indicated object. ImageNet uses a variant of the broad WordNet schema to categorize objects, augmented with 120 categories of dog breeds to showcase fine-grained classification.

YOLO. You Only Look Once (YOLO) is a new approach to object detection. While other object detection repurposes classifiers perform detection, YOLO object detection is defined as a regression problem to spatially separated bounding boxes and associated class probabilities. A single neural network predicts bounding boxes and class probabilities directly from full images in one evaluation. Since the whole detection pipeline is a single network, it can be optimized end-to-end directly on detection performance. YOLO makes more localization errors but is less likely to predict false positives on background, and further learns very general representations of objects. It outperforms other detection methods, including Deformable Parts Model (DPM) and R-CNN, when generalizing from natural images to other domains like artwork.

After classification, post-processing is used to refine the bounding boxes, eliminate duplicate detections, and rescore the boxes based on other objects in the scene. The object detection is framed as a single regression problem, straight from image pixels to bounding box coordinates and class probabilities, so that only looking once (YOLO) at an image predicts what objects are present and where they are. A single convolutional network simultaneously predicts multiple bounding boxes and class probabilities for those boxes. YOLO trains on full images and directly optimizes detection performance.

In one example, YOLO is implemented as a CNN and has been evaluated on the PASCAL VOC detection dataset. It consists of a total of 24 convolutional layers followed by 2 fully connected layers. The layers are separated by their functionality in the following manner: First 20 convolutional layers followed by an average pooling layer and a fully connected layer is pre-trained on the ImageNet 1000-class classification dataset; the pretraining for classification is performed on dataset with resolution 224×224; and the layers comprise of 1×1 reduction layers and 3×3 convolutional layers. Last 4 convolutional layers followed by 2 fully connected layers are added to train the network for object detection, that requires more granular detail hence the resolution of the dataset is bumped to 448×448. The final layer predicts the class probabilities and bounding boxes, and uses a linear activation whereas the other convolutional layers use leaky ReLU activation. The input is 448×448 image and the output is the class prediction of the object enclosed in the bounding box.

The YOLO approach to object detection describing frame object detection as a regression problem to spatially separated bounding boxes and associated class probabilities is described in an article authored by Joseph Redmon, Santosh Divvala, Ross Girshick, and Ali Farhadi, published 9 May 2016 and entitled: “You Only Look Once: Unified, Real-Time Object Detection”, which is incorporated in its entirety for all purposes as if fully set forth herein. A single neural network predicts bounding boxes and class probabilities directly from full images in one evaluation. Since the whole detection pipeline is a single network, it can be optimized end-to-end directly on detection performance. The base YOLO model processes images in real-time at 45 frames per second while a smaller version of the network, Fast YOLO, processes an astounding 155 frames per second while still achieving double the mAP of other real-time detectors. Compared to state-of-the-art detection systems, YOLO makes more localization errors but is less likely to predict false positives on background. Further, YOLO learns very general representations of objects.

Based on the general introduction to the background and the core solution CNN, one of the best CNN representatives You Only Look Once (YOLO), which breaks through the CNN family's tradition and innovates a complete new way of solving the object detection with most simple and high efficient way, is described in an article authored by Juan Du of New Research and Development Center of Hisense, Qingdao 266071, China, published 2018 in IOP Conf. Series: Journal of Physics: Conf. Series 1004 (2018) 012029 [doi:10.1088/1742-6596/1004/1/012029], entitled: “Understanding of Object Detection Based on CNN Family and YOLO”, which is incorporated in their entirety for all purposes as if fully set forth herein. As a key use of image processing, object detection has boomed along with the unprecedented advancement of Convolutional Neural Network (CNN) and its variants. When CNN series develops to Faster Region with CNN (R-CNN), the Mean Average Precision (mAP) has reached 76.4, whereas, the Frame Per Second (FPS) of Faster R-CNN remains 5 to 18 which is far slower than the real-time effect. Thus, the most urgent requirement of object detection improvement is to accelerate the speed. Its fastest speed has achieved the exciting unparalleled result with FPS 155, and its mAP can also reach up to 78.6, both of which have surpassed the performance of Faster R-CNN greatly.

YOLO9000 is a state-of-the-art, real-time object detection system that can detect over 9000 object categories, and is described in an article authored by Joseph Redmon and Ali Farhadi, published 2016 and entitled: “YOLO9000: Better, Faster, Stronger”, which is incorporated in its entirety for all purposes as if fully set forth herein. The article proposes various improvements to the YOLO detection method, and the improved model, YOLOv2, is state-of-the-art on standard detection tasks like PASCAL VOC and COCO. Using a novel, multi-scale training method the same YOLOv2 model can run at varying sizes, offers an easy tradeoff between speed and accuracy. At 67 FPS, YOLOv2 gets 76.8 mAP on VOC 2007. At 40 FPS, YOLOv2 gets 78.6 mAP, outperforming state-of-the-art methods like Faster RCNN with ResNet and SSD while still running significantly faster.

A Tera-OPS streaming hardware accelerator implementing a YOLO (You-Only-Look-One) CNN for real-time object detection with high throughput and power efficiency, is described in an article authored by Duy Thanh Nguyen, Tuan Nghia Nguyen, Hyun Kim, and Hyuk-Jac Lec, published August 2019 [DOI: 10.1109/TVLSI.2019.2905242] in IEEE Transactions on Very Large Scale Integration (VLSI) Systems 27(8), entitled: “A High-Throughput and Power-Efficient FPGA Implementation of YOLO CNN for Object Detection”, which is incorporated in their entirety for all purposes as if fully set forth herein. Convolutional neural networks (CNNs) require numerous computations and external memory accesses. Frequent accesses to off-chip memory cause slow processing and large power dissipation. The parameters of the YOLO CNN are retrained and quantized with PASCAL VOC dataset using binary weight and flexible low-bit activation. The binary weight enables storing the entire network model in Block RAMs of a field programmable gate array (FPGA) to reduce off-chip accesses aggressively and thereby achieve significant performance enhancement. In the proposed design, all convolutional layers are fully pipelined for enhanced hardware utilization. The input image is delivered to the accelerator line by line. Similarly, the output from previous layer is transmitted to the next layer line by line. The intermediate data are fully reused across layers thereby eliminating external memory accesses. The decreased DRAM accesses reduce DRAM power consumption. Furthermore, as the convolutional layers are fully parameterized, it is easy to scale up the network. In this streaming design, each convolution layer is mapped to a dedicated hardware block. Therefore, it outperforms the “one-size-fit-all” designs in both performance and power efficiency. This CNN implemented using VC707 FPGA achieves a throughput of 1.877 TOPS at 200 MHz with batch processing while consuming 18.29 W of on-chip power, which shows the best power efficiency compared to previous research. As for object detection accuracy, it achieves a mean Average Precision (mAP) of 64.16% for PASCAL VOC 2007 dataset that is only 2.63% lower than the mAP of the same YOLO network with full precision.

R-CNN. Regions with CNN features (R-CNN) family is a family of machine learning models used to bypass the problem of selecting a huge number of regions. The R-CNN uses selective search to extract just 2000 regions from the image, referred to as region proposals. Then, instead of trying to classify a huge number of regions, only 2000 regions are handled. These 2000 region proposals are generated using a selective search algorithm, that includes Generating initial sub-segmentation for generating many candidate regions, using greedy algorithm to recursively combine similar regions into larger ones, and using the generated regions to produce the final candidate region proposals. These 2000 candidate region proposals are warped into a square and fed into a convolutional neural network that produces a 4096-dimensional feature vector as output. The CNN acts as a feature extractor and the output dense layer consists of the features extracted from the image and the extracted features are fed into an SVM to classify the presence of the object within that candidate region proposal. In addition to predicting the presence of an object within the region proposals, the algorithm also predicts four values which are offset values to increase the precision of the bounding box. For example, given a region proposal, the algorithm would have predicted the presence of a person but the face of that person within that region proposal could've been cut in half. Therefore, the offset values help in adjusting the bounding box of the region proposal.

The original goal of R-CNN was to take an input image and produce a set of bounding boxes as output, where each bounding box contains an object and also the category (e.g., car or pedestrian) of the object. Then R-CNN has been extended to perform other computer vision tasks., R-CNN is used with a given an input image, and begins by applying a mechanism called Selective Search to extract Regions Of Interest (ROI), where each ROI is a rectangle that may represent the boundary of an object in image. Depending on the scenario, there may be as many as two thousand ROIs. After that, each ROI is fed through a neural network to produce output features. For each ROI's output features, a collection of support-vector machine classifiers is used to determine what type of object (if any) is contained within the ROI. While the original R-CNN independently computed the neural network features on each of as many as two thousand regions of interest, Fast R-CNN runs the neural network once on the whole image. At the end of the network is a novel method called ROIPooling, which slices out each ROI from the network's output tensor, reshapes it, and classifies it. As in the original R-CNN, the Fast R-CNN uses Selective Search to generate its region proposals. While Fast R-CNN used Selective Search to generate ROIs, Faster R-CNN integrates the ROI generation into the neural network itself. Mask R-CNN adds instance segmentation, and also replaced ROIPooling with a new method called ROIAlign, which can represent fractions of a pixel, and Mesh R-CNN adds the ability to generate a 3D mesh from a 2D image. R-CNN and Fast R-CNN are primarily image classifier networks which are used for object detection by using Region Proposal method to generate potential bounding boxes in an image, run the classifier on these boxes, and after classification, perform post processing to tighten the boundaries of the bounding boxes and remove duplicates.

Regions with CNN features (R-CNN) that combines two key insights: (1) one can apply high-capacity convolutional neural networks (CNNs) to bottom-up region proposals in order to localize and segment objects and (2) when labeled training data is scarce, supervised pre-training for an auxiliary task, followed by domain-specific fine-tuning, yields a significant performance boost, is described in an article authored by Ross Girshick, Jeff Donahue, Trevor Darrell, and Jitendra Malik, published 2014 In Proc. IEEE Conf. on computer vision and pattern recognition (CVPR), pp. 580-587, entitled: “Rich feature hierarchies for accurate object detection and semantic segmentation”, which is incorporated in its entirety for all purposes as if fully set forth herein. Object detection performance, as measured on the canonical PASCAL VOC dataset, has plateaued, and the best-performing methods are complex ensemble systems that typically combine multiple low-level image features with high-level context. The proposed R-CNN is a simple and scalable detection algorithm that improves mean average precision (mAP) by more than 30% relative to the previous best result on VOC 2012—achieving a mAP of 53.3%. Source code for the complete system is available at http://www.cs.berkeley.edu/\tilde{ }rbg/renn.

Fast R-CNN. Fast R-CNN solves some of the drawbacks of R-CNN to build a faster object detection algorithm. Instead of feeding the region proposals to the CNN, the input image is fed to the CNN to generate a convolutional feature map. From the convolutional feature map, the regions of proposals are identified and warped into squares, and by using a Rol pooling layer they are reshaped into a fixed size so that it can be fed into a fully connected layer. From the Rol feature vector, a softmax layer is used to predict the class of the proposed region and also the offset values for the bounding box. The reason “Fast R-CNN” is faster than R-CNN is because 2000 region proposals don't have to be fed to the convolutional neural network every time. Instead, the convolution operation is done only once per image and a feature map is generated from it.

A Fast Region-based Convolutional Network method (Fast R-CNN) for object detection is disclosed in an article authored by Ross Girshick of Microsoft Research published 27 Sep. 2015 [arXiv:1504.08083v2 [cs.CV]] In Proc. IEEE Intl. Conf. on computer vision, pp. 1440-1448. 2015, entitled: “Fast R-CNN”, which is incorporated in its entirety for all purposes as if fully set forth herein. Fast R-CNN builds on previous work to efficiently classify object proposals using deep convolutional networks, and employs several innovations to improve training and testing speed while also increasing detection accuracy. Fast R-CNN trains the very deep VGG16 network 9× faster than R-CNN, is 213× faster at test-time, and achieves a higher mAP on PASCAL VOC 2012. Compared to SPPnet, Fast R-CNN trains VGG16 3× faster, tests 10× faster, and is more accurate. Fast R-CNN is implemented in Python and C++ (using Caffe) and is available under the open-source MIT License at https://github.com/rbgirshick/fast-renn.

Faster R-CNN. In Faster R-CNN, similar to Fast R-CNN, the image is provided as an input to a convolutional network which provides a convolutional feature map. However, instead of using selective search algorithm on the feature map to identify the region proposals, a separate network is used to predict the region proposals. The predicted region proposals are then reshaped using a Rol pooling layer which is then used to classify the image within the proposed region and predict the offset values for the bounding boxes.

A Region Proposal Network (RPN) that shares full-image convolutional features with the detection network, thus enabling nearly cost-free region proposals, is described in an article authored by Shaoqing Ren, Kaiming He, Ross Girshick, and Jian Sun, published 2015, entitled: “Faster R-CNN: Towards Real-Time Object Detection with Region Proposal networks”, which is incorporated in its entirety for all purposes as if fully set forth herein. State-of-the-art object detection networks depend on region proposal algorithms to hypothesize object locations. Advances like SPPnet and Fast R-CNN have reduced the running time of these detection networks, exposing region proposal computation as a bottleneck. An RPN is a fully-convolutional network that simultaneously predicts object bounds and objectness scores at each position. RPNs are trained end-to-end to generate high quality region proposals, which are used by Fast R-CNN for detection. With a simple alternating optimization, RPN and Fast R-CNN can be trained to share convolutional features. For the very deep VGG-16 model, a described detection system has a frame rate of 5 fps (including all steps) on a GPU, while achieving state-of-the-art object detection accuracy on PASCAL VOC 2007 (73.2% mAP) and 2012 (70.4% mAP) using 300 proposals per image. Code is available at https://github.com/ShaoqingRen/faster_renn.

RetinaNet. RetinaNet is one of the one-stage object detection models that has proven to work well with dense and small-scale objects, that has become a popular object detection model to be used with aerial and satellite imagery. RetinaNet has been formed by making two improvements over existing single stage object detection models-Feature Pyramid Networks (FPN) and Focal Loss. Traditionally, in computer vision, featurized image pyramids have been used to detect objects with varying scales in an image. Featurized image pyramids are feature pyramids built upon image pyramids, where an image is subsampled into lower resolution and smaller size images (thus, forming a pyramid). Hand-engineered features are then extracted from each layer in the pyramid to detect the objects, which makes the pyramid scale-invariant. With the advent of deep learning, these hand-engineered features were replaced by CNNs. Later, the pyramid itself was derived from the inherent pyramidal hierarchical structure of the CNNs. In a CNN architecture, the output size of feature maps decreases after each successive block of convolutional operations, and forms a pyramidal structure.

FPN. Feature Pyramid Network (FPN) is an architecture that utilize the pyramid structure. In one example, pyramidal feature hierarchy is utilized by models such as Single Shot detector, but it doesn't reuse the multi-scale feature maps from different layers. Feature Pyramid Network (FPN) makes up for the shortcomings in these variations, and creates an architecture with rich semantics at all levels as it combines low-resolution semantically strong features with high-resolution semantically weak features, which is achieved by creating a top-down pathway with lateral connections to bottom-up convolutional layers. FPN is built in a fully convolutional fashion, which can take an image of an arbitrary size and output proportionally sized feature maps at multiple levels. Higher level feature maps contain grid cells that cover larger regions of the image and is therefore more suitable for detecting larger objects; on the contrary, grid cells from lower-level feature maps are better at detecting smaller objects. With the help of the top-down pathway and lateral connections, it is not required to use much extra computation, and every level of the resulting feature maps can be both semantically and spatially strong. These feature maps can be used independently to make predictions and thus contributes to a model that is scale-invariant and can provide better performance both in terms of speed and accuracy.

The construction of FPN involves two pathways which are connected with lateral connections: Bottom-up pathway and Top-down pathway and lateral connections. The bottom-up pathway of building FPN is accomplished by choosing the last feature map of each group of consecutive layers that output feature maps of the same scale. These chosen feature maps will be used as the foundation of the feature pyramid. Using nearest neighbor upsampling, the last feature map from the bottom-up pathway is expanded to the same scale as the second-to-last feature map. These two feature maps are then merged by element-wise addition to form a new feature map. This process is iterated until each feature map from the bottom-up pathway has a corresponding new feature map connected with lateral connections.

RetinaNet architecture incorporates FPN and adds classification and regression subnetworks to create an object detection model. There are four major components of a RetinaNet model architecture: (a) Bottom-up Pathway—The backbone network (e.g., ResNet) calculates the feature maps at different scales, irrespective of the input image size or the backbone; (b) Top-down pathway and Lateral connections—The top down pathway upsamples the spatially coarser feature maps from higher pyramid levels, and the lateral connections merge the top-down layers and the bottom-up layers with the same spatial size; (c) Classification subnetwork—It predicts the probability of an object being present at each spatial location for each anchor box and object class; and (d) Regression subnetwork—which regresses the offset for the bounding boxes from the anchor boxes for each ground-truth object.

Focal Loss (FL) is an enhancement over Cross-Entropy Loss (CE) and is introduced to handle the class imbalance problem with single-stage object detection models. Single Stage models suffer from an extreme foreground-background class imbalance problem due to dense sampling of anchor boxes (possible object locations). In RetinaNet, at each pyramid layer there can be thousands of anchor boxes. Only a few will be assigned to a ground-truth object while the vast majority will be background class. These easy examples (detections with high probabilities) although resulting in small loss values can collectively overwhelm the model. Focal Loss reduces the loss contribution from easy examples and increases the importance of correcting missclassified examples.

RetinaNet is a composite network composed of a backbone network called Feature Pyramid Net, which is built on top of ResNet and is responsible for computing convolutional feature maps of an entire image; a subnetwork responsible for performing object classification using the backbone's output; and a subnetwork responsible for performing bounding box regression using the backbone's output. RetinaNet adopts the Feature Pyramid Network (FPN) as its backbone, which is in turn built on top of ResNet (ResNet-50, ResNet-101 or ResNet-152) in a fully convolutional fashion. The fully convolutional nature enables the network to take an image of an arbitrary size and outputs proportionally sized feature maps at multiple levels in the feature pyramid.

The highest accuracy object detectors to date are based on a two-stage approach popularized by R-CNN, where a classifier is applied to a sparse set of candidate object locations. In contrast, one-stage detectors that are applied over a regular, dense sampling of possible object locations have the potential to be faster and simpler, but have trailed the accuracy of two-stage detectors thus far.

The extreme foreground-background class imbalance encountered during training of dense detectors is the central cause for these differences, as described in an article authored by Tsung-Yi Lin, Priya Goyal, Ross Girshick, Kaiming He, and Piotr Dollár, published 7 Feb. 2018 in IEEE Transactions on Pattern Analysis and Machine Intelligence. 42(2): 318-327 [doi:10.1109/TPAMI.2018.2858826; arXiv:1708.02002v2 [cs.CV]], entitled: “Focal Loss for Dense Object Detection”, which is incorporated in its entirety for all purposes as if fully set forth herein. This class imbalance may be addressed by reshaping the standard cross entropy loss such that it down-weights the loss assigned to well-classified examples. The Focal Loss focuses training on a sparse set of hard examples and prevents the vast number of easy negatives from overwhelming the detector during training. To evaluate the effectiveness of our loss, the paper discloses designing and training RetinaNet—a simple dense detector. The results show that when trained with the focal loss, RetinaNet is able to match the speed of previous one-stage detectors while surpassing the accuracy of all existing state-of-the-art two-stage detectors.

Feature pyramids are a basic component in recognition systems for detecting objects at different scales. Recent deep learning object detectors have avoided pyramid representations, in part because they are computing and memory intensive. The exploitation of inherent multi-scale, pyramidal hierarchy of deep convolutional networks to construct feature pyramids with marginal extra cost is described in an article authored by Tsung-Yi Lin, Piotr Dollár, Ross Girshick, Kaiming He, Bharath Hariharan, and Serge Belongie, published 19 Apr. 2017 [arXiv:1612.03144v2 [cs.CV]], entitled: “Feature Pyramid Networks for Object Detection”, which is incorporated in its entirety for all purposes as if fully set forth herein. A top-down architecture with lateral connections is developed for building high-level semantic feature maps at all scales. This architecture, called a Feature Pyramid Network (FPN), shows significant improvement as a generic feature extractor in several applications.

Object detection has gained great progress driven by the development of deep learning. Compared with a widely studied task—classification, generally speaking, object detection even needs one or two orders of magnitude more FLOPs (floating point operations) in processing the inference task. To enable a practical application, it is essential to explore effective runtime and accuracy trade-off scheme. Recently, a growing number of studies are intended for object detection on resource constraint devices, such as YOLOv1, YOLOv2, SSD, MobileNetv2-SSDLite, whose accuracy on COCO test-dev detection results are yield to mAP around 22-25% (mAP-20-tier). On the contrary, very few studies discuss the computation and accuracy trade-off scheme for mAP-30-tier detection networks. The insights of why RetinaNet gives effective computation and accuracy trade-off for object detection, and how to build a light-weight RetinaNet, is illustrated in an article authored by Yixing Li and Fengbo Ren published 24 May 2019 [arXiv:1905.10011v1 [cs.CV]] entitled: “Light-Weight RetinaNet for Object Detection”, which is incorporated in its entirety for all purposes as if fully set forth herein. The article proposed reduced FLOPs in computational-intensive layers and keep other layer the same, shows a constantly better FLOPs-mAP trade-off line. Quantitatively, the proposed method results in 0.1% mAP improvement at 1.15×FLOPs reduction and 0.3% mAP improvement at 1.8×FLOPs reduction.

GNN. A Graph Neural Network (GNN) is a class of neural networks for processing data represented by graph data structures. Several variants of the simple Message Passing Neural Network (MPNN) framework have been proposed, and these models optimize GNNs for use on larger graphs and apply them to domains such as social networks, citation networks, and online communities. It has been mathematically proven that GNNs are a weak form of the Weisfeiler-Lehman graph isomorphism test, so any GNN model is at least as powerful as this test.

Graph Neural Networks (GNNs) are neural models that capture the dependence of graphs via message passing between the nodes of graphs, and are described in an article by Jie Zhou, Ganqu Cui, Shengding Hu, Zhengyan Zhang, Chong Yang, Zhiyuan Liu, Lifeng Wang, Changcheng Li, and Maosong Sun published at AI Open 2021 [arXiv:1812.08434 [cs.LG]], entitled: “Graph neural networks: A review of methods and applications”, which is incorporated in its entirety for all purposes as if fully set forth herein. Variants of GNNs such as Graph Convolutional Network (GCN), Graph Attention Network (GAT), Graph Recurrent Network (GRN) have demonstrated ground-breaking performances on many deep learning tasks. A general design pipeline for GNN models and variants of each component, systematically categorize the applications, are described.

Graph Neural Networks (GNNs) are in the field of artificial intelligence due to their unique ability to ingest relatively unstructured data types as input data, and are described in an article authored by Isaac Ronald Ward, Jack Joyner, Casey Lickfold, Stash Rowe, Yulan Guo, and Mohammed Bennamoun, published 2020 [arXiv:2010.05234 [cs.LG]] entitled: “A Practical Guide to Graph Neural Networks”, which is incorporated in its entirety for all purposes as if fully set forth herein. Although some elements of the GNN architecture are conceptually similar in operation to traditional neural networks (and neural network variants), other elements represent a departure from traditional deep learning techniques. The article exposes the power and novelty of GNNs to the average deep learning enthusiast by collating and presenting details on the motivations, concepts, mathematics, and applications of the most common types of GNNs.

GraphNet is an example of a GNN. Recommendation systems that are widely used in many popular online services use either network structure or language features. A scalable and efficient recommendation system that combines both language content and complex social network structure is presented in an article authored by Rex Ying. Yuanfang Li, and Xin Li of Stanford University, published 2017 by Stanford University, entitled: “GraphNet: Recommendation system based on language and network structure”, which is incorporated in its entirety for all purposes as if fully set forth herein. Given a dataset consisting of objects created and commented on by users, the system predicts other content that the user may be interested in. The efficacy of the system is presented through the task of recommending posts to reddit users based on their previous posts and comments. The language feature using GloVe vectors is extracted and sequential model, and use attention mechanism, multi-layer perceptron and max pooling to learn hidden representations for users and posts, so the method is able to achieve the state-of-the-art performance. The general framework consists of the following steps: (1) extract language features from contents of users; (2) for each user and post, sample intelligently a set of similar users and posts; (3) for each user and post, use a deep architecture to aggregate information from the features of its sampled similar users and posts and output a representation for each user and post, which captures both its language features and the network structure; and (4) use a loss function specific to the task to train the model.

Graph Neural Networks (GNNs) have achieved state-of-the-art results on many graph-analysis tasks such as node classification and link prediction. Unsupervised training of GNN pooling in terms of their clustering capabilities is described in an article by Anton Tsitsulin, John Palowitch, Bryan Perozzi, and Emmanuel Müller published 30 Jun. 2020 [arXiv:2006.16904v1 [cs.LG]] entitled: “Graph Clustering with Graph Neural Networks”, which is incorporated in its entirety for all purposes as if fully set forth herein. The article draws a connection between graph clustering and graph pooling: intuitively, a good graph clustering is expected from a GNN pooling layer. Counterintuitively, this is not true for state-of-the-art pooling methods, such as MinCut pooling. Deep Modularity Networks (DMON) is used to address these deficiencies, by using an unsupervised pooling method inspired by the modularity measure of clustering quality, so it tackles recovery of the challenging clustering structure of real-world graphs.

MobileNet. MobileNets is a class of efficient models for mobile and embedded vision applications, which are based on a streamlined architecture that uses depthwise separable convolutions to build light weight deep neural networks. Two simple global hyperparameters are used for efficiently trading off between latency and accuracy, allowing to choose the right sized model for their application based on the constraints of the problem. Extensive experiments on resource and accuracy tradeoffs and showing strong performance compared to other popular models on ImageNet classification are described in an article authored by Andrew G. Howard, Menglong Zhu, Bo Chen, Dmitry Kalenichenko, Weijun Wang, Tobias Weyand, Marco Andreetto, and Hartwig Adam of Google Inc., published 17 Apr. 2017 [arXiv:1704.04861v1 [cs.CV]] entitled: “MobileNets: Efficient Convolutional Neural Networks for Mobile Vision Applications”, which is incorporated in its entirety for all purposes as if fully set forth herein. The article demonstrates the effectiveness of MobileNets across a wide range of applications and use cases including object detection, finegrain classification, face attributes and large scale geo-localization. The system uses an efficient network architecture and a set of two hyper-parameters in order to build very small, low latency models that can be easily matched to the design requirements for mobile and embedded vision applications, and describes the MobileNet architecture and two hyper-parameters width multiplier and resolution multiplier to define smaller and more efficient MobileNets.

A new mobile architecture, MobileNetV2, that is specifically tailored for mobile and resource constrained environments and improves the state-of-the-art performance of mobile models on multiple tasks and benchmarks as well as across a spectrum of different model sizes, is described in an article by Mark Sandler, Andrew Howard, Menglong Zhu, Andrey Zhmoginov, and Liang-Chich Chen of Google Inc., published 21 Mar. 2019 [arXiv:1801.04381v4 [cs.CV]] entitled: “MobileNetV2: Inverted Residuals and Linear Bottlenecks”, which is incorporated in its entirety for all purposes as if fully set forth herein. The article describes efficient ways of applying these mobile models to object detection in a novel framework referred to as SSDLite, and further demonstrates how to build mobile semantic segmentation models through a reduced form of DeepLabv3 (referred to as Mobile DeepLabv3), is based on an inverted residual structure where the shortcut connections are between the thin bottleneck layers. The intermediate expansion layer uses lightweight depth-wise convolutions to filter features as a source of non-linearity. The scheme allows for decoupling of the input/output domains from the expressiveness of the transformation, which provides a convenient framework for further analysis.

MobileNetV3 is tuned to mobile phone CPUs through a combination of hardware aware network architecture search (NAS) complemented by the NetAdapt algorithm and then subsequently improved through novel architecture advances. The next generation of MobileNets based on a combination of complementary search techniques as well as a novel architecture design, and is described in an article authored by Andrew Howard, Mark Sandler, Grace Chu, Liang-Chich Chen, Bo Chen, Mingxing Tan, Weijun Wang, Yukun Zhu, Ruoming Pang, Vijay Vasudevan, Quoc V. Le, and Hartwig Adam published 2019 [arXiv:1905.02244 [cs.CV]] entitled: “Searching for MobileNetV3”, which is incorporated in its entirety for all purposes as if fully set forth herein. This article describes the exploration of how automated search algorithms and network design can work together to harness complementary approaches improving the overall state of the art, and describes best possible mobile computer vision architectures optimizing the accuracy-latency trade off on mobile devices, by introducing (1) complementary search techniques, (2) new efficient versions of nonlinearities practical for the mobile setting. (3) new efficient network design, (4) a new efficient segmentation decoder.

U-Net. U-Net is a convolutional neural network that was developed for biomedical image segmentation at the Computer Science Department of the University of Freiburg. The network is based on the fully convolutional network and its architecture was modified and extended to work with fewer training images and to yield more precise segmentations. For example, segmentation of a 512×512 image takes less than a second on a modern GPU. The main idea is to supplement a usual contracting network by successive layers, where pooling operations are replaced by upsampling operators. These layers increase the resolution of the output, and a successive convolutional layer can then learn to assemble a precise output based on this information. One important modification in U-Net is that there are a large number of feature channels in the upsampling part, which allow the network to propagate context information to higher resolution layers. As a consequence, the expansive path is more or less symmetric to the contracting part, and yields a u-shaped architecture. The network only uses the valid part of each convolution without any fully connected layers. To predict the pixels in the border region of the image, the missing context is extrapolated by mirroring the input image. The network consists of a contracting path and an expansive path, which gives it the u-shaped architecture. The contracting path is a typical convolutional network that consists of repeated application of convolutions, each followed by a rectified linear unit (ReLU) and a max pooling operation. During the contraction, the spatial information is reduced while feature information is increased. The expansive pathway combines the feature and spatial information through a sequence of up-convolutions and concatenations with high-resolution features from the contracting path.

Convolutional networks are powerful visual models that yield hierarchies of features, which when trained end-to-end, pixels-to-pixels, exceed the state-of-the-art in semantic segmentation, using a “fully convolutional” networks that take input of arbitrary size and produce correspondingly-sized output with efficient inference and learning. Such “fully convolutional” networks are described in an article authored by Jonathan Long, Evan Shelhamer, and Trevor Darrell, published Apr. 1 2017 in IEEE Transactions on Pattern Analysis and Machine Intelligence (Volume: 39, Issue: 4) [DOI: 10.1109/TPAMI.2016.2572683], entitled: “Fully Convolutional Networks for Semantic Segmentation”, which is incorporated in its entirety for all purposes as if fully set forth herein. The article describes the space of fully convolutional networks, explains their application to spatially dense prediction tasks, and draws connections to prior models. A skip architecture is defined, that combines semantic information from a deep, coarse layer with appearance information from a shallow, fine layer to produce accurate and detailed segmentations. The article shows that a fully convolutional network (FCN) trained end-to-end, pixels-to-pixels on semantic segmentation exceeds the state-of-the-art without further machinery.

Convolutional neural networks can naturally operate on images, but have significant challenges in dealing with graph data. Given images are special cases of graphs with nodes lie on 2D lattices, graph embedding tasks have a natural correspondence with image pixelwise prediction tasks such as segmentation. While encoder-decoder architectures like U-Nets have been successfully applied on many image pixelwise prediction tasks, similar methods are lacking for graph data, since pooling and up-sampling operations are not natural on graph data. An encoder-decoder model on graph, known as the graph U-Nets and based on gPool and gUnpool layers, is described in an article authored by Hongyang Gao and Shuiwang Ji published 2019 [arXiv:1905.05178 [cs.LG]] entitled: “Graph U-Nets”, which is incorporated in its entirety for all purposes as if fully set forth herein. The gPool layer adaptively selects some nodes to form a smaller graph based on their scalar projection values on a trainable projection vector. The gUnpool layer as the inverse operation of the gPool layer. The gUnpool layer restores the graph into its original structure using the position information of nodes selected in the corresponding gPool layer.

A network and training strategy that relies on the strong use of data augmentation to use the available annotated samples more efficiently is described in an article authored by Olaf Ronneberger, Philipp Fischer, and Thomas Brox, published 18 May 2015 in Medical Image Computing and Computer-Assisted Intervention (MICCAI), Springer, LNCS, Vol. 9351:234-241 [arXiv:1505.04597v1 [cs.CV]], entitled: “U-Net: Convolutional Networks for Biomedical Image Segmentation”, which is incorporated in its entirety for all purposes as if fully set forth herein. The architecture consists of a contracting path to capture context and a symmetric expanding path that enables precise localization. Such a network can be trained end-to-end from very few images and outperforms the prior best method (a sliding-window convolutional network) on the ISBI challenge for segmentation of neuronal structures in electron microscopic stacks. The architecture further works with very few training images and yields more precise segmentations. The main idea in is to supplement a usual contracting network by successive layers, where pooling operators are replaced by upsampling operators. Hence, these layers increase the resolution of the output. In order to localize, high resolution features from the contracting path are combined with the upsampled output. A successive convolution layer can then learn to assemble a more precise output based on this information. One important modification in our architecture is that in the upsampling part there is a large number of feature channels, which allow the network to propagate context information to higher resolution layers. As a consequence, the expansive path is more or less symmetric to the contracting path, and yields a u-shaped architecture. The network does not have any fully connected layers and only uses the valid part of each convolution, i.e., the segmentation map only contains the pixels, for which the full context is available in the input image.

VGG Net. VGG Net is a pre-trained Convolutional Neural Network (CNN) invented by Simonyan and Zisserman from Visual Geometry Group (VGG) at University of Oxford, described in an article published 2015 [arXiv:1409.1556 [cs.CV]] as a conference paper at ICLR 2015 entitled: “Very Deep Convolutional Networks for Large-Scale Image Recognition”, which is incorporated in its entirety for all purposes as if fully set forth herein. The VGG Net extracts the features (feature extractor) that can distinguish the objects and is used to classify unseen objects, and was invented with the purpose of enhancing classification accuracy by increasing the depth of the CNNs. VGG 16 and VGG 19, having 16 and 19 weight layers, respectively, have been used for object recognition. VGG Net takes input of 224×224 RGB images and passes them through a stack of convolutional layers with the fixed filter size of 3×3 and the stride of 1. There are five max pooling filters embedded between convolutional layers in order to down-sample the input representation. The stack of convolutional layers are followed by 3 fully connected layers, having 4096, 4096 and 1000 channels, respectively, and the last layer is a soft-max layer. A thorough evaluation of networks of increasing depth is using an architecture with very small (3×3) convolution filters, which shows that a significant improvement on the prior-art configurations can be achieved by pushing the depth to 16-19 weight layers.

The VGG16 model achieves 92.7% top-5 test accuracy in ImageNet, which is a dataset of over 14 million images belonging to 1000 classes, and is described in an article published 20 Nov. 2018 in ‘Popular networks’, entitled: “VGG16-Convolutional Network for Classification and Detection”, which is incorporated in its entirety for all purposes as if fully set forth herein. The input to cov1 layer is of fixed size 224×224 RGB image. The image is passed through a stack of convolutional (conv.) layers, where the filters were used with a very small receptive field: 3×3 (which is the smallest size to capture the notion of left/right, up/down, and center). In one of the configurations, it also utilizes 1×1 convolution filters, which can be seen as a linear transformation of the input channels (followed by non-linearity). The convolution stride is fixed to 1 pixel; the spatial padding of conv. layer input is such that the spatial resolution is preserved after convolution, i.e., the padding is 1-pixel for 3×3 conv. layers. Spatial pooling is carried out by five max-pooling layers, which follow some of the conv. layers (not all the conv. layers are followed by max-pooling). Max-pooling is performed over a 2×2 pixel window, with stride 2. Three Fully-Connected (FC) layers follow a stack of convolutional layers (which has a different depth in different architectures): the first two have 4096 channels each, the third performs 1000-way ILSVRC classification and thus contains 1000 channels (one for each class). The final layer is the soft-max layer. The configuration of the fully connected layers is the same in all networks. All hidden layers are equipped with the rectification (ReLU) non-linearity. It is also noted that none of the networks (except for one) contain Local Response Normalization (LRN), such normalization does not improve the performance on the ILSVRC dataset, but leads to increased memory consumption and computation time.

SIFT. The Scale-Invariant Feature Transform (SIFT) is a computer vision algorithm to detect, describe, and match local features in images, invented by David Lowe in 1999, and used in applications that include object recognition, robotic mapping and navigation, image stitching, 3D modeling, gesture recognition, video tracking, individual identification of wildlife and match moving. SIFT keypoints of objects are first extracted from a set of reference images and stored in a database. An object is recognized in a new image by individually comparing each feature from the new image to this database and finding candidate matching features based on Euclidean distance of their feature vectors. From the full set of matches, subsets of keypoints that agree on the object and its location, scale, and orientation in the new image are identified to filter out good matches. The determination of consistent clusters is performed rapidly by using an efficient hash table implementation of the generalised Hough transform. Each cluster of 3 or more features that agree on an object and its pose is then subject to further detailed model verification and subsequently outliers are discarded. Finally, the probability that a particular set of features indicates the presence of an object is computed, given the accuracy of fit and number of probable false matches. Object matches that pass all these tests can be identified as correct with high confidence.

For any object in an image, interesting points on the object can be extracted to provide a “feature description” of the object. This description, extracted from a training image, can then be used to identify the object when attempting to locate the object in a test image containing many other objects. To perform reliable recognition, it is important that the features extracted from the training image be detectable even under changes in image scale, noise and illumination. Such points usually lie on high-contrast regions of the image, such as object edges. Another important characteristic of these features is that the relative positions between them in the original scene shouldn't change from one image to another. For example, if only the four corners of a door were used as features, they would work regardless of the door's position; but if points in the frame were also used, the recognition would fail if the door is opened or closed. Similarly, features located in articulated or flexible objects would typically not work if any change in their internal geometry happens between two images in the set being processed. However, in practice SIFT detects and uses a much larger number of features from the images, which reduces the contribution of the errors caused by these local variations in the average error of all feature matching errors.

SIFT transforms an image into a large collection of feature vectors, each of which is invariant to image translation, scaling, and rotation, partially invariant to illumination changes, and robust to local geometric distortion. These features share similar properties with neurons in the primary visual cortex that are encoding basic forms, color, and movement for object detection in primate vision. Key locations are defined as maxima and minima of the result of difference of Gaussians function applied in scale space to a series of smoothed and resampled images. Low-contrast candidate points and edge response points along an edge are discarded. Dominant orientations are assigned to localized key points. These steps ensure that the key points are more stable for matching and recognition. SIFT descriptors robust to local affine distortion are then obtained by considering pixels around a radius of the key location, blurring, and resampling local image orientation planes.

A SIFT method for extracting distinctive invariant features from images that can be used to perform reliable matching between different views of an object or scene is described in a paper by David G. Lowe of the Keypoints Computer Science Department University of British Columbia Vancouver, B.C., Canada, entitled: “Distinctive Image Features from Scale-Invariant”, published Jan. 5, 2004 [International Journal of Computer Vision, 2004], which is incorporated in its entirety for all purposes as if fully set forth herein. The features are invariant to image scale and rotation, and are shown to provide robust matching across a a substantial range of affine distortion, change in 3D viewpoint, addition of noise, and change in illumination. The features are highly distinctive, in the sense that a single feature can be correctly matched with high probability against a large database of features from many images. This paper also describes an approach to using these features for object recognition. The recognition proceeds by matching individual features to a database of features from known objects using a fast nearest-neighbor algorithm, followed by a Hough transform to identify clusters belonging to a single object, and finally performing verification through least-squares solution for consistent pose parameters.

Scale Invariant Feature Transform (SIFT) is an image descriptor for image-based matching and recognition, and is described in a paper by Tony Lindeberg entitled: “Scale Invariant Feature Transform”, published May 2012 [DOI: 10.4249/scholarpedia.10491], which is incorporated in its entirety for all purposes as if fully set forth herein. This descriptor as well as related image descriptors are used for a large number of purposes in computer vision related to point matching between different views of a 3-D scene and view-based object recognition. The SIFT descriptor is invariant to translations, rotations and scaling transformations in the image domain and robust to moderate perspective transformations and illumination variations. Experimentally, the SIFT descriptor has been proven to be very useful in practice for image matching and object recognition under real-world conditions. In its original formulation, the SIFT descriptor comprised a method for detecting interest points from a greylevel image at which statistics of local gradient directions of image intensities were accumulated to give a summarizing description of the local image structures in a local neighbourhood around each interest point, with the intention that this descriptor should be used for matching corresponding interest points between different images. Later, the SIFT descriptor has also been applied at dense grids (dense SIFT) which have been shown to lead to better performance for tasks such as object categorization, texture classification, image alignment and biometrics. The SIFT descriptor has also been extended from grey-level to colour images and from 2-D spatial images to 2+1-D spatio-temporal video.

A method and apparatus for identifying scale invariant features in an image and a further method and apparatus for using such scale invariant features to locate an object in an image are disclosed in U.S. Pat. No. 6,711,293 to Lowe entitled: “Method and apparatus for identifying scale invariant features in an image and use of same for locating an object in an image”, which is incorporated in its entirety for all purposes as if fully set forth herein. The method and apparatus for identifying scale invariant features may involve the use of a processor circuit for producing a plurality of component subregion descriptors for each subregion of a pixel region about pixel amplitude extrema in a plurality of difference images produced from the image. This may involve producing a plurality of difference images by blurring an initial image to produce a blurred image and by subtracting the blurred image from the initial image to produce the difference image. For each difference image, pixel amplitude extrema are located and a corresponding pixel region is defined about each pixel amplitude extremum. Each pixel region is divided into subregions and a plurality of component subregion descriptors are produced for each subregion. These component subregion descriptors are correlated with component subregion descriptors of an image under consideration and an object is indicated as being detected when a sufficient number of component subregion descriptors (scale invariant features) define an aggregate correlation exceeding a threshold correlation with component subregion descriptors (scale invariant features) associated with the object.

SURF. Speeded-Up Robust Features (SURF) is a local feature detector and descriptor, that can be used for tasks such as object recognition, image registration, classification, or 3D reconstruction. It is partly inspired by the scale-invariant feature transform (SIFT) descriptor. The standard version of SURF is several times faster than SIFT and claimed to be more robust against different image transformations than SIFT. To detect interest points, SURF uses an integer approximation of the determinant of Hessian blob detector, which can be computed with 3 integer operations using a precomputed integral image. Its feature descriptor is based on the sum of the Haar wavelet response around the point of interest. These can also be computed with the aid of the integral image. SURF descriptors have been used to locate and recognize objects, people or faces, to reconstruct 3D scenes, to track objects and to extract points of interest. The image is transformed into coordinates, using the multi-resolution pyramid technique, to copy the original image with Pyramidal Gaussian or Laplacian Pyramid shape to obtain an image with the same size but with reduced bandwidth. This achieves a special blurring effect on the original image, called Scale-Space and ensures that the points of interest are scale invariant.

A scale- and rotation-invariant interest point detector and descriptor, coined SURF (Speeded Up Robust Features), is described in a paper by Herbert Bay, Andreas Ess, Tinne Tuytelaars, and Luc Van Gool, all of ETH Zurich, entitled: “SURF: Speeded Up Robust Features”, presented at the ECCV 2006 conference and published 2008 at Computer Vision and Image Understanding (CVIU), Vol. 110, No. 3, pp. 346-359, 2008, which is incorporated in its entirety for all purposes as if fully set forth herein. The SURF approximates or even outperforms previously proposed schemes with respect to repeatability, distinctiveness, and robustness, yet can be computed and compared much faster. This is achieved by relying on integral images for image convolutions; by building on the strengths of the leading existing detectors and descriptors (in casu, using a Hessian matrix-based measure for the detector, and a distribution-based descriptor); and by simplifying these methods to the essential. This leads to a combination of novel detection, description, and matching steps. The paper presents experimental results on a standard evaluation set, as well as on imagery obtained in the context of a real-life object recognition application. Both show SURF's strong performance.

Methods and apparatus for operating on images, in particular methods and apparatus for interest point detection and/or description working under different scales and with different rotations, e.g., for scale-invariant and rotation-invariant interest point detection and/or description, are disclosed in U.S. Pat. No. 8,165,401 to Funayama et al. entitled: “Robust interest point detector and descriptor”, which is incorporated in its entirety for all purposes as if fully set forth herein. The described invention can provide improved or alternative apparatus and methods for matching interest points either in the same image or in a different image. The described invention can provide alternative or improved software for implementing any of the methods of the invention. The described invention can provide alternative or improved data structures created by multiple filtering operations to generate a plurality of filtered images as well as data structures for storing the filtered images themselves, e.g., as stored in memory or transmitted through a network. The described invention can provide alternative or improved data structures including descriptors of interest points in images, e.g., as stored in memory or transmitted through a network as well as data structures associating such descriptors with an original copy of the image or an image derived therefrom, e.g., a thumbnail image.

FAST. Features from Accelerated Segment Test (FAST) is a corner detection method, which could be used to extract feature points and later used to track and map objects in many computer vision tasks. The most promising advantage of the FAST corner detector is its computational efficiency, where it is indeed faster than many other well-known feature extraction methods, such as Difference of Gaussians (DoG) used by the SIFT, SUSAN, and Harris detectors. Moreover, when machine learning techniques are applied, superior performance in terms of computation time and resources can be realized.

FAST is described in a paper by Edward Rosten and Tom Drummond of the Department of Engineering, Cambridge University, UK, published 2006 in Computer Vision-ECCV 2006 [Lecture Notes in Computer Science. Vol. 3951. pp. 430-443. doi:10.1007/11744023_34; ISBN 978-3-540-33832-1. S2CID 1388140], entitled: “Machine Learning for High-speed Corner Detection”, which is incorporated in its entirety for all purposes as if fully set forth herein. Where feature points are used in real-time frame-rate applications, a high-speed feature detector is necessary. Feature detectors such as SIFT (DoG), Harris, and SUSAN are good methods which yield high-quality features, however they are too computationally intensive for use in real-time applications of any complexity. The paper shows that machine learning can be used to derive a feature detector which can fully process live PAL video using less than 7% of the available processing time. By comparison neither the Harris detector (120%) nor the detection stage of SIFT (300%) can operate at full frame rate. Clearly a high-speed detector is of limited use if the features produced are unsuitable for downstream processing. In particular, the same scene viewed from two different positions should yield features which correspond to the same real-world 3D locations. The paper further provides a comparison of corner detectors based on this criterion applied to 3D scenes. This comparison supports a number of claims made elsewhere concerning existing corner detectors.

FAST is further described in an article published in IEEE Transactions on Pattern Analysis and Machine Intelligence (Volume: 32, Issue: 1, January 2010) [DOI: 10.1109/TPAMI.2008.275] entitled: “FASTER and better: A Machine Learning Approach to Corner Detection”, which is incorporated in its entirety for all purposes as if fully set forth herein. The repeatability and efficiency of a corner detector determines how likely it is to be useful in a real-world application. The repeatability is important because the same scene viewed from different positions should yield features which correspond to the same real-world 3D locations. The efficiency is important because this determines whether the detector combined with further processing can operate at frame rate. Three advances are described in this article. First, a new heuristic for feature detection is presented and, using machine learning, a feature detector is derived which can fully process live PAL video using less than 5 percent of the available processing time. By comparison, most other detectors cannot even operate at frame rate (Harris detector 115 percent, SIFT 195 percent). Second, the article generalizes the detector, allowing it to be optimized for repeatability, with little loss of efficiency. Third, the article carries out a rigorous comparison of corner detectors based on the above repeatability criterion applied to 3D scenes, and shows that, despite being principally constructed for speed, on these stringent tests, the heuristic detector significantly outperforms existing feature detectors. Finally, the comparison demonstrates that using machine learning produces significant improvements in repeatability, yielding a detector that is both very fast and of very high quality.

MPEG-7. Moving Picture Experts Group (MPEG)-7, formally referred to as Multimedia Content Description Interface, is a multimedia content description standard that is standardized in ISO/IEC 15938 (Multimedia content description interface). This description will be associated with the content itself, to allow fast and efficient searching for material that is of interest to the user, uses XML to store metadata, and can be attached to timecode in order to tag particular events, or synchronize lyrics to a song, for example. It was designed to standardize: a set of Description Schemes (“DS”) and Descriptors (“D”); and a language to specify these schemes, called the Description Definition Language (“DDL”)—a scheme for coding the description. MPEG-7 is intended to provide complementary functionality to the previous MPEG standards, representing information about the content, not the content itself (“the bits about the bits”). This functionality is the standardization of multimedia content descriptions. MPEG-7 can be used independently of the other MPEG standards—the description might even be attached to an analog movie. The representation that is defined within MPEG-4, i.e., the representation of audio-visual data in terms of objects, is however very well suited to what will be built on the MPEG-7 standard. This representation is basic to the process of categorization. In addition, MPEG-7 descriptions could be used to improve the functionality of previous MPEG standards. With these tools, we can build an MPEG-7 Description and deploy it. According to the requirements document, “a Description consists of a Description Scheme (structure) and the set of Descriptor Values (instantiations) that describe the Data.” A Descriptor Value is “an instantiation of a Descriptor for a given data set (or subset thereof).” The Descriptor is the syntactic and semantic definition of the content. Extraction algorithms are inside the scope of the standard because their standardization is not required to allow interoperability. MPEG-7 uses the following tools: (i) Descriptor (D)—It is a representation of a feature defined syntactically and semantically. It could be that a unique object was described by several descriptors; (ii) Description Schemes (DS)—Specify the structure and semantics of the relations between its components, these components can be descriptors (D) or description schemes (DS); (iii) Description Definition Language (DDL)—It is based on XML language used to define the structural relations between descriptors. It allows the creation and modification of description schemes and also the creation of new descriptors (D); and (iv) System tools—These tools deal with binarization, synchronization, transport and storage of descriptors. It also deals with Intellectual Property protection

MPEG-7 Multimedia Description Schemes (MDSs) are metadata structures for describing and annotating audio-visual (AV) content, that are described in an article by Neil Day (Digital Garage Inc, JP) and José M. Martínez (UPM-GTI, ES) published March 2001 [ISO/IEC JTC1/SC29/WG11 N4032] and entitled: “Introduction to MPEG-7 (v3.0)”, which is incorporated in its entirety for all purposes as if fully set forth herein. The Description Schemes (DSs) provide a standardized way of describing in XML the important concepts related to AV content description and content management in order to facilitate searching, indexing, filtering, and access. The DSs are defined using the MPEG-7 Description Definition Language, which is based on the XML Schema Language, and are instantiated as documents or streams. The resulting descriptions can be expressed in a textual form (i.e., human readable XML for editing, searching, filtering) or compressed binary form (i.e., for storage or transmission). In this paper, we provide an overview of the MPEG-7 MDSs and describe their targeted functionality and use in multimedia applications.

Smartphone. A mobile phone (also known as a cellular phone, cell phone, smartphone, or hand phone) is a device which can make and receive telephone calls over a radio link whilst moving around a wide geographic area, by connecting to a cellular network provided by a mobile network operator. The calls are to and from the public telephone network, which includes other mobiles and fixed-line phones across the world. The Smartphones are typically hand-held and may combine the functions of a personal digital assistant (PDA), and may serve as portable media players and camera phones with high-resolution touch-screens, web browsers that can access, and properly display, standard web pages rather than just mobile-optimized sites, GPS navigation, Wi-Fi and mobile broadband access. In addition to telephony, the Smartphones may support a wide variety of other services such as text messaging, MMS, email, Internet access, short-range wireless communications (infrared, Bluetooth), business applications, gaming and photography.

An example of a contemporary smartphone is model iPhone 6 available from Apple Inc., headquartered in Cupertino, California, U.S.A. and described in iPhone 6 technical specification (retrieved October 2015 from www.apple.com/iphone-6/specs/), and in a User Guide dated 2015 (019-00155/2015-06) by Apple Inc. entitled: “iPhone User Guide For IOS 8.4 Software”, which are both incorporated in their entirety for all purposes as if fully set forth herein. Another example of a smartphone is Samsung Galaxy S6 available from Samsung Electronics headquartered in Suwon, South-Korea, described in the user manual numbered English (EU), March 2015 (Rev. 1.0) entitled: “SM-G925F SM-G925FQ SM-G9251 User Manual” and having features and specification described in “Galaxy S6 Edge—Technical Specification” (retrieved October 2015 from www.samsung.com/us/explore/galaxy-s-6-features-and-specs), which are both incorporated in their entirety for all purposes as if fully set forth herein.

A mobile operating system (also referred to as mobile OS), is an operating system that operates a smartphone, tablet, PDA, or another mobile device. Modern mobile operating systems combine the features of a personal computer operating system with other features, including a touchscreen, cellular, Bluetooth, Wi-Fi, GPS mobile navigation, camera, video camera, speech recognition, voice recorder, music player, near field communication and infrared blaster. Currently popular mobile OSs are Android, Symbian, Apple IOS, BlackBerry, MeeGo, Windows Phone, and Bada. Mobile devices with mobile communications capabilities (e.g. smartphones) typically contain two mobile operating systems—a main user-facing software platform is supplemented by a second low-level proprietary real-time operating system that operates the radio and other hardware.

Android is an open source and Linux-based mobile operating system (OS) based on the Linux kernel that is currently offered by Google. With a user interface based on direct manipulation, Android is designed primarily for touchscreen mobile devices such as smartphones and tablet computers, with specialized user interfaces for televisions (Android TV), cars (Android Auto), and wrist watches (Android Wear). The OS uses touch inputs that loosely correspond to real-world actions, such as swiping, tapping, pinching, and reverse pinching to manipulate on-screen objects, and a virtual keyboard. Despite being primarily designed for touchscreen input, it also has been used in game consoles, digital cameras, and other electronics. The response to user input is designed to be immediate and provides a fluid touch interface, often using the vibration capabilities of the device to provide haptic feedback to the user. Internal hardware such as accelerometers, gyroscopes and proximity sensors are used by some applications to respond to additional user actions, for example adjusting the screen from portrait to landscape depending on how the device is oriented, or allowing the user to steer a vehicle in a racing game by rotating the device by simulating control of a steering wheel.

Android devices boot to the homescreen, the primary navigation and information point on the device, which is similar to the desktop found on PCs. Android homescreens are typically made up of app icons and widgets; app icons launch the associated app, whereas widgets display live, auto-updating content such as the weather forecast, the user's email inbox, or a news ticker directly on the homescreen. A homescreen may be made up of several pages that the user can swipe back and forth between, though Android's homescreen interface is heavily customizable, allowing the user to adjust the look and feel of the device to their tastes. Third-party apps available on Google Play and other app stores can extensively re-theme the homescreen, and even mimic the look of other operating systems, such as Windows Phone. The Android OS is described in a publication entitled: “Android Tutorial”, downloaded from tutorialspoint.com on July 2014, which is incorporated in its entirety for all purposes as if fully set forth herein.

iOS (previously iPhone OS) from Apple Inc. (headquartered in Cupertino, California, U.S.A.) is a mobile operating system distributed exclusively for Apple hardware. The user interface of the iOS is based on the concept of direct manipulation, using multi-touch gestures. Interface control elements consist of sliders, switches, and buttons. Interaction with the OS includes gestures such as swipe, tap, pinch, and reverse pinch, all of which have specific definitions within the context of the iOS operating system and its multi-touch interface. Internal accelerometers are used by some applications to respond to shaking the device (one common result is the undo command) or rotating it in three dimensions (one common result is switching from portrait to landscape mode). The iOS OS is described in a publication entitled: “IOS Tutorial”, downloaded from tutorialspoint.com on July 2014, which is incorporated in its entirety for all purposes as if fully set forth herein.

RTOS. A Real-Time Operating System (RTOS) is an Operating System (OS) intended to serve real-time applications that process data as it comes in, typically without buffer delays. Processing time requirements (including any OS delay) are typically measured in tenths of seconds or shorter increments of time, and is a time bound system which has well defined fixed time constraints. Processing is commonly to be done within the defined constraints, or the system will fail. They either are event driven or time sharing, where event driven systems switch between tasks based on their priorities while time sharing systems switch the task based on clock interrupts. A key characteristic of an RTOS is the level of its consistency concerning the amount of time it takes to accept and complete an application's task; the variability is jitter. A hard real-time operating system has less jitter than a soft real-time operating system. The chief design goal is not high throughput, but rather a guarantee of a soft or hard performance category. An RTOS that can usually or generally meet a deadline is a soft real-time OS, but if it can meet a deadline deterministically it is a hard real-time OS. An RTOS has an advanced algorithm for scheduling, and includes a scheduler flexibility that enables a wider, computer-system orchestration of process priorities. Key factors in a real-time OS are minimal interrupt latency and minimal thread switching latency; a real-time OS is valued more for how quickly or how predictably it can respond than for the amount of work it can perform in a given period of time.

Common designs of RTOS include event-driven, where tasks are switched only when an event of higher priority needs servicing; called preemptive priority, or priority scheduling, and time-sharing, where task are switched on a regular clocked interrupt, and on events; called round robin. Time sharing designs switch tasks more often than strictly needed, but give smoother multitasking, giving the illusion that a process or user has sole use of a machine. In typical designs, a task has three states: Running (executing on the CPU); Ready (ready to be executed); and Blocked (waiting for an event, I/O for example). Most tasks are blocked or ready most of the time because generally only one task can run at a time per CPU. The number of items in the ready queue can vary greatly, depending on the number of tasks the system needs to perform and the type of scheduler that the system uses. On simpler non-preemptive but still multitasking systems, a task has to give up its time on the CPU to other tasks, which can cause the ready queue to have a greater number of overall tasks in the ready to be executed state (resource starvation).

RTOS concepts and implementations are described in an Application Note No. RES05B00008-0100/Rec. 1.00 published January 2010 by Renesas Technology Corp. entitled: “R8C Family—General RTOS Concepts”, in JAJA Technology Review article published February 2007 [1535-5535/$32.00] by The Association for Laboratory Automation [doi:10.1016/j.jala.2006.10.016] entitled: “An Overview of Real-Time Operating Systems”, and in Chapter 2 entitled: “Basic Concepts of Real Time Operating Systems” of a book published 2009 [ISBN—978-1-4020-9435-4] by Springer Science+Business Media B.V. entitled: “Hardware-Dependent Software—Principles and Practice”, which are all incorporated in their entirety for all purposes as if fully set forth herein.

QNX. One example of RTOS is QNX, which is a commercial Unix-like real-time operating system, aimed primarily at the embedded systems market. QNX was one of the first commercially successful microkernel operating systems and is used in a variety of devices including cars and mobile phones. As a microkernel-based OS, QNX is based on the idea of running most of the operating system kernel in the form of a number of small tasks, known as Resource Managers. In the case of QNX, the use of a microkernel allows users (developers) to turn off any functionality they do not require without having to change the OS itself; instead, those services will simply not run.

FreeRTOS. FreeRTOS™ is a free and open-source Real-Time Operating system developed by Real Time Engineers Ltd., designed to fit on small embedded systems and implements only a very minimalist set of functions: very basic handle of tasks and memory management, and just sufficient API concerning synchronization. Its features include characteristics such as preemptive tasks, support for multiple microcontroller architectures, a small footprint (4.3 Kbytes on an ARM7 after compilation), written in C, and compiled with various C compilers. It also allows an unlimited number of tasks to run at the same time, and no limitation about their priorities as long as used hardware can afford it.

FreeRTOS™ provides methods for multiple threads or tasks, mutexes, semaphores and software timers. A tick-less mode is provided for low power applications, and thread priorities are supported. Four schemes of memory allocation are provided: allocate only; allocate and free with a very simple, fast, algorithm; a more complex but fast allocate and free algorithm with memory coalescence; and C library allocate and free with some mutual exclusion protection. While the emphasis is on compactness and speed of execution, a command line interface and POSIX-like IO abstraction add-ons are supported. FreeRTOS™ implements multiple threads by having the host program call a thread tick method at regular short intervals.

The thread tick method switches tasks depending on priority and a round-robin scheduling scheme. The usual interval is 1/1000 of a second to 1/100 of a second, via an interrupt from a hardware timer, but this interval is often changed to suit a particular application. FreeRTOS™ is described in a paper by Nicolas Melot (downloaded July 2015) entitled: “Study of an operating system: FreeRTOS—Operating systems for embedded devices”, in a paper (dated Sep. 23, 2013) by Dr. Richard Wall entitled: “Carebot PIC32 MX7ck implementation of Free RTOS”, FreeRTOS™ modules are described in web pages entitled: “FreeRTOS™ Modules” published in the www,freertos.org web-site dated 26 Nov. 2006, and FreeRTOS kernel is described in a paper published 1 April 07 by Rich Goyette of Carleton University as part of ‘SYSC5701: Operating System Methods for Real-Time Applications’, entitled: “An Analysis and Description of the Inner Workings of the FreeRTOS Kernel”, which are all incorporated in their entirety for all purposes as if fully set forth herein.

SafeRTOS. SafeRTOS was constructed as a complementary offering to FreeRTOS, with common functionality but with a uniquely designed safety-critical implementation. When the FreeRTOS functional model was subjected to a full HAZOP, weakness with respect to user misuse and hardware failure within the functional model and API were identified and resolved. Both SafeRTOS and FreeRTOS share the same scheduling algorithm, have similar APIs, and are otherwise very similar, but they were developed with differing objectives. SafeRTOS was developed solely in the C language to meet requirements for certification to IEC61508. SafeRTOS is known for its ability to reside solely in the on-chip read only memory of a microcontroller for standards compliance. When implemented in hardware memory, SafeRTOS code can only be utilized in its original configuration, so certification testing of systems using this OS need not re-test this portion of their designs during the functional safety certification process.

VxWorks. VxWorks is an RTOS developed as proprietary software and designed for use in embedded systems requiring real-time, deterministic performance and, in many cases, safety and security certification, for industries, such as aerospace and defense, medical devices, industrial equipment, robotics, energy, transportation, network infrastructure, automotive, and consumer electronics. VxWorks supports Intel architecture, POWER architecture, and ARM architectures. The VxWorks may be used in multicore asymmetric multiprocessing (AMP), symmetric multiprocessing (SMP), and mixed modes and multi-OS (via Type 1 hypervisor) designs on 32- and 64-bit processors. VxWorks comes with the kernel, middleware, board support packages, Wind River Workbench development suite and complementary third-party software and hardware technologies. In its latest release, VxWorks 7, the RTOS has been re-engineered for modularity and upgradeability so the OS kernel is separate from middleware, applications and other packages. Scalability, security, safety, connectivity, and graphics have been improved to address Internet of Things (IoT) needs.

μC/OS. Micro-Controller Operating Systems (MicroC/OS, stylized as μC/OS) is a real-time operating system (RTOS) that is a priority-based preemptive real-time kernel for microprocessors, written mostly in the programming language C, and is intended for use in embedded systems. MicroC/OS allows defining several functions in C, each of which can execute as an independent thread or task. Each task runs at a different priority, and runs as if it owns the central processing unit (CPU). Lower priority tasks can be preempted by higher priority tasks at any time. Higher priority tasks use operating system (OS) services (such as a delay or event) to allow lower priority tasks to execute. OS services are provided for managing tasks and memory, communicating between tasks, and timing.

POI. A Point-Of-Interest, or POI, is a specific point location that someone may find useful or interesting. An example is a point on the Earth representing the location of the Space Needle, or a point on Mars representing the location of the mountain, Olympus Mons. Most consumers use the term when referring to hotels, campsites, fuel stations or any other categories used in modern (automotive) navigation systems. Users of a mobile devices can be provided with geolocation and time aware POI service, that recommends geolocations nearby and with a temporal relevance (e.g., POI to special services in a Ski resort are available only in winter). A GPS point of interest specifies, at minimum, the latitude and longitude of the POI, assuming a certain map datum. A name or description for the POI is usually included, and other information such as altitude or a telephone number may also be attached. GPS applications typically use icons to represent different categories of POI on a map graphically. Typically, POIs are divided up by category, such as dining, lodging, gas stations, parking areas, emergency services, local attractions, sports venues, and so on. Usually, some categories are subdivided even further, such as different types of restaurants depending on the fare. Sometimes a phone number is included with the name and address information.

Digital maps for modern GPS devices typically include a basic selection of POI for the map area. There are websites that specialize in the collection, verification, management and distribution of POI, which end-users can load onto their devices to replace or supplement the existing POI. While some of these websites are generic, and will collect and categorize POI for any interest, others are more specialized in a particular category (such as speed cameras) or GPS device (e.g. TomTom/Garmin). End-users also have the ability to create their own custom collections.

As GPS-enabled devices as well as software applications that use digital maps become more available, so too the applications for POI are also expanding. Newer digital cameras for example can automatically tag a photograph using Exif with the GPS location where a picture was taken; these pictures can then be overlaid as POI on a digital map or satellite image such as Google Earth or ArcGIS by Esri (Environmental Systems Research Institute). Geocaching applications are built around POI collections. In common vehicle tracking systems, POIs are used to mark destination points and/or offices so that users of GPS tracking software would easily monitor position of vehicles according to POIs.

Many different file formats, including proprietary formats, are used to store point of interest data, even where the same underlying WGS84 system is used. Some of the file formats used by different vendors and devices to exchange POI (and in some cases, also navigation tracks), are: ASCII Text (.asc, .txt, .csv, or .plt), Topografix GPX (.gpx), Garmin Mapsource (.gdb), Google Earth Keyhole Markup Language (.kml, .kmz), Pocket Street Pushpins (.psp), Maptech Marks (.msf), Maptech Waypoint (.mxf), Microsoft MapPoint Pushpin (.csv), OziExplorer (.wpt), TomTom Overlay (.ov2) and TomTom plain text format (.asc), and OpenStreetMap data (.osm). Furthermore, many applications will support the generic ASCII text file format, although this format is more prone to error due to its loose structure as well as the many ways in which GPS co-ordinates can be represented (e.g., decimal vs degree/minute/second).

A Point of Interest (POI) icon display method in a navigation system that is described for displaying a POI icon at a POI point on a map is disclosed in U.S. Pat. No. 6,983,203 to Wako entitled: “POI icon display method and navigation system”, which is incorporated in its entirety for all purposes as if fully set forth herein. For every POI in a POI category, the location point and type of POI are stored. Each POI is identified on the displayed map by the same POI icon, and when a POI icon of a POI is selected, the type of POI is displayed. Accordingly, it is possible to reduce the number of POI icons, recognize the type of POI, such as the type of food of a restaurant (classified by country, such as Japanese food, Chinese food, Italian food, and French food), and provide a guide route to a desired POI quickly.

Vehicle. A vehicle is a mobile machine that transports people or cargo. Most often, vehicles are manufactured, such as wagons, bicycles, motor vehicles (motorcycles, cars, trucks, buses), railed vehicles (trains, trams), watercraft (ships, boats), aircraft and spacecraft. The vehicle may be designed for use on land, in fluids, or be airborne, such as bicycle, car, automobile, motorcycle, train, ship, boat, submarine, airplane, scooter, bus, subway, train, or spacecraft. A vehicle may consist of, or may comprise, a bicycle, a car, a motorcycle, a train, a ship, an aircraft, a boat, a spacecraft, a boat, a submarine, a dirigible, an electric scooter, a subway, a train, a trolleybus, a tram, a sailboat, a yacht, or an airplane. Further, a vehicle may be a bicycle, a car, a motorcycle, a train, a ship, an aircraft, a boat, a spacecraft, a boat, a submarine, a dirigible, an electric scooter, a subway, a train, a trolleybus, a tram, a sailboat, a yacht, or an airplane.

A vehicle may be a land vehicle typically moving on the ground, using wheels, tracks, rails, or skies. The vehicle may be locomotion-based where the vehicle is towed by another vehicle or an animal. Propellers (as well as screws, fans, nozzles, or rotors) are used to move on or through a fluid or air, such as in watercrafts and aircrafts. The system described herein may be used to control, monitor or otherwise be part of, or communicate with, the vehicle motion system. Similarly, the system described herein may be used to control, monitor or otherwise be part of, or communicate with, the vehicle steering system. Commonly, wheeled vehicles steer by angling their front or rear (or both) wheels, while ships, boats, submarines, dirigibles, airplanes and other vehicles moving in or on fluid or air usually have a rudder for steering. The vehicle may be an automobile, defined as a wheeled passenger vehicle that carries its own motor, and primarily designed to run on roads, and have seating for one to six people. Typical automobiles have four wheels, and are constructed to principally transport of people.

Human power may be used as a source of energy for the vehicle, such as in non-motorized bicycles. Further, energy may be extracted from the surrounding environment, such as solar powered car or aircraft, a street car, as well as by sailboats and land yachts using the wind energy. Alternatively or in addition, the vehicle may include energy storage, and the energy is converted to generate the vehicle motion. A common type of energy source is a fuel, and external or internal combustion engines are used to burn the fuel (such as gasoline, diesel, or ethanol) and create a pressure that is converted to a motion. Another common medium for storing energy are batteries or fuel cells, which store chemical energy used to power an electric motor, such as in motor vehicles, electric bicycles, electric scooters, small boats, subways, trains, trolleybuses, and trams.

Aircraft. An aircraft is a machine that is able to fly by gaining support from the air. It counters the force of gravity by using either static lift or by using the dynamic lift of an airfoil, or in a few cases, the downward thrust from jet engines. The human activity that surrounds aircraft is called aviation. Crewed aircraft are flown by an onboard pilot, but unmanned aerial vehicles may be remotely controlled or self-controlled by onboard computers. Aircraft may be classified by different criteria, such as lift type, aircraft propulsion, usage and others.

Aerostats are lighter than air aircrafts that use buoyancy to float in the air in much the same way that ships float on the water. They are characterized by one or more large gasbags or canopies filled with a relatively low-density gas such as helium, hydrogen, or hot air, which is less dense than the surrounding air. When the weight of this is added to the weight of the aircraft structure, it adds up to the same weight as the air that the craft displaces. Heavier-than-air aircraft, such as airplanes, must find some way to push air or gas downwards, so that a reaction occurs (by Newton's laws of motion) to push the aircraft upwards. This dynamic movement through the air is the origin of the term aerodyne. There are two ways to produce dynamic upthrust: aerodynamic lift and powered lift in the form of engine thrust.

Aerodynamic lift involving wings is the most common, with fixed-wing aircraft being kept in the air by the forward movement of wings, and rotorcraft by spinning wing-shaped rotors sometimes called rotary wings. A wing is a flat, horizontal surface, usually shaped in cross-section as an aerofoil. To fly, air must flow over the wing and generate lift. A flexible wing is a wing made of fabric or thin sheet material, often stretched over a rigid frame. A kite is tethered to the ground and relies on the speed of the wind over its wings, which may be flexible or rigid, fixed, or rotary.

Gliders are heavier-than-air aircraft that do not employ propulsion once airborne. Take-off may be by launching forward and downward from a high location, or by pulling into the air on a tow-line, either by a ground-based winch or vehicle, or by a powered “tug” aircraft. For a glider to maintain its forward air speed and lift, it must descend in relation to the air (but not necessarily in relation to the ground). Many gliders can ‘soar’-gain height from updrafts such as thermal currents. Common examples of gliders are sailplanes, hang gliders and paragliders. Powered aircraft have one or more onboard sources of mechanical power, typically aircraft engines although rubber and manpower have also been used. Most aircraft engines are either lightweight piston engines or gas turbines. Engine fuel is stored in tanks, usually in the wings but larger aircraft also have additional fuel tanks in the fuselage.

A propeller aircraft use one or more propellers (airscrews) to create thrust in a forward direction. The propeller is usually mounted in front of the power source in tractor configuration but can be mounted behind in pusher configuration. Variations of propeller layout include contra-rotating propellers and ducted fans. A Jet aircraft use airbreathing jet engines, which take in air, burn fuel with it in a combustion chamber, and accelerate the exhaust rearwards to provide thrust. Turbojet and turbofan engines use a spinning turbine to drive one or more fans, which provide additional thrust. An afterburner may be used to inject extra fuel into the hot exhaust, especially on military “fast jets”. Use of a turbine is not absolutely necessary: other designs include the pulse jet and ramjet. These mechanically simple designs cannot work when stationary, so the aircraft must be launched to flying speed by some other method. Some rotorcrafts, such as helicopters, have a powered rotary wing or rotor, where the rotor disc can be angled slightly forward so that a proportion of its lift is directed forwards. The rotor may, similar to a propeller, be powered by a variety of methods such as a piston engine or turbine. Experiments have also used jet nozzles at the rotor blade tips.

UAV. An Unmanned Aerial Vehicle (UAV) (commonly known as a ‘drone’) is an aircraft without a human pilot on board and a type of unmanned vehicle. UAVs are a component of an Unmanned Aircraft System (UAS), which includes a UAV, a ground-based controller, and a system of communications between the two. The flight of UAVs may operate with various degrees of autonomy: either under remote control by a human operator, autonomously by onboard computers, or piloted by an autonomous robot.

A UAV is typically a powered, aerial vehicle that does not carry a human operator, uses aerodynamic forces to provide vehicle lift, can fly autonomously or be piloted remotely, can be expendable or recoverable, and can carry a lethal or nonlethal payload. UAVs typically fall into one of six functional categories (although multi-role airframe platforms are becoming more prevalent): Target and decoy for providing ground and aerial gunnery a target that simulates an enemy aircraft or missile; Reconnaissance, for providing battlefield intelligence; Combat, for providing attack capability for high-risk missions; Logistics for delivering cargo; Research and development, including improved UAV technologies; and Civil and commercial UAVs, used for agriculture, aerial photography, or data collection. The different types of drones can be differentiated in terms of the type (fixed-wing, multirotor, etc.), the degree of autonomy, the size and weight, and the power source. Aside from the drone itself (i.e., the ‘platform’) various types of payloads can be distinguished, including freight (e.g., mail parcels, medicines, fire extinguishing material, or flyers) and different types of sensors (e.g., cameras, sniffers, or meteorological sensors). In order to perform a flight, drones have a need for a certain amount of wireless communications with a pilot on the ground. In addition, in most cases there is a need for communication with a payload, like a camera or a sensor.

UAV manufacturers often build in specific autonomous operations, such as: Self-level—attitude stabilization on the pitch and roll axes; Altitude hold—The aircraft maintains its altitude using barometric pressure and/or GPS data; Hover/position hold—Keep level pitch and roll, stable yaw heading and altitude while maintaining position using GNSS or inertial sensors; Headless mode—Pitch control relative to the position of the pilot rather than relative to the vehicle's axes; Care-free—automatic roll and yaw control while moving horizontally; Take-off and landing—using a variety of aircraft or ground-based sensors and systems; Failsafe—automatic landing or return-to-home upon loss of control signal; Return-to-home—Fly back to the point of takeoff (often gaining altitude first to avoid possible intervening obstructions such as trees or buildings); Follow-me—Maintain relative position to a moving pilot or other object using GNSS, image recognition or homing beacon; GPS waypoint navigation—Using GNSS to navigate to an intermediate location on a travel path; Orbit around an object—Similar to Follow-me but continuously circle a target; and Pre-programmed acrobatics (such as rolls and loops).

An example of a fixed wing UAV is MQ-1B Predator, build by General Atomics Corporation headquartered in San Diego, California, and described in a Fact Sheet by the U.S. Air Force Published Sep. 23, 2015, downloaded August 2020 from https://www.af.mil/About-Us/Fact-Sheets/Display/Article/104469/mq-1b-predator/, which is incorporated in its entirety for all purposes as if fully set forth herein. The MQ-1 Predator is an armed, multi-mission, medium-altitude, long endurance remotely piloted aircraft (RPA) that is employed primarily in a killer/scout role as an intelligence collection asset and secondarily against dynamic execution targets. Given its significant loiter time, wide-range sensors, multi-mode communications suite, and precision weapons—it provides a unique capability to autonomously execute the kill chain (find, fix, track, target, engage, and assess) against high value, fleeting, and time sensitive targets (TSTs). Predators can also perform the following missions and tasks: intelligence, surveillance, reconnaissance (ISR), close air support (CAS), combat search and rescue (CSAR), precision strike, buddy-lase, convoy/raid overwatch, route clearance, target development, and terminal air guidance. The MQ-1's capabilities make it uniquely qualified to conduct irregular warfare operations in support of Combatant Commander objectives.

The MQ-1B Predator carries the Multi-spectral Targeting System, or MTS-A, which integrates an infrared sensor, a color/monochrome daylight TV camera, an image-intensified TV camera, a laser designator and a laser illuminator into a single package. The full motion video from each of the imaging sensors can be viewed as separate video streams or fused together. The Predator can operate on a 5,000 by 75 foot (1,524 meters by 23 meters) hard surface runway with clear line-of-sight to the ground data terminal antenna. The antenna provides line-of-sight communications for takeoff and landing. The PPSL provides over-the-horizon communications for the aircraft and sensors. The MQ-1B Predator provides the capabilities of Expanded EO/IR payload, SAR all-weather capability, Satellite control, GPS and INS, Over 24 Hr on-station at 400 nmi, Operations up to 25,000 ft (7620 m), 450 Lbs (204 Kg) payload, and Wingspan of 48.7 ft (14.84 m), length 27 ft (8.23 m).

A pictorial view 30b of a general fixed-wing UAV, such as the MQ-1B Predator, is shown in FIG. 3. The main part of the quadcopter is an elongated frame 31b, to which a right wing 36a and a left wing 36b are attached. Three tail surfaces 36c, 36d, and 36e are used for stabilizing. The thrust is provided by a rear propeller 33e. A bottom transparent dome 35 is used to protect a facing down on-board mounted camera.

Quadcopter. A quadcopter (or quadrotor) is a type of helicopter with four rotors. The small size and low inertia of drones allows use of a particularly simple flight control system, which has greatly increased the practicality of the small quadrotor in this application. Each rotor produces both lift and torque about its center of rotation, as well as drag opposite to the vehicle's direction of flight. Quadcopters generally have two rotors spinning clockwise (CW) and two counterclockwise (CCW). Flight control is provided by independent variation of the speed and hence lift and torque of each rotor. Pitch and roll are controlled by varying the net center of thrust, with yaw controlled by varying the net torque. Unlike conventional helicopters, quadcopters do not usually have cyclic pitch control, in which the angle of the blades varies dynamically as they turn around the rotor hub. The common form factor for rotary wing devices, such as quadcopters, is tailless, while tailed structure is common for fixed wing or mono- and bi-copters.

If all four rotors are spinning at the same angular velocity, with two rotating clockwise and two counterclockwise, the net torque about the yaw axis is zero, which means there is no need for a tail rotor as on conventional helicopters. Yaw is induced by mismatching the balance in aerodynamic torques (i.e., by offsetting the cumulative thrust commands between the counter-rotating blade pairs). All quadcopters are subject to normal rotorcraft aerodynamics, including the vortex ring state. The main mechanical components are a fuselage or frame, the four rotors (either fixed-pitch or variable-pitch), and motors. For best performance and simplest control algorithms, the motors and propellers are equidistant. In order to allow more power and stability at reduced weight, a quadcopter, like any other multirotor can employ a coaxial rotor configuration. In this case, each arm has two motors running in opposite directions (one facing up and one facing down). While quadcopters lack certain redundancies, hexcopters (six rotors) and octocopters (eight rotors), have more motors, and thus have greater lift and greater redundancy in case of possible motor failure. Because of these extra motors, hexcopter and octocopters are able to safely land even in the unlikely event of motor failure.

An example of a quadcopter type of a drone for photographic applications is Phantom 4 PRO V2.0 available from DJI Innovations headquartered in Shenzhen, China. Featuring a 1-inch CMOS sensor that can shoot 4K/60 fps videos and 20 MP photos, the Phantom 4 Pro V2.0 grants filmmakers absolute creative freedom. The OcuSync 2.0 HD transmission system ensures stable connectivity and reliability, five directions of obstacle sensing ensures additional safety, and a dedicated remote controller with a built-in screen grants even greater precision and control. A wide array of intelligent features makes flying that much easier. The Phantom 4 Pro V2.0 is a complete aerial imaging solution, designed for the professional creator, and is described on a web page entitled “Phantom 4 PRO V2.0-Visionary Intelligence. Elevated Imagination” and having specifications on a web page titled: “Specs—Phantom 4 Pro V2.0 Aircraft”, downloaded August 2020 from web-site https://www.dji.com/phantom-4-pro-v2, which are both incorporated in their entirety for all purposes as if fully set forth herein.

A design, construction and testing procedure of quadcopter, as a small UAV, is disclosed in an article entitled: “Quadcopter: Design, Construction and Testing” by Omkar Tatale, Nitinkumar Anckar, Supriya Phatak, and Suraj Sarkale, published by AMET_0001 @ MIT College of Engineering. Pune, Vol. 04, Special Issue AMET-2018 in International Journal for Research in Engineering Application & Management (IJREAM) [DOI: 10.18231/2454-9150.2018.1386, ISSN: 2454-9150 Special Issue-AMET-2018], which is incorporated in its entirety for all purposes as if fully set forth herein. Unmanned Aerial Vehicles (UAVs) like drones and quadcopters have revolutionized flight. They help humans to take to the air in new, profound ways. The military use of larger size UAVs has grown because of their ability to operate in dangerous locations while keeping their human operators at a safe distance. It is the unmanned air vehicles and playing a predominant role in different areas like surveillance, military operations, fire sensing, traffic control and commercial and industrial applications. In the proposed system, design is based on the approximate payload carry by quadcopter and weight of individual components which gives corresponding electronic components selection. The selection of materials for the structure is based on weight, forces acting on them, mechanical properties and cost.

A pictorial view 30a of a general quadcopter is shown in FIG. 3, and an examplary illustrative block diagram 40 of a general quadcopter is shown in FIG. 4. The main part of the quadcopter is frame 31a, which has four arms. The frame 31a should be light and rigid to host a battery 37, four brushless DC motors (BLDC) 39a, 39b, 39c, and 39d, a controller board 41, four propellers or rotors (blades) 33a, 33b, 33c, and 33d, a video camera 34 and different types of sensors along with a light frame. Two landing skids 32a and 32b are shown, and the canopy covers and protects a GPS antenna 48. The quadcopter 40 comprises a still or video camera 34 that may include, be based on, or consists of, the camera 10 shown in FIG. 1.

Generally, an ‘X’-shaped frame 31a is used in the quadcopter 30a since it is thin strong enough to withstand deformation due to loads as well as light in weight. Generally, closed cross sectional hollow frame is used to reduce weight. When the frame is subjected to bending or twisting load, the amount of deformation is related to the cross-sectional shape section. Whereas stiffness of solid structure and torsional stiffness of closed circular section is lower than closed square cross-section, the stiffness can be varied by changing cross sectional profile dimensions and wall thickness.

The speed of BLDC motors 39a, 39b, 39c, and 39d is varied by Electronic Speed Controller (ESC), shown as respective motor controllers 38a, 38b, 38c, and 38d. The batteries 37 are typically placed at lower half for higher stability, such as to provide lower center of gravity. The motors 39a, 39b, 39c, and 39d are placed equidistant from the center on opposite sides, and to avoid any aerodynamic interaction between propeller blades, the distance between motors is roughly adjusted. All these parts are mounted on the main frame or chassis 31a of the quadcopter 30a. Commonly, the main structure consists of a frame made of carbon composite materials to increase payload and decrease the weight. Brushless DC motors are exclusively used in Quadcopter because they superior thrust-to-weight ratios compare to brushed DC motors and its commutators are integrated into the speed controller while a brushed DC motor's commutators are located directly inside the motor. They are electronically commutated having better speed vs torque characteristics, high efficiency with noiseless operation and very high-speed range with longer life.

The lifting thrust is provided to quadcopter 30a by providing spin to the propellers or rotors (blades) 33a, 33b, 33c, and 33d. The propellers are selected to yield appropriate thrust for the hover or lift while not overheating the respective BLDC motors 39a, 39b, 39c, and 39d that drives the propellers. The four propellers are practically not the same, as the front and back propellers are tilted to the right, while the left and right propellers are tilted to the left.

Each of the Motor Controls 38a, 38b, 38c, and 38d includes an Electronic Speed Controller (ESC), typically commanded by the control block 41 in the form of PWM signals, which are accepted by individual ESC of the motor and output the appropriate motor speed accordingly. Each ESC converts 2-phase battery current to the 3-phase power and regulates the speed of brushless motor by taking the signal from the control board 41. The ESC acts as a Battery Elimination Circuit (BEC) allowing both the motors and the receiver to power by a single battery, and further receives flight controller signals to apply the right current to the motors.

Electric power is provided to the motors 39a-d and to all electronic components by the battery 37. In most small UAVs, the battery 37 comprises Lithium-Polymer batteries (Li—Po), while larger vehicles often rely on conventional airplane engines or a hydrogen fuel cell. The energy density of modern Li—Po batteries is far less than gasoline or hydrogen. Battery Elimination Circuitry (BEC) is used to centralize power distribution and often harbors a Microcontroller Unit (MCU). LIPO batteries can be found in packs of everything from a single cell (3.7V) to over 10 cells (37V). The cells are usually connected in series, making the voltage higher but giving the same amount of Amp in hours.

UAV computing capabilities in the control block 41 may be based on embedded system platform, such as microcontrollers, System-On-a-Chip (SOC), or Single-Board Computers (SBC). The control block 41 is based on a processor (or microcontroller) 42 and a memory 43 that stores the data and instructions that control the overall performance of the quadcopter 40, such as flying mechanism and live streaming of videos. The control block 41 controls the motor controls 38a-d for maintaining stable flight while moving or hovering. The computer system 41 may be used for implementing any of the methods and techniques described herein. According to one embodiment, these methods and techniques are performed by the computer system 41 in response to the processor 42 executing one or more sequences of one or more instructions contained in the memory 43. Such instructions may be read into the memory 43 from another computer-readable medium. Execution of the sequences of instructions contained in the memory 43 causes the processor 42 to perform the process steps described herein. In alternative embodiments, hard-wired circuitry may be used in place of or in combination with software instructions to implement the arrangement. Thus, embodiments of the invention are not limited to any specific combination of hardware circuitry and software.

The memory 43 stores the software for managing the quadcopter 40 flight, typically referred to as flight stack or autopilot. This software (or firmware) is a real-time system that provides rapid response to changing sensor data. A UAV may employ open-loop, closed-loop or hybrid control architectures: In open loop, a positive control signal (faster, slower, left, right, up, down) is provided, without incorporating a feedback from sensor data. A closed loop control incorporates sensor feedback to adjust behavior (such as to reduce speed to reflect tailwind or to move to altitude 300 feet). In closed loop structure, a PID controller is typically used, commonly feedforward type.

Various sensors for positioning, orientation, movement, or motion of the quadcopter 40 are part of the movement sensors 49, for sensing information about the aircraft state. The sensors allows for stabilization and control using on board 6 DOF (Degrees of freedom) control that implies 3-axis gyroscopes and accelerometers (a typical inertial measurement unit-IMU), 9 DOF control refers to an IMU plus a compass, 10 DOF adds a barometer, or 11 DOF that usually adds a GPS receiver.

In a closed control loop, the various sensors in the movement sensors block 49, such as a Gyroscope (roll, pitch, and yaw), send their output as an input to the control board 41 for stabilizing the copter 40 during flight. The processor 42 processes these signals, and outputs the appropriate control signals to the motor control blocks 38a-d. These signals instruct the ESCs in these blocks to make fine adjustments to the motors 39a-d rotational speed, which in turn stabilizes the quadcopter 40, to induce stabilized and controlled flight (up, down, backwards, forwards, left, right, yaw).

Any sensor herein may use, may comprise, may consist of, or may be based on, a clinometer that may use, may comprise, may consist of, or may be based on, an accelerometer, a pendulum, or a gas bubble in liquid. Any sensor herein may use, may comprise, may consist of, or may be based on, an angular rate sensor, and any sensor herein may use, may comprise, may consist of, or may be based on, piezoelectric, piezoresistive, capacitive, MEMS, or electromechanical sensor. Alternatively or in addition, any sensor herein may use, may comprise, may consist of, or may be based on, an inertial sensor that may use, may comprise, may consist of, or may be based on, one or more accelerometers, one or more gyroscopes, one or more magnetometers, or an Inertial Measurement Unit (IMU).

Any sensor herein may use, may comprise, may consist of, or may be based on, a single-axis, 2-axis or 3-axis accelerometer, which may use, may comprise, may consist of, or may be based on, a piezoresistive, capacitive, Micro-mechanical Electrical Systems (MEMS), or electromechanical accelerometer. Any accelerometer herein may be operative to sense or measure the video camera mechanical orientation, vibration, shock, or falling, and may comprise, may consist of, may use, or may be based on, a piezoelectric accelerometer that utilizes a piezoelectric effect and comprises, consists of, uses, or is based on, piezoceramics or a single crystal or quartz. Alternatively or in addition, any sensor herein may use, may comprise, may consist of, or may be based on, a gyroscope that may use, may comprise, may consist of, or may be based on, a conventional mechanical gyroscope, a Ring Laser Gyroscope (RLG), or a piezoelectric gyroscope, a laser-based gyroscope, a Fiber Optic Gyroscope (FOG), or a Vibrating Structure Gyroscope (VSG).

Most UAVs use a bi-directional radio communication links via an antenna 45, using a wireless transceiver 44, and a communication module 46 for remote control and exchange of video and other data. These bi-directional radio links carried Command and Control (C&C) and telemetry data about the status of aircraft systems to the remote operator. For supporting video transmission is required, a broadband link is used to carry all types of data on a single radio link, such as C&C, telemetry and video traffic, These broadband links can leverage quality of service techniques to optimize the C&C traffic for low latency. Usually, these broadband links carry TCP/IP traffic that can be routed over the Internet.

The radio signal from the operator side can be issued from either a ground control, where a human operating a radio transmitter/receiver, a smartphone, a tablet, a computer, or the original meaning of a military Ground Control Station (GCS), or from a remote network system, such as satellite duplex data links for some military powers. Further, signals may be received from another aircraft, serving as a relay or mobile control station. A protocol MAVLink is increasingly becoming popular to carry command and control data between the ground control and the vehicle. The control board 41 further receives the remote-control signals, such as aileron, elevator, throttle and rudder signals, from the antenna 45 via the communication module 46, and passes these signals to the processor 42.

The estimation of the local geographic location may use multiple RF signals transmitted by multiple sources, and the geographical location may be estimated by receiving the RF signals from the multiple sources via one or more antennas, and processing or comparing the received RF signals. The multiple sources may comprise geo-stationary or non-geo-stationary satellites, that may be Global Positioning System (GPS), and the RF signals may be received using a GPS antenna 48 coupled to the GPS receiver 47 for receiving and analyzing the GPS signals from GPS satellites. Alternatively or in addition, the multiple sources comprises satellites may be part of a Global Navigation Satellite System (GNSS), such as the GLONASS (GLObal NAvigation Satellite System), the Beidou-1, the Beidou-2, the Galileo, or the IRNSS/VAVIC.

Satellite. A satellite, as used herein, refers to an artificial satellite that is a man-made object, which is intentionally placed into orbit. Satellites are used for many purposes, such as to make star maps and maps of planetary surfaces, and also take pictures of planets they are launched into. Common types include military and civilian Earth observation satellites, communications satellites, navigation satellites, weather satellites, and space telescopes. Space stations and human spacecraft in orbit are also referred to as satellites. Satellites can operate by themselves or as part of a larger system, a satellite formation or satellite constellation. Satellite orbits have a large range depending on the purpose of the satellite, and are classified in a number of ways. Well-known (overlapping) classes include low Earth orbit, polar orbit, and geostationary orbit. A launch vehicle is a rocket that places a satellite into orbit. Usually, it lifts off from a launch pad on land. Some are launched at sea from a submarine or a mobile maritime platform, or aboard a plane. Satellites are usually semi-independent computer-controlled systems. Satellite subsystems attend many tasks, such as power generation, thermal control, telemetry, attitude control, scientific instrumentation, communication, etc.

In general, there are three basic categories of (non-military) satellite services: Fixed satellite services, that handle hundreds of billions of voice, data, and video transmission tasks across all countries and continents between certain points on the Earth's surface; Mobile satellite systems that help connect remote regions, vehicles, ships, people, and aircraft to other parts of the world and/or other mobile or stationary communications units, in addition to serving as navigation systems; and Scientific research satellites that provide meteorological information, land survey data (e.g., remote sensing), Amateur (HAM) Radio, and other different scientific research applications such as earth science, marine science, and atmospheric research.

Altitude classifications include Low Earth orbit (LEO) referring to Geocentric orbits ranging in altitude from 180 Km-2,000 Km (1,200 mi); Medium Earth orbit (MEO) referring to Geocentric orbits ranging in altitude from 2,000 Km (1,200 mi)-35,786 Km (22,236 mi) (also known as an intermediate circular orbit); Geosynchronous orbit (GEO) referring to Geocentric circular orbit with an altitude of 35,786 Kilometers (22,236 mi), and where the period of the orbit equals one sidereal day, coinciding with the rotation period of the Earth. The speed is 3,075 metres per second (10,090 ft/s); and High Earth orbit (HEO) referring to Geocentric orbits above the altitude of geosynchronous orbit 35,786 Km (22,236 mi).

A geosynchronous satellite is a satellite in geosynchronous orbit, with an orbital period the same as the Earth's rotation period. Such a satellite returns to the same position in the sky after each sidereal day, and over the course of a day traces out a path in the sky that is typically some form of analemma. A special case of geosynchronous satellite is the geostationary satellite, which has a geostationary orbit—a circular geosynchronous orbit directly above the Earth's equator. Another type of geosynchronous orbit used by satellites is the Tundra elliptical orbit. Geostationary satellites have the unique property of remaining permanently fixed in exactly the same position in the sky as viewed from any fixed location on Earth, meaning that ground-based antennas do not need to track them but can remain fixed in one direction. Such satellites are often used for communication purposes; a geosynchronous network is a communication network based on communication with or through geosynchronous satellites.

The satellite's functional versatility is embedded within its technical components and its operations characteristics. The structural subsystem provides the mechanical base structure with adequate stiffness to withstand stress and vibrations experienced during launch, maintain structural integrity and stability while on station in orbit, and shields the satellite from extreme temperature changes and micro-meteorite damage. A telemetry subsystem (a.k.a. Command and Data Handling, C&DH) monitors the on-board equipment operations, transmits equipment operation data to the earth control station, and receives the earth control station's commands to perform equipment operation adjustments. A power subsystem may consist of solar panels to convert solar energy into electrical power, regulation and distribution functions, and batteries that store power and supply the satellite when it passes into the Earth's shadow. A thermal control subsystem helps protect electronic equipment from extreme temperatures due to intense sunlight or the lack of sun exposure on different sides of the satellite's body (e.g., optical solar reflector). Attitude and orbit control subsystem consists of sensors to measure vehicle orientation, control laws embedded in the flight software, and actuators (reaction wheels, thrusters). These apply the torques and forces needed to re-orient the vehicle to the desired altitude, keep the satellite in the correct orbital position, and keep antennas pointed in the right directions. A second major module is the communication payload, which is made up of transponders. A transponder is capable of receiving uplinked radio signals from earth satellite transmission stations (antennas), amplifying received radio signals, and sorting the input signals and directing the output signals through input/output signal multiplexers to the proper downlink antennas for retransmission to earth satellite receiving stations (antennas).

Earth observation. Earth Observation (EO) is the gathering of information about the physical, chemical, and biological systems of the planet Earth. It can be performed via remote-sensing technologies (Earth observation satellites) or through direct-contact sensors in ground-based or airborne platforms (such as weather stations and weather balloons, for example). Earth observation may be used to monitor and assess the status of and changes in natural and built environments. Earth observations may include numerical measurements taken by a thermometer, wind gauge, ocean buoy, altimeter or seismometer; photos and radar or sonar images taken from ground or ocean-based instruments; photos and radar images taken from remote-sensing satellites; and decision-support tools based on processed information, such as maps and models. Just as Earth observations consist of a wide variety of possible elements, they may be applied to a wide variety of possible uses. Some of the specific applications of Earth observations are forecasting weather; tracking biodiversity and wildlife trends; measuring land-use change (such as deforestation); monitoring and responding to natural disasters, including fires, floods, earthquakes, landslides, land subsidence and tsunamis; managing natural resources, such as energy, freshwater and agriculture; addressing emerging diseases and other health risks; and predicting, adapting to and mitigating climate change

Earth observation satellite. An Earth observation satellite (or Earth remote sensing satellite) is a satellite used or designed for Earth observation (EO) from orbit, including non-military uses such as environmental monitoring, meteorology, cartography and others. The most common type are Earth imaging satellites, that take satellite images, analogous to aerial photographs; some EO satellites may perform remote sensing without forming pictures, such as in GNSS radio occultation. Most Earth observation satellites carry instruments that should be operated at a relatively low altitude. Most orbit at altitudes above 500 to 600 Kilometers (310 to 370 mi). Lower orbits have significant air-drag, which makes frequent orbit reboost maneuvers necessary. To get (nearly) global coverage with a low orbit, a polar orbit is used. A low orbit will have an orbital period of roughly 100 minutes and the Earth will rotate around its polar axis about 25° between successive orbits. The ground track moves towards the west 25° each orbit, allowing a different section of the globe to be scanned with each orbit. Most are in Sun-synchronous orbits. A geostationary orbit, at 36,000 km (22,000 mi), allows a satellite to hover over a constant spot on the earth since the orbital period at this altitude is 24 hours. This allows uninterrupted coverage of more than ⅓ of the Earth per satellite, so three satellites, spaced 120° apart, can cover the whole Earth except the extreme polar regions. This type of orbit is mainly used for meteorological satellites.

Earth observation satellites are commonly used for weather, environmental monitoring, or mapping applications. A weather satellite is a type of satellite that is primarily used to monitor the weather and climate of the Earth. These meteorological satellites, however, see more than clouds and cloud systems. City lights, fires, effects of pollution, auroras, sand and dust storms, snow cover, ice mapping, boundaries of ocean currents, energy flows, etc., are other types of environmental information collected using weather satellites. Other environmental satellites can assist environmental monitoring by detecting changes in the Earth's vegetation, atmospheric trace gas content, sea state, ocean color, and ice fields. By monitoring vegetation changes over time, droughts can be monitored by comparing the current vegetation state to its long-term average. These types of satellites are almost always in Sun-synchronous and “frozen” orbits. A sun-synchronous orbit passes over each spot on the ground at the same time of day, so that observations from each pass can be more easily compared, since the sun is in the same spot in each observation. A “frozen” orbit is the closest possible orbit to a circular orbit that is undisturbed by the oblateness of the Earth, gravitational attraction from the sun and moon, solar radiation pressure, and air drag. Further. Terrain can be mapped from space with the use of satellites.

A satellite may provide a Fixed-satellite service, an Inter-satellite service, or an Earth exploration-satellite service such as a Meteorological-satellite service. Fixed-Satellite Service (FSS—also: fixed-satellite radiocommunication service) is defined as A radiocommunication service between earth stations at given positions, when one or more satellites are used; the given position may be a specified fixed point or any fixed point within specified areas; in some cases this service includes satellite-to-satellite links, which may also be operated in the inter-satellite service; the fixed-satellite service may also include feeder links for other space radiocommunication services. An inter-satellite service (also: inter-satellite radiocommunication service) defined as A radiocommunication service providing links between artificial satellites, and an Earth exploration-satellite service may include a Meteorological-satellite service. A weather satellite or meteorological satellite is a type of Earth observation satellite that is primarily used to monitor the weather and climate of the Earth. Satellites can be polar orbiting (covering the entire Earth asynchronously), or geostationary (hovering over the same spot on the equator). While primarily used to detect the development and movement of storm systems and other cloud patterns, meteorological satellites can also detect other phenomena such as city lights, fires, effects of pollution, auroras, sand and dust storms, snow cover, ice mapping, boundaries of ocean currents, and energy flows. Other types of environmental information are collected using weather satellites.

Remote sensing is defined as the science which deals with obtaining information about objects on earth surface by analysis of data, received from a remote platform. Some principles of Earth observation satellites are described in an article by Rahul Ratnam downloaded from the Internet on July 2022 and entitled: “Principles of Earth Observation Satellites”, which is incorporated in its entirety for all purposes as if fully set forth herein. Since the launch of the first remote sensing weather satellite (TIROS-1) in 1960 and the first Earth resources satellite in 1972 (Landsat-1), various platforms with a variety of remote sensing sensors have been launched to study the Earth land cover, the oceans, the atmosphere or to monitor the weather. In the present context, information flows from an object to a receiver (sensor) in the form of radiation transmitted through the atmosphere. The interaction between the radiation and the object of interest conveys information required on the nature of the object. In order for a sensor to collect and record energy reflected or emitted from a target or surface, it must reside on a stable platform away from the target or surface being observed. Important properties of sensor system are the number of spectral bands, the spectral position of these bands, the spatial resolution or pixel size and the orbit of the satellite.

A pictorial view of an Earth observation or imaging satellite 50 that includes a control system 51 and an imaging system 55 is shown in FIG. 5, The imaging system 55 may include one or more cameras (also referred herein as “imaging sensor”), such as a macro camera 56a designed to capture relatively wide field of view imaging data, and a micro camera 56b having a relatively narrow field of view and which may generally also provide more detailed resolution images. A general-purpose (GP) camera 56c may be incorporated for broad field of view imagery and may provide imaging data input to a cloud detection algorithm. A Thermal and InfraRed (TIR) camera 56d may also be incorporated for thermal imaging data and infrared imaging data. Additional cameras may include a multispectral camera or a hyperspectral camera, among others.

The control system 51 may be comprised of one or more on board computers for handling the functions of any payload and other systems on board the satellite. The control system 51 may include one or more processors 52 and a memory of other computer-readable media 53. The described satellite system provides for at least three beneficial features: i) pushing the image-processing pipeline to orbit; ii) automated tasking and scheduling; and iii) pushing higher-level image analytics to orbit. The satellite system in FIG. 5 allows the satellite 50 to do in real-time much of the image processing pipeline, including transforming raw sensor data into geo-located, normalized, ortho-rectified images that are ready for interpretation and/or analysis. Much of this ability is stored as instructions, processes, and logic within the computer-readable media 53 of the satellite 50.

The computer-readable media 53 is typically a non-transitory and may store various instructions, routines, operations, and modules that, when executed, cause the processors to perform various activities. In some implementations, the one or more processors 52 are Central Processing Units (CPU), Graphics Processing Units (GPU) or both CPU and GPU, or any other sort of processing unit, such as, for example, Digital Signal Processors (DSPs), Field Programmable Gate Arrays (FPGAs), application-specific integrated circuits (ASICs), or others, such as, artificial intelligence and machine learning accelerators. The non-transitory computer-readable media 53 may include volatile and nonvolatile, removable and non-removable tangible, physical media implemented in technology for storage of information, such as computer-readable instructions, data structures, program modules, or other data. System memory, removable storage, and non-removable storage are all examples of non-transitory computer-readable media. Non-transitory computer-readable storage media may include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the system.

The computer-readable media 53 may store one or more modules for controlling the satellite 50 and the payload and for other satellite-based tasks. In some embodiments, the control system 51 may include modules such as a communications module 54a, a propulsion module 54b, an attitude and orbital control subsystem (“AOCS”) module 54c, a power module 54d, an imaging module 54e, an analysis module 54f, and a tasking module 54g. It should be appreciated that not all of the modules need be present in every embodiment, that additional modules may be present for other purposes, and that several modules may be present for one or many of the purposes described. The modules stored within the computer-readable media 53, in many instances, provide for control of other systems and hardware on board the satellite. While the disclosure describes separate modules for performing specific acts and duties, it should be appreciated that all modules have functionality for collecting telemetry/operational data that is used for monitoring status/health of the satellite and for use in decision making by payload subsystems. This allows the modules to cooperate together and exchange data for monitoring the health and status of the satellite, and additionally for on-board evaluation, reprioritizing tasks, image selection, augmenting sensors, extracting higher level meaning, performing analytics, and automated tasking, among other things.

The communications module 54a may control the communications system to provide for a communication channel with one or more base stations on the surface of the Earth or with other satellites within a satellite constellation. The communications module 54a may be responsible for receiving instructions and data from ground or airborne stations, for transmitting data to ground or airborne stations, and for transmitting and receiving data and instructions to and from other satellites within the satellite constellation, or for transmitting and receiving data and instructions to and from other similarly equipped devices such as manned or unmanned aerial vehicles, balloons, cars, ships, and sensor networks. The communication module 54a may selectively transmit and receive data when a communication link has been established and may transmit data such as any images, the results of image analysis, scientific data, the position of the satellite 50 or the health of the satellite 50 or its systems. The propulsion module 54b is largely responsible for controlling the propulsion system, such as for repositioning the satellite, as necessary. It may be any suitable spacecraft propulsion system, such as for example, a monopropellant or bipropellant chemical propulsion system, or an electric propulsion system, such as arcjet thrusters or plasma thrusters. The propulsion module 54b, in combination with the AOCS module 54c, maintains the satellite 50 in its desired position, orbit, and attitude.

The AOCS module 54c, as part of the AOCS, provides attitude information and maintains the satellite 50 attitude during its operational lifetime. It may include various sensors, such as stars, sun and earth sensors, gyroscopes, magnetometers, momentum and reaction wheels, magnetic torquers, and other such equipment to, in combination with the propulsion module, maintain the satellite moving along its desired path across space and with the desired orientation, to ensure the components of the payload or communication system are oriented in the proper direction.

The power module 54d has primary responsibility for sending commands to the power system, such as a solar power system for harvesting the sun's radiation and converting it into electrical power, for managing the power storage, and for maintaining the power conditioning units. The imaging module 54e is primarily responsible for sending instructions to the hardware components of the imaging system 55 for capturing image data. The imaging module 54c may further include instructions for collecting, storing, cataloging, timestamping collected images, determining exposure, amplification gains, and image statistics, among other things. Furthermore, the imaging module 54e may further include instructions for processing the image data, such as segmenting, stitching, correcting, or rectifying the image data. In some instances, the image acquisition and image processing may be handled by separate modules. For example, image acquisition may be handled by the imaging module 54e and image processing may have a separate image processing module for processing the image data generated by the imaging module 54e, such as performing syntactic transformations on the images (e.g., corrections, stitching, rectification, etc.). In some instances, the image capture may be performed on-board the satellite, and some (or all) of the image processing may be performed off-board the satellite. The image processing capabilities may be shared between multiple satellites within a constellation, or between a satellite and a ground-based station.

The analysis module 54f, which in some instances may be a part of the imaging module 54e, allows much of the image analysis workflow to be performed on-board the satellite 50. The analysis module 54f allows much of the image analysis to be performed on board the satellite as opposed to sending images to a base station for analysis as is traditionally done. The analysis module 54f may include algorithms that allow the analysis module 54f to perform actions such as object detection, edge detection, feature recognition, and cloud detection, among others. Of course, image capture and analysis may be performed by the imaging module 54e, or may be shared between the imaging module 54e and the analysis module 54f. In some instances, the image analysis workflow may be shared between multiple satellites within a constellation, or between a satellite and a ground-based station. In some cases, the image processing and/or image analysis includes instructions uploaded to the satellite. In addition, the image processing and/or analysis instructions may be specific to a particular task that the satellite has been tasked to complete.

The tasking module 54g may store a list of prioritized tasks uploaded from a base station, and may additionally reorder those tasks based upon opportunity. The tasking module 54g may further add new tasks based upon sensor data from the various on-board sensors. As used herein, the term sensors is a broad term and refers to any sensors on board the satellite that generate data, and may include image sensors, instruments for Earth observation, temperature sensors (e.g., thermal imaging sensors, or infrared sensors), sun sensors, earth sensors, power meters, attitude sensors, and the like. As such, the tasking module 54g may use sensor data as an input and create new tasks or reprioritize tasks based upon sensor data.

Satellite link. The term ‘satellite link’ refers to a radio link between a transmitting earth station and a receiving earth station through one satellite. A satellite link typically comprises one up-link and one down-link, and uses a modem in the satellite 50 and a respective modem in the ground station, and typically use X band (8 to 12 GHZ), Ku band (12 to 18 GHZ), or Ka band (27 to 40 GHZ). The main functions of a satellite modem are modulation and demodulation. Satellite communication standards also define error correction codes and framing formats. Popular modulation types being used for satellite communications include Binary phase-shift keying (BPSK), Quadrature phase-shift keying (QPSK), Offset quadrature phase-shift keying (OQPSK), 8PSK, and Quadrature amplitude modulation (QAM), especially 16QAM. The Communication module 54a typically comprises a modem that uses an intermediate frequency (IF) output (that is, 50-200 MHz). However, sometimes the signal is modulated directly to L band. In most cases, frequency has to be converted using an upconverter before amplification and transmission. A signal received from a satellite is firstly downconverted (this is done by a Low-noise block converter—LNB), then demodulated by a modem, and at last handled by data terminal equipment.

Ground station. A ground station, (also known as Earth station or Earth terminal) is a terrestrial radio station designed for extraplanetary telecommunication with spacecraft (constituting part of the ground segment of the spacecraft system), or reception of radio waves from astronomical radio sources. Ground stations, that may be either in a fixed or itinerant position, may be located either on the surface of the Earth, or in its atmosphere. Earth stations communicate with spacecraft by transmitting and receiving radio waves in the super high frequency (SHF) or extremely high frequency (EHF) bands (e.g., microwaves). When a ground station successfully transmits radio waves to a spacecraft (or vice versa), it establishes a telecommunications link. A principal telecommunications device of the ground station is the parabolic antenna. Specialized satellite Earth stations are used to telecommunicate with satellites—chiefly communications satellites. Other ground stations communicate with crewed space stations or uncrewed space probes. A ground station that primarily receives telemetry data, or that follows space missions, or satellites not in geostationary orbit, is called a ground tracking station, or space tracking station, or simply a tracking station.

Aerial photography. Aerial photography (or airborne imagery) refers to the taking of photographs from an aircraft or other flying object. Platforms for aerial photography include fixed-wing aircraft, helicopters, Unmanned Aerial Vehicles (UAVs or drones”), balloons, blimps and dirigibles, rockets, pigeons, kites, parachutes, stand-alone telescoping and vehicle-mounted poles. Mounted cameras may be triggered remotely or automatically. Orthogonal video is shot from aircraft mapping pipelines, crop fields, and other points of interest. Using GPS, the captured video may be embedded with metadata and later synced with a video mapping program. This “Spatial Multimedia” is the timely union of digital media including still photography, motion video, stereo, panoramic imagery sets, immersive media constructs, audio, and other data with location and date-time information from the GPS and other location designs. A general schematic view 75 pictorially depicts in FIG. 7a an aerial photography arrangement using the quadcopter 30a capturing an area that includes a river 76a and a lake 76b, various buildings 77a, 77b, 77c, 77d, 77e, a road 78, and various trees 79a, 79b, 79c, and 79d. The captured image 75a is shown in FIG. 7b.

Aerial videos are emerging Spatial Multimedia which can be used for scene understanding and object tracking. The input video is captured by low-flying aerial platforms and typically consists of strong parallax from non-ground-plane structures. The integration of digital video, Global Positioning Systems (GPS) and automated image processing will improve the accuracy and cost-effectiveness of data collection and reduction. Several different aerial platforms are under investigation for the data collection. In order to carry out an aerial survey, a sensor needs to be fixed to the interior or the exterior of the airborne platform with line-of-sight to the target it is remotely sensing. With manned aircraft, this is accomplished either through an aperture in the skin of the aircraft or mounted externally on a wing strut. With unmanned aerial vehicles (UAVs), the sensor is typically mounted under or inside the airborne platform.

Aerial survey is a method of collecting geomatics or other imagery by using airplanes, helicopters, UAVs, balloons or other aerial methods. Typical types of data collected include aerial photography, Lidar, Synthetic Aperture Radar (SAR), remote sensing (using various visible and invisible bands of the electromagnetic spectrum, such as infrared, gamma, or ultraviolet) and also geophysical data (such as aeromagnetic surveys and gravity. It can also refer to the chart or map made by analyzing a region from the air. Aerial survey should be distinguished from satellite imagery technologies because of its better resolution, quality and atmospheric conditions (which may negatively impact and obscure satellite observation). Aerial surveys can provide information on many things not visible from the ground.

Aerial survey systems are typically operated with the following: Flight navigation software, which directs the pilot to fly in the desired pattern for the survey; GNSS, a combination of GPS and Inertial Measurement Unit (IMU) to provide position and orientation information for the data recorded; Gyro-stabilized mount to counter the effects of aircraft roll, pitch and yaw; and Data storage unit to save the data that is recorded. Aerial surveys are used for Archacology; Fishery surveys; Geophysics in geophysical surveys; Hydrocarbon exploration; Land survey; Mining and mineral exploration; Monitoring wildlife and insect populations (called aerial census or sampling); Monitoring vegetation and ground cover; Reconnaissance; and Transportation projects in conjunction with ground surveys (roadway, bridge, highway). Aerial surveys use a measuring camera where the elements of its interior orientation are known, but with much larger focal length and film and specialized lenses.

Location representation. When representing positions relative to the Earth, it is often most convenient to represent vertical position (height or depth) separately, and to use some other parameters to represent horizontal position. Latitude/Longitude, WGS 84, and UTM are common horizontal position representations. The horizontal position has two degrees of freedom, and thus two parameters are sufficient to uniquely describe such a position. The most common horizontal position representation is Latitude and Longitude. However, latitude and longitude should be used with care in mathematical expressions (including calculations in computer programs).

Latitude is a geographic coordinate that specifies the north-south position of a point on the Earth's surface, and is represented as an angle, which ranges from 0° at the Equator to 90° (North or South) at the poles. Lines of constant latitude, or parallels, run east-west as circles parallel to the equator. Latitude is used together with longitude to specify the precise location of features on the surface of the Earth. Longitude is a geographic coordinate that specifies the cast-west position of a point on the Earth's surface, or the surface of a celestial body. It is an angular measurement, usually expressed in degrees and denoted by the Greek letter lambda (2). Meridians (lines running from pole to pole) connect points with the same longitude. The prime meridian, which passes near the Royal Observatory, Greenwich, England, is defined as 0° longitude by convention. Positive longitudes are cast of the prime meridian, and negative ones are west. A location's north-south position along a meridian is given by its latitude, which is approximately the angle between the local vertical and the equatorial plane.

UTM. The Universal Transverse Mercator (UTM) is a system for assigning coordinates to locations on the surface of the Earth, and is a horizontal position representation, which ignores altitude and treats the earth as a perfect ellipsoid. However, it differs from global latitude/longitude in that it divides earth into 60 zones and projects each to the plane as a basis for its coordinates. Specifying a location means specifying the zone and the x, y coordinate in that plane. The projection from spheroid to a UTM zone is some parameterization of the transverse Mercator projection. The parameters vary by nation or region or mapping system.

The UTM system divides the Earth into 60 zones, each 6° of longitude in width. Zone 1 covers longitude 180° to 174° W; zone numbering increases eastward to zone 60, which covers longitude 174°E to 180°. The polar regions of south of 80°S and north of 84°N are excluded. Each of the 60 zones uses a transverse Mercator projection that can map a region of large north-south extent with low distortion. By using narrow zones of 6° of longitude (up to 668 km) in width, and reducing the scale factor along the central meridian to 0.9996 (a reduction of 1:2500), the amount of distortion is held below 1 part in 1,000 inside each zone. Distortion of scale increases to 1.0010 at the zone boundaries along the equator. In each zone the scale factor of the central meridian reduces the diameter of the transverse cylinder to produce a secant projection with two standard lines, or lines of true scale, about 180 km on each side of, and about parallel to, the central meridian (Arc cos 0.9996=1.62° at the Equator). The scale is less than 1 inside the standard lines and greater than 1 outside them, but the overall distortion is minimized.

WGS 84. World Geodetic System (WGS) 84 is an Earth-centered, Earth-fixed terrestrial reference system and geodetic datum. WGS 84 is based on a consistent set of constants and model parameters that describe the Earth's size, shape, and gravity and geomagnetic fields. WGS 84 is the standard U.S. Department of Defense definition of a global reference system for geospatial information and is the reference system for the Global Positioning System (GPS). It is compatible with the International Terrestrial Reference System (ITRS). The World Geodetic System (WGS) is a standard for use in cartography, geodesy, and satellite navigation including GPS. This standard includes the definition of the coordinate system's fundamental and derived constants, the normal gravity Earth Gravitational Model (EGM), a description of the associated World Magnetic Model (WMM), and a current list of local datum transformations. The latest revision is WGS 84 (also known as WGS 1984 ensemble: EPSG: 4326 for 2D coordinate reference system (CRS), EPSG: 4979 for 3D CRS and EPSG: 4978 for geocentric 3D CRS), established and maintained by the United States National Geospatial-Intelligence Agency since 1984, and last revised in January 2021 (G2139 frame realization). WGS 84 ensemble is static, while frame realizations have an epoch. Earlier schemes included WGS 72, WGS 66, and WGS 60. WGS 84 is the reference coordinate system used by the Global Positioning System. The coordinate origin of WGS 84 is meant to be located at the Earth's center of mass; the uncertainty is believed to be less than 2 cm.

Feature. As used herein, the term ‘feature’ refers to a piece of information, such as a part of, or a pattern, of a content of an image, typically about whether a certain region of the image has certain properties that can be the result of a general neighborhood operation or feature extraction or detection (or other low-level or high-level image processing methods or algorithms) applied to the image. Features may include specific structures in the image such as corners, edges, regions of interest points, ridges, points, or objects, as well as shapes defined in terms of curves or boundaries between different image regions. Further, a feature may include specific color or intensity level (general or of a specific color).

Edges are points where there is a boundary (or an edge) between two image regions. In general, an edge can be of almost arbitrary shape, and may include junctions. In practice, edges are usually defined as sets of points in the image which have a strong gradient magnitude. Furthermore, some common algorithms will then chain high gradient points together to form a more complete description of an edge. These algorithms usually place some constraints on the properties of an edge, such as shape, smoothness, and gradient value. Locally, edges have a one-dimensional structure.

The terms corners and interest points are used interchangeably and refer to point-like features in an image, which have a local two-dimensional structure. The name “Corner” arose since early algorithms first performed edge detection, and then analysed the edges to find rapid changes in direction (corners). These algorithms were then developed so that explicit edge detection was no longer required, for instance by looking for high levels of curvature in the image gradient. It was then noticed that the so-called corners were also being detected on parts of the image which were not corners in the traditional sense (for instance a small bright spot on a dark background may be detected).

Blobs provide a complementary description of image structures in terms of regions, as opposed to corners that are more point-like. Nevertheless, blob descriptors may often contain a preferred point (a local maximum of an operator response or a center of gravity) which means that many blob detectors may also be regarded as interest point operators. Blob detectors can detect areas in an image which are too smooth to be detected by a corner detector.

For elongated objects, the notion of ridges is a natural tool. A ridge descriptor computed from a grey-level image can be seen as a generalization of a medial axis. From a practical viewpoint, a ridge can be thought of as a one-dimensional curve that represents an axis of symmetry, and in addition has an attribute of local ridge width associated with each ridge point. Ridge descriptors are frequently used for road extraction in aerial images and for extracting blood vessels in medical images.

Object detection. Object detection (a.k.a. ‘object recognition’) is a process of detecting and finding semantic instances of real-world objects, typically of a certain class (such as humans, buildings, or cars), in digital images and videos. Object detection techniques are described in an article published International Journal of Image Processing (IJIP), Volume 6, Issue June 2012, entitled: “Survey of The Problem of Object Detection In Real Images” by Dilip K. Prasad, and in a tutorial by A. Ashbrook and N. A. Thacker entitled: “Tutorial: Algorithms For 2-dimensional Object Recognition” published by the Imaging Science and Biomedical Engineering Division of the University of Manchester, which are both incorporated in their entirety for all purposes as if fully set forth herein. Various object detection techniques are based on pattern recognition, described in the Computer Vision: March 2000 Chapter 4 entitled: “Pattern Recognition Concepts”, and in a book entitled: “Hands-On Pattern Recognition—Challenges in Machine Learning, Volume I”, published by Microtome Publishing, 2011 (ISBN-13:978-0-9719777-1-6), which are both incorporated in their entirety for all purposes as if fully set forth herein.

Various object detection (or recognition) schemes in general, and face detection techniques in particular, are based on using Haar-like features (Haar wavelets) instead of the usual image intensities. A Haar-like feature considers adjacent rectangular regions at a specific location in a detection window, sums up the pixel intensities in each region, and calculates the difference between these sums. This difference is then used to categorize subsections of an image. Viola-Jones object detection framework, when applied to a face detection using Haar features, is based on the assumption that all human faces share some similar properties, such as the eyes region is darker than the upper checks, and the nose bridge region is brighter than the eyes. The Haar-features are used by the Viola-Jones object detection framework, described in articles by Paul Viola and Michael Jones, such as the International Journal of Computer Vision 2004 article entitled: “Robust Real-Time Face Detection” and in the Accepted Conference on Computer Vision and Pattern Recognition 2001 article entitled: “Rapid Object Detection using a Boosted Cascade of Simple Features”, which are both incorporated in their entirety for all purposes as if fully set forth herein.

Edge detection. Edge detection is a name for a set of mathematical methods that aim at identifying points in a digital image at which the image brightness changes sharply, or more formally, has discontinuities. The points at which image brightness changes sharply are typically organized into a set of curved line segments, which are termed ‘edges’. The purpose of detecting sharp changes in image brightness is to capture important events and changes in properties, and it can be shown that under rather general assumptions for an image formation model, discontinuities in image brightness are likely to correspond to discontinuities in depth, discontinuities in surface orientation, changes in material properties, and variations in scene illumination.

Ideally, the result of applying an edge detector to an image may lead to a set of connected curves that indicate the boundaries of objects, the boundaries of surface markings as well as curves that correspond to discontinuities in surface orientation. Thus, applying an edge detection algorithm to an image may significantly reduce the amount of data to be processed and may therefore filter out information that may be regarded as less relevant, while preserving the important structural properties of the image. If the edge detection step is successful, the subsequent task of interpreting the information contents in the original image may, therefore, be substantially simplified.

A typical edge might be the border between a block of red color and a block of yellow color. In contrast, a line (as can be extracted by a ridge detector) may be a small number of pixels of a different color on an otherwise unchanging background. For a line, there may therefore usually be one edge on each side of the line. There are many methods for edge detection, but most of them can be grouped into two major categories, a search-based and a zero-crossing based. The search-based methods detect edges by first computing a measure of edge strength, usually a first-order derivative expression such as the gradient magnitude, and then searching for local directional maxima of the gradient magnitude using a computed estimate of the local orientation of the edge, usually the gradient direction. The zero-crossing based methods search for zero crossings in a second-order derivative expression computed from the image to find edges, usually the zero-crossings of a Laplacian or the zero-crossings of a non-linear differential expression. As a pre-processing step to edge detection, a smoothing stage, typically Gaussian smoothing, is almost always applied (see also noise reduction). The general criteria for edge detection includes detection of edge with low error rate, which means that the detection should accurately catch as many edges shown in the image as possible, the edge point detected by the operator should accurately localize on the center of the edge, and a given edge in the image should only be marked once, and where possible, image noise should not create false edges.

Various edge detection techniques are described in a paper by Djemel Ziou (of Universite de Sherbrooke, Quebec, Canada) and Salvatore Tabbone (of Crin-Cnrs/Inria Lorraine, Nancy, France) (downloaded July 2015) entitled: “Edge Detection Techniques—An Overview”, in an International Journal of Computer Science Issues (IJCSI), Vol. 9 Issue 5, No. 1, September 2012 [ISSN (online): 1694-0814] by G. T. Shrivakshan (of Bharathiar University, Tamilnadu, India) and Dr. C. Chandrasekar (of Periyar University Salem, Tamilnadu, India) entitled: “A Comparison of various Edge Detection Techniques used in Image Processing”, in a technical report CES-506 by the University of Essex (dated 29 Feb. 2010) ISSN 1744-8050 entitled: “A Survey on Edge Detection Methods”, in a paper by Applied Methematical Sciences, Vol. 2, 2008, no. 31, 1507-1520 by Ehsan Nadernejad, Sara Sharifzadeh, and Hamid Hassanpour entitled: “Edge Detection Techniques: Evaluations and Comparisons”, and in a paper by Tzu-Heng Henry Lee (of National Taiwan University, Taipei, Taiwan, ROC), downloaded July 2015 entitled: “Edge Detection Analysis”, which are all incorporated in their entirety for all purposes as if fully set forth herein.

Various existing tools may be used for edge detection such as the Apple Inc. Quartz™ 2D drawing engine (available from Apple Inc.) and described in Apple Inc. Developer guide (dated 2014 Sep. 17) entitled: “Quartz 2D Programming Guide”, which is incorporated in its entirety for all purposes as if fully set forth herein.

Canny edge detection. Canny edge detector is an edge detection operator that uses a multi-stage algorithm to detect a wide range of edges in images, and may be used to filter spurious edges. A process of Canny edge detection algorithm can be broken down into 5 different steps, (1) Apply Gaussian filter to smooth the image in order to remove the noise, (2) Find the intensity gradients of the image, (3) Apply non-maximum suppression to get rid of spurious response to edge detection, (4) Apply double threshold to determine potential edges, and (5) Track edge by hysteresis, followed by finalizing the detection of edges by suppressing all the other edges that are weak and not connected to strong edges. Canny edge detection (and any variants thereof) is described in an IEEE Transaction on Pattern Analysis and Machine Intelligence, Vol. PAMI-8, No. 6, November 1986 paper (0162-8828/86/1100-0679$01.00) by John Canny entitled: “A Computational Approach to Edge Detection”, in a tutorial 09gr820 (dated Mar. 23, 2009) entitled: “Canny Edge Detection”, and in an International Journal of Computer Vision 53(3), 225-243, 2003 paper authored by R. Kimmel and A. M. Bruckstein (of the Technion, Haifa, Israel) entitled: “Regularized Laplacian Zero Crossings as Optimal Edge Integrators”, which are all incorporated in their entirety for all purposes as if fully set forth herein.

Differential edge detection. A differential edge detection is a second-order edge detection approach that automatically detects edges with sub-pixel accuracy by using the differential approach of detecting zero-crossings of the second-order directional derivative in the gradient direction.

Prewitt operator. The Prewitt operator is a discrete differentiation operator, for computing an approximation of the gradient of an image intensity function. At each point in the image, the result of the Prewitt operator is either the corresponding gradient vector or the norm of this vector. The Prewitt operator is based on convolving the image with a small, separable, and integer valued filter in horizontal and vertical directions and is therefore relatively inexpensive in terms of computations. On the other hand, the gradient approximation produced is relatively crude, in particular for high-frequency variations in the image. In simple terms, the operator calculates the gradient of the image intensity at each point, giving the direction of the largest possible increase from light to dark and the rate of change in that direction. The result therefore shows how “abruptly” or “smoothly” the image changes at that point, and therefore how likely it is that a part of the image represents an edge, as well as how that edge is likely to be oriented. In practice, the magnitude (effectively the likelihood of an edge) calculation is more reliable and easier to interpret than the direction calculation.

Mathematically, the gradient of a two-variable function (here the image intensity function) is at each image point a 2D vector with the components given by the derivatives in the horizontal and vertical directions, and the operator uses two 3×3 kernels that are convolved with the original image to calculate approximations of the derivatives—one for horizontal changes, and one for vertical. At each image point, the gradient vector points in the direction of the largest possible intensity increase, and the length of the gradient vector corresponds to the rate of change in that direction. This implies that the result of the Prewitt operator at an image point which is in a region of constant image intensity is a zero vector and at a point on an edge is a vector which points across the edge, from darker to brighter values. The Prewitt operator is described in a paper by Judith M. S. Prewitt (of University of Pennsylvania, Philadelphia, Pennsylvania, U.S.A.), entitled: “Object Enhancement and Extraction”, which is incorporated in its entirety for all purposes as if fully set forth herein.

Sobel operator. Sobel operator (also referred to as Sobel-Feldman operator), sometimes called Sobel Filter, is used in image processing and computer vision, particularly within edge detection algorithms, to create an image that emphasizes edges and transitions. Technically, it is a discrete differentiation operator, computing an approximation of the gradient of the image intensity function. At each point in the image, the result of the Sobel operator is either the corresponding gradient vector or the norm of this vector. The Sobel operator is based on convolving the image with a small, separable, and integer valued filter in horizontal and vertical direction and is therefore relatively inexpensive in terms of computations. On the other hand, the gradient approximation that it produces is relatively crude, in particular for high-frequency variations in the image. Since the intensity function of a digital image is only known at discrete points, derivatives of this function cannot be defined unless we assume that there is an underlying continuous intensity function that has been sampled at the image points. With some additional assumptions, the derivative of the continuous intensity function may be computed as a function of the sampled intensity function, i.e. the digital image. It turns out that the derivatives of the continuous intensity function at any particular point are functions of the intensity values at virtually all image points. However, approximations of these derivative functions may be defined at lesser or larger degrees of accuracy.

The Sobel operator represents a rather inaccurate approximation of the image gradient but is still of sufficient quality to be of practical use in many applications. More precisely, it uses intensity values only in a 3×3 region around each image point to approximate the corresponding image gradient, and it uses only integer values for the coefficients that weight the image intensities to produce the gradient approximation. The Sobel operator (and variants thereof) is described in a paper by Irwin Sobel (Updated Jun. 14, 2015), entitled: “History and Definition of the so-called “Sobel Operator” more appropriately named the Sobel—Feldman Operator”, in an article by Guennadi (Henry) Levkine (of Vancouver, Canada) Second Draft, June 2012 entitled: “Prewitt, Sobel, and Scharr gradient 5×5 convolution Matrices”, and in an article in Proceedings of Informing Science & IT Education Conference (InSITE) 2009 by O. R. Voncent and O. Folorunso (both of University of Agriculture, Abcokuta, Nigeria), entitled: “A Descriptive Algorithm for Sobel Image Edge Detection”, which are all incorporated in their entirety for all purposes as if fully set forth herein.

Deriche edge detector. Deriche edge detector (often referred to as Canny-Deriche detector) is an edge detection operator that includes a multistep algorithm to obtain an optimal result of edge detection in a discrete two-dimensional image, targeting the following criteria for optimal edge detection: Detection quality-all existing edges should be marked and no false detection should occur, Accuracy—the marked edges should be as close to the edges in the real image as possible, and Unambiguity—a given edge in the image should only be marked once, where no multiple responses to a single edge in the real image should occur. This differential edge detector can be seen as a reformulation of Canny's method from the viewpoint of differential invariants computed from a scale space representation leading to a number of advantages in terms of both theoretical analysis and sub-pixel implementation. The Deriche edge detector is described in an article by Rachid Deriche (of INRIA, Le Chesnay, France) published in International Journal of Computer Vision, 167-187 (1987), entitled: “Using Canny's criteria to Derive a Recursively Implemented Optimal Edge Detector”, and in a presentation by Diane Lingrand (of University of Nice, Sophia Antipolis, France) dated August 2006, entitled: “Segmentation”, which are both incorporated in their entirety for all purposes as if fully set forth herein.

RANSAC. RANdom SAmple Consensus (RANSAC) is an iterative method to estimate parameters of a mathematical model from a set of observed data which contains outliers. It is a non-deterministic algorithm in the sense that it produces a reasonable result only with a certain probability, with this probability increasing as more iterations are allowed. A basic assumption is that the data consists of “inliers”-data whose distribution can be explained by some set of model parameters, though may be subject to noise, and “outliers”-data that do not fit the model. The outliers may come from extreme values of the noise, from erroneous measurements, or from incorrect hypotheses about the interpretation of data. RANSAC also assumes that, given a (usually small) set of inliers, there exists a procedure that can estimate the parameters of a model that optimally explains or fits this data.

The RANSAC algorithm is a learning technique to estimate parameters of a model by random sampling of observed data. Given a dataset whose data elements contain both inliers and outliers, RANSAC uses a voting scheme to find the optimal fitting result. Data elements in the dataset are used to vote for one or multiple models. The implementation of this voting scheme is based on two assumptions: that the noisy features is not voted consistently for any single model (few outliers) and that there are enough features to agreeing on a good model (few missing data). The RANSAC algorithm is essentially composed of two steps that are iteratively repeated: In the first step, a sample subset containing minimal data items is randomly selected from the input dataset. A fitting model and the corresponding model parameters are computed using only the elements of this sample subset. The cardinality of the sample subset is the smallest sufficient to determine the model parameters. In the second step, the algorithm checks which elements of the entire dataset are consistent with the model instantiated by the estimated model parameters obtained from the first step. A data element will be considered as an outlier if it does not fit the fitting model instantiated by the set of estimated model parameters within some error threshold that defines the maximum deviation attributable to the effect of noise. The set of inliers obtained for the fitting model is called consensus set. The RANSAC algorithm iteratively repeats the above two steps until the obtained consensus set in certain iteration has enough inliers.

RANSAC is described in SRI International (Menlo Park, California, U.S.A.) Technical Note 213 (March 1980) by Martin A. Fischler and Robert C. Bolles entitled: “A Paradigm for Model Fitting with Applications to Image Analysis and Automated Cartography”, and in an article by Anders Hast, Johan Nysjo (both of Uppsala University, Uppsala, Sweden) and Andrea Marchetti (of IIT, CNR, Pisa, Italy) entitled: “Optimal RANSAC—Towards a Repeatable Algorithm for Finding the Optimal Set”, which are both incorporated in their entirety for all purposes as if fully set forth herein. Using RANSAC for edge detection is described in U.S. Patent Application Publication No. 2011/0188708 to AHN et al. entitled: “Three-Dimensional Edge Extraction Method, Apparatus and Computer-Readable Medium Using Time of Flight Camera”, in U.S. Pat. No. 8,121,431 to Hwang et al. entitled: “Method and Apparatus for Detecting Edge of Image and Computer Readable Medium Processing Method”, in U.S. Pat. No. 8,224,051 to Chen et al. entitled: “Method for Detection of Linear Structures and Microcalcifications in Mammographic Images”, and in U.S. Pat. No. 8,265,393 to Tribelhorn et al. entitled: “Photo-Document Segmentation Method and System”, which are all incorporated in their entirety for all purposes as if fully set forth herein.

Line segment detection. Straight-line detection techniques are described in an article in J Math Imaging Vis (DOI 10.1007/s10851-008-0102-5) by Rafael Grompone von Gioi et al. (published by Springer Science+Business Media, LLC 2008) entitled: “On Straight Line Segment Detection”, and in a Norwegian University of Science and Technology (NTNU) Master work submitted June 2010 by Kari Haugsdal entitled: “Edge and line detection of complicated and blurred objects”, which are both incorporated in their entirety for all purposes as if fully set forth herein.

LSD is a common linear-time Line Segment Detector providing subpixel accurate results, designed to work on any digital image without parameter tuning. It controls its own number of false detections, and on average, one false alarm is allowed per image. The process starts by computing a level-line angle at each pixel to produce a level-line field, i.e., a unit vector field such that all vectors are tangent to the level line going through their base point. Then, this field is segmented into connected regions of pixels that share the same level-line angle up to a certain tolerance. Various Line Segment Detectors (LSD) are described in an article published in Image Processing On Line (IPOL) 2012 Mar. 24 (ISSN 2105-1232) by Rafael Grompone von Gioi et al. entitled: “LSD: a Line Segment Detector”, in an article in International Conference on Remote Sensing, Environment and Transportation Engineering (RSETE 2013) by TAN Xi, ZHAO Lingjun, and SU Yi (of NUDT, Changsha, China), entitled: “Linear Feature Extraction from SAR Images based on the modified LSD Algorithm”, in a paper dated September 2011 by Rafael Grompone von Gioi et al. entitled: “LSD: a Line Segment Detector”, and in an article by Xiaohu Lu, Jian Yao, Kai Li, and Li Li (of Wuhan University, P.R. China), entitled: “Cannylines: A Parameter-Free Line Segment Detector”, which are all incorporated in their entirety for all purposes as if fully set forth herein.

Hough transform. The Hough transform is a feature extraction technique used in image analysis, computer vision, and digital image processing. The purpose of this technique is to find imperfect instances of objects within a certain class of shapes by a voting procedure that is carried out in a parameter space, from which object candidates are obtained as local maxima in a so-called accumulator space that is explicitly constructed by an algorithm for computing the Hough transform. The classical Hough transform is concerned with the identification of lines in the image, but may be used for identifying positions of arbitrary shapes, most commonly circles or ellipses. Hough transform is described in an article in Computer Vision, Graphics, and Image Processing 44, 87-116 (1988) [0734-189X/88] by J. Illingworth and J. Kittler entitled: “A Survey of the Hough Transform”, and in an article by Allam Shehata Hassanein et al. (of Electronic Research Institute, El-Dokki, Giza, Egypt) entitled: “A Survey on Hough Transform, Theory, Techniques and Applications”, which are both incorporated in their entirety for all purposes as if fully set forth herein.

Detecting lines by using the Hough Transformation is described in Graphics and Image Processing (Association for Computing Machinery, 1972) by Richard O. Duda and Peter E. Hart (of Stanford Research Institute, Menlo Park, California, U.S.A.), entitled: “Use of the Hough Transformation To Detect Lines and Curves in Pictures”, in Chapter 2 of a book “Real-Time detection of Lines and grids” by Herout, A., Dubska, M, and Havel, J., (ISBN: 978-1-4471-4413-7), entitled: “Chapter 2—Review of Hough Transform for Line Detection”, which are both incorporated in their entirety for all purposes as if fully set forth herein.

Corner detection. A corner is defined herein as the intersection of two edges, or as a point for which there are two dominant and different edge directions in a local neighborhood of the point. Techniques for corner detection are described in a paper in 2010 10^{th} International Conference on Computer and Information Technology (CIT 2010) by Andres Solis Montero, Milos Stojmenovic, and Amiya Nayak (of the University of Ottawa, Ottawa, Canada) [978-0-7695-4108-2/10, DOI 10.1109/CIT.2010.109] entitled: “Robust Detection of Corners and Corner-line links in images”, in a paper by Chris Harris and Mike Stephens of The Plessey Company plc. 1988 [AVC 1988 doi:10.5244/C.2.23] entitled: “A Combined Corner and Edge Detector”, and in April 1980 paper by Les Kitchen and Azriel Rosenfeld (of University of Maryland, College Park, Maryland, U.S.A.) [DARPA TR-887, DAAG-53-76C-0138] entitled: “Gray-Level Corner Detection”, which are all incorporated in their entirety for all purposes as if fully set forth herein.

Other corner detection techniques are described in U.S. Pat. No. 4,242,734 to Deal entitled: “Image Corner Detector Using Haar Coefficients”, in U.S. Pat. No. 5,311,305 to Mahadevan et al. entitled: “Technique for Edge/Corner Detection/Tracking in Image Frames”, in U.S. Pat. No. 6,124,896 to Kurashige entitled: “Corner Detection Device and Corner Detection Method”, in U.S. Pat. No. 8,873,865 to Sung entitled: “Algorithm for Fast Corner Detection”, and in U.S. Patent Application Publication No. 2013/0135689 to Shacham et al. entitled: “Automatic detection of Corners of a Scanned Document”, which are all incorporated in their entirety for all purposes as if fully set forth herein.

Neural networks. Neural Networks (or Artificial Neural Networks (ANNs)) are a family of statistical learning models inspired by biological neural networks (the central nervous systems of animals, in particular the brain) and are used to estimate or approximate functions that may depend on a large number of inputs and are generally unknown. Artificial neural networks are generally presented as systems of interconnected “neurons” which send messages to each other. The connections have numeric weights that can be tuned based on experience, making neural nets adaptive to inputs and capable of learning. For example, a neural network for handwriting recognition is defined by a set of input neurons that may be activated by the pixels of an input image. After being weighted and transformed by a function (determined by the network designer), the activations of these neurons are then passed on to other neurons, and this process is repeated until finally, an output neuron is activated, and determines which character was read. Like other machine learning methods-systems that learn from data-neural networks have been used to solve a wide variety of tasks that are hard to solve using ordinary rule-based programming, including computer vision and speech recognition. A class of statistical models is typically referred to as “Neural” if it contains sets of adaptive weights, i.e. numerical parameters that are tuned by a learning algorithm, and capability of approximating non-linear functions from their inputs. The adaptive weights can be thought of as connection strengths between neurons, which are activated during training and prediction. Neural Networks are described in a book by David Kriesel entitled: “A Brief Introduction to Neural Networks” (ZETA2-EN) [downloaded May 2015 from www.dkriesel.com], which is incorporated in its entirety for all purposes as if fully set forth herein.

Neural networks based techniques may be used for image processing, as described in an article in Engineering Letters, 20:1, EL_20_1_09 (Advance online publication: 27 Feb. 2012) by Juan A. Ramirez-Quintana, Mario I. Cacon-Murguia, and F. Chacon-Hinojos entitled: “Artificial Neural Image Processing Applications: A Survey”, in an article published 2002 by Pattern Recognition Society in Pattern Recognition 35 (2002) 2279-2301 [PII: S0031-3203 (01) 00178-9] authored by M. Egmont-Petersen, D. de Ridder, and H. Handels entitled: “Image processing with neural networks—a review”, and in an article by Dick de Ridder et al. (of the Utrecht University, Utrecht, The Netherlands) entitled: “Nonlinear image processing using artificial neural networks”, which are all incorporated in their entirety for all purposes as if fully set forth herein.

Neural networks may be used for object detection as described in an article by Christian Szegedy, Alexander Toshev, and Dumitru Erhan (of Google, Inc.) (downloaded July 2015) entitled: “Deep Neural Networks for Object Detection”, in a CVPR2014 paper provided by the Computer Vision Foundation by Dumitru Erhan, Christian Szegedy, Alexander Toshev, and Dragomir Anguelov (of Google, Inc., Mountain-View, California, U.S.A.) (downloaded July 2015) entitled: “Scalable Object Detection using Deep Neural Networks”, and in an article by Shawn McCann and Jim Reesman (both of Stanford University) (downloaded July 2015) entitled: “Object Detection using Convolutional Neural Networks”, which are all incorporated in their entirety for all purposes as if fully set forth herein.

Using neural networks for object recognition or classification is described in an article (downloaded July 2015) by Mehdi Ebady Manaa, Nawfal Turki Obies, and Dr. Tawfiq A. Al-Assadi (of Department of Computer Science, Babylon University), entitled: “Object Classification using neural networks with Gray-level Co-occurrence Matrices (GLCM)”, in a technical report No. IDSIA-01-11 Jan. 2001 published by IDSIA/USI-SUPSI and authored by Dan C. Ciresan et al. entitled: “High-Performance Neural Networks for Visual Object Classification”, in an article by Yuhua Zheng et al. (downloaded July 2015) entitled: “Object Recognition using Neural Networks with Bottom-Up and top-Down Pathways”, and in an article (downloaded July 2015) by Karen Simonyan, Andrea Vedaldi, and Andrew Zisserman (all of Visual Geometry Group, University of Oxford), entitled: “Deep Inside Convolutional Networks: Visualising Image Classification Models and Saliency Maps”, which are all incorporated in their entirety for all purposes as if fully set forth herein.

Using neural networks for object recognition or classification is further described in U.S. Pat. No. 6,018,728 to Spence et al. entitled: “Method and Apparatus for Training a Neural Network to Learn Hierarchical Representations of Objects and to Detect and Classify Objects with Uncertain Training Data”, in U.S. Pat. No. 6,038,337 to Lawrence et al. entitled: “Method and Apparatus for Object Recognition”, in U.S. Pat. No. 8,345,984 to Ji et al. entitled: “3D Convolutional Neural Networks for Automatic Human Action Recognition”, and in U.S. Pat. No. 8,705,849 to Prokhorov entitled: “Method and System for Object Recognition Based on a Trainable Dynamic System”, which are all incorporated in their entirety for all purposes as if fully set forth herein.

Saliency. Salience (also called saliency) of an item—be it an object, a person, a pixel, etc.—is a state or a quality by which it stands out relative to its neighbors. Saliency detection is considered to be a key attentional mechanism that facilitates learning and survival by enabling organisms to focus their limited perceptual and cognitive resources on the most pertinent subset of the available sensory data. Saliency typically arises from contrasts between items and their neighborhood, such as a red dot surrounded by white dots, a flickering message indicator of an answering machine, or a loud noise in an otherwise quiet environment. Saliency detection is often studied in the context of the visual system, but similar mechanisms operate in other sensory systems. What is salient can be influenced by training: for example, for human subjects particular letters can become salient by training.

When attention deployment is driven by salient stimuli, it is considered to be bottom-up, memory-free, and reactive. Attention can also be guided by top-down, memory-dependent, or anticipatory mechanisms, such as when looking ahead of moving objects or sideways before crossing streets. Humans and other animals have difficulty paying attention to more than one item simultaneously, so they are faced with the challenge of continuously integrating and prioritizing different bottom-up and top-down influences.

Saliency map. ‘Saliency Map’ is a topographically arranged map that represents visual saliency of a corresponding visual scene. Saliency maps, as well as techniques for creating and using saliency and saliency maps, are described in an article by Tiike Judd, Frado Durand, and Antonio Torralba (2012) entitled: “Supplemental Material for A Benchmark of Computational Models of Saliency to Predict Human Fixations”, in an ICVS article (pages 66-75. Springer, 2008. 410, 412, 414) by R. Achanta, F. Estrada, P. Wils, and S. Susstrunk (of I&C EPFL) entitled: “Salient Region Detection and Segmentation”, in an CVPR article (pages 1597-1604, 2009. 409, 410, 412, 413, 414, 415) by R. Achanta, S. Hemami, F. Estrada, and S. Susstrunk entitled: “Frequency-tuned Salient Region Detection”, in an IEEE article (TPAMI, 20 (11): 1254-1259, 1998. 409, 410, 412, 414) by L. Itti, C. Koch, and E. Niebur entitled: “A Model of Saliency based Visual Attention for Rapid Scene Analysis”, in an CVPR article (2010. 410, 412, 413, 414, 415) by S. Goferman, L. Zelnik-Manor, and A. Tal (all of the Technion, Haifa, Israel) entitled: “Context-Aware Saliency Detection”, and in an CVPR (2011) article by MM Cheng, GX Zhang, N. J. Mitra, X. Huang, S. M. Hu entitled: “Global Contrast based Salient Region Detection”, which are all incorporated in their entirety for all purposes as if fully set forth herein.

Techniques for generating saliency maps, and for using such maps for image analysis or manipulation are described in U.S. Patent Application Publication No. 2013/0156320 to Fredembach entitled: “Method, Apparatus and System for Determining a Saliency Map for an Input Image”, in U.S. Pat. No. 8,437,543 to Chamaret et al. entitled: “Method and Device of Determining a Saliency Map for an Image”, in U.S. Pat. No. 8,649,606 to Zhao et al. entitled: “Method and Systems for Generating Saliency Models Through Linear and/or Nonlinear Integration”, in U.S. Pat. No. 8,660,351 to Tang entitled: “Auto-Cropping Using Salience Maps”, in U.S. Pat. No. 8,675,966 to Tang entitled: “System and Method for Saliency Map Generation”, in PCT International Publication No. WO 2008/043204 to G U et al. entitled: “Device and Method for Generating a Saliency Map of a Picture”, in European Patent Application No. EP 2034439 to Zhu et al. entitled: “Method for Establishing the Saliency Map of an Image”, and in European Patent Application No. EP 2731074 to Chevet entitled: “Method for Reframing an Image Based on a Saliency Map”, which are all incorporated in their entirety for all purposes as if fully set forth herein.

A system that can parse both telemetry data and corresponding encoded video data wherein the telemetry and video data are subsequently synchronized based upon temporal information, such as a time stamp, is described in U.S. Patent Application Publication No. 2011/0090399 to Whitaker et al. entitled: “Data Search, Parser, and Synchronization of Video and Telemetry Data”, which is incorporated in its entirety for all purposes as if fully set forth herein. The telemetry data and the video data are originally unsynchronized and the data for each is acquired by a separate device. The acquiring devices may be located within or attached to an aerial vehicle. The system receives the telemetry data stream or file and the encoded video data stream or file and outputs a series of synchronized video images with telemetry data. Thus, there is telemetry information associated with each video image. The telemetry data may be acquired at a different rate than the video data. As a result, telemetry data may be interpolated or extrapolated to create telemetry data that corresponds to each video image. The present system operates in real-time, so that data acquired from aerial vehicles can be displayed on a map.

A system, apparatus, and method for combining video with telemetry data is described in international application published under the Patent Cooperation Treaty (PCT) as WIPO PCT Publication No. WO 17214400 A1 to AGUILAR-GAMEZ et al. entitled: “Networked apparatus for real-time visual integration of digital video with telemetry data feeds”, which is incorporated in its entirety for all purposes as if fully set forth herein. The video is received from a camera associated with a user at a wireless device. Telemetry data associated with the video is received at the wireless device. The telemetry data is time stamped as received. The video is overlaid with the telemetry data to generate integrated video utilizing the wireless device. The integrated video is communicated from the wireless device to one or more users.

A positional recording synchronization system is described in U.S. Patent Application Publication No. 2017/0301373 to Dat Tran et al. entitled: “Positional Recording Synchronization System”, which is incorporated in its entirety for all purposes as if fully set forth herein. The system can include: creating a time stamped telemetry point for an unmanned aerial vehicle; creating a time stamped recording; creating transformed data from the time stamped recording, the transformed data being tiles for zooming or thumbnails; creating a flightpath array, an image metadata array, and a video metadata array; determining whether entries of the video metadata array match with the flightpath array; determining whether entries of the image metadata array match with the flightpath array; synchronizing the time stamped telemetry point with the time stamped recording based on either the entries of the image metadata array matching the flightpath array, the entries of the visualizer module matching the flightpath array, or a combination thereof; and displaying the time stamped telemetry point as a selection tool for calling, viewing, or manipulating the time stamped recording on a display.

Condition detection using image processing may include receiving telemetry data related to movement of a vehicle along a vehicle path is described in U.S. Patent Application Publication No. 2018/0218214 to PESTUN et al. entitled: “Condition detection using image processing”, which is incorporated in its entirety for all purposes as if fully set forth herein. Condition detection using image processing may further include receiving images captured by the vehicle, and generating, based on the telemetry data and the images, an altitude map for the images, and world coordinates alignment data for the images. Condition detection using image processing may further include detecting the entities in the images, and locations of the entities detected in the images, consolidating the locations of the entities detected in the images to determine a consolidated location for the entities detected in the images, generating, based on the consolidated location, a mask related to the vehicle path and the entities detected in the images, and reconstructing three-dimensional entities model for certain types of entities, based on the entities masks and world coordinates alignment data for the images.

A flight training image recording apparatus that includes a housing comprising one or more cameras is described in U.S. Patent Application Publication No. 2016/0027335 to Schoensee et al. entitled: “Flight training image recording apparatus”, which is incorporated in its entirety for all purposes as if fully set forth herein. The housing and/or separate cameras in a cockpit are mounted in locations to capture images of the pilot, the pilot's hands, the aircraft instrument panel and a field of view to the front of the aircraft. The recorded images are date and time synced along with aircraft location, speed and other telemetry signals and cockpit and control tower audio signals into a multiplexed audio and visual stream. The multiplexed audio and video stream is downloaded either wirelessly to a remote processor or to a portable memory device which can be input to the remote processor. The remote processor displays multiple camera images that are time-stamped synced along with cockpit audio signals and aircraft telemetry for pilot training.

An observation system that comprises at least one platform means and a video or image sensor installed on said platform means is described in international application published under the Patent Cooperation Treaty (PCT) as WIPO PCT Publication No. WO 2007/135659 to Shechtman et al. entitled: “Clustering—based image registration”, which is incorporated in its entirety for all purposes as if fully set forth herein. The system is used in order to produce several images of an area of interest under varying conditions and a computer system in order to perform registration between said images and wherein said system is characterized by a clustering-based image registration method implemented in said computer system, which includes steps of inputting images, detecting feature points, initial matching of feature points into pairs, clustering feature point pairs, outlier rejection and defining final correspondence of pairs of points.

Condition detection using image processing may include receiving a mask generated from images and telemetry data captured by a vehicle, an altitude map, and alignment data for the mask, is described in U.S. Patent Application Publication No. 2018/0260626 to PESTUN et al. entitled: “Condition detection using image processing”, which is incorporated in its entirety for all purposes as if fully set forth herein. The images may be related to movement of the vehicle along a vehicle path and non-infrastructure entities along an infrastructure entity position of a corresponding infrastructure entity, and the telemetry data may include movement log information related to the movement of the vehicle along the vehicle path. Condition detection using image processing may further include using the mask related to the vehicle path and the non-infrastructure entities, and an infrastructure rule to detect a risk related to the infrastructure entity by analyzing the mask related to the vehicle path and the non-infrastructure entities, and the infrastructure rule, and determining whether the infrastructure rule is violated.

An Ethernet-compatible synchronization process between isolated digital data streams assures synchronization by embedding an available time code from a first stream into data locations in a second stream that are known a priori to be unneeded, is described in U.S. Patent Application Publication No. 2010/0067553 to McKinney et al. entitled: “Synchronization of video with telemetry signals method and apparatus”, which is incorporated in its entirety for all purposes as if fully set forth herein. Successive bits of time code values, generated as a step in acquiring and digitizing analog sensor data, are inserted into least-significant-bit locations in a digitized audio stream generated along with digitized image data by a digital video process. The overwritten LSB locations are shown to have no discernable effect on audio reconstructed from the Ethernet packets. Telemetry recovery is the reverse of the embedment process, and the data streams are readily synchronized by numerical methods.

A method for producing images is described in U.S. Patent Application Publication No. 2007/0285438 to Kanowitz entitled: “Frame grabber”, which is incorporated in its entirety for all purposes as if fully set forth herein. The method involves acquiring images, acquiring data corresponding to the location of the acquired images, and transferring the images and data to a frame grabber. The method also involves combining the images and data within the frame grabber to provide a plurality of imagery products.

An optical device is described in U.S. Patent Application Publication No. 2004/0155993 to Cueff et al. entitled: “Optical device, particularly a liquid-crystal imaging device, and mirror therefor”, which is incorporated in its entirety for all purposes as if fully set forth herein. The invention described relates to the field of optical devices, in particular liquid crystal imagers, as well as the mirrors associated with these optical devices. The optical device is angled, and includes at least one lamp (3) and a channel (9) guiding at least some of the light coming from the lamp (3), as well as a mirror (12) in an angled part of the optical device, consisting of a sheet which is folded so that, on the one hand, it can be partially introduced into the channel (9), and, on the other hand, once introduced into the channel (9) and immobilized therein, it can reflect some of the light coming from the lamp (3) into a determined direction. The invention may, in particular, be applied to liquid crystal imagers for military aircraft.

Systems and methods for analyzing a game application are disclosed in U.S. Patent Application Publication No. 2017/0266568 to Lucas et al. entitled: “Synchronized video with in game telemetry”, which is incorporated in its entirety for all purposes as if fully set forth herein. While the game application is executed in a gameplay session, embodiment of the systems and methods can acquire data associated with the game application. The data acquired during the gameplay session may be associated with a session identifier. Different types of data (such as telemetry data and video data) can be linked together using the timestamps of the gameplay session. A user can choose a timestamp of the gameplay session to view the data associated with that timestamp. In certain embodiments, the systems and methods can associate an event with one or more timestamps. When a user chooses the event, the systems and methods can automatically display event data starting from the beginning of the event.

A video recording method capable of synchronously merging information of a barometer and positioning information into a video in real time is disclosed in Chinese Patent Application Publication No. CN105163056A entitled: “Video recording method capable of synchronously merging information of barometer and positioning information into video in real time”, which is incorporated in its entirety for all purposes as if fully set forth herein. According to the method, video information, audio information, and air pressure information, altitude information, grid location coordinate information and speed information of a motion camera in real time are acquired, coding processing on the video information is carried out to output a first video flow, coding processing on the audio information is carried out to output an audio flow synchronization with the first video flow, coding processing on the air pressure information, the altitude information, the grid location coordinate information and the speed information is carried out to output an air pressure altitude data flow synchronization with the first video flow and a coordinate speed data flow, through synthesis, a second video flow containing synchronization air pressure, altitude, grid location coordinate and speed information is outputted, and an audio and video file containing the second video flow and the audio flow are finally outputted. Through the method, the air pressure information, the altitude information, the grid location coordinate information and the speed information of the motion camera are merged in real time into the video through synchronization coding, so subsequent edition, management and analysis on the video are conveniently carried out.

Systems and methods for using image warping to improve geo-registration feature matching in vision-aided positioning is disclosed in U.S. Patent Application Publication No. 2015/0199556 to Qian et al. entitled: “Method of using image warping for geo-registration feature matching in vision-aided positioning”, which is incorporated in its entirety for all purposes as if fully set forth herein. In at least one embodiment, the method comprises capturing an oblique optical image of an area of interest using an image capturing device. Furthermore, digital elevation data and at least one geo-referenced orthoimage of an area that includes the area of interest are provided. The area of interest in the oblique optical image is then correlated with the digital elevation data to create an image warping matrix. The at least one geo-referenced orthoimage is then warped to the perspective of the oblique optical image using the image warping matrix. And, features in the oblique optical image are matched with features in the at least one warped geo-referenced orthoimage.

Techniques for augmenting a reality captured by an image capture device are disclosed in U.S. Patent Application Publication No. 2019/0051056 to Chiu et al. entitled: “Augmenting reality using semantic segmentation”, which is incorporated in its entirety for all purposes as if fully set forth herein. In one example, a system includes an image capture device that generates a two-dimensional frame at a local pose. The system further includes a computation engine executing on one or more processors that queries, based on an estimated pose prior, a reference database of three-dimensional mapping information to obtain an estimated view of the three-dimensional mapping information at the estimated pose prior. The computation engine processes the estimated view at the estimated pose prior to generate semantically segmented sub-views of the estimated view. The computation engine correlates, based on at least one of the semantically segmented sub-views of the estimated view, the estimated view to the two-dimensional frame. Based on the correlation, the computation engine generates and outputs data for augmenting a reality represented in at least one frame captured by the image capture device.

A method, device, and computer-readable storage medium for performing a method for discerning a vehicle at an access control point are disclosed in U.S. Patent Application Publication No. 2016/0210512 to Madden et al. entitled: “System and method for detecting, tracking, and classifying objects”, which is incorporated in its entirety for all purposes as if fully set forth herein. The method including obtaining a video sequence of the access control point; detecting an object of interest from the video sequence; tracking the object from the video sequence to obtain tracked-object data; classifying the object to obtain classified-object data; determining that the object is a vehicle based on the classified-object data; and determining that the vehicle is present in a predetermined detection zone based on the tracked-object data.

Various technologies that relate to identifying manmade and/or natural features in a radar image are presented in U.S. Pat. No. 9,239,384 to Chow et al. entitled: “Terrain detection and classification using single polarization SAR”, which is incorporated in its entirety for all purposes as if fully set forth herein. Two radar images (e.g., single polarization SAR images) can be captured for a common scene. The first image is captured at a first instance and the second image is captured at a second instance, whereby the duration between the captures are of sufficient time such that temporal decorrelation occurs for natural surfaces in the scene, and only manmade surfaces, e.g., a road, produce correlated pixels. A LCCD image comprising the correlated and decorrelated pixels can be generated from the two radar images. A median image can be generated from a plurality of radar images, whereby any features in the median image can be identified. A superpixel operation can be performed on the LCCD image and the median image, thereby enabling a feature(s) in the LCCD image to be classified.

A signal processing appliance that will simultaneously process the image data sets from disparate types of imaging sensors and data sets taken by them under varying conditions of viewing geometry, environmental conditions, lighting conditions, and at different times, is disclosed in U.S. Patent Application Publication No. 2018/0005072 to Justice entitled: “Method and Processing Unit for Correlating Image Data Content from Disparate Sources”, which is incorporated in its entirety for all purposes as if fully set forth herein. Processing techniques that emulate how the human visual path processes and exploits data are implemented. The salient spatial, temporal, and color features of observed objects are calculated and cross-correlated over the disparate sensors and data sets to enable improved object association, classification and recognition. The appliance uses unique signal processing devices and architectures to enable near real-time processing.

A method and apparatus for processing images are disclosed in U.S. Pat. No. 9,565,403 to Higgins entitled: “Video processing system”, which is incorporated in its entirety for all purposes as if fully set forth herein. A sequence of images is received from a sensor system. A number of objects is present in the sequence of images. Information about the number of objects is identified using the sequence of images and a selection of a level of reduction of data from different levels of reduction of data. A set of images from the sequence of images is identified using the selection of the level of reduction of data. The set of images and the information about the number of objects are represented in data. An amount of the data for the sequence of images is based on the selection of the level of reduction of data.

Embodiments that provide method and systems for providing customized augmented reality data are disclosed in U.S. Patent Application Publication No. 2008/0147325 to Maassel et al. entitled: “Method and system for providing augmented reality”, which is incorporated in its entirety for all purposes as if fully set forth herein. The method includes Some embodiments consistent with the present disclosure provide a method for providing customized augmented reality data. The method includes receiving geo-registered sensor data including data captured by a sensor and metadata describing a position of the sensor at the time the data was captured and receiving geospatial overlay data including computer-generated objects having a predefined geospatial position. The method also includes receiving a selection designating at least one portion of the geo-registered sensor data, said at least one portion of the geo-registered sensor data including some or all of the geo-registered sensor data, and receiving a selection designating at least one portion of the geospatial overlay data, said at least one portion of the geospatial overlay data including some or all of the geospatial overlay data. And the method includes providing a combination of the at least one selected portion of the geo-registered sensor data and the at least one selected portion of geospatial overlay data, said combination being operable to display the at least one selected portion of the geo-registered sensor data overlaid with the at least one selected portion of geospatial overlay data based on the position of the sensor without receiving other geo-registered sensor data or other geospatial overlay data.

A package launch system that can be implemented to propel a package from an unmanned aerial vehicle (UAV) in a generally vertically descent trajectory, while the UAV is in motion, is disclosed in U.S. Pat. No. 10,377,490 to Haskin et al. entitled: “Maneuvering a package following in-flight release from an unmanned aerial vehicle (UAV)”, which is incorporated in its entirety for all purposes as if fully set forth herein. The package launch system can apply the force onto the package in a number of different ways. For example, flywheels, coils, and springs can generate the force that establishes the vertical descent path of the package. Further, the package delivery system can also monitor the package during its vertical descent. The package can be equipped with one or more control surfaces. Instructions can be transmitted from the UAV via an RF module that cause the one or more controls surfaces to alter the vertical descent path of the package to avoid obstructions or to regain a stable orientation.

Techniques for using an unmanned aerial vehicle (UAV) to deliver a payload are disclosed in U.S. Pat. No. 9,650,136 to Haskin et al. entitled: “Unmanned aerial vehicle payload delivery”, which is incorporated in its entirety for all purposes as if fully set forth herein. For example, upon arrival to a delivery location, the UAV may release the payload and lower a tether coupling the payload to the UAV. Based on a distance associated with the lowering of the payload, the UAV may release the cable. This release may decouple the payload and at a least a portion of the cable from the UAV, thereby delivering the payload at the delivery location.

An arrangement where a physical phenomenon affects a digital video camera and is measured or sensed by a sensor, and a delay of a digital video stream from the digital video camera is estimated, is described in international application published under the Patent Cooperation Treaty (PCT) as WIPO PCT Publication No. WO 2020/170237 to Haskin et al. entitled: “ESTIMATING REAL-TIME DELAY OF A VIDEO DATA STREAM”, which is incorporated in its entirety for all purposes as if fully set forth herein. The digital video stream is processed by a video processor for producing a signal that represents the changing over time of the effect of the physical phenomenon on the digital video camera. The signal is then compared with the sensor output signal, such as by using cross-correlation or cross-convolution, for estimating the time delay between the compared signals. The estimated time delay may be used for synchronizing when combining additional varied data to the digital video stream for low-error time alignment. The physical phenomenon may be based on mechanical position or motion, such as pitch, yaw, or roll. The time delay estimating may be performed once, upon user control, periodically, or continuously.

A Geo-synchronization system that involves a video camera in a vehicle, such as a drone, that captures aerial images of an area, is described in international application published under the Patent Cooperation Treaty (PCT) as WIPO PCT Publication No. WO 2022/074643 to Haskin et al. entitled: “Improving geo-registration using machine-learning based object identification”, which is incorporated in its entirety for all purposes as if fully set forth herein. The success rate and the accuracy of the geo-synchronization algorithms is improved by using a trained feed-forward Artificial Neural Network (ANN) for identifying dynamic objects, that changes over time, in frames captured by the video camera. Such frames are tagged, such as by adding metadata. The tagged frames may be used in a geosynchronization algorithm that may be based on comparing with reference images or may be based on another or same ANN, by removing the dynamic object from the fame, or removing the tagged frame for the algorithm. A dynamic object may change over time due to environmental conditions, such as weather changes, or geographical changes. The environmental condition may change is in response to the Earth rotation, the Moon orbit, or the Earth orbit around the Sun.

A method of obtaining and geo-registering an aerial image of an object of interest is provided in U.S. Patent Application Publication No. 2019/0354741 to Yang entitled: “Geo-registering an aerial image by an object detection model using machine learning”, which is incorporated in its entirety for all purposes as if fully set forth herein. The method includes obtaining an aerial image by a camera onboard an aircraft. The method includes accessing an object detection model trained using a machine learning algorithm and a training set of aerial images of an object of interest, and using the object detection model to detect the object of interest in the aerial image. The object detection includes a prediction of a boundary of the object of interest depicted in the aerial image based on the defined boundary of the object of interest. The method includes accessing a data store including a geographic location of the object of interest. And the method includes geo-registering the aerial image including the prediction of the boundary of the object of interest with the geographic location of the object of interest.

A computer-implemented method of providing georeferenced information regarding a location of capture of an image is disclosed in U.S. Pat. No. 9,471,986 to Junky et al. entitled: “Image-based georeferencing”, which is incorporated in its entirety for all purposes as if fully set forth herein. The method includes receiving a first image at an image-based georeferencing system, the first image comprising digital image information and identifying a cataloged second image that correlates to the first image. The method further includes automatically determining reference features common to both the second image and the first image, accessing geographic location information related to the common reference features, utilizing the geographic location information related to the common features to determine a georeferenced location of capture of the first image and providing the georeferenced location of capture for access by a user of the image-based georeferencing system.

A smart satellite system that is capable of decision making and prioritization on the fly to optimize the use of downlink bandwidth to deliver prioritized data based upon opportunity and the resources of available payloads, is disclosed in U.S. Pat. No. 11,101,876 to Kargieman et al. entitled: “System for planetary-scale analytics”, which is incorporated in its entirety for all purposes as if fully set forth herein. By providing a satellite system with substantial processing power and a level of autonomy, the satellite is able to make decisions about capturing imagery data, including image data processing, object detection, image segmentation, and re-orientation of the satellite based upon the opportunity, from the satellite's perspective, for capturing image data of areas or objects of interest. Through the use of machine learning and in-orbit image analysis, the satellite may transmit only a subset of the captured images, portions of the captured images, or the result of image analysis, thereby efficiently using the downlink communication channel.

A method for visual imaging arrays is disclosed in U.S. Pat. No. 10,027,873 to Brav et al. entitled: “Devices, methods and systems for visual imaging arrays”, which is incorporated in its entirety for all purposes as if fully set forth herein. The method comprises capturing a scene through use of the array of more than one image sensor; receiving a request via the wireless communication interface for a particular zoom level view of the scene; identifying one or more pixels of the scene that correspond to the particular zoom level view; decimating prior to transmission at least some of the one or more pixels that correspond to the particular zoom level view to result in one or more remaining pixels that correspond to the particular zoom level view, the decimating being to an extent that depends upon a field of view size of the particular zoom level view; and transmitting via the wireless communication interface the one or more remaining pixels that correspond to the particular zoom level view.

Solutions for performing on-platform analytics for collected images are described in U.S. Patent Application Publication No. 2020/0334442 to Zargahi et al. entitled: “On-platform analytics”, which is incorporated in its entirety for all purposes as if fully set forth herein. The solutions include: enriching, on-board an orbital platform, collected images using a packaged analytics component; based at least on content of the collected images, selecting a set of the collected images to transmit to a ground station; and transmitting the selected set of the collected images to the ground station. Other solutions include: packaging an analytics component for on-platform execution by a platform in orbit; transmitting, from a ground station to the platform, at least one update selected from the list consisting of: an analytics algorithm update, a machine learning (ML) model, and ML training data; and executing the analytics component with the update. Other solutions include: performing intelligent compression on collected images, wherein the intelligent compression process determines data to transmit to a ground station, based at least on content of the collected images; and transmitting the data to the ground station.

A corner feature real-time detection and matching process is described in Chinese Patent Application Publication No. CN110084784 entitled: “REAL-TIME DETECTION AND MATCHING METHOD FOR ON-SATELLITE ANGULAR POINT CHARACTERISTICS”, which is incorporated in its entirety for all purposes as if fully set forth herein. The detection and matching process comprises the following steps of: (1) enabling a satellite image to enter an FPGA chip in a data stream form, and firstly writing the data stream into a DDR3 chip; (2) while writing data, carrying out FAST-12-based angular point feature detection; (3) reading a sub-image taking the angular point as the center from the DDR3, and adopting a sub-image reading method of a remainder method; (4) using the read sub-images for generating BRIEF descriptors, and then carrying out Hamming distance matching; (5) adopting a combination mode of a slope method and a correlation coefficient method to complete mismatching elimination; and (6) calculating the center-of-gravity position of the point pair to complete sub-pixel positioning. According to the invention, the problem of output from image data input to sub-pixel level point pairs is integrally solved, and correct basic data is provided for satellite implementation of a subsequent algorithm.

A method and a system for detecting a remote sensing image target is described in Chinese Patent Application Publication No. CN112818723A entitled: “Remote sensing image target detection method and system”, which is incorporated in its entirety for all purposes as if fully set forth herein. According to the characteristics of on-satellite data processing, the invention designs corresponding characteristic description, detection and matching algorithms by utilizing the characteristics of invariance of the edges, shapes, scales and the like of typical ground large-scale targets such as airports, bridges and oil depots, optimizes the algorithms and realizes real-time and accurate detection processing of the on-satellite large-scale ground targets. By applying the processing method of the remote sensing data, the fixed target can be quickly and accurately detected and identified from the high-resolution remote sensing image; meanwhile, by establishing a multi-feature matching model as a classification basis of a fixed target, the accuracy of target identification can be effectively improved.

A high-bandwidth remote sensing image target extraction method suitable for on-board on-orbit processing is described in Chinese Patent Application Publication No. CN112580431 entitled: “High-bandwidth remote sensing image target extraction method suitable for on-satellite on-orbit processing”, which is incorporated in its entirety for all purposes as if fully set forth herein. The remote sensing image target extraction method comprises the following steps of: data splicing: serially reading 4 image pixel data from a single-port memory according to lines, splicing the image pixel data into a processing unit, and carrying out shunt output according to 64 pixels and 512 pixels; calculating and counting the characteristics: calculating a characteristic value of the branched data through a mean value, a variance, a Gamma value and a pulse array of histogram statistics; abnormal extraction: performing exception extraction by adopting a mode that a distributed storage structure meets the requirement of characteristic value data, and outputting a binary matrix; target detection; and marking each unit by using the expanded symbol discrimination binary matrix, merging adjacent same marks, and generating new region marks for adjacent different marks. The invention adopts a multi-data flow structure to realize high-bandwidth design of data splicing, feature calculation and statistics, exception extraction and target detection, and improves the bandwidth of target extraction VLSI.

A smart satellite system that is capable of decision making and prioritization on the fly to optimize the use of downlink bandwidth to deliver prioritized data based upon opportunity and the resources of available payloads is described in U.S. Pat. No. 11,101,876 to Kargieman et al. entitled: “System for planetary-scale analytics”, which is incorporated in its entirety for all purposes as if fully set forth herein. By providing a satellite system with substantial processing power and a level of autonomy, the satellite is able to make decisions about capturing imagery data, including image data processing, object detection, image segmentation, and re-orientation of the satellite based upon the opportunity, from the satellite's perspective, for capturing image data of areas or objects of interest. Through the use of machine learning and in-orbit image analysis, the satellite may transmit only a subset of the captured images, portions of the captured images, or the result of image analysis, thereby efficiently using the downlink communication channel.

Solutions for performing on-platform analytics for collected images are described in U.S. Patent Application Publication No. 2020/0334442 to Rajabi Zargahi et al. entitled: “On-platform analytics”, which is incorporated in its entirety for all purposes as if fully set forth herein. The solutions include: enriching, on-board an orbital platform, collected images using a packaged analytics component; based at least on content of the collected images, selecting a set of the collected images to transmit to a ground station; and transmitting the selected set of the collected images to the ground station. Other solutions include: packaging an analytics component for on-platform execution by a platform in orbit; transmitting, from a ground station to the platform, at least one update selected from the list consisting of: an analytics algorithm update, a machine learning (ML) model, and ML training data; and executing the analytics component with the update. Other solutions include: performing intelligent compression on collected images, wherein the intelligent compression process determines data to transmit to a ground station, based at least on content of the collected images; and transmitting the data to the ground station.

Corner feature real-time detection and matching process on a kind of star is described in in Chinese Patent Application Publication No. CN110084784A entitled: “Corner feature real-time detection and matching process on star”, which is incorporated in its entirety for all purposes as if fully set forth herein. The detection and matching process includes (1) satellite image enters fpga chip in the form of data flow, and data flow is written in DDR3 chip first; (2) while writing data, the corner feature detection based on FAST-12 is carried out; (3) from the subgraph read in DDR3 centered on angle point, using the subgraph read method of method of residues; (4) subgraph read is sub for generating BRIEF description, then carries out Hamming distance matching; (5) error hiding is completed using Slope Method and correlation coefficient process combination to reject; (6) position of centre of gravity of point pair is calculated to complete sub-pixel positioning. Integration of the present invention solves the problems, such as to be input to sub-pixel point from image data to output, provides correct basic data to realize on the star of subsequent algorithm.

A method of constructing an image mosaic is described in U.S. Pat. No. 6,075,905 to Herman et al. entitled: “Method and apparatus for mosaic image construction”, which is incorporated in its entirety for all purposes as if fully set forth herein. The method comprising the steps of selecting source images, aligning the source images, selecting source segments, enhancing the images, and merging the images to form the image mosaic is disclosed. An apparatus for constructing an image mosaic comprising means for selecting source images, means for aligning the source images, means for selecting source image segments, means for enhancing the images, and means for merging the images to form the image mosaic is also disclosed. The process may be performed automatically by the system or may be guided interactively by a human operator. Applications include the construction of photographic quality prints form video and digital camera images.

An invention that is embodied in a block adjustment method and apparatus which simultaneously aligns a set of overlapping images in order to construct an image mosaic is described in U.S. Pat. No. 5,987,164 to Szeliski et al. entitled: “Block adjustment method and apparatus for construction of image mosaics”, which is incorporated in its entirety for all purposes as if fully set forth herein. For each one of the images of the set, the invention performs the alignment by determining ray directions relative to a 3-dimensional coordinate system at plural predetermined pixel locations in the one image. For each one of the plural pixel locations in the one image, ray directions are determined relative to the 3-dimensional coordinate system of the corresponding pixel location in each one of the other images overlapping the one predetermined pixel location of the one image. Then, incremental deformations of the overlapping images are computed which simultaneously minimize differences between the ray directions of plural pairs of the overlapping images which include the one image. The foregoing is performed for each of the plural predetermined pixel locations of the one image simultaneously. The images are warped in accordance with the incremental deformations and the process is repeated.

An electronic device and a method for processing an image are described in U.S. Pat. No. 10,893,184 to Moon et al. entitled: “Electronic device and method for processing image”, which is incorporated in its entirety for all purposes as if fully set forth herein. A method of the electronic device according to various embodiments can comprise the operations of: obtaining, using an image sensor, a plurality of images including a first image and a second image corresponding to external objects, providing, using the image sensor, at least a part of processed images of the plurality of images as a preview image; detecting image information based on at least the preview image; storing, in a buffer, images including at least the first and second images of the plurality of images; and synthesising, in response to an image capture related input, an image set including at least the first and second images of the images stored in the buffer using the image information so as to create a third image. In addition, the present invention may include other embodiments.

Technologies pertaining to registering a target image with a base image are described in U.S. Patent Application Publication No. 2014/0334735 to Pitts et al. entitled: “Image registration via optimization over disjoint image regions”, which is incorporated in its entirety for all purposes as if fully set forth herein. In a general embodiment, the base image is selected from a set of images, and the target image is an image in the set of images that is to be registered to the base image. A set of disjoint regions of the target image is selected, and a transform to be applied to the target image is computed based on the optimization of a metric over the selected set of disjoint regions. The transform is applied to the target image so as to register the target image with the base image.

A method for collecting and processing remotely sensed imagery in order to achieve precise spatial co-registration (e.g., matched alignment) between multi-temporal image sets is described in U.S. Pat. No. 9,977,978 to Coulter et al. entitled: “Image station matching, preprocessing, spatial registration and change detection with multi-temporal remotely-sensed imagery”, which is incorporated in its entirety for all purposes as if fully set forth herein. Such precise alignment or spatial co-registration of imagery can be used for change detection, image fusion, and temporal analysis/modeling. Further, images collected in this manner may be further processed in such a way that image frames or line arrays from corresponding photo stations are matched, co-aligned and if desired merged into a single image and/or subjected to the same processing sequence. A second methodology for automated detection of moving objects within a scene using a time series of remotely sensed imagery is also presented. Specialized image collection and preprocessing procedures are utilized to obtain precise spatial co-registration (image registration) between multitemporal image frame sets. In addition, specialized change detection techniques are employed in order to automate the detection of moving objects.

A method and apparatus for generating a composite image from a set of images is described in U.S. Patent Application Publication No. 2007/0031063 to Zhou entitled: “Method and apparatus for generating a composite image from a set of images”, which is incorporated in its entirety for all purposes as if fully set forth herein. A reference image is selected from said set. The remaining images in the set are registered to the reference image either directly or through intermediate images that have been previously-registered. The registration of images through previously-registered intermediate images is at least partially based on the length of a shortest path from the images to the reference image through the previously-registered images. The remaining images to the reference image are mapped thereby to generate the composite image.

A panoramic high-dynamic range (HDR) image method and system of combining multiple images having different exposures and at least partial spatial overlap wherein each of the images may have scene motion, camera motion, or both, are described in U.S. Pat. No. 7,239,805 to Uyttendaele et al. entitled: “Method and system for combining multiple exposure images having scene and camera motion”, which is incorporated in its entirety for all purposes as if fully set forth herein. The major part of the panoramic HDR image method and system is a two-pass optimization-based approach that first defines the position of the objects in a scene and then fills in the dynamic range when possible and consistent. Data costs are created to encourage radiance values that are both consistent with object placement (defined by the first pass) and of a higher signal-to-noise ratio. Seam costs are used to ensure that transitions occur in regions of consistent radiances. The result is a high-quality panoramic HDR image having the full available spatial extent of the scene along with the full available exposure range.

Method and apparatus for aligning more than two fragments of an image to assemble the image while providing high alignment quality between each pair of overlapping image fragments are described in U.S. Pat. No. 6,038,349 to Cullen entitled: “Simultaneous registration of multiple image fragments”, which is incorporated in its entirety for all purposes as if fully set forth herein. Image registration operations are performed rapidly. The disclosed method and apparatus find application in, for example, scanning, copying, and facsimile transmission of large format documents.

A method for combining a sequence of two-dimensional images of a scene to construct a panoramic mosaic of the scene has a sequence of images acquired by a camera with relative motion to the scene is described in U.S. Pat. No. 6,532,036 to Peleg entitled: “Generalized panoramic mosaic”, which is incorporated in its entirety for all purposes as if fully set forth herein. The relative motion gives rise to an optical flow between the images. The images are warped so that the optical flow becomes substantially parallel to a direction in which the mosaic is constructed and pasted so that the sequence of the images is continuous for the scene to construct the panoramic mosaic of the scene. For this, the images are projected onto a three-dimensional cylinder having a major axis that approximates the path of an optical center of the camera. The combination of the images is achieved by translating the projected two-dimensional images substantially along the cylindrical surface of the three-dimensional cylinder.

A correction method for minimizing the difference in brightness between satellite images for the production of a heat distribution map is described in Korean Patent Publication No. KR102353123 entitled: “Compensation method for minimizing differences between satellite images for heat map production”, which is incorporated in its entirety for all purposes as if fully set forth herein. In order to produce a heat distribution map, the steps of collecting satellite images of the corresponding area, selecting a reference image and an adjacent image from the collected images, and the reference extracting a histogram for an overlapping region between an image and an adjacent image; and fitting an average value of the histogram of the adjacent image to the average value of the histogram of a reference image.

A computer system that execute a method to stitch satellite images into a wide-angle image is described in U.S. Pat. No. 9,990,753 to Cai et al. entitled: “Image stitching”, which is incorporated in its entirety for all purposes as if fully set forth herein. The method includes dividing each of the satellite images into plural subimages, determining whether the subimages include an overlap area that overlaps with adjacent subimages, obtaining cropped subimages by removing the overlap area from the subimages, generating preprocessed satellite images each including the cropped subimages, selecting a reference image and a target image from the preprocessed satellite images, determining plural correspondent pairs in an overlap region between the reference and target images based on a feature matching algorithm, obtaining a transformation matrix by a least-squares algorithm and based on coordinates of the correspondent pairs, obtaining calibrated coordinates for each pixel of the target image by applying the transformation matrix, and stitching the target images into the wide-angle image based on the calibrated coordinates of the target image.

An automatic ortho-rectification frame and method for dynamically extracting a remote sensing satellite image of image control points are described in Chinese Patent Publication CN 103383773 entitled: “Automatic ortho-rectification frame and method for dynamically extracting remote sensing satellite image of image control points”, which is incorporated in its entirety for all purposes as if fully set forth herein. The frame comprises a region level reference image set and an executing module which automatically conducts geometric correction on the remote sensing satellite image. The executing module automatically conducts geometric correction mainly through the four steps of firstly, through coordinate information of the four corner points of an image to be corrected and an estimated value of a system correction error, extracting a reference image which is basically overlapped with the image to be corrected in the aspect of the geographical range and a DEM, using the extracted reference image as a control image, and using data of the DEM for ortho-rectification correction; secondly, conducting automatic matching on the control image and the image to be corrected to obtain the control points; thirdly, setting up a correction model between the image to be corrected and the control image based on the control points, and conducting correction on the image to be corrected; fourthly, conducting automatic registration on the corrected image and the control image again through an image automatic matching method, and automatically calculating relative correction errors through the matched control points.

Computer-based methods and systems for automatically determining convergence when registering image sets are described in U.S. Patent Application Publication No. 2006/0165267 to Wyman et al. entitled: “System and method for determining convergence of image set registration”, which is incorporated in its entirety for all purposes as if fully set forth herein. Example embodiments provide an Enhanced Image Registration System (EIRS), which includes an Image Comparison Module, a Transformation Optimizer, and a Convergence Calculator. When the EIRS receives two image sets to align, the Image Comparison Module compares two image sets to determine or measure how closely the image sets are aligned. The Transformation Optimizer determines an appropriate transformation to apply to one of the image sets to align it with the reference image set. The Transformation Optimizer then applies the determined transformation. The Convergence Calculator examines one or more points within the transformed image set to determine when convergence is attained.

An image registration system and method for matching images having fundamentally different characteristics are described in U.S. Patent Application Publication No. 2016/0217577 to Tom et al. entitled: “Enhanced phase correlation for image registration”, which is incorporated in its entirety for all purposes as if fully set forth herein. One exemplary feature of the system and method includes the use of an enhanced phase correlation method combined with a coarse sensor model to hypothesize and match a custom match metric to determine a best solution. The system and method may be operated on a non-transitory computer-readable medium storing a plurality of instructions which when executed by one or more processors causes the one or more processors to perform the image registration method utilizing the enhanced phase correlation.

Each of the methods or steps herein, may consist of, include, be part of, be integrated with, or be based on, a part of, or the whole of, the steps, functionalities, or structure (such as software) described in the publications that are incorporated in their entirety herein. Further, each of the components, devices, or elements herein may consist of, integrated with, include, be part of, or be based on, a part of, or the whole of, the components, systems, devices or elements described in the publications that are incorporated in their entirety herein.

In consideration of the foregoing, it would be an advancement in the art to provide methods and systems for aerial photography, such as by an earth-looking satellite, such as for aerial inspection, survey, and surveillance, and for improving accuracy and success-rate of geo-synchronization schemes, and to provide systems and methods that are low simple, intuitive, require low communication bandwidth, small, secure, cost-effective, reliable, provide lower power consumption, provide lower CPU and/or memory usage, easy to use, reduce latency, faster, has a minimum part count, minimum hardware, and/or uses existing and available components, protocols, programs, and applications for providing better quality of service, better or optimal resources allocation, and provides a better user experience.

### SUMMARY

A method for geosynchronization may be used with a ground station that wirelessly communicates with an aerial vehicle, that may include a camera that is positioned to capture images of an Earth surface, and may further be use with multiple features descriptor sets and a plurality of geosynchronized reference images. The method may comprise capturing, by the camera in the aerial vehicle, an image of an Earth surface; identifying, in the aerial vehicle, using the multiple features descriptor sets, N (N>1) features in the captured image; associating, in the aerial vehicle, for each of the N identified features, a location ({Xᵢ; Yᵢ} where i=1, 2, . . . . N), in the captured image and respective descriptor set; sending, by the aerial vehicle to the ground station over the wireless communication, the locations in the captured image and the descriptors set for each of the identified features; receiving, by ground station from the aerial vehicle over the wireless communication, the locations in the captured image and the descriptors set for each of the identified features; selecting, in the ground station, a first reference image from the plurality of geosynchronized reference images; identifying, in the ground station, using the received descriptors sets, each of the identified features in the selected reference image; associating, in the ground station, a geographical location ({AXᵢ; AYᵢ} where i=1, 2, . . . . N) for each of the identified features; and calculating, in the ground station, a mapping function for mapping a location {X;Y} in the captured image to a geographical location {AX;AY}.

Any N features herein may be at least 30, 50, 80, 100, 120, 150, 200, 500, 1,000, 2,000, 5,000, or 10,000 features, or may be less than 3, 4, 5, 8, 10, 12, 15, 20, 25, 30, 50, 80, 100, 120, 150, 200, 500, 1,000, 2,000, 5,000, 10,000 or 20,000 features. Any multiple features descriptor sets herein may be stored in a memory in the aerial vehicle, and any memory herein may be a non-volatile memory. Any plurality of geosynchronized reference images herein may be stored in a volatile or non-volatile memory in the ground station, and at least one of, most of, or all of, the geographical location or position on Earth herein may be represented as Latitude and Longitude values, according to World Geodetic System (WGS) 84 standard, or may use Universal Transverse Mercator (UTM) zones. Any method herein may further comprise determining, any location, such as any location of the aerial vehicle, such as when the image was captured, using the calculated mapping function.

Any identifying of any feature herein, such as in the captured image or in the selected reference image, may be based on, or may use, identifying a feature of an object in the image. Any feature herein may comprise, may consist of, or may be part of, shape, size, texture, boundaries, or color, of any object. Any identifying of any feature herein in the captured image or in the selected reference image, may be based on, or may use, a same, a similar, or different, feature detection schemes, algorithms, or processes.

Any one of, or each one of, any multiple descriptor sets herein may comprise a respective shape, color, texture, motion, or any combination thereof, a general information descriptor or a specific domain information descriptor, or any combination thereof. Any one of, or each one of, the multiple descriptor sets herein may use, may be according to, may be compatible with, or may be based on, Moving Picture Experts Group (MPEG)-7 (MPEG-7) standard ISO/IEC 15938 (Multimedia content description interface).

Any color descriptor herein may use, may be according to, may be compatible with, or may be based on, Dominant color descriptor (DCD), Scalable color descriptor (SCD), Color structure descriptor (CSD), Color layout descriptor (CLD), Group of frame (GoF) or Group-of-Pictures (GoP), or any combination thereof. Any texture descriptor herein may use, may be according to, may be compatible with, or may be based on, Homogeneous texture descriptor (HTD), Texture browsing descriptor (TBD), Edge histogram descriptor (EHD), or any combination thereof. Any shape descriptor herein may use, may be according to, may be compatible with, or may be based on, Region-based shape descriptor (RSD), Contour-based shape descriptor (CSD), 3-D shape descriptor (3-D SD), or any combination thereof. Any motion descriptor herein may use, may be according to, may be compatible with, or may be based on, Motion activity descriptor (MAD), Camera motion descriptor (CMD), Motion trajectory descriptor (MTD), Warping and parametric motion descriptor (WMD and PMD), or any combination thereof. Any location descriptor herein may use, may be according to, may be compatible with, or may be based on, Region Locator Descriptor (RLD), Spatio Temporal Locator Descriptor (STLD), or any combination thereof.

Any reference images herein may be stored in a database in the ground station. Any geosunchronization of any reference images herein, or any associating of the geographical locations herein, may comprise, may be based on, or may use, a Geographic Information System (GIS), that may be based on, or may use, a United States Geological Survey's (USGS) survey reference points and georeferenced images, city public works databases, Continuously Operating Reference Stations (CORS), or any combination thereof. Any reference images herein may be stored in a database located externally to the ground station, and any method may further comprise receiving, over the Internet, part of, or all of, the reference images, such part of a service that is Google Earth™ (by Google®), Virtual Earth™ (by Microsoft®), TerraServer® (by TerraServer®), or ArcGIS by Esri (Environmental Systems Research Institute).

Any calculating herein may comprise constructing any function, such as any mapping function herein, using curve fitting, that may be based on, or may comprise, interpolation, smoothing, least squares, or any combination thereof. Any curve fitting herein may be based on, or may comprise, a mapping function that is a polynomial function, a first, second, or third, degree polynomial function, a trigonometric function, or any combination thereof.

‘Any method herein may be further for geosynchronization of a region, and any method herein may further comprise: identifying, in the aerial vehicle, a region in the captured image, the region having a shape and is associated with multiple locations in the captured image; cropping, in the aerial vehicle, the identified region from the captured image; sending, by the aerial vehicle to the ground station over the wireless communication, the cropped region and the multiple locations; receiving, by ground station from the aerial vehicle over the wireless communication, the cropped region and the multiple locations; and associating, in the ground station, using the mapping function, a respective geographical location to each of the multiple locations. Any identifying of any region herein may use at least one descriptor set from the multiple features descriptor sets.

Any area of any identified region herein may be at least 0.01%, 0.02%, 0.05%, 0.1%, 0.2%, 0.5%, 1%, 2%, 5%, 10%, 20%, or 50% of the area of any captured image, or may be less than 0.02%, 0.05%, 0.1%, 0.2%, 0.5%, 1%, 2%, 5%, 10%, 20%, 50%, or 75% of the area of any captured image. Any multiple locations herein may comprise multiple locations on a perimeter of the identified region, such as on corners or sides of any polygon shaped identified region. Any region herein, such as any identified region herein, may be shaped as a polygon, that may comprise a triangle, a quadrilateral, a rectangle, a square, a pentagon, a hexagon, an Equiangular polygon, a Regular polygon, an Equilateral polygon, a Cyclic polygon, a Tangential polygon, an Isotoxal polygon, or any combination thereof. Alternatively or in addition, any region herein, such as any identified region herein, may be shaped as a circle or as an ellipsis.

Any method herein may be used for geosynchronization of an additional feature, and any method herein may comprise: identifying, in the aerial vehicle, the additional feature in the captured image; associating, in the aerial vehicle, for the identified additional features, a location {Xⱼ;Yⱼ} in the captured image; sending, by the aerial vehicle to the ground station over the wireless communication, the location of the additional feature; receiving, by ground station from the aerial vehicle over the wireless communication, the location of the additional feature; and associating, in the ground station, using the mapping function, a respective geographical location to the location of the additional feature. Any identifying of any feature, such as of any additional feature, may use at least one descriptor set from the multiple features descriptor sets, or may use at least one descriptor set that is not in the multiple features descriptor sets.

Any aerial vehicle herein may be, or may comprise, an aircraft adapted to fly in air, that may be a fixed wing or a rotorcraft aircraft, that may be configured for aerial photography. Any aircraft herein may comprise, or may consist of, an airplane, a spacecraft, a drone, a glider, a drone, or an Unmanned Aerial Vehicle (UAV) that is a fixed-wing or rotary-wing aircraft, such as a quadcopter, hexcopter, or octocopter.

Any aerial vehicle herein may comprise, may consist of, or may be part of, a satellite that provides a fixed satellite service, a mobile satellite service, or a scientific research satellite, that is configured to move in a Geocentric orbit, in a Low Earth orbit (LEO), in a Medium Earth orbit (MEO), or in a High Earth orbit (HEO). Alternatively or in addition, any satellite herein may be a geosynchronous satellite in a Geosynchronous orbit (GEO), or an Earth observation satellite that is configured for an Earth observation (EO). Any satellite herein may be configured for weather, environmental monitoring, mapping a Fixed-Satellite Service (FSS), an Inter-satellite service, an Earth exploration-satellite service, a Meteorological-satellite service, or any combination thereof.

Any camera herein may consist of, may comprise, or may be based on, a MultiSpectral Scanner (MSS) that may collect data over a plurality of different wavelength ranges, and any capturing of the image herein may comprise along-track scanning, push-broom scanning, across-track scanning, whisk-broom scanning, or any combination thereof, by the scanner. Alternatively or in addition, any camera herein may consist of, may comprise, or may be based on, a Light Detection And Ranging (LIDAR) camera or scanner, Synthetic Aperture Radar (SAR), or a thermal camera that is operative to capture in a visible light, an invisible light, is infrared, ultraviolet, X-rays, gamma rays, or any combination thereof.

Any camera herein may comprise, or may consist of, a Digital Video Camera (DVC) that may produces a video data stream, and any capturing of the image herein may comprise extracting a frame that may comprises the image from the video data stream. Any camera herein, such as any digital video camera herein, may comprise: an optical lens for focusing received light, the lens being mechanically oriented to guide a captured image; a photosensitive image sensor array disposed approximately at an image focal point plane of the optical lens for capturing the image and producing an analog signal representing the image; and an analog-to-digital (A/D) converter coupled to the image sensor array for converting the analog signal to the video data stream. Any image sensor array herein may comprise, may use, or may be based on, semiconductor elements that use the photoelectric or photovoltaic effect. Alternatively or in addition, any image sensor array herein may use, may comprise, or may be based on, Charge-Coupled Devices (CCD) or Complementary Metal-Oxide-Semiconductor Devices (CMOS) elements.

Any digital video camera herein may comprise an image processor coupled to the image sensor array for providing the video data stream according to a digital video format, and any digital video format herein may uses, may be compatible with, or may be based on, TIFF (Tagged Image File Format), RAW format, AVI, DV, MOV, WMV, MP4, DCF (Design Rule for Camera Format), ITU-T H.261, ITU-T H.263, ITU-T H.264, ITU-T CCIR 601, ASF, Exif (Exchangeable Image File Format), DPOF (Digital Print Order Format) standard, or any combination thereof. Any video data stream herein may be in a High-Definition (HD) or Standard-Definition (SD) format, and may be based on, may be compatible with, or may be according to, ISO/IEC 14496 standard, MPEG-4 standard, or ITU-T H.264 standard. Any method herein may be used with a video compressor that may be coupled to the digital video camera for compressing the video data stream, and may perform a compression scheme that may use, or may be based on, intraframe or interframe compression, and lossy or non-lossy compression. Any compression scheme herein may use, may be compatible with, or may be based on, at least one standard compression algorithm which is selected from a group consisting of: JPEG (Joint Photographic Experts Group) and MPEG (Moving Picture Experts Group), ITU-T H.261, ITU-T H.263, ITU-T H.264 and ITU-T CCIR 601. Any video data herein may comprise, or may be based on, an MPEG2 transport stream that may encapsulate H.264 video stream and KLV (Key-Length-Value) encoded telemetries stream. Any video data protocol herein may be according to, or may be based on, an MISB ST 0601.15 standard, published 28 Feb. 2019 by the Motion Imagery Standards Board.

Any of the features herein, such as of the identified features herein, may comprise a structure or shape, corners, edges, regions of interest points, ridges, points, a color, intensity level of a color or of a combination of colors, or any combination thereof.

Any identifying or detecting of any features herein, such as in the captured image or in the selected reference image, may be according to, may use, may be based on, or may consist of, an edge detection algorithm, a corner detection algorithm, a blob detection algorithm, a corner detection algorithm, a ridge detection algorithm, detecting straight-line segments, detecting of the corners, detecting straight-line segments, or any combination thereof. Any identifying or detecting herein may be according to, may be based on, or may consist of, a pattern recognition algorithm, that may be according to, may be based on, or may consist of, a edge detection algorithm, Canny edge detection, Sobel operator, Prewitt operator, Deriche edge detector, RANdom SAmple Consensus (RANSAC), Differential edge detection, Line Segment Detectors (LSD) technique, a Hough transformation, or any combination thereof. Any edge detection algorithm herein may be according to, may be based on, or may use, Apple Quartz™ 2D software application, a first-order derivative expression, second-order derivative expression, a non-linear differential expression, a gradient magnitude, zero-crossing detection, a Gaussian smoothing, or any combination thereof.

Any identifying or detecting herein, such as of any features in any image such as in the captured image or in the selected reference image, may be according to, may use, may be based on, or may consist of, an Artificial Neural Network (ANN), that may be a Feedforward Neural Network (FNN), a Recurrent Neural Network (RNN), a Deep Neural Network (DNN), a Recurrent neural network (RNNs), a Convolutional deep Neural Network (CNNs), an AutoEncoder (AE), a Deep Belief Network (DBN), or a Restricted Boltzmann machine (RBM), a deep convolutional neural network, or any combination thereof, and may be trained to classify a feature or object in the captured image or in the selected reference image. Any ANN herein may comprise at least 3, 4, 5, 7, 10, 15, 20, 25, 30, 35, 40, 45, or 50 layers, or may comprise less than 4, 5, 7, 10, 15, 20, 25, 30, 35, 40, 45, or 50 layers.

Any determining, detecting, localizing, identifying, classifying, or recognizing of one or more dynamic or static features or objects (or any combination thereof) in any image, such as in the first or second image, may use an ANN or any other scheme that may use, may comprise, or may be based on, a Convolutional Neural Network (CNN), or wherein the determining comprises the second image using a CNN. Any object herein may be identified using a single-stage scheme where the CNN is used once, or may be identified using a two-stage scheme where the CNN is used twice. Any determining, detecting, localizing, identifying, classifying, or recognizing of one or more dynamic or static objects (or any combination thereof) in any image, such as in the first or second image, may use an ANN or any other scheme that may use, may comprise, or may be based on, a pre-trained neural network that is publicly available and trained using crowdsourcing for visual object recognition, such as the ImageNet network.

Any determining, detecting, localizing, identifying, classifying, or recognizing of one or more dynamic or static features or objects (or any combination thereof) in any image, such as in the first or second image, may use an ANN or any other scheme that may use, may comprise, or may be based on, an ANN that may be based on extracting features from the image, such as a Visual Geometry Group (VGG)—VGG Net that is VGG16 or VGG19 network or scheme. Any determining, detecting, localizing, identifying, classifying, or recognizing of one or more dynamic or static objects (or any combination thereof) in any image, such as in the first or second image, may use an ANN or any other scheme that may use, may comprise, or may be based on, defining or extracting regions in the image, and feeding the regions to the CNN, such as a Regions with CNN features (R-CNN) network or scheme, that may be Fast R-CNN, Faster R-CNN, or Region Proposal Network (RPN) network or scheme.

Any determining, detecting, localizing, identifying, classifying, or recognizing of one or more dynamic or static features or objects (or any combination thereof) in any image, such as in the first or second image, may use an ANN or any other scheme that may use, may comprise, or may be based on, defining a regression problem to spatially detect separated bounding boxes and their associated classification probabilities in a single evaluation, such as You Only Look Once (YOLO) based object detection, that is based on, or uses, YOLOv1, YOLOv2, or YOLO9000 network or scheme. Any determining, detecting, localizing, identifying, classifying, or recognizing of one or more dynamic or static objects (or any combination thereof) in any image, such as in the first or second image, may use an ANN or any other scheme that may use, may comprise, or may be based on, Feature Pyramid Networks (FPN), Focal Loss, or any combination thereof, and may further be may be using, may be based on, or may be comprising, nearest neighbor upsampling, such as RetinaNet network or scheme

Any determining, detecting, localizing, identifying, classifying, or recognizing of one or more dynamic or static features or objects (or any combination thereof) in any image, such as in the first or second image, may use an ANN or any other scheme that may use, may comprise, or may be based on, Graph Neural Network (GNN) that may process data represented by graph data structures that may capture the dependence of graphs via message passing between the nodes of graphs, such as GraphNet, Graph Convolutional Network (GCN), Graph Attention Network (GAT), or Graph Recurrent Network (GRN) network or scheme. Any determining, detecting, localizing, identifying, classifying, or recognizing of one or more dynamic or static objects (or any combination thereof) in any image, such as in the first or second image, may use an ANN or any other scheme that may use, may comprise, or may be based on, a step of defining or extracting regions in the image, and feeding the regions to the Convolutional Neural Network (CNN), such as MobileNet, MobileNetV1, MobileNetV2, or MobileNetV3 network or scheme. Any determining, detecting, localizing, identifying, classifying, or recognizing of one or more dynamic or static objects (or any combination thereof) in any image, such as in the first or second image, may use an ANN or any other scheme that may use, may comprise, or may be based on, a fully convolutional network, such as U-Net network or scheme.

Any video camera herein may consist of, may comprise, or may be based on, a Light Detection And Ranging (LIDAR) camera or scanner, or Synthetic Aperture Radar (SAR). Alternatively or in addition, any video camera herein may consist of, may comprise, or may be based on, a thermal camera. Alternatively or in addition, any video camera herein may be operative to capture in a visible light. Alternatively or in addition, any video camera herein may be operative to capture in an invisible light, that may be infrared, ultraviolet, X-rays, or gamma rays.

Any dynamic object herein may shift from being in the first state to being in the second state in response to an environmental condition, such as in response to the Earth rotation around its own axis, in response to the Moon orbit around the earth, or in response to the Earth orbit around the Sun. Any environmental condition herein may comprise, or may consist of, a weather change, such as wind change, snowing, temperature change, humidity change, clouding, air pressure change, Sun light intensity and angle, and moisture change.

Any weather change herein may comprise, or may consist of, a wind velocity, a wind density, a wind direction, or a wind energy, and the wind may affect a surface structure or texture. Any dynamic object herein may comprise, may be part of, or may consist of, a sandy area or a dune, and each of the different states herein may include different surface structure or texture change that may comprise, may be part of, or may consist of, sand patches. Alternatively or in addition, any dynamic object herein may comprise, may be part of, or may consist of, a body of water, and any of the different states herein may comprise, may be part of, or may consist of, different sea waves or wind waves. Alternatively or in addition, any weather change herein may comprise, or may consist of, snowing, and any snowing herein may affect a surface structure or texture. Alternatively or in addition, any dynamic object herein may comprise, may be part of, or may consist of, a land area, and wherein each of the different states includes different surface structure or texture change that comprises, is part of, or consists of, snow patches. Alternatively or in addition, any weather change herein may comprise, or may consist of, a temperature change, a humidity change, or a clouding that may affect a viewing of a surface structure or texture. Any environmental condition herein may comprise, or may consist of, a geographical affect such as a tide.

Any dynamic object herein may comprise, may consist of, or may be part of, a vegetation area that includes one or more plants or one or more trees. Any of the states herein may comprise, may consist of, or may be part of, different foliage color, different foliage existence, different foliage density, distinct structure, color, or density of a canopy of the vegetation area. Alternatively or in addition, any vegetation area herein may comprise, may consist of, or may be part of, a forest, a field, a garden, a primeval redwood forests, a coastal mangrove stand, a sphagnum bog, a desert soil crust, a roadside weed patch, a wheat field, a woodland, a cultivated garden, or a lawn. Alternatively or in addition, any dynamic object herein may comprise, may consist of, or may be part of, a man-made object that may shift from being in the first state to being in the second state in response to man-made changes, or image stitching artifacts.

Any dynamic object herein may comprise, may consist of, or may be part of, a land area, such as a sandy area or a dune, and any one of the different states herein may comprise, may be part of, or may consist of, different sand patches. Any dynamic object herein may comprise, may consist of, or may be part of, a body of water, and any one of the different states herein may comprise, may be part of, or may consist of, different sea waves, wing waves, or sea states.

Any dynamic object herein may comprise, may consist of, or may be part of, a movable object or a non-ground attached object, such as a vehicle that is a ground vehicle adapted to travel on land, and any ground vehicle herein may comprise, or may consist of, a bicycle, a car, a motorcycle, a train, an electric scooter, a subway, a train, a trolleybus, or a tram. Alternatively or in addition, any dynamic object herein may comprise, may consist of, or may be part of, a vehicle that is a buoyant watercraft adapted to travel on or in water, such as a ship, a boat, a hovercraft, a sailboat, a yacht, or a submarine. Alternatively or in addition, any dynamic object herein may comprise, may consist of, or may be part of, a vehicle that is an aircraft adapted to fly in air, such as a fixed wing or a rotorcraft aircraft. Any aircraft herein may comprise, may consist of, or may be part of, an airplane, a spacecraft, a drone, a glider, a drone, or an Unmanned Aerial Vehicle (UAV).

Any state herein, such as the first state, may be in a time during a daytime and the second state may be in a time during night-time. Alternatively or in addition, any state herein, such as the first state, may be in a time during a season, and the second state may be in a different season.

Any dynamic object herein may be in the second state a time interval after being in the first state. Any time interval herein may be at least 1 second, 2 seconds, 5 seconds, 10 seconds, 20 seconds, 30 seconds, 1 minute, 2, minutes, 5 minutes, 10 minutes, 20 minutes, 30 minutes, 1 hour, 2 hours, 5 hours, 10 hours, 15 hours, or 24 hours. Alternatively or in addition, any time interval herein may be less than 2 seconds, 5 seconds, 10 seconds, 20 seconds, 30 seconds, 1 minute, 2, minutes, 5 minutes, 10 minutes, 20 minutes, 30 minutes, 1 hour, 2 hours, 5 hours, 10 hours, 15 hours, 24 hours, or 48 hours. Alternatively or in addition, any time interval herein may be at least 1 day, 2 days, 4 days, 1 week, 2 weeks, 3 weeks, or 1 month. Alternatively or in addition, any time interval herein may be less than 2 months, 3 months, 4 months, 6 months, 9 months, 1 year, or 2 years.

Any method herein may be used with a group of objects that may include static objects, and any set of steps herein may comprise, may consist of, or may be part of, a geosynchronization algorithm that may be based on identifying an object from the group in the captured frame.

Any method herein may be used with a location sensor in the vehicle, and may further comprise estimating the current geographical location of the vehicle based on, or by using, the location sensor. Any method herein may be used with multiple RF signals transmitted by multiple sources, and the current location may be estimated by receiving the RF signals from the multiple sources via one or more antennas, and processing or comparing the received RF signals. Any multiple sources herein may comprise satellites that may be part of Global Navigation Satellite System (GNSS). Any GNSS herein may be the Global Positioning System (GPS), and any location sensor herein may comprise a GPS antenna coupled to a GPS receiver for receiving and analyzing the GPS signals. Any GNSS herein may be the GLONASS (GLObal NAvigation Satellite System), the Beidou-1, the Beidou-2, the Galileo, or the IRNSS/VAVIC.

Any one of, or each one of, the objects herein in the group may include, may consist of, or may be part of, a landform that may include, may consist of, or may be part of, a shape or form of a land surface, and the landform may be a natural or an artificial man-made feature of the solid surface of the Earth, or may be associated with vertical or horizontal dimension of a land surface.

Alternatively or in addition, any landform herein may comprise, or may be associated with, elevation, slope, or orientation of a terrain feature. Alternatively or in addition, any landform herein may comprise, may consist of, or may be part of, an erosion landform, and any landform herein may comprise, may consist of, or may be part of, a badlands, a bornhardt, a butte, a canyon, a cave, a cliff, a cryoplanation terrace, a cuesta, a dissected plateau, an erg, an etchplain, an exhumed river channel, a fjord, a flared slope, a flatiron, a gulch, a gully, a hoodoo, a homoclinal ridge, an inselberg, an inverted relief, a lavaka, a limestone pavement, a natural arch, a pediment, a pediplain, a peneplain, a planation surface, potrero, a ridge, a strike ridge, a structural bench, a structural terrace, a tepui, a tessellated pavement, a truncated spur, a tor, a valley, or a wave-cut platform. Alternatively or in addition, any landform herein may comprise, may consist of, or may be part of, a cryogenic erosion landform, such as a cryoplanation terrace, a lithalsa, a nivation hollow, a palsa, a permafrost plateau, a pingo, a rock glacier, or a thermokarst.

Alternatively or in addition, any landform herein may comprise, may consist of, or may be part of, a tectonic erosion landform, such as a dome, a faceted spur, a fault scarp, a graben, a horst, a mid-ocean ridge, a mud volcano, an oceanic trench, a pull-apart basin, a rift valley, or a sand boil. Alternatively or in addition, any landform herein may comprise, may consist of, or may be part of, a Karst landform, such as an abime, a calanque, a cave, a cenote, a foiba, a Karst fenster, a mogote, a polje, a scowle, or a sinkhole. Alternatively or in addition, any landform herein may comprise, may consist of, or may be part of, a mountain and glacial landform, such as an arete, a cirque, a col, a crevasse, a corrie, a cove, a dirt cone, a drumlin, an esker, a fjord, a fluvial terrace, a flyggberg, a glacier, a glacier cave, a glacier foreland, hanging valley, a nill, an inselberg, a kame, a kame delta, a kettle, a moraine, a rogen moraine, a moulin, a mountain, a mountain pass, a mountain range, a nunatak, a proglacial lake, a glacial ice dam, a pyramidal peak, an outwash fan, an outwash plain, a rift valley, a sandur, a side valley, a summit, a trim line, a truncated spur, a tunnel valley, a valley, or an U-shaped valley.

Alternatively or in addition, any landform herein may comprise, may consist of, or may be part of, a volcanic landform, such as a caldera, a cinder cone, a complex volcano, a cryptodome, a cryovolcano, a diatreme, a dike, a fissure vent, a geyser, a guyot, a hornito, a kipuka, mid-ocean ridge, a pit crater, a pyroclastic shield, a resurgent dome, a seamount, a shield volcano, a stratovolcano, a somma volcano, a spatter cone, a lava, a lava dome, a lava coulee, a lava field, a lava lake, a lava spin, a lava tube, a maar, a malpais, a mamelon, a volcanic crater lake, a subglacial mound, a submarine volcano, a supervolcano, a tuff cone, a tuya, a volcanic cone, a volcanic crater, a volcanic dam, a volcanic field, a volcanic group, a volcanic island, a volcanic plateau, a volcanic plug, or a volcano. Alternatively or in addition, any landform herein may comprise, may consist of, or may be part of, a slope-based landform, such as a bluff, a butte, a cliff, a col, a cuesta, a dale, a defile, a dell, a doab, a draw, an escarpment, a plain plateau, a ravine, a ridge, a rock shelter, a saddle; a scree, a solifluction lobes and sheets, a strath, a terrace, a terracette, a vale, a valley, a flat landform, a gully, a hill, a mesa, or a mountain pass.

Any one of, or each one of, the objects herein in the group, may include, may consist of, or may be part of, a natural or an artificial body of water landform or a waterway. Any body of water landform or the waterway landform herein may include, may consists of, or may be part of, a bay, a bight, a bourn, a brook, a creek, a brooklet, a canal, a lake, a river, an ocean, a channel, a delta, a sea, an estuary, a reservoir, a distributary or distributary channel, a drainage basin, a draw, a fjord, a glacier, a glacial pothole, a harbor, an impoundment, an inlet, a kettle, a lagoon, a lick, a mangrove swamp, a marsh, a mill pond, a moat, a mere, an oxbow lake, a phytotelma, a pool, a pond, a puddle, a roadstead, a run, a salt marsh, a sea loch, a seep, a slough, a source, a sound, a spring, a strait, a stream, a streamlet, a rivulet, a swamp, a tarn, a tide pool, a tributary or affluent, a vernal pool, a wadi (or wash), or a wetland.

Any one of, or each one of, the objects herein in the group, may comprise, may consist of, or may be part of, a static object that may comprise, may consist of, or may be part of, a man-made structure, such as a building that is designed for continuous human occupancy, a single-family residential building, a multi-family residential building, an apartment building, semi-detached buildings, an office, a shop, a high-rise apartment block, a housing complex, an educational complex, a hospital complex, or a skyscraper, an office, a hotel, a motel, a residential space, a retail space, a school, a college, an university, an arena, a clinic, or a hospital. Any man-made structure herein may comprise, may consist of, or may be part of, a non-building structure that may not be designed for continuous human occupancy, such as an arena, a bridge, a canal, a carport, a dam, a tower (such as a radio tower), a dock, an infrastructure, a monument, a rail transport, a road, a stadium, a storage tank, a swimming pool, a tower, or a warehouse.

Any wireless communication herein may use, or may be based on, a satellite link that may use X band (8 to 12 GHZ), Ku band (12 to 18 GHZ), or Ka band (27 to 40 GHZ), and further may use a modulation scheme that may comprise Binary phase-shift keying (BPSK), Quadrature phase-shift keying (QPSK), Offset quadrature phase-shift keying (OQPSK), 8PSK, or Quadrature amplitude modulation (QAM), 16QAM, or any combination thereof.

Any method herein may be used with an Artificial Neural Network (ANN) trained to identify and classify the object, and any identifying of the object herein may be based on, or may use, the ANN. Any object herein may be a dynamic object that shifts from being in the first state to being in the second state in response to an environmental condition. Further, any object herein may be a dynamic object that may comprise, may consist of, or may be part of, a vegetation area that includes one or more plants.

All the steps of any method herein may be performed in the vehicle, such as an aerial vehicle, or may be performed external to the vehicle. Any part of steps of any method herein may be performed in the vehicle and any other part of the steps of any method herein may be performed external to the vehicle.

Any method herein may be used with a memory or a non-transitory tangible computer readable storage media for storing computer executable instructions that comprises at least part of the method, and a processor for executing the instructions. A non-transitory computer readable medium may be having computer executable instructions stored thereon, wherein the instructions include the steps of any method herein. Any dynamic object herein may comprise, may consist of, or may be part of, an Earth surface of an area, and any image herein, such as any first or second image herein, may comprise, may consist of, or may be part of, an aerial capture by the video camera of the area. Any method or any set of steps may comprise, may consist of, or may be part of, a geo-synchronization algorithm.

Any executing of any set of steps may be using the captured frame tagging and may comprise ignoring the captured frame of part thereof. Any tagging herein may comprise identifying the part in the captured image that may comprise, or may consist of, any dynamic object. Any executing of any set of steps may be using the captured frame tagging and may comprise ignoring the identified part of the frame. Any tagging herein may comprise generating a metadata to the captured frame. Any generated metadata may comprise the identification of the dynamic object, the type of the dynamic object, or the location of the dynamic object in the captured frame. Any method herein may comprise sending the tagged frame to a computer device.

Any method herein may be used in a vehicle that may comprise a Digital Video Camera (DVC) that produces a video data stream, and may be use with a first server that may include a database that associates geographical location to objects. Any object herein may be a static or dynamic object. Any method herein may comprise obtaining the video data from the video camera; extracting a captured frame that comprises an image from the video stream; identifying an object in the image of the frame; sending an identifier of the identified object to the first server; determining a geographic location of the object by using the database; receiving the geographic location from the first server; and using the received geographic location.

Any method herein may be used with a group of objects that may include the identified object, and any using herein of the geographic location may comprise, may consist of, or may be part of, a geosynchronization algorithm. Any using herein of the geographic location may comprise, may consist of, or may be part of, tagging of the extracted frame, and any tagging herein may comprise generating a metadata to the captured frame. Alternatively or in addition, any using herein of the geographic location may comprise, may consist of, or may be part of, ignoring the identified part of the frame, or sending the received geographic location to a second server, such as over the Internet. Any identifying of the object may be based on, or may use, identifying a feature of the object in the image, and any feature herein may comprise, may consist of, or may be part of, shape, size, texture, boundaries, or color, of the object.

Any digital video camera herein may comprise an optical lens for focusing received light, the lens may be mechanically oriented to guide a captured image; a photosensitive image sensor array that may be disposed approximately at an image focal point plane of the optical lens for capturing the image and producing an analog signal representing the image; and an analog-to-digital (A/D) converter that may be coupled to the image sensor array for converting the analog signal to the video data stream. Any image sensor array herein may comprise, may use, or may be based on, semiconductor elements that use the photoelectric or photovoltaic effect, such as Charge-Coupled Devices (CCD) or Complementary Metal-Oxide-Semiconductor Devices (CMOS) elements.

Any digital video camera herein may comprise an image processor that may be coupled to the image sensor array for providing the video data stream according to a digital video format, which may use, may be compatible with, or may be based on, one of TIFF (Tagged Image File Format), RAW format, AVI, DV, MOV, WMV, MP4, DCF (Design Rule for Camera Format), ITU-T H.261, ITU-T H.263, ITU-T H.264, ITU-T CCIR 601, ASF, Exif (Exchangeable Image File Format), and DPOF (Digital Print Order Format) standards. Further, any video data stream herein may be in a High-Definition (HD) or Standard-Definition (SD) format. Alternatively or in addition, any video data stream herein may be based on, may be compatible with, or may be according to, ISO/IEC 14496 standard, MPEG-4 standard, or ITU-T H.264 standard.

Any method herein may further be used with a video compressor that may be coupled to the digital video camera for compressing the video data stream, and any video compressor herein may perform a compression scheme that may use, or may be based on, intraframe or interframe compression, and any compression herein may be lossy or non-lossy. Further, any compression scheme herein may use, may be compatible with, or may be based on, at least one standard compression algorithm which is selected from a group consisting of: JPEG (Joint Photographic Experts Group) and MPEG (Moving Picture Experts Group), ITU-T H.261, ITU-T H.263, ITU-T H.264 and ITU-T CCIR 601.

All the steps of any method herein may be performed in any vehicle, and may further be used for navigation of the vehicle. Alternatively, all the steps of any method herein may be performed external to the vehicle. Any system herein may further comprise a computer device, and all the steps of any method herein may be performed by the computer device, which may comprises, may consist of, or may be part of, a server device or a client device. Any system or method herein may further be used with a wireless network for communication between any vehicle and any computer device, and any obtaining of the video data may comprise receiving the video data from the vehicle over the wireless network, and may further comprise receiving the video data from the vehicle over the Internet.

Any system herein may further comprise a computer device and a wireless network for communication between the vehicle and the computer device, and any method herein may further comprise sending the tagged frame to a computer device, and the sending of the tagged frame or the obtaining of the video data may comprise sending over the wireless network, which may be over a licensed radio frequency band or may be over an unlicensed radio frequency band, such as an unlicensed radio frequency band is an Industrial, Scientific and Medical (ISM) radio band. Any ISM band herein may comprise, or may consist of, a 2.4 GHz band, a 5.8 GHZ band, a 61 GHz band, a 122 GHZ, or a 244 GHZ.

Any wireless network herein may comprise a Wireless Wide Area Network (WWAN), any wireless transceiver herein may comprise a WWAN transceiver, and any antenna herein may comprise a WWAN antenna. Any WWAN herein may be a wireless broadband network. any WWAN herein may be a WiMAX network, any antenna herein may be a WiMAX antenna and any wireless transceiver herein may be a WiMAX modem, and the WiMAX network may be according to, compatible with, or based on, Institute of Electrical and Electronics Engineers (IEEE) IEEE 802.16-2009. Alternatively or in addition, the WWAN may be a cellular telephone network, any antenna herein may be a cellular antenna, and any wireless transceiver herein may be a cellular modem, where the cellular telephone network may be a Third Generation (3G) network that uses Universal Mobile Telecommunications System (UMTS), Wideband Code Division Multiple Access (W-CDMA) UMTS, High Speed Packet Access (HSPA), UMTS Time-Division Duplexing (TDD), CDMA2000 1×RTT, Evolution-Data Optimized (EV-DO), or Global System for Mobile communications (GSM), Enhanced Data rates for GSM Evolution (EDGE) EDGE-Evolution, or the cellular telephone network may be a Fourth Generation (4G) network that uses Evolved High Speed Packet Access (HSPA+), Mobile Worldwide Interoperability for Microwave Access (WiMAX), Long-Term Evolution (LTE), LTE-Advanced, Mobile Broadband Wireless Access (MBWA), or is based on IEEE 802.20-2008.

Any wireless network herein may comprise a Wireless Personal Area Network (WPAN), any wireless transceiver herein may comprise a WPAN transceiver, and any antenna herein may comprise an WPAN antenna. The WPAN may be according to, compatible with, or based on, Bluetooth™, Bluetooth Low Energy (BLE), or IEEE 802.15.1-2005 standards, or the WPAN may be a wireless control network that may be according to, or may be based on, Zigbee™, IEEE 802.15.4-2003, or Z-Wave™ standards. Any wireless network herein may comprise a Wireless Local Area Network (WLAN), any wireless transceiver herein may comprise a WLAN transceiver, and any antenna herein may comprise a WLAN antenna. The WLAN may be according to, may be compatible with, or may be based on, a standard selected from the group consisting of IEEE 802.11-2012, IEEE 802.11a, IEEE 802.11b, IEEE 802.11g, IEEE 802.11n, and IEEE 802.11ac.

Any wireless network herein may be using, or may be based on, Dedicated Short-Range Communication (DSRC) that may be according to, may be compatible with, or may be based on, European Committee for Standardization (CEN) EN 12253:2004, EN 12795:2002, EN 12834:2002, EN 13372:2004, or EN ISO 14906:2004 standard. Alternatively or in addition, the DSRC may be according to, may be compatible with, or may be based on, IEEE 802.11p, IEEE 1609.1-2006, IEEE 1609.2, IEEE 1609.3, IEEE 1609.4, or IEEE1609.5.

Any non-transitory tangible computer readable storage media herein may comprise a code to perform part of, or whole of, the steps of any method herein. Alternatively or in addition, any device herein may be housed in a single enclosure and may comprise the digital camera, a memory for storing computer-executable instructions, and a processor for executing the instructions, and the processor may be configured by the memory to perform acts comprising part of, or whole of, any method herein. Any apparatus, device, or enclosure herein may be a portable or a hand-held enclosure, and the may be battery-operated, such as a notebook, a laptop computer, a media player, a cellular phone, a Personal Digital Assistant (PDA), or an image processing device. Any method herein may be used with a memory or a non-transitory tangible computer readable storage media for storing computer executable instructions that may comprise at least part of the method, and a processor for executing part of, or all of, the instructions. Any non-transitory computer readable medium may be having computer executable instructions stored thereon, and the instructions may include the steps of any method herein.

Any digital video camera herein may comprise an optical lens for focusing received light, the lens being mechanically oriented to guide a captured image; a photosensitive image sensor array disposed approximately at an image focal point plane of the optical lens for capturing the image and producing an analog signal representing the image; and an analog-to-digital (A/D) converter coupled to the image sensor array for converting the analog signal to the video data stream. Any camera or image sensor array herein may be operative to respond to a visible or non-visible light, and any invisible light herein may be infrared, ultraviolet, X-rays, or gamma rays. Any image sensor array herein may comprise, may use, or may be based on, semiconductor elements that use the photoelectric or photovoltaic effect, such as Charge-Coupled Devices (CCD) or Complementary Metal-Oxide-Semiconductor Devices (CMOS) elements. Any video camera herein may consist of, may comprise, or may be based on, a Light Detection And Ranging (LIDAR) camera or scanner, Synthetic Aperture Radar (SAR), or a thermal camera.

Any digital video camera herein may further comprise an image processor coupled to the image sensor array for providing the video data stream according to a digital video format, which may use, may be compatible with, may be according to, or may be based on, TIFF (Tagged Image File Format), RAW format, AVI, DV, MOV, WMV, MP4, DCF (Design Rule for Camera Format), ITU-T H.261, ITU-T H.263, ITU-T H.264, ITU-T CCIR 601, ASF, Exif (Exchangeable Image File Format), or DPOF (Digital Print Order Format) standard. Further, any video data stream herein may be in a High-Definition (HD) or Standard-Definition (SD) format. Alternatively or in addition, any video data stream herein may be based on, may be compatible with, or may be according to, ISO/IEC 14496 standard, MPEG-4 standard, or ITU-T H.264 standard.

Any method herein may be used with a video compressor coupled to the digital video camera for compressing the video data stream, and any video compressor herein may perform a compression scheme that may uses, or may be based on, intraframe or interframe compression, and wherein the compression is lossy or non-lossy. Further, any compression scheme herein may use, may be compatible with, or may be based on, at least one standard compression algorithm which is selected from a group consisting of: JPEG (Joint Photographic Experts Group) and MPEG (Moving Picture Experts Group), ITU-T H.261, ITU-T H.263, ITU-T H.264 and ITU-T CCIR 601.

A method may be used with a ground station that may wirelessly communicate with an aerial vehicle. Any aerial vehicle herein may include a camera that may be positioned to capture images of the Earth surface. Any method herein may comprise: capturing, by the camera in the aerial vehicle, a first image of an Earth surface; capturing, by the camera in the aerial vehicle, a second image of an Earth surface; identifying, in the aerial vehicle, an overlapping region in the first and second images; forming, in the aerial vehicle, a third image by cropping the region from the second image; sending, by the aerial vehicle to the ground station over the wireless communication, the first and third images; receiving, by ground station from the aerial vehicle over the wireless communication, the first and third images; identifying, in the ground station, the region in the first image; and forming, in the ground station, the second image by stitching the region from the first image into the third image. Any two images herein, such as the first and second images, may be captured at different times, using different poses of the camera, or any combination thereof. Alternatively or in addition, any two images herein, such as the first and second images, may be different due to the Erath rotation, the aerial vehicle movement, or any combination thereof. Any method herein may further comprise forming, in the ground station, a combined image by stitching the first and third images based on, or using, the overlapping region. Any camera herein may consist of, may comprise, or may be based on, a MultiSpectral Scanner (MSS) that collects data over a plurality of different wavelength ranges, and any image capturing herein, such as the capturing of the first or second image, may comprises scanning by the scanner.

Any camera herein may comprise, or may consist of, a Digital Video Camera (DVC) that may produce a video data stream. Any capturing of any image herein, such as the capturing of the first image, may comprise extracting a first frame that may comprise the first image from the video data stream, and the capturing of the second image, may comprise extracting a second frame that may comprise the second image from the video data stream. the area of the identified overlapping region may be at least 0.01%, 0.02%, 0.05%, 0.1%, 0.2%, 0.5%, 1%, 2%, 5%, 10%, 20%, or 50% of the area of the first or second image, or may be less than 0.02%, 0.05%, 0.1%, 0.2%, 0.5%, 1%, 2%, 5%, 10%, 20%, 50%, or 75% of the area of the captured image.

Any identified region herein, such as the overlapping region, may be polygon shaped, and any method herein may further comprise: sending, by the aerial vehicle to the ground station over the wireless communication, multiple locations or data on the perimeter of the polygon in the first or second image; and receiving, by the ground station from the aerial vehicle over the wireless communication, the multiple locations or data on the perimeter of the polygon in the first or second image. Alternatively or in addition, any method herein may further comprise: sending, by the aerial vehicle to the ground station over the wireless communication, multiple locations of corners or sides of the polygon in the first or second image; and receiving, by the ground station from the aerial vehicle over the wireless communication, the multiple locations of corners or sides of the polygon in the first or second image. Any polygon or region herein may comprise a triangle, a quadrilateral, a rectangle, a square, a pentagon, a hexagon, Equiangular polygon, a Regular polygon, an Equilateral polygon, a Cyclic polygon, a Tangential polygon, an Isotoxal polygon, or any combination thereof. Alternatively or in addition, any polygon or region herein may be shaped as a circle or as an ellipsis.

Any identifying herein of any region, such as the overlapping region, may use or comprise applying a spatial-based and/or intensity-based Digital Image Correlation (DIC) technique, that may comprise comparing pixels, or group of pixels, intensities in the first and second images. Any DIC technique herein may comprise performing phase correlation and estimating relative offset between the compared first and second images, and any comparing herein may comprise comparing frequency-domain representations of the first and second images. Any method or comparing herein may comprises, may use, or may be based on, forming frequency-domain representations of the first and second images using Fast Fourier Transform (FFT). Alternatively or in addition, any identifying herein of any region, such as the overlapping region, may use or may comprise identifying, in the aerial vehicle, a first set of points in the first image; identifying, in the aerial vehicle, a second set of points in the second image; comparing, in the aerial vehicle, the first and second sets to find matching points; and identifying the region based on, or using, the matched points.

Any matched points herein may be included in the overlapping region, on the perimeter of the overlapping region, or may define the corners or edges of the overlapping region. Any method herein may be used with multiple features descriptor sets, and at least some points of the first or second set may be features that may be identified using the multiple features descriptor sets. Any feature herein, or each of the features in the points or in multiple features descriptor sets, may comprise, may consist of, or may be part of, shape, size, texture, boundaries, or color, of an object. Alternatively or in addition, any feature herein, or each of the features in the points or in multiple features descriptor sets, may comprise, may consist of, or may be part of, a landform that includes, consists of, or is part of, a shape or form of a land surface, a static object., a dynamic object that may shift from being in the first state to being in the second state in response to an environmental condition, a vegetation area that may include one or more plants, a man-made object that may shift from being in the first state to being in the second state in response to man-made changes, a land area, a movable object or a non-ground attached object, or any combination thereof.

Alternatively or in addition, any identifying herein of any region, such as the overlapping region, may use, may comprise, may be based on, or may consists of, an edge detection algorithm, a corner detection algorithm, a blob detection algorithm, a ridge detection algorithm, Scale-Invariant Feature Transform (SIFT), Speeded-Up Robust Features (SURF), Features from Accelerated Segment Test (FAST), a detecting straight-line segments, a Line Segment Detectors (LSD) technique, a Hough transformation, an edge detection algorithm, Canny edge detection, Sobel operator, Prewitt operator, Deriche edge detector, RANdom SAmple Consensus (RANSAC), Differential edge detection, Apple Quartz™ 2D software application, a first-order derivative expression, second-order derivative expression, a non-linear differential expression, a gradient magnitude, zero-crossing detection, or a Gaussian smoothing, or any combination thereof.

Alternatively or in addition, any identifying herein of any region, such as the overlapping region, may use, may comprise, may be based on, or may consists of, an Artificial Neural Network (ANN), that may comprise, may use, may be based on, or may consist of, a Feedforward Neural Network (FNN), Deep Neural Network (DNN), a Recurrent neural network (RNNs), a Convolutional deep Neural Network (CNNs), an AutoEncoder (AE), a Deep Belief Network (DBN), or a Restricted Boltzmann machine (RBM), Recurrent Neural Network (RNN), or a deep convolutional neural network, the ANN may comprise at least 3, 4, 5, 7, 10, 15, 20, 25, 30, 35, 40, 45, or 50 layers, or the ANN may comprise less than 4, 5, 7, 10, 15, 20, 25, 30, 35, 40, 45, or 50 layers.

Any computer or any single enclosure herein may be a hand-held enclosure or a portable enclosure, or may be a surface mountable enclosure. Further, any device or enclosure herein may consist or, may comprise, or may be part of, at least one of a wireless device, a notebook computer, a laptop computer, a media player, a Digital Still Camera (DSC), a Digital video Camera (DVC or digital camcorder), a Personal Digital Assistant (PDA), a cellular telephone, a digital camera, a video recorder, or a smartphone. Furthermore, any device or enclosure herein may consist or, may comprise, or may be part of, a smartphone that comprises, or is based on, an Apple iPhone 6 or a Samsung Galaxy S6. Any method herein may comprise operating of an operating system that may be a mobile operating system, such as Android version 2.2 (Froyo), Android version 2.3 (Gingerbread), Android version 4.0 (Ice Cream Sandwich), Android Version 4.2 (Jelly Bean), Android version 4.4 (KitKat)), Apple IOS version 3, Apple IOS version 4, Apple iOS version 5, Apple IOS version 6, Apple IOS version 7, Microsoft Windows® Phone version 7, Microsoft Windows® Phone version 8, Microsoft Windows® Phone version 9, or Blackberry® operating system. Alternatively or in addition, any operating system may be a Real-Time Operating System (RTOS), such as FreeRTOS, SafeRTOS, QNX, VxWorks, or Micro-Controller Operating Systems (μC/OS).

Video files that are received from aerial platforms may incorporate telemetries stream describing the position, orientation, or motion of the aircraft and camera, for the purpose of status report and control over the equipment by remote operator. The correlation between the two information sources, namely visual and telemetries, may be utilized. Visual may be visible light video, other bandwidth video (IR, thermal, radio imaging, CAT scan, etc.), Synthetic Aperture Radar (SAR), ELOP imagery (LIDAR, SONAR, RADAR etc.). Telemetry may include any information regarding the visual source state, such as its position, speed, acceleration, or temperature. The correlated information may include changes to the video source, camera position, camera velocity, camera acceleration, FOV (Field of View) or Zoom, payload operation (such as moving from one camera to another or moving from visible to IR sensor), satellite navigation system (such as GPS) reception level, ambient light level, wind speed (such as identifying wind gusts from movement of trees in the captured video), or vibrations.

A tangible machine-readable medium (such as a storage) may have a set of instructions detailing part (or all) of the methods and steps described herein stored thereon, so that when executed by one or more processors, may cause the one or more processors to perform part of, or all of, the methods and steps described herein. Any of the network elements may be a computing device that comprises a processor and a computer-readable memory (or any other tangible machine-readable medium), and the computer-readable memory may comprise computer-readable instructions such that, when read by the processor, the instructions causes the processor to perform the one or more of the methods or steps described herein. A non-transitory computer readable medium may contain computer instructions that, when executed by a computer processor, may cause the processor to perform at least part of the steps described herein.

The above summary is not an exhaustive list of all aspects of the present invention. Indeed, it is contemplated that the invention includes all systems and methods that can be practiced from all suitable combinations and derivatives of the various aspects summarized above, as well as those disclosed in the detailed description below and particularly pointed out in the claims filed with the application. Such combinations have particular advantages not specifically recited in the above summary.

### BRIEF DESCRIPTION OF THE DRAWINGS

The invention is herein described, by way of non-limiting examples only, with reference to the accompanying drawings, wherein like designations denote like elements. Understanding that these drawings only provide information concerning typical embodiments and are not therefore to be considered limiting in scope:

FIG. 1 schematically illustrates a simplified schematic block diagram of a prior-art digital camera;

FIG. 2 pictorially depicts definitions of an aircraft axes and motion around the axes;

FIG. 3 pictorially depicts overviews of a quadcopter and a fixed wing UAV;

FIG. 4 schematically illustrates a simplified schematic block diagram of a quadcopter;

FIG. 5 schematically illustrates a simplified schematic block diagram of a satellite;

FIG. 6 schematically illustrates a block diagram of an example of a feed-forward Artificial Neural Network (ANN);

FIG. 6a schematically illustrates a schematic diagram of examples of a Deep Neural Network (DNN);

FIG. 7a pictorially depicts an overview of an aerial photography using a quadcopter;

FIG. 7b pictorially depicts an image captured by a camera in a quadcopter performing an aerial photography;

FIG. 8 schematically illustrates a simplified flow-chart of Geo-synchronization of a captured image without sending the image;

FIG. 8a schematically illustrates a simplified flow-chart of Geo-synchronization of a video camera captured image using a geo-location service without sending the image;

FIGS. 9 and 9a schematically illustrate a simplified flow-chart of Geo-synchronization of a region in an image without sending the image;

FIG. 10 pictorially depicts various surface textures of sand patches;

FIG. 11 pictorially depicts various surface textures of wind waves and high sea states;

FIG. 12 pictorially depicts various surface textures of swell and low sea states;

FIG. 13 pictorially depicts an aerial image with marked identified region and the cropped region;

FIG. 14 pictorially depict two aerial images with overlapping region;

FIG. 14a pictorially depicts a combined image from the two aerial images with overlapping region;

FIG. 14b pictorially depicts an image without an overlapping region; and

FIG. 15 schematically illustrates a simplified flow-chart of identifying overlapping region in two images and sending the overlapping region only as part of one of the images.

### DETAILED DESCRIPTION

The principles and operation of an apparatus or a method according to the present invention may be understood with reference to the figures and the accompanying description wherein identical or similar components (either hardware or software) appearing in different figures are denoted by identical reference numerals. The drawings and descriptions are conceptual only. In actual practice, a single component can implement one or more functions; alternatively or in addition, each function can be implemented by a plurality of components and devices. In the figures and descriptions, identical reference numerals indicate those components that are common to different embodiments or configurations. Identical numerical references (in some cases, even in the case of using different suffix, such as 5, 5a, 5b and 5c) refer to functions or actual devices that are either identical, substantially similar, similar, or having similar functionality. It is readily understood that the components of the present invention, as generally described and illustrated in the figures herein, could be arranged and designed in a wide variety of different configurations. Thus, the following more detailed description of the embodiments of the apparatus, system, and method of the present invention, as represented in the figures herein, is not intended to limit the scope of the invention, as claimed, but is merely representative of embodiments of the invention. It is to be understood that the singular forms “a”, “an”, and “the” herein include plural referents unless the context clearly dictates otherwise. Thus, for example, a reference to “a component surface” includes a reference to one or more of such surfaces. By the term “substantially” it is meant that the recited characteristic, parameter, feature, or value need not be achieved exactly, but that deviations or variations, including, for example, tolerances, measurement error, measurement accuracy limitations and other factors known to those of skill in the art, may occur in amounts that do not preclude the effect the characteristic was intended to provide.

All directional references used herein (e.g., upper, lower, upwards, downwards, left, right, leftward, rightward, top, bottom, above, below, vertical, horizontal, clockwise, and counterclockwise, etc.) are only used for identification purposes to aid the reader's understanding of the present invention, and do not create limitations, particularly as to the position, orientation, or use of the invention. Spatially relative terms, such as “inner,” “outer,” “beneath”, “below”, “right”, “left”, “upper”, “lower”, “above”, “front”, “rear”, “left”, “right” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

All directional references used herein (e.g., upper, lower, upwards, downwards, left, right, leftward, rightward, top, bottom, above, below, vertical, horizontal, clockwise, and counterclockwise, etc.) are only used for identification purposes to aid the reader's understanding of the present invention, and do not create limitations, particularly as to the position, orientation, or use of the invention.

Geo-synchronization, also referred to as ‘Georeferencing’, generally refers to associate something with locations in physical space. It relates to associating the internal coordinate system of a map or aerial photo image with a ground system of geographic coordinates. The relevant coordinate transforms are typically stored within the image file (GeoPDF and GeoTIFF are examples), though there are many possible mechanisms for implementing Georeferencing. In one example, the term may be used in the geographic information systems field to describe the process of associating a physical map or raster image of a map with spatial locations. Georeferencing may be applied to any kind of object or structure that can be related to a geographical location, such as points of interest, roads, places, bridges, or buildings. Geographic locations are most commonly represented using a coordinate reference system, which in turn can be related to a geodetic reference system such as WGS-84. Examples include establishing the correct position of an aerial photograph within a map or finding the geographical coordinates of a place name or street address (Geocoding). Georeferencing is crucial to making aerial and satellite imagery, usually raster images, useful for mapping as it explains how other data, such as the above GPS points, relate to the imagery.

Very essential information may be contained in data or images that were produced at a different point of time. The latter can be used to analyze the changes in the features under study over a period of time. Using Geo-referencing methods, data obtained from surveying tools like total stations may be given a point of reference from topographic maps already available. In one example, a Geo-synchronization may be used to analyze an aerial image captured by a camera, such as the camera 10, in an airborne device, such as the quadcopter 30a or the fixed wing UAV 30b. As the images are captured at high altitudes and from a moving and rotating craft, an improved Geo-synchronization algorithm need to be used to improve the accuracy and the increase the algorithm success.

Various applications, ranging from map creation tools to navigation systems, employ methods introduced by the domain of georeferencing, which investigates techniques for uniquely identifying geographical objects. An overview of ongoing challenges of the georeferencing domain by presenting, classifying and exploring the field and its relevant methods and applications is disclosed in an article by Hackelocer, A.; Klasing. K.; Krisp, J. M.; Meng. L. (2014) entitled: “Georeferencing: a review of methods and applications”, published 2014 in Annals of GIS. 20(1): 61-69 [doi:10.1080/19475683.2013.868826], which is incorporated in its entirety for all purposes as if fully set forth herein.

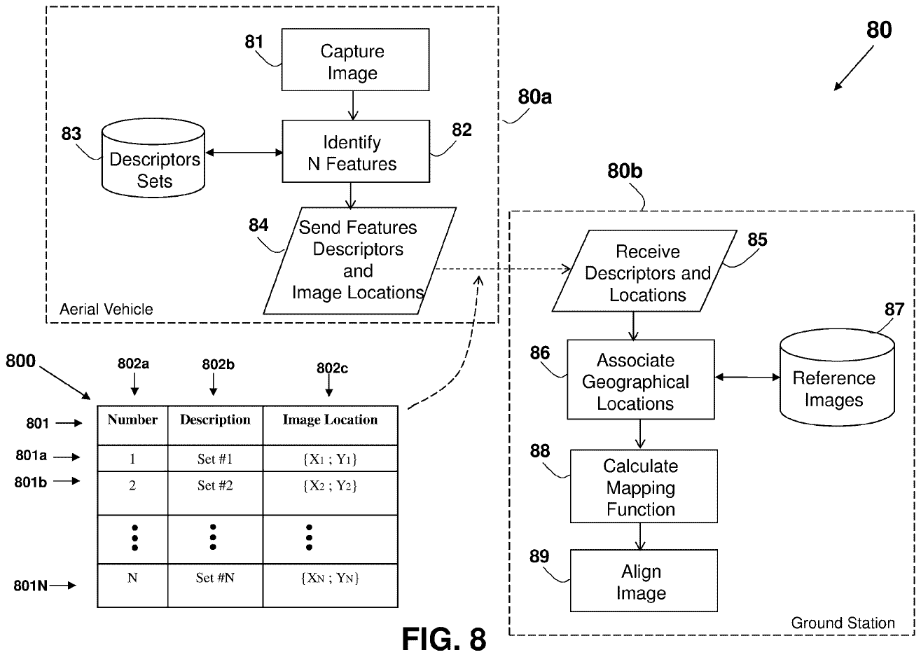

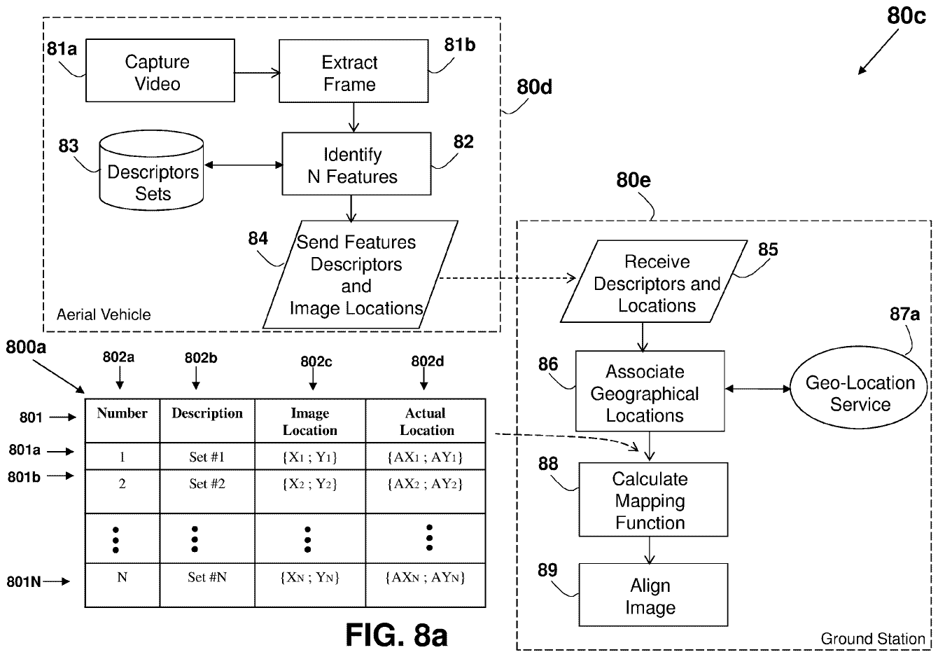

A Geo-synchronization method of an aerial vehicle, or of an image captured therein, is exampled in a flow chart 80 shown in FIG. 8. The method is based on executing part of the geo-synchronization process, shown as sub flow-chart 80a, by the aerial vehicle, and on executing another part of the geo-synchronization process, shown as sub flow-chart 80b, in a ground station or in any location other than the aerial vehicle itself. Another example of a Geo-synchronization method of an aerial vehicle is exampled in a flow chart 80c shown in FIG. 8a, and similarly includes executing part of the geo-synchronization process, shown as sub flow-chart 80d, by the aerial vehicle, and on executing another part of the geo-synchronization process, shown as sub flow-chart 80e, in a ground station or in any location other than the aerial vehicle itself.

As used herein, the term “aerial vehicle” includes any airborne device or vehicle that is designed or adapted to fly, to be transported or carried, or to travel through the air, or may stay in air, such as a fixed wing or a rotorcraft aircraft, an airplane, a spacecraft, an helicopter, an airship, a drone, a balloon (such as hot air balloon), a glider, a drone, or an Unmanned Aerial Vehicle (UAV). Further, any aerial vehicle herein may consist of, may include, or may be part of, a satellite that is configured to move in a Geocentric orbit, or may be configured to be in a Low Earth orbit (LEO), a Medium Earth orbit (MEO), or a High Earth orbit (HEO). Such a satellite may be used for providing a fixed satellite service, a mobile satellite service, a scientific research satellite, weather, environmental monitoring, mapping, may be an Earth observation satellite that is configured for an Earth observation (EO), or any combination thereof. The satellite may be a geosynchronous satellite in a Geosynchronous orbit (GEO), or may be configured for a Fixed-Satellite Service (FSS), an Inter-satellite service, an Earth exploration-satellite service, a Meteorological-satellite service, or any combination thereof. Further, any aerial vehicle herein may comprise, or may consist of, an Unmanned Aerial Vehicle (UAV), that may be a fixed-wing aircraft or a rotary-wing aircraft. Further, any UAV herein may comprise, may consist of, or may be part of, a quadcopter, hexcopter, or octocopter, and may be configured for aerial photography.

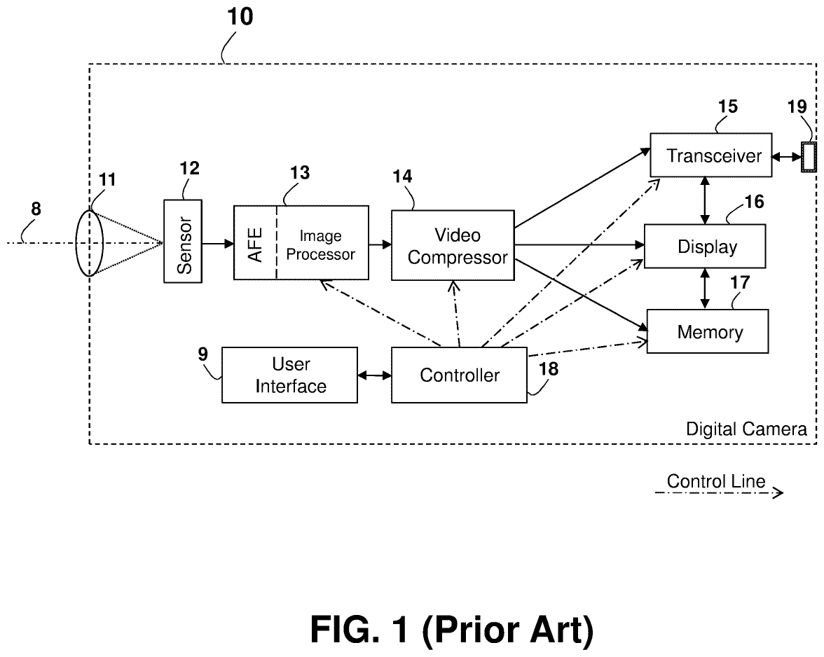

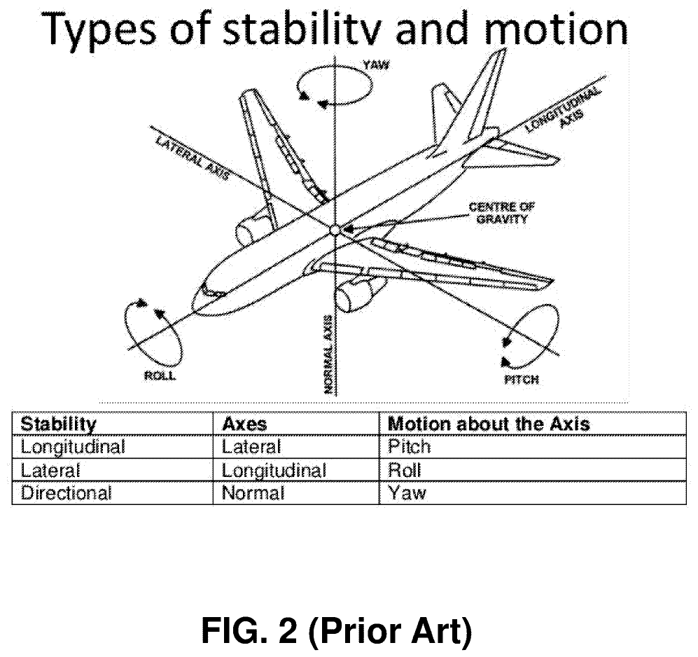

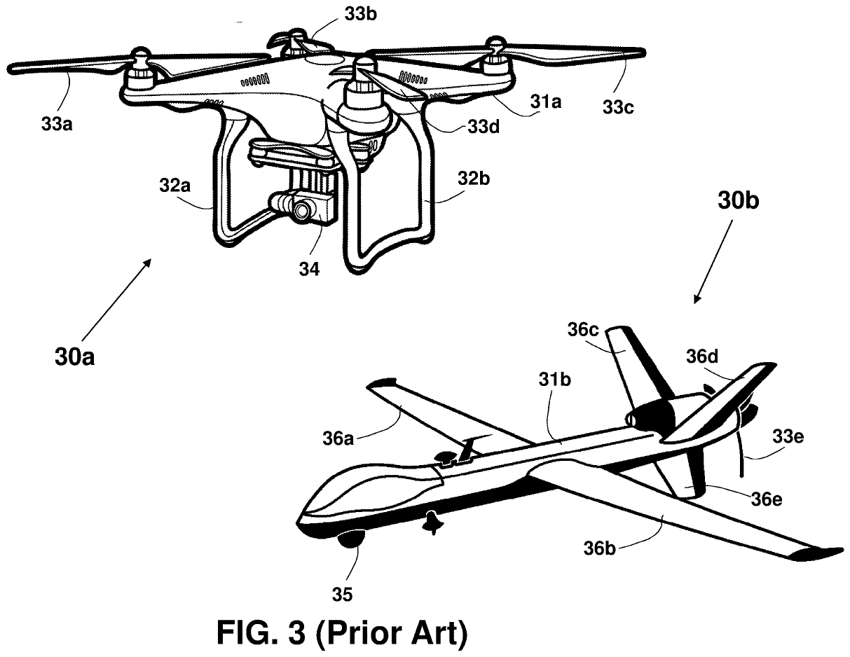

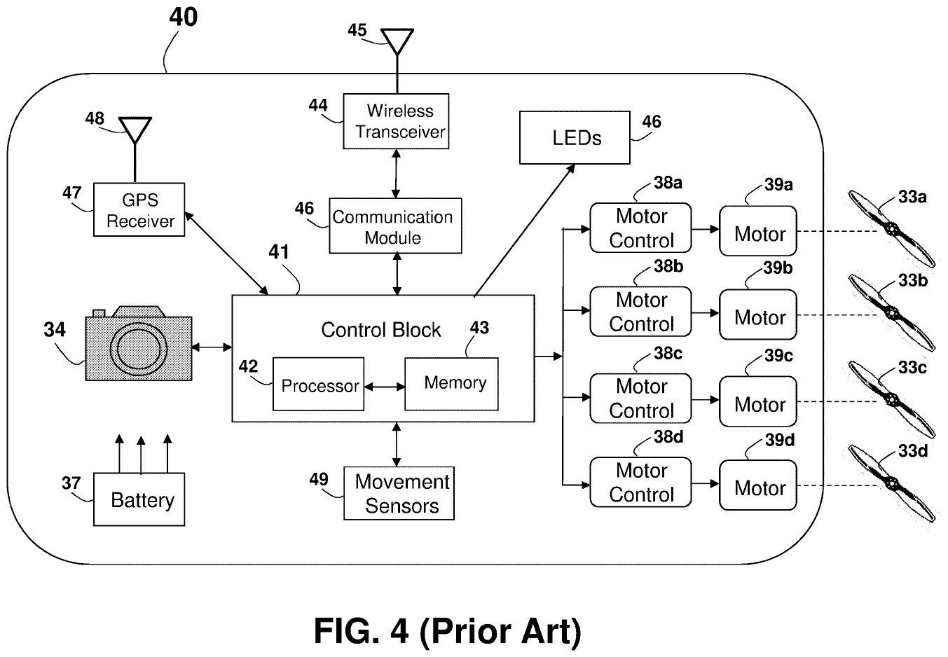

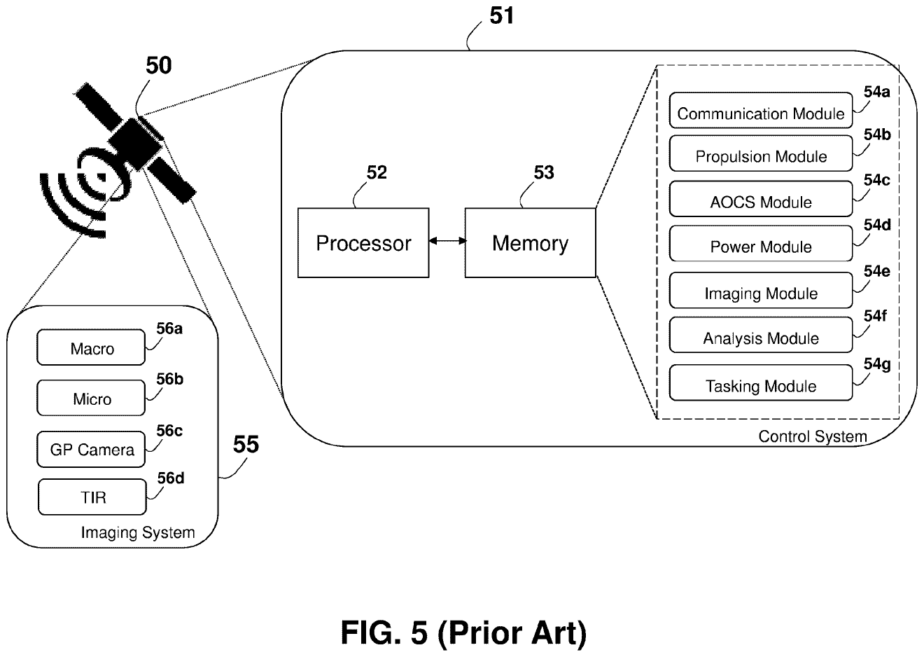

Using an aerial vehicle on-board camera, such as the camera 10 shown in FIG. 1, the camera 34 shown in FIGS. 3 and 4, or the imaging system 55 shown in FIG. 5, an image is captured as part of a “Capture Image” step 81. The camera may be an optical-based imaging video camera that is operative to capture images or scenes in a visible or non-visible spectrum, or may equally use a LiDAR camera or scanner or Synthetic Aperture Radar (SAR), as well as thermal camera, as a substitute to the still or video camera 34.

In one example, the aerial vehicle on-board camera comprises a scanner, and the image is captured as part of the “Capture Image” step 81 using a scanning system that employs a sensor with a narrow field of view (i.e., IFOV) that sweeps over the terrain to build up and produce a two-dimensional image of the surface. Such a scanning system that is used to collect data over a variety of different wavelength ranges is called a MultiSpectral Scanner (MSS), and is the most commonly used scanning system. There are two main modes or methods of scanning employed to acquire multispectral image data-across-track scanning, and along-track scanning.

Across-track scanners, referred to also as whiskbroom scanners, scan the Earth in a series of lines, where the lines are oriented perpendicular to the direction of motion of the sensor platform (i.e., across the swath). Each line is scanned from one side of the sensor to the other, using a rotating mirror. As the platform moves forward over the Earth, successive scans build up a two-dimensional image of the Earth's surface. So, the Earth is scanned point by point and line after line. The incoming reflected or emitted radiation is separated into several spectral components that are detected independently. A bank of internal detectors, each sensitive to a specific range of wavelengths, detects and measures the energy for each spectral band and then, as an electrical signal, they are converted to digital data and recorded for subsequent computer processing. The IFOV of the sensor and the altitude of the platform determine the ground resolution cell viewed, and thus the spatial resolution. The angular field of view is the sweep of the mirror, measured in degrees, used to record a scan line, and determines the width of the imaged swath. Airborne scanners typically sweep large angles (between 90° and 120°), while satellites, because of their higher altitude need only to sweep fairly small angles (10-20°) to cover a broad region. Because the distance from the sensor to the target increases towards the edges of the swath, the ground resolution cells also become larger and introduce geometric distortions to the images. Also, the length of time the IFOV “sees” a ground resolution cell as the rotating mirror scans (called the dwell time), is generally quite short and influences the design of the spatial, spectral, and radiometric resolution of the sensor.

Along-track scanners also use the forward motion of the platform to record successive scan lines and buildup a two-dimensional image, perpendicular to the flight direction (FIG. 5c). However, instead of a scanning mirror, they use a linear array of detectors (so-called charge-coupled devices, CCDs) located at the focal plane of the image formed by lens systems, which are “pushed” along in the flight track direction (i.e., along track). These systems are also referred to as push broom scanners, as the motion of the detector array is analogous to a broom being pushed along a floor. A separate linear array is required to measure each spectral band or channel. For each scan line, the energy detected by each detector of each linear array is sampled electronically and digitally recorded

Along-track scanners with linear arrays have several advantages over across-track mirror scanners. The array of detectors combined with the pushbroom motion allows each detector to “see” and measure the energy from each ground resolution cell for a longer period of time (dwell time). This allows more energy to be detected and improves the radiometric resolution. The increased dwell time also facilitates smaller IFOVs and narrower bandwidths for each detector. Thus, finer spatial and spectral resolution can be achieved without impacting radiometric resolution. Because detectors are usually solid-state microelectronic devices, they are generally smaller, lighter, require less power, and are more reliable and last longer because they have no moving parts. On the other hand, cross-calibrating thousands of detectors to achieve uniform sensitivity across the array is necessary and complicated.

An overview of these schemes that may be used to acquire digital images directly from an airborne platform is described in a paper by Prof. Gordon Petrie entitled: “Airborne Pushbroom Line Scan—An Alternative to Digital Frame Cameras”, published January/February 2005 issue of GeoInformatics, which is incorporated in its entirety for all purposes as if fully set forth herein. As the name suggests, these frame cameras use areal (square or rectangular) arrays of CCD or CMOS detectors to record individual frame images of the ground for mapping purposes. The main alternative airborne digital imaging technology uses linear arrays of detectors allied to a pushbroom mode of operation that utilizes the forward motion of the airborne platform to sweep out a continuous strip image of the ground. The aim of this new article is to present an overview of this alternative digital imaging technology. by

Regardless of whether the scanning system used is either of these two types, it has several advantages over photographic systems. The spectral range of photographic systems is restricted to the visible and near-infrared regions while MSS systems can extend this range into the thermal infrared. They are also capable of much higher spectral resolution than photographic systems. Multi-band or multispectral photographic systems use separate lens systems to acquire each spectral band. This may cause problems in ensuring that the different bands are comparable both spatially and radiometrically and with registration of the multiple images. MSS systems acquire all spectral bands simultaneously through the same optical system to alleviate these problems. Photographic systems record the energy detected by means of a photochemical process which is difficult to measure and to make consistent. Because MSS data are recorded electronically, it is easier to determine the specific amount of energy measured, and they can record over a greater range of values in a digital format. Photographic systems require a continuous supply of film and processing on the ground after the photos have been taken. The digital recording in MSS systems facilitates transmission of data to receiving stations on the ground and immediate processing of data in a computer environment.

In one example, the camera is a video camera that captures video as part of a “Capture video” step 81a, and extracts a single frame as an image to process as part of a “Extract Frame” step 81b, as described in the flow chart 80d shown in FIG. 8a. Since the analysis is on an image that consists of, or is part of an extracted frame on a frame-by-frame basis, a single frame is extracted from the received video stream as part of the “Extract Frame” step 81b.

Descriptors sets are stored in a database or memory 83 in the aerial vehicle, and are used to identify N features in the captured image as part of an “Identify N Features” step 82. An example of a data structure or table 800 that includes the results of the features identifying as part of the “Identify N Features” step 82 is shown in FIG. 8. A first row 801 identifies the various columns, where a first column 802a ‘Number’ includes a serial number of the identified feature, ranging from 1 to N (1, 2, . . . . N), a second column 802b ‘Description’ includes the applicable descriptors set for the respective feature, obtained from the Descriptors Sets database 83, and a third column 802c ‘Image Location’ includes the location of the respective feature in the captured image, such as in a form of {Xᵢ; Yᵢ}, where ‘i’ ranges from 1 to N (1, 2, . . . . N). A first row 801a relates to a first feature ‘1’, identified by a descriptor set ‘Set #1’ and located at location {X₁; Y₁} in the captured image. Similarly, a second row 801b relates to a second feature ‘2’, identified by a descriptor set ‘Set #2’ and located at location {X₂; Y₂} in the captured image, and a Nth row 801N relates to a last (Nth) feature ‘N’, identified by a descriptor set ‘Set #N’ and located at location {X_{N}; Y_{N}} in the captured image.

The amount ‘N’ of the features that are identified as part of the “Identify N Features” step 82 and included in the table 800 may be at least 2, 3, 4, 5, 6, 7, 8, 10, 12, 15, 20, 25, 30, 50, 80, 100, 120, 150, 200, 500, 1,000, 2,000, 5,000, or 10,000 features, or may be less than 3, 4, 5, 8, 10, 12, 15, 20, 25, 30, 50, 80, 100, 120, 150, 200, 500, 1,000, 2,000, 5,000, 10,000 or 20,000 features. In one example, one of, few of, most of, or all of, the identified features comprise a structure or shape, such as corners, edges, regions of interest points, ridges, points, or any combination thereof. Alternatively or in addition, one of, few of, most of, or all of, the identified features comprise a color, or an intensity level of a color or of a combination of colors.

The table 800 is sent to the ground station as part of a “Send Features Descriptors and Image Locations” step 84, and is received by the ground station as part of a “Receive Descriptors and Locations” step 85, which is part of the flow-chart 80b. It is noted that in this example, the captured image itself is not sent to the ground station, but only the table 800, thus off-loading the size of the data sent from the aerial vehicle to the ground station, thus requiring and using much lower bandwidth for the communication between the aerial vehicle and the ground station.

Multiple images that may correspond to the captured image, such as aerial images captured by other aerial vehicles in other times, of the same or close geographic location, may be stored in a database “Reference Images” 87. In one example, these reference images have already been accurately geosynchronized. Using the received descriptor sets 802b associated with the descriptor sets 802b of the table 800, the features identified as part of the “Identify N Features” step 82 are identified in a reference image selected from the database 87 as part of an “Associate Geographical Locations” step 86. In one example, the same algorithm, process, or technique used for features identifying as part of the “Identify N Features” step 82 is used for locating the same features in the reference image as part of the “Associate Geographical Locations” step 86. Alternatively or in addition, the “Associate Geographical Locations” step 86 uses similar or different algorithm, process, or technique than the features identifying as part of the “Identify N Features” step 82. Any geographical location or position on Earth herein may be represented as Latitude and Longitude values, according to World Geodetic System (WGS) 84, or using UTM zones.

In one example, as part of the “Associate Geographical Locations” step 86, a new column 802d ‘Actual Location’ is added to the table 800 to form a table 800a shown in FIG. 8a. The added column 802d associates an actual geographical location {AXᵢ; AYᵢ} on Earth to each of the identified features. For example, an actual geographical location {AX₁; AY₁} is associated with features #1 as part of the first row 801a, an actual geographical location {AX₂; AY₂} is associated with features #2 as part of the second row 801b, and an actual geographical location {AX_{N}; AY_{N}} is associated with features #N as part of the Nth row 801N.

In one example, the geosynchronization involves a mapping function that maps an actual geographical location {AXᵢ; AYᵢ} on Earth to any location in the captured image {Xᵢ; Yᵢ}, such as f {Xᵢ; Yᵢ}→{AXᵢ; AYᵢ}. Such mapping function may be calculated as part of a “Calculate Mapping Function” step 88, allowing for using of the calculated mapping function for alignment of the captured image as part of a “Align Image” step 89.

In one example, the mapping unction calculated as part of the “Calculate Mapping Function” step 88, may be used as part of the “Align Image” step 89 for a determining or estimating the aerial vehicle location and/or the camera pose when the image was captured as part of the “Capture Image” step 81. In one example, the determining or estimating the aerial vehicle location and/or the camera pose may use, or may be based on, a system and method for estimating the geographical location at which image data was captured with a camera, as described in U.S. Pat. No. 9,501,699 to Kim et al. entitled: “Systems and methods for estimating the geographic location at which image data was captured”, which is incorporated in its entirety for all purposes as if fully set forth herein. The method identifies matching feature points between the captured images, estimates a pose of the camera during the image capture from the feature points, performs geometric reconstruction of a scene in the images using the estimated pose of the camera to obtain a reconstructed scene, and compares the reconstructed scene to overhead images of known geographical origin to identify potential matches.

Alternatively or in addition, the determining or estimating the aerial vehicle location and/or the camera pose may use, or may be based on, a method for determining a pose of a camera includes obtaining both a first image of a scene and a second image of the scene where both the first and second images are captured by the camera, as described in U.S. Pat. No. 9,984,301 to dos Santos Mendonca entitled: “Non-matching feature-based visual motion estimation for pose determination”, which is incorporated in its entirety for all purposes as if fully set forth herein. A first set of features is extracted from the first image and a second set of features is extracted from the second set of features. The method includes calculating a value of a visual-motion parameter based on the first set of features and the second set of features without matching features of the first set with features of the second set. The method also includes determining the pose of the camera based, at least, on the value of the visual motion parameter.

Alternatively or in addition, the determining or estimating the aerial vehicle location and/or the camera pose may use, or may be based on, a method and apparatus for estimating the position and attitude of an aerial vehicle transiting over terrain through a combination of steps combining image registration and the inherent image coordinate system of the camera, as described in U.S. Pat. No. 10,515,458 to Yakimenko et al. entitled: “Image-matching navigation method and apparatus for aerial vehicles”, which is incorporated in its entirety for all purposes as if fully set forth herein. The aerial vehicle captures an image of the terrain and extracts features from the camera image and pre-existing aerial imagery, and determines a perspective transform between the images. Image reference points are projected with the 2D perspective transform and an elevation map provides estimated 3D coordinates of the image reference points. Subsequently a camera position and orientation necessary for the camera to obtain the initial camera image is determined by projecting reference points with locations defined by the image coordinate system of the camera to define terrain points, and conducting an optimization to minimize displacements between the estimated coordinates and the terrain coordinates. The estimated camera position provides a location and attitude for the aerial vehicle.

The calculating of a mapping function as part of the “Calculate Mapping Function” step 88 may use any process of constructing a curve or a mathematical function that best (or exactly) fits the mapping of the locations in the captured image {Xᵢ; Yᵢ} to the actual geographical locations {AXᵢ; AYᵢ} on Earth, such as curve fitting. Such curve fitting may use interpolation or smoothing, as well as regression analysis. Typically, a curve fitting method is based on minimizing least squares deviation, where the sum of squares of the residuals is minimized. The curve fitting may fit into a polynomial equation such as a first degree (linear function-straight line), a second degree, or a third degree, polynomial functions. In some cases, trigonometric functions such as sine or cosine may be used. Curve fitting is described in a paper as part of CGN 3421—Computer Methods by Gurley entitled: “Numerical Methods Lecture 5—Curve Fitting Techniques”, downloaded from the Internet on July 2022, which is incorporated in its entirety for all purposes as if fully set forth herein.

The sets of descriptors in the “Descriptors Sets” database 83 comprise descriptions of the visual features of the contents in the captured images, that produce such descriptions. They describe elementary characteristics such as the shape, the color, the texture or the motion, among others. Such visual descriptors are divided in two main groups: General information descriptors that contain low level descriptors which give a description about color, shape, regions, textures and motion, and specific domain information descriptors that give information about objects and events in the scene. A concrete example would be face recognition. In one example, the sets of descriptors in the “Descriptors Sets” database 83 may be according to, compatible with, or based on, Moving Picture Experts Group (MPEG)-7 (MPEG-7) standard ISO/IEC 15938 (Multimedia content description interface).

The descriptors may consist of a set of descriptors that covers different basic and elementary features like: color, texture, shape, motion, location and others. Color is the most basic quality of visual content, and typically five tools are defined to describe color. The three first tools represent the color distribution and the last ones describe the color relation between sequences or group of images: Dominant color descriptor (DCD); Scalable color descriptor (SCD); Color structure descriptor (CSD); Color layout descriptor (CLD); and Group of frame (GoF) or group-of-pictures (GoP). Texture is an important quality in order to describe an image, and related descriptors characterize image textures or regions. They observe the region homogeneity and the histograms of these region borders. The set of descriptors is formed by Homogeneous texture descriptor (HTD); Texture browsing descriptor (TBD); and Edge histogram descriptor (EHD). Shape contains important semantic information due to human's ability to recognize objects through their shape. However, this information can only be extracted by means of a segmentation similar to the one that the human visual system implements. There exists a serial of algorithms which are considered to be a good approximation. These descriptors describe regions, contours and shapes for 2D images and for 3D volumes, such as Region-based shape descriptor (RSD); Contour-based shape descriptor (CSD); and 3-D shape descriptor (3-D SD).

Motion is defined by four different descriptors which describe motion in video sequence. Motion is related to the objects motion in the sequence and to the camera motion as is provided by the capture device, whereas the rest is implemented by means of image processing. The descriptor set includes Motion activity descriptor (MAD); Camera motion descriptor (CMD); Motion trajectory descriptor (MTD); and Warping and parametric motion descriptor (WMD and PMD). Elements' location in the image is used to describe elements in the spatial domain. And may be located in the temporal domain using Region locator descriptor (RLD) and Spatio temporal locator descriptor (STLD). Specific domain information descriptors provide information about objects and events in the scene, are not easily extractable, even more when the extraction is to be automatically done. A face recognition is a concrete example of an application that tries to automatically obtain this information.

The Reference Images database 87 may include a local repository of georeferenced images, and may receive, and may respond to, inputs and queries as part of the “Associate Geographical Locations” step 86. Alternatively or in addition, the geosynchronized reference images are remotely stored such as over the Internet, shown as a “Geo-Location Service” database 87a shown as part of the flow chart 80e in FIG. 8a. For example, georeference data points that encompass GIS locations may be obtained from many sources such as United States Geological Survey's (USGS) survey reference points and georeferenced images, city public works databases, and Continuously Operating Reference Stations (CORS). Further, such map repositories may be provided as a service over the Internet such as Google Earth™ (by Google®), Virtual Earth™ (by Microsoft®), TerraServer® (by TerraServer®), ArcGIS by Esri (Environmental Systems Research Institute), and the like. ArcGIS is a family of client software, server software, and online Geographic Information System (GIS) services developed and maintained by Esri (Environmental Systems Research Institute), headquartered in Redlands, California. ArcGIS Pro works in 2D and 3D for cartography and visualization, and includes Artificial Intelligence (AI). Esri also provides server side ArcGIS software for web maps, known as ArcGIS Server.

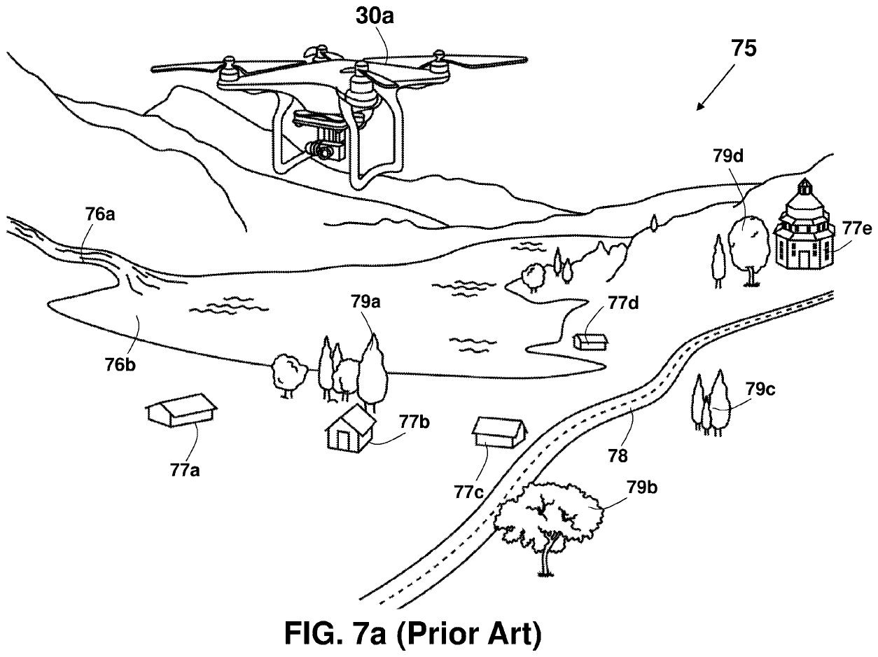

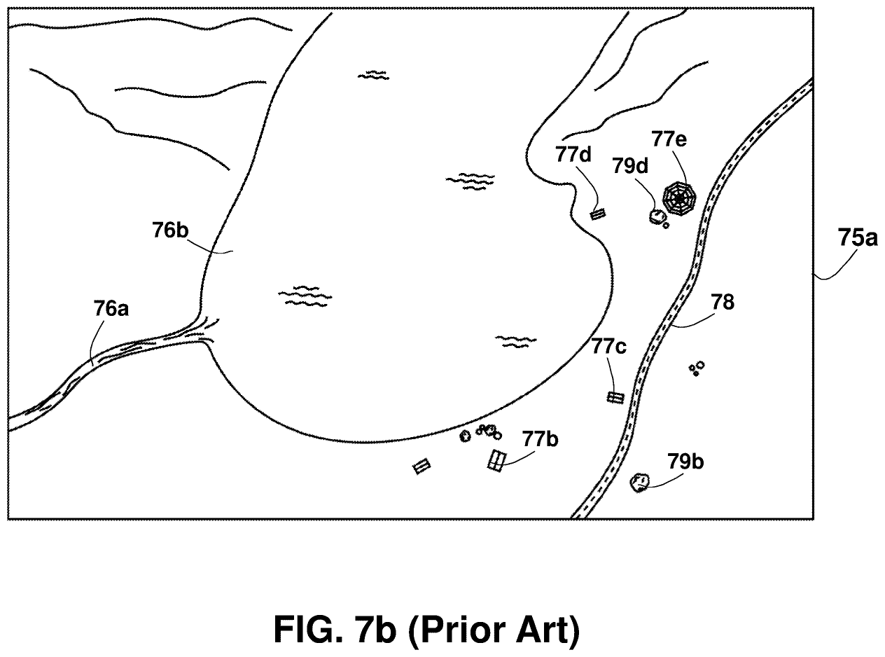

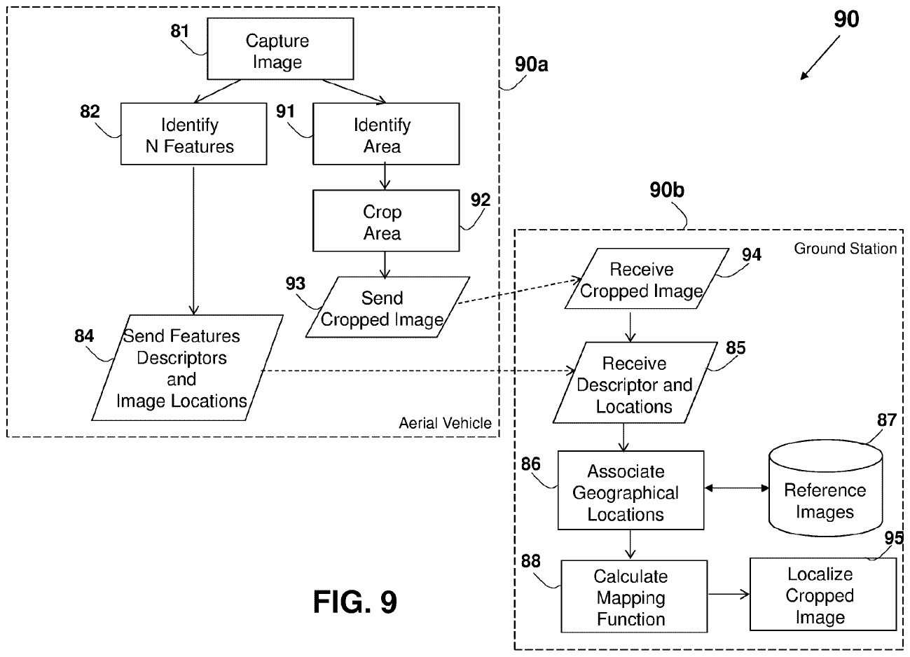

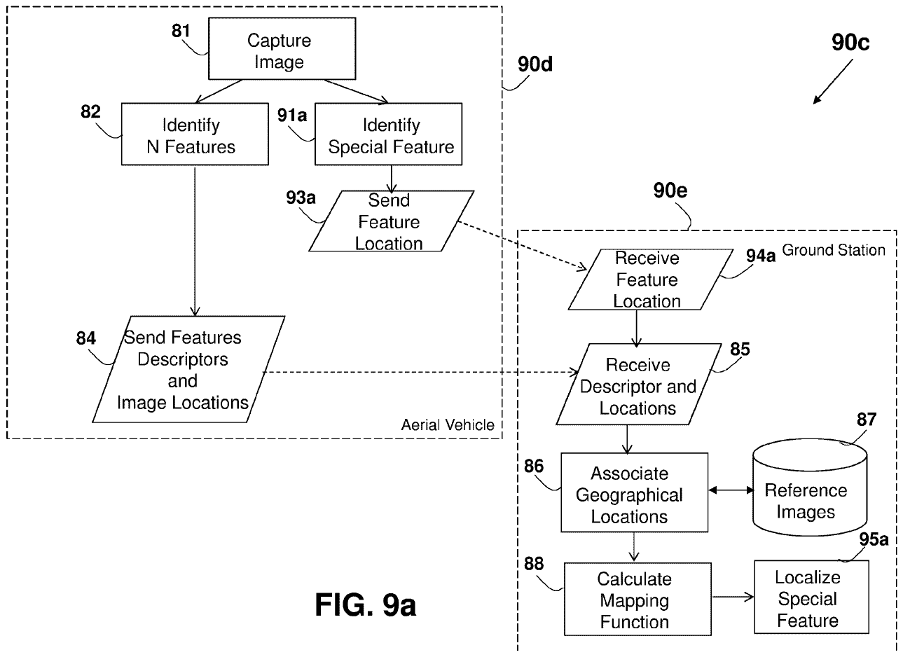

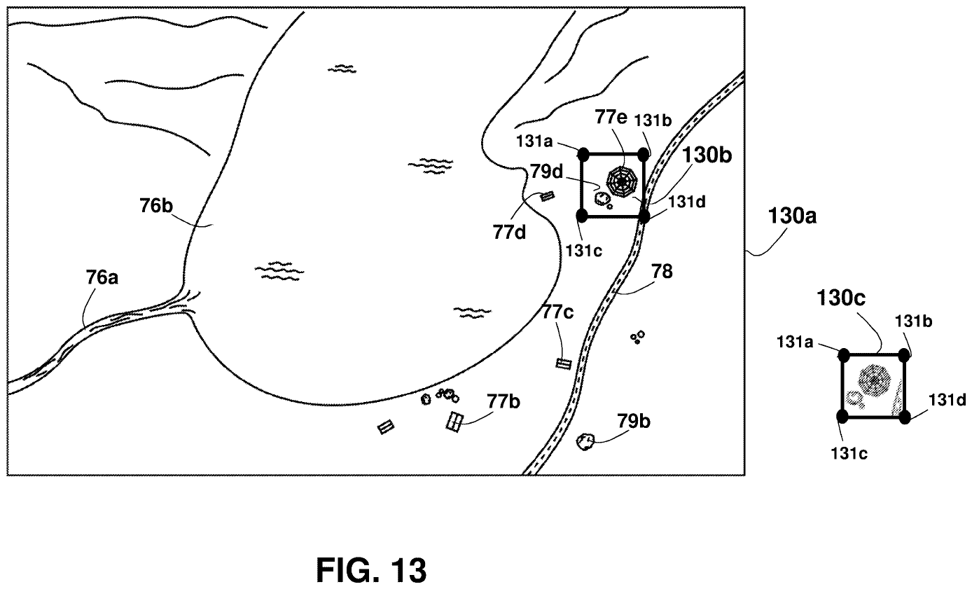

A flow chart 90 shown in FIG. 9 may be used for geosynchronizing of an area (such as a region) in an aerial image based on the flow chart 80 shown in FIG. 8. Similar to the flow chart 80, the method is based on executing part of the geo-synchronization process, shown as a sub flow-chart 90a, by the aerial vehicle, and on executing another part of the geo-synchronization process, shown as a sub flow-chart 90b, in a ground station or in any location other than the aerial vehicle itself. In addition to the identifying of the N features (that may be associated with the Descriptors Sets database 83) as part of the “Identify N Features” step 82, a specific area or region in the captured image is identified as part of an “Identify Area” step 91. The area or region may be identified using a descriptor set that is part of the sets stored in the Descriptors Sets database 83, or may be identified using a separate, distinct, or different criterion. In one example, a square region 130b is shown in an aerial image 130a (shown in FIG. 13) that corresponds to the aerial image 75a shown in FIG. 7b, and includes the building object 77e and the tree 79d. In one example, the identified region, such as the region 130b in FIG. 13 may be identified or referred to using the four corners of the square 130b, that are designated as points 131a, 131b, 131c, and 131d in the aerial image 130a. For example, the four corner points 131a, 131b, 131c, and 131d may be respectively associated with the locations {X′₁;Y′₁}, {X′₂;Y′₂}, {X′3; Y′₃}, and {X′₄;Y′₄}. As part of a “Crop Arca” step 92, the region or area identified as part of the “Identify Area” step 91 is cropped from the total captured image. In the example shown in FIG. 13, a region 130c shows the identified region 130b after being cropped from the captured aerial image 130a.

The cropped image is sent by the aerial vehicle as part of a “Send Cropped Image” step 93, and is received by the ground station as part of a “Receive Cropped Image” step 94. In one example, it is only the cropped image that is sent, while the captured image itself is not sent. Sending only part of the image, rather the full image, requires much less bandwidth and processing time and/or power, thus better utilizing the communication (and processing power) between the aerial vehicle and the ground station, or alternatively allows for proper geosynchronization while using less bandwidth and/or processing power or time. In the example, shown in FIG. 13, the cropped region 130c is less than 5% of the total image 130a, hence requiring only 5% of the time or bandwidth for sending from the aerial vehicle to the ground station.

The area or region identified as part of the “Identify Area” step 91 or cropped as part of the “Crop Arca” step 92 may be of any shape. In one example, the region may be a polygon that is described by a finite number of straight line segments connected to form a closed polygonal chain (or polygonal circuit). The segments of a polygonal circuit are called its edges or sides, and the points where two edges meet are the polygon's vertices (singular: vertex) or corners. For example, the polygon may be a triangle having 3 sides, a quadrilateral having 4 sides (such as a square or a rectangle), a pentagon having 5 sides, or a hexagon having 6 sides. The polygon may be Equiangular where all corner angles are equal, may be Equilateral where all edges are of the same length, may be Regular (both equilateral and equiangular), may be Cyclic where all corners lie on a single circle, called the circumcircle, may be Tangential, where all sides are tangent to an inscribed circle, may be Isogonal or vertex-transitive, where all corners lie within the same symmetry orbit. The polygon is also cyclic and equiangular, or may be Isotoxal or edge-transitive where all sides lie within the same symmetry orbit. Similarly, the shape of the cropped area may be a circular or ellipsoid based.

The size of the area or region that is identified as part of the “Identify Area” step 91 or cropped as part of the “Crop Area” step 92 may be more than 0.01%, 0.02%, 0.05%, 0.1%, 0.2%, 0.5%, 1%, 2%, 5%, 10%, 20%, or 50% of the size of the area of the whole of the captured image. Further, the size of the area or region that is identified as part of the “Identify Area” step 91 or cropped as part of the “Crop Area” step 92 may be less than 0.02%, 0.05%, 0.1%, 0.2%, 0.5%, 1%, 2%, 5%, 10%, 20%, 50%, or 75% of the size of the area of the whole of the captured image.

After calculating the mapping function as part of the “Calculate Mapping Function” step 88, the cropped region that was received by the ground station as part of the “Receive Cropped Image” step 94, may be geosynchronized using the mapping function. Any point (or multiple points) in the cropped image may be represented as actual geographical location by using the mapping function to map from the point location in the image to the geographical coordinated using the mapping function. The points selected for the geosynchronization may be located at the perimeter of the cropped region. For example, in case of a polygon-shaped area, the cropped region may be geosynchronized by applying the mapping function to the image locations of the polygon edges or corners. In the example shown in FIG. 13, the mapping function may be applied to the four corners points of the cropped image square 130c, forming four actual geographical coordinates of the four corners, such as {AX′₁;AY′₁}; {AX′₂;AY′₂}; {AX′₃;AY′₃} and {AX′₄;AY′₄}, where {AX′₁;AY′₁}=f({X′₁;Y′₁}), {AX′₂;AY′₂}=f({X′₂;Y′₂}), {AX′₃;AY′₃}=f({X′₃;Y′₃}), and {AX′₄;AY′₄}=f({X′₄;Y′₄}).

A flow chart 90c shown in FIG. 9a may be used for geosynchronizing of a feature (that may be an object) in an aerial image based on the flow chart 80 shown in FIG. 8. Similar to the flow chart 80, the method is based on executing part of the geo-synchronization process, shown as a sub flow-chart 90d, by the aerial vehicle, and on executing another part of the geo-synchronization process, shown as a sub flow-chart 90e, in a ground station or in any location other than the aerial vehicle itself. In addition to the identifying of the N features (that may be associated with the Descriptors Sets database 83) as part of the “Identify N Features” step 82, another specific feature in the captured image is identified as part of an “Identify Special Feature” step 91a. The special feature may be identified using a descriptor set that is part of the sets stored in the Descriptors Sets database 83, or may be identified using a separate, distinct, or different criterion. The special feature may be located at a location {X′ⱼ;Y′ⱼ} in the image. The location of the feature identified as part of the “Identify Special Feature” step 91a, is sent by the aerial vehicle as part of a “Send Feature Location” step 93a, and is received by the ground station as part of a “Receive Feature Location” step 94a. After calculating the mapping function as part of the “Calculate Mapping Function” step 88, the special feature may be geosynchronized using the mapping function, as part of a “Localize Special Feature” step 95a. For example, the special feature geographical coordinates may be calculated as {AX′ⱼ;AY′ⱼ}=f({X′ⱼ;Y′ⱼ}).

Some of the elements shown in an image captured by an aerial photography may be static objects, which image in the aerial captured image is deemed not to change over time. For example, the aerial view of man-made structures, such as buildings, bridges, or roads, are generally not supposed to change over time, with the exception of aging and deterioration. A building, or edifice, is a structure with a roof and walls standing more or less permanently in one place, such as a house or factory. Buildings come in a variety of sizes, shapes, and functions, and have been adapted throughout history for a wide number of factors, from building materials available, to weather conditions, land prices, ground conditions, specific uses, and aesthetic reasons. In general, buildings are designed and constructed to last for a long time, and to substantially withstand weather conditions and aging. In one example, one or more of the features identified as part of the “Identify N Features” step 82 include static objects.

A building, or edifice, is a structure with a roof and walls standing more or less permanently in one place, such as a house or factory. Buildings come in a variety of sizes, shapes, and functions, and have been adapted throughout history for a wide number of factors, from building materials available, to weather conditions, land prices, ground conditions, specific uses, and aesthetic reasons. Buildings serve several societal needs-primarily as shelter from weather, security, living space, privacy, to store belongings, and to comfortably live and work. A building as a shelter represents a physical division of the human habitat (a place of comfort and safety) and the outside (a place that at times may be harsh and harmful).

Single-family residential buildings are most often called houses or homes. Multi-family residential buildings containing more than one dwelling unit are sometimes referred to as a duplex or an apartment building. A condominium is an apartment that the occupant owns rather than rents. Houses may also be built in pairs (semi-detached), in terraces where all but two of the houses have others either side; apartments may be built round courtyards or as rectangular blocks surrounded by a piece of ground of varying sizes. Houses that were built as a single dwelling may later be divided into apartments or bedsitters; they may also be converted to another use e.g., an office or a shop.

Building types may range from huts to multimillion-dollar high-rise apartment blocks able to house thousands of people. Increasing settlement density in buildings (and smaller distances between buildings) is usually a response to high ground prices resulting from many people wanting to live close to work or similar attractors. Other common building materials are brick, concrete or combinations of either of these with stone. Sometimes a group of inter-related (and possibly inter-connected) builds are referred to as a complex—for example a housing complex, educational complex, hospital complex, etc.

A skyscraper is a continuously habitable high-rise building that has over 40 floors and is taller than 150 m (492 ft). Skyscrapers may host offices, hotels, residential spaces, and retail spaces. One common feature of skyscrapers is having a steel framework that supports curtain walls. These curtain walls either bear on the framework below or are suspended from the framework above, rather than resting on load-bearing walls of conventional construction. Some early skyscrapers have a steel frame that enables the construction of load-bearing walls taller than of those made of reinforced concrete. Buildings may be dedicated for specific uses, for example as religious places, such as churches, mosques, or synagogues. Other building may be used for educational purposes such as schools, colleges, and universities, and other may be used for healthcare, such as clinics and hospitals. In additional, buildings may be used for hospitality, such as hotels and motels.

Static objects may further include non-building structures, that include any structure, body, or system of connected parts, used to support a load that was not designed for continuous human occupancy, such as an arena, a bridge, a canal, a carport, a dam, a tower (such as a radio tower), a dock, an infrastructure, a monument, a rail transport, a road, a stadium, a storage tank, a swimming pool, a tower, or a warehouse.

An arena is a large enclosed platform, often circular or oval-shaped, designed to showcase theatre, musical performances, or sporting events, and are usually designed to accommodate a multitude of spectators. It is composed of a large open space surrounded on most or all sides by tiered seating for spectators, and may be covered by a roof. The key feature of an arena is that the event space is the lowest point, allowing maximum visibility. An arena may be a soccer or football field.

A bridge is a structure built to span a physical obstacle, such as a body of water, valley, or road, without closing the way underneath, and can be thought of as an artificial version of a river. It is constructed for the purpose of providing passage over the obstacle, usually something that is otherwise difficult or impossible to cross. There are many different designs that each serve a particular purpose and apply to different situations. Canals are waterways channels, or artificial waterways, for water conveyance, or to service water transport vehicles. In most cases, the engineered works will have a series of dams and locks that create reservoirs of low speed current flow. These reservoirs are referred to as slack water levels, and are often just called levels.

A carport is a covered structure used to offer limited protection to vehicles, primarily cars, from rain and snow, and its structure may either be free standing, or be attached to a wall. Unlike most structures, a carport does not need to have four walls, and usually has one or two. Carports offer less protection than garages but allow for more ventilation. In particular, a carport prevents frost on the windshield.

A dam is a barrier that stops or restricts the flow of water or underground streams. Reservoirs created by dams not only suppress floods but also provide water for activities such as irrigation, human consumption, industrial use, aquaculture, and navigability. Hydropower is often used in conjunction with dams to generate electricity. A dam can also be used to collect water or for storage of water which can be evenly distributed between locations. Dams generally serve the primary purpose of retaining water, while other structures such as floodgates or levees (also known as dikes) are used to manage or prevent water flow into specific land regions.

Radio masts and typically, towers are, tall structures designed to support antennas for telecommunications and broadcasting, including television. There are two main types: guyed and self-supporting structures. They are among the tallest human-made structures. Masts are often named after the broadcasting organizations that originally built them or currently use them. A dock is the area of water between or next to one or a group of human-made structures that are involved in the handling of boats or ships (usually on or near a shore) or such structures themselves. “Dock” may also refer to a dockyard (also known as a shipyard) where the loading, unloading, building, or repairing of ships occurs.

An infrastructure is the set of fundamental facilities and systems serving a country, city, or other area, including the services and facilities necessary for its economy to function. Infrastructure is composed of public and private physical structures such as roads, railways, bridges, tunnels, water supply, sewers, electrical grids, and telecommunications (including Internet connectivity and broadband speeds). In general, it has also been defined as the physical components of interrelated systems providing commodities and services essential to enable, sustain, or enhance societal living conditions. There are two general types of ways to view infrastructure: hard and soft. Hard infrastructure refers to the physical networks necessary for the functioning of a modern industry, such as roads, bridges, or railways. Soft infrastructure refers to all the institutions that maintain the economic, health, social, and cultural standards of a country, such as educational programs, official statistics, parks and recreational facilities, law enforcement agencies, and emergency services.

A monument is a type of structure that was explicitly created to commemorate a person or event, or which has become relevant to a social group as a part of their remembrance of historic times or cultural heritage, due to its artistic, historical, political, technical or architectural importance. Examples of monuments include statues, (war) memorials, historical buildings, archaeological sites, and cultural assets. Rail transport (also known as train transport) is a means of transferring passengers and goods on wheeled vehicles running on rails, which are located on tracks. In contrast to road transport, where vehicles run on a prepared flat surface, rail vehicles (rolling stock) are directionally guided by the tracks on which they run. Tracks usually consist of steel rails, installed on ties (sleepers) set in ballast, on which the rolling stock, usually fitted with metal wheels, moves. Other variations are also possible, such as slab track. This is where the rails are fastened to a concrete foundation resting on a prepared subsurface.

A road is a thoroughfare, route, or way on land between two places that has been paved or otherwise improved to allow travel by foot or by some form of conveyance (including a motor vehicle, cart, bicycle, or horse). Roads consist of one or two roadways, each with one or more lanes and any associated sidewalks, and road verges. A bike path refers to a road for use by bicycles, which may or may not be parallel other roads. Other names for a road include: parkway; avenue; freeway, motorway or expressway; tollway; interstate; highway; thoroughfare; or primary, secondary, and tertiary local road. A stadium (plural stadiums or stadia) is a place or venue for (mostly) outdoor sports, concerts, or other events and consists of a field or stage either partly or completely surrounded by a tiered structure designed to allow spectators to stand or sit and view the event.

Storage tanks are artificial containers that hold liquids, compressed gases or mediums used for the short- or long-term storage of heat or cold. The term can be used for reservoirs (artificial lakes and ponds), and for manufactured containers. A swimming pool, swimming bath, wading pool, paddling pool, or simply a pool is a structure designed to hold water to enable swimming or other leisure activities. Pools can be built into the ground (in-ground pools) or built above ground (as a freestanding construction or as part of a building or other larger structure). In-ground pools are most commonly constructed from materials such as concrete, natural stone, metal, plastic, or fiberglass, and can be of a custom size and shape or built to a standardized size, the largest of which is the Olympic-size swimming pool.

A tower is a tall structure, taller than it is wide, often by a significant factor. Towers are distinguished from masts by their lack of guy-wires and are therefore, along with tall buildings, self-supporting structures. Towers are specifically distinguished from “buildings” in that they are not built to be habitable but to serve other functions. The principal function is the use of their height to enable various functions to be achieved including: visibility of other features attached to the tower such as clock towers; as part of a larger structure or device to increase the visibility of the surroundings for defensive purposes as in a fortified building such as a castle; as a structure for observation for leisure purposes; or as a structure for telecommunication purposes. Towers can be stand-alone structures or be supported by adjacent buildings or can be a feature on top of a large structure or building.

A warehouse is building for storing goods. Warehouses are used by manufacturers, importers, exporters, wholesalers, transport businesses, and customs. They are usually large plain buildings in industrial parks on the outskirts of cities, towns or villages. They usually have loading docks to load and unload goods from trucks. Sometimes warehouses are designed for the loading and unloading of goods directly from railways, airports, or seaports. They often have cranes and forklifts for moving goods, which are usually placed on ISO standard pallets loaded into pallet racks. Stored goods may include any raw materials, packing materials, spare parts, components, or finished goods associated with agriculture, manufacturing, and production.

Some of the elements shown in an image captured by an aerial photography may be non-static or dynamic objects, which image in the aerial captured image is expected to change over time. For example, a dynamic object may include an object that is affected by changing environmental conditions, such as an aerial view of area affected by various weather conditions, such as a wind.

The time-depending nature of the dynamic objects results in that these objects may look different in time from the aerial photography point of view. For example, a dynamic object may be in multiple states at different times, and shown as different images according to the different states. These different states and the corresponding changing images of dynamic objects may impose a challenge to most geosynchronization schemes. In one example, one or more of the features identified as part of the “Identify N Features” step 82 include static objects.

Wind refers to the flow of gases on a large scale, such as a bulk movement of air. Winds are commonly classified by their spatial scale, their speed, types of forces that cause them, the affected regions, and their effect. Winds have various aspects: velocity (wind speed); the density of the gas involved; and energy content or wind energy.

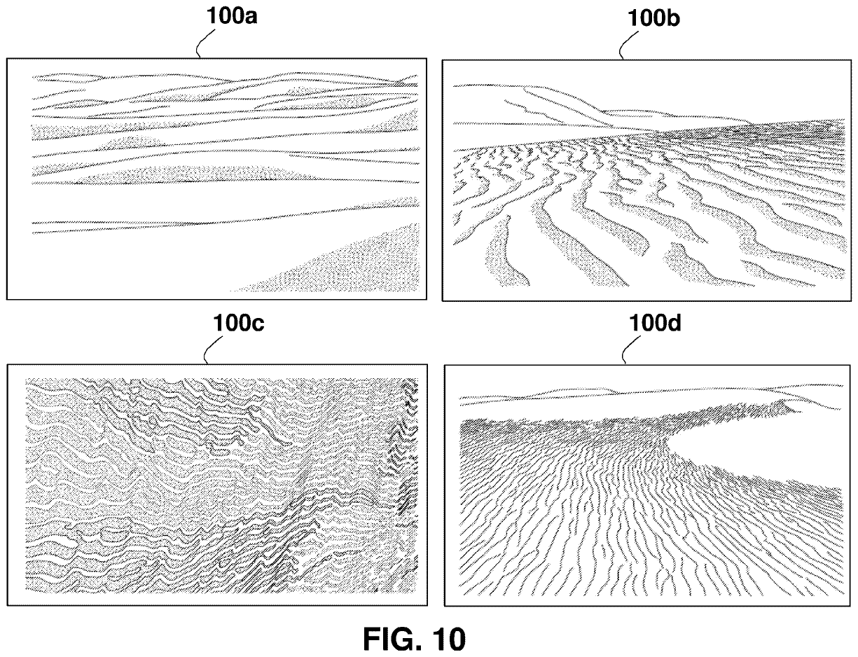

An example of a dynamic object is a wind-blown sandy area landform, such as a dune. Dunes are most common in deserted environments, such as the Sahara, and also near beaches. Dunes occur in different shapes and sizes, formed by interaction with the flow of air or water, and are made of sand-sized particles, and may consist of quartz, calcium carbonate, snow, gypsum, or other materials. The upwind/upstream/upcurrent side of the dune is called the stoss side; the downflow side is called the lee side. Sand is pushed (creep) or bounces (saltation) up the stoss side, and slides down the lee side. A side of a dune that the sand has slid down is called a slip face (or slipface). The winds may change the dune surface texture, to form sand patches, which consist of a thin layer of aeolian drift sand deposit (of uniform grain-size distribution) concentrated in a round or ellipsoid shape, usually rising slightly above a surrounding (higher-roughness) surface but without any slip-face development or evidence of lee-side flow separation. The winds direction and intensity may form different types of sand patches, corresponding to different states, each differently visualized by aerial photography. Various textures of sand patches are schematically shown in views 100a. 100b, 100c, and 100d in FIG. 10.

The main dimensions associated with waves are: Wave height, which is the vertical distance from trough to crest, wave length, which is the distance from crest to crest in the direction of propagation, wave period, which is the time interval between arrival of consecutive crests at a stationary point, and wave propagation direction. Three different types of wind waves may develop over time: Capillary waves, or ripples, dominated by surface tension effects, gravity waves, dominated by gravitational and inertial forces, seas, raised locally by the wind, and swell, which have travelled away from where they were raised by wind, and have to a greater or lesser extent dispersed.

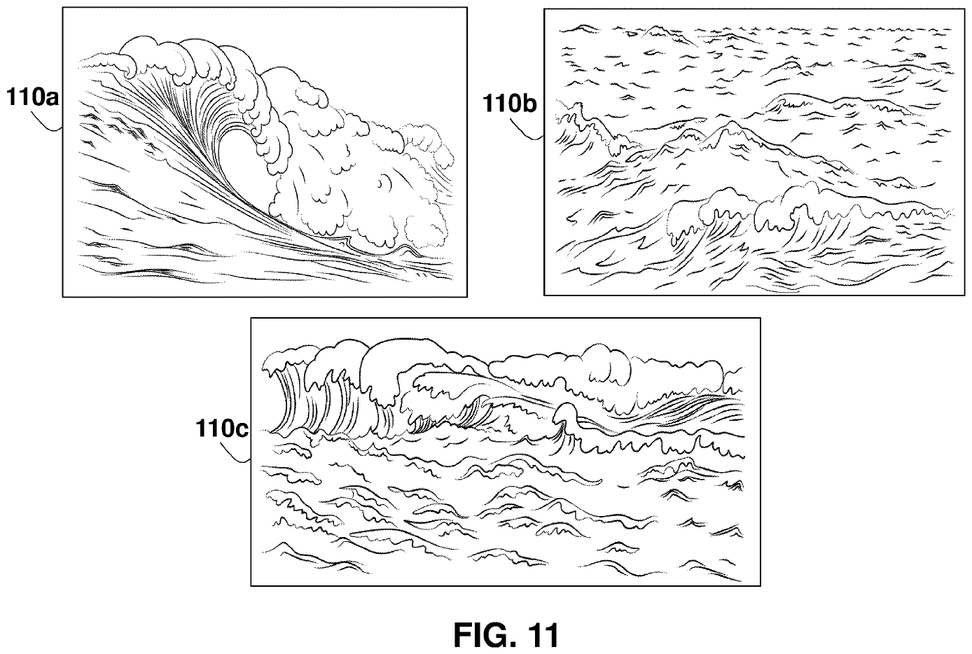

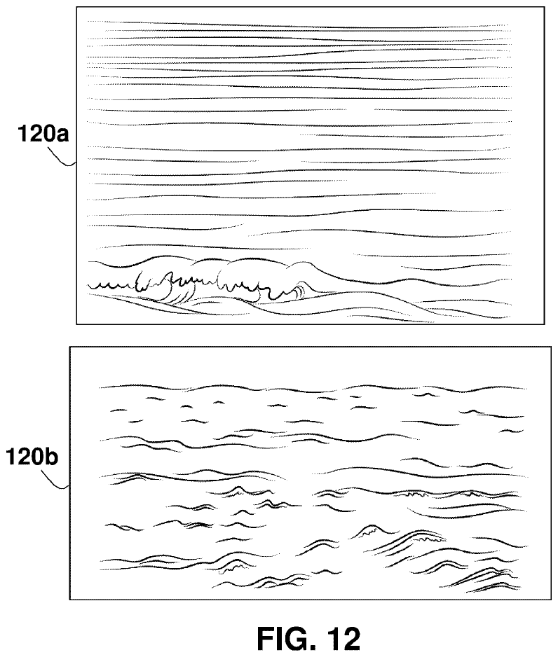

The effect of wind waves and swell on the general condition of the free surface on a large body of water, at a certain location and moment, is referred to as ‘sea state’. A sea state is characterized by statistics, including the wave height, period, and power spectrum. The sea state varies with time, as the wind conditions or swell conditions change. The sea state can either be assessed by an experienced observer, like a trained mariner, or through instruments like weather buoys, wave radar or remote sensing satellites. Sea state ‘0’ refers to none or low waves, sea state ‘1’ refers to short or average waves, and sea state ‘2’ refers to long/moderate sea surface. The wind waves direction and intensity may form different types of sea surface patterns, corresponding to different states, each differently visualized by aerial photography. Various views 110a, 110b, and 110c of sea surface during wind waves and high sea states are shown in FIG. 11. Various views 120a and 120b of sea surface during swell and low sea states are shown in FIG. 12.

Another dynamic object may consist of a landform that is affected by snow. Snow comprises individual ice crystals that grow while suspended in the atmosphere, usually within clouds, and then fall, accumulating on the ground where they undergo further changes. It consists of frozen crystalline water throughout its life cycle, starting when, under suitable conditions, the ice crystals form in the atmosphere, increase to millimeter size, precipitate and accumulate on surfaces, then metamorphose in place, and ultimately melt, slide or sublimate away. Snowstorms organize and develop by feeding on sources of atmospheric moisture and cold air. Snowflakes nucleate around particles in the atmosphere by attracting supercooled water droplets, which freeze in hexagonal-shaped crystals. Snowflakes take on a variety of shapes, basic among these are platelets, needles, columns and rime. As snow accumulates into a snowpack, it may blow into drifts. Over time, accumulated snow metamorphoses, by sintering, sublimation and freeze-thaw.

A snow patch is a geomorphological pattern of snow and firn accumulation, which lies on the surface for a longer time than other seasonal snow cover. There are two types to distinguish; seasonal snow patches and perennial snow patches. Seasonal patches usually melt during the late summer but later than the rest of the snow. Perennial snow patches are stable for more than two years and also have a bigger influence on surroundings. Snow patches often start in sheltered places where both thermal and orographical conditions are favorable for the conservation of snow such as small existing depressions, gullies or other concave patterns.

Snow accumulation in general, and snow patches in particular, changes the way the landform surface or texture is shown, corresponding to different states, each differently visualized by aerial photography.

Another dynamic object may consist of an area that is affected by temperature. For example, different air or surface temperatures between day and night may cause an area to look different for aerial photography. Temperature is a physical property of matter that quantitatively expresses hot and cold. It is the manifestation of thermal energy, present in all matter, which is the source of the occurrence of heat, a flow of energy, when a body is in contact with another that is colder. The most common scales are the Celsius scale (formerly called centigrade, denoted ® C.), the Fahrenheit scale (denoted ® F.), and the Kelvin scale (denoted K), the last of which is predominantly used for scientific purposes by conventions of the International System of Units (SI). Many physical processes are related to temperature, such as the physical properties of materials including the phase (solid, liquid, gaseous or plasma), density, solubility, vapor pressure, electrical conductivity, the rate and extent to which chemical reactions occur, the amount and properties of thermal radiation emitted from the surface of an object, and the speed of sound which is a function of the square root of the absolute temperature. Atmospheric temperature is a measure of temperature at different levels of the Earth's atmosphere. It is governed by many factors, including incoming solar radiation, humidity and altitude. When discussing surface air temperature, the annual atmospheric temperature range at any geographical location depends largely upon the type of biome, as measured by the Köppen climate classification.

A temperature of an area (either in air or surface), typically changes not only between day and night, but also throughout the day (between sunrise and sunset) and throughout the night (between sunset and sunrise). Further, throughout the year an average temperature of an area may be changed based on the season. A season is a division of the year marked by changes in weather, ecology, and the amount of daylight. Seasons are the result of Earth's orbit around the Sun and Earth's axial tilt relative to the ecliptic plane. In temperate and polar regions, the seasons are marked by changes in the intensity of sunlight that reaches the Earth's surface, variations of which may cause animals to undergo hibernation or to migrate, and plants to be dormant. Various cultures define the number and nature of seasons based on regional variations. The Northern Hemisphere experiences more direct sunlight during May, June, and July, as the hemisphere faces the Sun. The same is true of the Southern Hemisphere in November, December, and January. It is Earth's axial tilt that causes the Sun to be higher in the sky during the summer months, which increases the solar flux. However, due to seasonal lag, June, July, and August are the warmest months in the Northern Hemisphere while December, January, and February are the warmest months in the Southern Hemisphere. In temperate and sub-polar regions, four seasons based on the Gregorian calendar are generally recognized: spring, summer, autumn or fall, and winter.

Another dynamic object may consist of an area that is affected by humidity. Humidity is the concentration of water vapor present in the air. Water vapor, the gaseous state of water, is generally invisible to the human eye. Humidity indicates the likelihood for precipitation, dew, or fog to be present. The amount of water vapor needed to achieve saturation increases as the temperature increases. As the temperature of a parcel of air decreases, it will eventually reach the saturation point without adding or losing water mass. The amount of water vapor contained within a parcel of air can vary significantly. For example, a parcel of air near saturation may contain 28 grams of water per cubic meter of air at 30° C., but only 8 grams of water per cubic meter of air at 8° C.

Three primary measurements of humidity are widely employed: absolute, relative and specific. Absolute humidity describes the water content of air and is expressed in either grams per cubic meter or grams per kilogram. Relative humidity, expressed as a percentage, indicates a present state of absolute humidity relative to a maximum humidity given the same temperature. Specific humidity is the ratio of water vapor mass to total moist air parcel mass, and humidity plays an important role for surface life.

Another dynamic object may involve clouds. Clouds are typically located at altitude between the aerial vehicle that performs the aerial photography and the Earth surface that is to be captured by the camera in the aerial vehicle. As such, the existence of clouds may interfere with the captured image or totally hide the Earth surface that is to be captured.

A cloud is an aerosol consisting of a visible mass of minute liquid droplets, frozen crystals, or other particles suspended in the atmosphere of a planetary body or similar space. Water or various other chemicals may compose the droplets and crystals, and clouds are formed as a result of saturation of the air when it is cooled to its dew point, or when it gains sufficient moisture (usually in the form of water vapor) from an adjacent source to raise the dew point to the ambient temperature. Clouds are typically formed in the Earth's homosphere, which includes the troposphere, stratosphere, and mesosphere.

While exampled above regarding wind, snow, temperature, and humidity affecting aerial imaging of dynamic objects, any other weather-related phenomenon may equally be sought. Weather is the state of the atmosphere, describing for example the degree to which it is hot or cold, wet or dry, calm or stormy, clear or cloudy. Most weather phenomena occur in the lowest level of the planet's atmosphere, the troposphere, just below the stratosphere. Weather refers to day-to-day temperature and precipitation activity, whereas climate is the term for the averaging of atmospheric conditions over longer periods of time.

Weather is driven by air pressure, temperature, and moisture differences between one place and another. These differences can occur due to the Sun's angle at any particular spot, which varies with latitude. Weather systems in the middle latitudes, such as extratropical cyclones, are caused by instabilities of the jet streamflow. Because Earth's axis is tilted relative to its orbital plane (called the ecliptic), sunlight is incident at different angles at different times of the year. On Earth's surface, temperatures usually range ±40° C. (−40° F. to 100° F.) annually. Over thousands of years, changes in Earth's orbit can affect the amount and distribution of solar energy received by Earth, thus influencing long-term climate and global climate change.

Surface temperature differences in turn cause pressure differences. Higher altitudes are cooler than lower altitudes, as most atmospheric heating is due to contact with the Earth's surface while radiative losses to space are mostly constant. Weather forecasting is the application of science and technology to predict the state of the atmosphere for a future time and a given location. Earth's weather system is a chaotic system; as a result, small changes to one part of the system can grow to have large effects on the system as a whole.

While the dynamic objects described above were visualized differently in response to a weather phenomenon, dynamic objects may be affected by other geographical affects, such as tides. In one example, the dynamic object may consist of tides, which are the rise and fall of sea levels caused by the combined effects of the gravitational forces exerted by the Moon and the Sun, and the rotation of the Earth. Ebb and Flow (also called Ebb flood and flood drain) are two phases of the tide or any similar movement of water. The Ebb is the outgoing phase, when the tide drains away from the shore; and the flow is the incoming phase when water rises again. While tides are usually the largest source of short-term sea-level fluctuations, sea levels are also subject to forces such as wind and barometric pressure changes, resulting in storm surges, especially in shallow seas and near coasts. Tidal phenomena are not limited to the oceans, but can occur in other systems whenever a gravitational field that varies in time and space is present. For example, the shape of the solid part of the Earth is affected slightly by Earth tide, though this is not as easily seen as the water tidal movements.

Tide changes proceed via the following stages: (a) sea level rises over several hours, covering the intertidal zone; flood tide, (b) the water rises to its highest level, reaching high tide, (c) sea level falls over several hours, revealing the intertidal zone; ebb tide, and (d) the water stops falling, reaching low tide. Oscillating currents produced by tides are known as tidal streams. The moment that the tidal current ceases is called slack water or slack tide. The tide then reverses direction and is said to be turning. Slack water usually occurs near high water and low water. However, there are locations where the moments of slack tide differ significantly from those of high and low water. Tides are commonly semi-diurnal (two high waters and two low waters each day), or diurnal (one tidal cycle per day). The two high waters on a given day are typically not the same height (the daily inequality); these are the higher high water and the lower high water in tide tables. Similarly, the two low waters each day are the higher low water and the lower low water. The daily inequality is not consistent and is generally small when the Moon is over the Equator.

A dynamic object may include an area that is affected by a tide. The same area may be shown on one state as part of the body of water when the sea level rises, and on another state may be shown as a dry land when the sea level falls.

Another dynamic object may consist of a vegetation area, which includes an assemblage of plant species and the ground cover they provide. Examples of vegetation areas include forests, such as primeval redwood forests, coastal mangrove stands, sphagnum bogs, desert soil crusts, roadside weed patches, wheat fields, cultivated gardens, and lawns. A vegetation area other gymnosperms, ferns and their may include flowering plants, conifers and allies, hornworts, liverworts, mosses and the green algae. Green plants obtain most of their energy from sunlight via photosynthesis by primary chloroplasts that are derived from endosymbiosis with cyanobacteria. Their chloroplasts contain chlorophylls a and b, which gives them their green color. Some plants are parasitic or mycotrophic and have lost the ability to produce normal amounts of chlorophyll or to photosynthesize, but still have flowers, fruits, and seeds. Plants are characterized by sexual reproduction and alternation of generations, although asexual reproduction is also common. Plants that produce grain, fruit and vegetables also form basic human foods and have been domesticated for millennia. Plants have many cultural and other uses, as ornaments, building materials, writing material and, in great variety, they have been the source of medicines and psychoactive drugs.

A forest is a large area of land dominated by trees. Hundreds of more precise definitions of forest are used throughout the world, incorporating factors such as tree density, tree height, land use, legal standing and ecological function. Forests at different latitudes and elevations form distinctly different ecozones: boreal forests around the poles, tropical forests around the Equator, and temperate forests at the middle latitudes. Higher elevation areas tend to support forests similar to those at higher latitudes, and amount of precipitation also affects forest composition. An understory is made up of bushes, shrubs, and young trees that are adapted to living in the shades of the canopy. A canopy is formed by the mass of intertwined branches, twigs and leaves of the mature trees. The crowns of the dominant trees receive most of the sunlight. This is the most productive part of the trees where maximum food is produced. The canopy forms a shady, protective “umbrella” over the rest of the forest.

A forest typically includes many trees. A tree is a perennial plant with an elongated stem, or trunk, supporting branches and leaves in most species. In some usages, the definition of a tree may be narrower, including only woody plants with secondary growth, plants that are usable as lumber or plants above a specified height. In wider definitions, the taller palms, tree ferns, bananas, and bamboos are also trees. Trees are not a taxonomic group but include a variety of plant species that have independently evolved a trunk and branches as a way to tower above other plants to compete for sunlight. Trees tend to be long-lived, some reaching several thousand years old. Trees usually reproduce using seeds. Flowers and fruit may be present, but some trees, such as conifers, instead have pollen cones and seed cones. Palms, bananas, and bamboos also produce seeds, but tree ferns produce spores instead.

A woodland is, in the broad sense, land covered with trees, a low-density forest forming open habitats with plenty of sunlight and limited shade. Woodlands may support an understory of shrubs and herbaceous plants including grasses. Woodland may form a transition to shrubland under drier conditions or during early stages of primary or secondary succession. Higher-density areas of trees with a largely closed canopy that provides extensive and nearly continuous shade are often referred to as forests. A grove is a small group of trees with minimal or no undergrowth, such as a sequoia grove, or a small orchard planted for the cultivation of fruits or nuts. Groups of trees include woodland, woodlot, thicket, or stand. A grove typically refers to a group of trees that grow close together, generally without many bushes or other plants underneath.

In one example, the dynamic object may include a vegetation area that is affected by the seasons of the years. For example, during Prevernal (early or pre-spring) deciduous tree buds begin to swell, in vernal (spring), tree buds burst into leaves, during Estival (high summer), trees are in full leaf, in Serotinal (late summer), deciduous leaves begin to change color in higher latitude locations (above 45 north), during Autumnal (autumn) tree leaves in full color then turn brown and fall to the ground, and in Hibernal (winter), deciduous trees are bare and fallen leaves begin to decay. Hence, the status of foliage or leaves of the trees in a forest may change throughput the four seasons, changing the forest canopy structure, hence substantially changing the aerial photography view of the vegetation area.

While exampled above regarding day/night changes, a dynamic object may be equally affected by any other changes resulting from the Earth rotation. round its own axis. The Earth rotates eastward, in prograde motion. As viewed from the north pole star Polaris, Earth turns counterclockwise. The North Pole, also known as the Geographic North Pole or Terrestrial North Pole, is the point in the Northern Hemisphere where Earth's axis of rotation meets its surface. This point is distinct from Earth's North Magnetic Pole. The South Pole is the other point where Earth's axis of rotation intersects its surface, in Antarctica. Earth rotates once in about 24 hours with respect to the Sun, but once every 23 hours, 56 minutes, and 4 seconds with respect to other, distant, stars.

While exampled above regarding tides that are caused by the gravitational forces exerted by the Moon, a dynamic object may be equally affected by any other changes resulting from the Moon rotation around the Earth. The Moon is in synchronous rotation with Earth, and thus always shows the same side to Earth, the near side. Its gravitational influence produces the ocean tides, body tides, and the slight lengthening of the day. The Moon makes a complete orbit around Earth with respect to the fixed stars about once every 27.3 days. However, because Earth is moving in its orbit around the Sun at the same time, it takes slightly longer for the Moon to show the same phase to Earth, which is about 29.5 days.

While exampled above regarding seasons that are caused by the Sun, a dynamic object may be equally affected by any other changes resulting from the Sun, such as being affected by sunlight, sun magnetic and electromagnetic radiation, and the orbiting of the Earth around the Sun.

The dynamic objects described above are in fixed locations, but involve time-depending nature that cause these objects may look different in different times from the aerial photography point of view. Alternatively or in addition, a dynamic object may be an object that changes its position over the photographed surface, such as a vehicle or any other object that may move over time from one location to another location. Each of the locations may be considered as a different state of the object. Even if the vehicle may not look different in different times from the aerial photography point of view, its location may be changed over time. Since the location of a vehicle may be considered as a random location, an identification of a vehicle in the frame cannot be reliably used as feature to use for geosynchronization purpose, and may thus be ignored, in order not to affect the accuracy or reliability of the geosynchronization algorithm. Hence, a dynamic object may consist of, may comprise, or may be part of a vehicle, that may be a ground vehicle adapted to travel on land, such as a bicycle, a car, a motorcycle, a train, an electric scooter, a subway, a train, a trolleybus, or a tram. In one example, since cars and trucks, for example, are expected to move over roads, the identification of such vehicles may be used as identification of a point or part of a road, as part of the geosynchronization algorithm.

Alternatively or in addition, the vehicle may be a buoyant or submerged watercraft adapted to travel on or in water, and the watercraft may be a ship, a boat, a hovercraft, a sailboat, a yacht, or a submarine. In one example, since buoyant watercrafts, for example such as ships and boats, are expected to move in seas or lakes, the identification of such buoyant watercrafts may be used as identification of a point or part of a body of water, such as river, lake, or sea, as part of the geosynchronization algorithm.

Alternatively or in addition, the vehicle may be an aircraft adapted to fly in air, and the aircraft may be a fixed wing or a rotorcraft aircraft, such as an airplane, a spacecraft, a glider, a drone, or an Unmanned Aerial Vehicle (UAV). Any vehicle herein may be a ground vehicle that may consist of, or may comprise, an autonomous car, which may be according to levels 0, 1, 2, 3, 4, or 5 of the Society of Automotive Engineers (SAE) J3016 standard. In one example, when aircrafts are identified on ground, the identification of such aircrafts may be used as identification of a point or part of a body of an airport, such as taxiway or runway.

Due to the time dependent feature of dynamic objects, the objects may be in a first state, that may be properly identified, followed after a time interval by a second state that is not properly identified. The time of shifting between states may be periodic or random. Similarly, the time interval may be periodic or random.

The time period may be in the order of seconds or hours, such as at least 1 second, 2 seconds, 5 seconds, 10 seconds, 20 seconds, 30 seconds, 1 minute, 2, minutes, 5 minutes, 10 minutes, 20 minutes, 30 minutes, 1 hour, 2 hours, 5 hours, 10 hours, 15 hours, or 24 hours. Further, a time interval may be less than 2 seconds, 5 seconds, 10 seconds, 20 seconds, 30 seconds, 1 minute, 2, minutes, 5 minutes, 10 minutes, 20 minutes, 30 minutes, 1 hour, 2 hours, 5 hours, 10 hours, 15 hours, 24 hours, or 48 hours. Similarly, the time period may be in the order of days, such as day/night changes, or may be at least 1 day, 2 days, 4 days, 1 week, 2 weeks, 3 weeks, or 1 month. Further, a time interval may be less than 2 days, 4 days, 1 week, 2 weeks, 3 weeks, 1 month, or 2 months. Further, the time interval may be in the order of weeks or months, such as changes between seasons, such as at least 1 month, 2 months, 3 months, 4 months, 6 months, 9 months, or 1 year. Further, a time interval may be less than 2 months, 3 months, 4 months, 6 months, 9 months, 1 year, or 2 years.

The features detection as part of the “Identify N Features” step 82 and the features detection as part of the “Associate Geographical Locations” step 86 may comprise, may use, may be based on, a same, a similar, or a different features detection scheme, algorithm, or process. In one example, the features detection used as part of the “Identify N Features” step 82, or as part of the “Associate Geographical Locations” step 86, may use, or may be based on, the Scale-Invariant Feature Transform (SIFT), the Speeded-Up Robust Features (SURF), the Features from Accelerated Segment Test (FAST), or any combination thereof.

Any line-segment detection technique may be used, such as the LSD or the Hough transformation. Alternatively or in addition, the line-segment detection technique may consist of, may include, or may be based on, any edge detection algorithm or technique. For example, the edge detection technique may be based on search-based that detect edges by first computing a measure of edge strength, usually a first-order derivative expression such as the gradient magnitude, and then searching for local directional maxima of the gradient magnitude using a computed estimate of the local orientation of the edge, usually the gradient direction. Alternatively or in addition, the edge detection technique may be based on zero-crossing, where a search for zero crossings in a second-order derivative expression is computed from the image in order to find edges, usually the zero-crossings of the Laplacian or the zero-crossings of a non-linear differential expression. As a pre-processing step to edge detection, a smoothing stage, typically Gaussian smoothing, is commonly always applied. The edge detector technique used may consist of, may comprise, or may be based on, the Canny edge detection, the Sobel operator, the Prewitt operator, the Deriche edge detector, RANSAC, Hough transform, LSD technique, or the Differential edge detection.

The detecting of the corners may be according to, may be based on, or may consist of, a corner detection algorithm. The detecting of the corners may comprise detecting straight-line segments in the captured image, the detecting may be according to, may be based on, or may consist of, a pattern recognition algorithm, a Line Segment Detectors (LSD) technique, a Hough transformation, or an edge detection algorithm. The edge detection algorithm may be according to, may be based on, or may consist of, Canny edge detection, Sobel operator, Prewitt operator, Deriche edge detector, RANSAC, or Differential edge detection (such as by using Apple Quartz™ 2D software application). Alternatively or in addition, the edge detection algorithm may be according to, may be based on, or may use, a first-order derivative expression, second-order derivative expression, a non-linear differential expression, a gradient magnitude, zero-crossing detection, or a Gaussian smoothing.

The features detection as part of the “Identify N Features” step 82 or the features detection as part of the “Associate Geographical Locations” step 86 (or both) may comprise, may use, or may be based on, corners detection that is according to, is based on, or consists of, a corner detection algorithm. Alternatively or in addition, The features detection as part of the “Identify N Features” step 82 or the features detection as part of the “Associate Geographical Locations” step 86 (or both) may comprise, may use, or may be based on, detecting of the corners by detecting straight-line segments in the image. Alternatively or in addition, The features detection as part of the “Identify N Features” step 82 or the features detection as part of the “Associate Geographical Locations” step 86 (or both) may comprise, may use, or may be based on, comprises detecting straight-line segments in the captured image that is according to, is based on, or consists of, a pattern recognition algorithm. Any detecting of straight-line segments in the image may be according to, may be based on, or may consist of, a Line Segment Detectors (LSD) technique, a Hough transformation, an edge detection algorithm, or any combination thereof. Any edge detection algorithm may be according to, may be based on, or may consist of, Canny edge detection, Sobel operator, Prewitt operator, Deriche edge detector, RANSAC, Differential edge detection, Apple Quartz™ 2D software application, a first-order derivative expression, second-order derivative expression, a non-linear differential expression, a gradient magnitude, zero-crossing detection, a Gaussian smoothing, or any combination thereof.

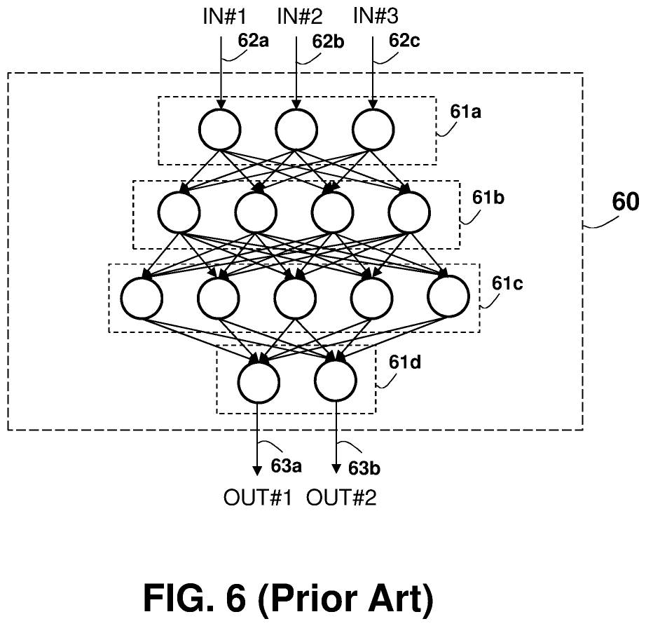

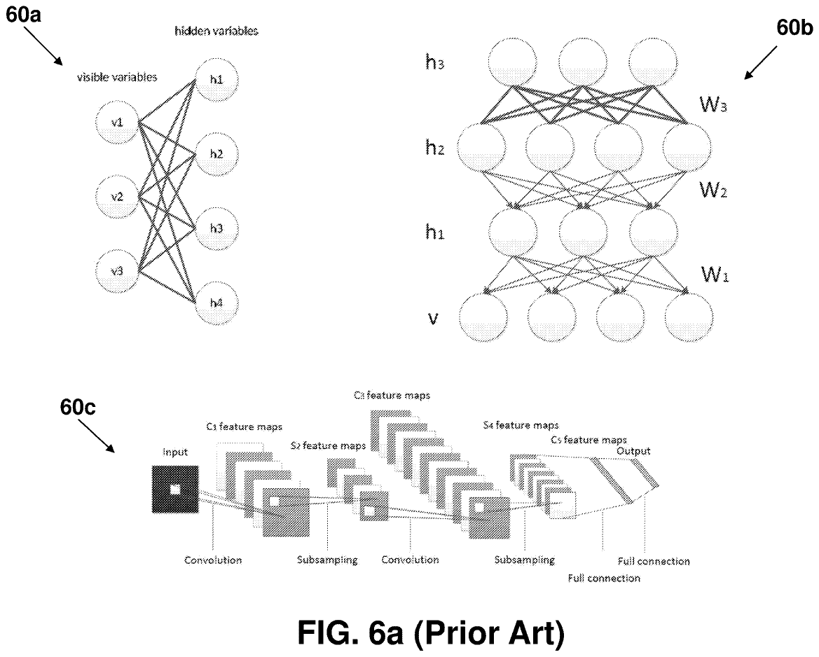

The features detection as part of the “Identify N Features” step 82 or the features detection as part of the “Associate Geographical Locations” step 86 (or both) may comprise, may use, or may be based on, an Artificial Neural Network (ANN) that may be used to analyze or classify any part of, or whole of, the received image. The ANN may comprise, or may be based on, the ANN 60 shown in FIG. 6, or the ANNs 60a, 60b, or 60c shown in FIG. 6a. The ANN may be a dynamic neural network, such as Feedforward Neural Network (FNN) or Recurrent Neural Network (RNN), and may comprise at least 3, 4, 5, 7, 10, 15, 20, 25, 30, 35, 40, 45, or 50 layers. Alternatively, or in addition, the ANN may comprise less than 3, 4, 5, 7, 10, 15, 20, 25, 30, 35, 40, 45, or 50 layers.

Any ANN herein, may comprises, may use, or may be based on, any Convolutional Neural Network (CNN). In one example, the CNN is trained to detect, identify, classify, localize, or recognize one or more static objects, one or more dynamic objects, or any combination thereof. In one example, a one-stage approach may be used, where the CNN is used once. Alternatively, a two-stage approach may be used, where the CNN is used twice for the object detection. Any ANN herein, may comprise, may use, or may be based on, a pre-trained neural network that is based on a large visual database designed for use in visual object recognition, that is trained using crowdsourcing, such as Imagenet.

Any ANN herein, may comprise, may use, or may be based on, a Convolutional Neural Network (CNN). In one example, the CNN is trained to detect, identify, classify, localize, or recognize one or more static objects, one or more dynamic objects, or any combination thereof. In one example, a one-stage approach may be used, where the CNN is used once. Alternatively, a two-stage approach may be used, where the CNN is used twice for the object detection. Further, using the CNN may comprise, may use, or may be based on, a pre-trained neural network that is based on a large visual database designed for use in visual object recognition, that is trained using crowdsourcing, such as Imagenet.

Any ANN herein, may comprise, may use, or may be based on, a method, scheme or architecture such as YOLO, for example YOLOv1, YOLOv2, or YOLO9000. Such a scheme includes defining as a regression problem to spatially separated bounding boxes and associated class probabilities, where a single neural network predicts bounding boxes and class probabilities directly from full images in one evaluation. After classification, post-processing is used to refine the bounding boxes, eliminate duplicate detections, and rescore the boxes based on other objects in the scene. The object detection is framed as a single regression problem, straight from image pixels to bounding box coordinates and class probabilities. A single convolutional network simultaneously predicts multiple bounding boxes and class probabilities for those boxes. YOLO trains on full images and directly optimizes detection performance. In one example, YOLO is implemented as a CNN and has been evaluated on the PASCAL VOC detection dataset.

Any ANN herein, may comprise, may use, or may be based on, Regions with CNN features (R-CNN), or any other scheme that uses selective search to extract just 2000 regions from the image, referred to as region proposals. Then, instead of trying to classify a huge number of regions, only 2000 regions are handled. These 2000 region proposals are generated using a selective search algorithm, that includes Generating initial sub-segmentation for generating many candidate regions, using greedy algorithm to recursively combine similar regions into larger ones, and using the generated regions to produce the final candidate region proposals. These 2000 candidate region proposals are warped into a square and fed into a convolutional neural network that produces a 4096-dimensional feature vector as output. The CNN acts as a feature extractor and the output dense layer consists of the features extracted from the image and the extracted features are fed into an SVM to classify the presence of the object within that candidate region proposal. In addition to predicting the presence of an object within the region proposals, the algorithm also predicts four values which are offset values to increase the precision of the bounding box. The R-CNN may be a Fast R-CNN, where the input image is fed to the CNN to generate a convolutional feature map. From the convolutional feature map, the regions of proposals are identified and warped into squares, and by using a Rol pooling layer they are reshaped into a fixed size so that it can be fed into a fully connected layer. From the Rol feature vector, a softmax layer is used to predict the class of the proposed region and also the offset values for the bounding box. Further, the R-CNN may be a Faster R-CNN, where instead of using selective search algorithm on the feature map to identify the region proposals, a separate network is used to predict the region proposals. The predicted region proposals are then reshaped using a Rol pooling layer which is then used to classify the image within the proposed region and predict the offset values for the bounding boxes. The R-CNN may use, comprise, or be based on a Region Proposal Network (RPN) that shares full-image convolutional features with the detection network, thus enabling nearly cost-free region proposals.

Any ANN herein, may comprise, may use, or may be based on, a method, scheme or architecture such as RetinaNet, that is a one-stage object detection model that is incorporates two improvements over existing single stage object detection models-Feature Pyramid Networks (FPN) and Focal Loss. The Feature Pyramid Network (FPN) may be built in a fully convolutional fashion architecture that utilizes the pyramid structure. In one example, pyramidal feature hierarchy is utilized by models such as Single Shot detector, but it doesn't reuse the multi-scale feature maps from different layers. Feature Pyramid Network (FPN) makes up for the shortcomings in these variations, and creates an architecture with rich semantics at all levels as it combines low-resolution semantically strong features with high-resolution semantically weak features, which is achieved by creating a top-down pathway with lateral connections to bottom-up convolutional layers. The construction of FPN involves two pathways which are connected with lateral connections: Bottom-up pathway and Top-down pathway and lateral connections. The bottom-up pathway of building FPN is accomplished by choosing the last feature map of each group of consecutive layers that output feature maps of the same scale. These chosen feature maps will be used as the foundation of the feature pyramid. Using nearest neighbor upsampling, the last feature map from the bottom-up pathway is expanded to the same scale as the second-to-last feature map. These two feature maps are then merged by element-wise addition to form a new feature map. This process is iterated until each feature map from the bottom-up pathway has a corresponding new feature map connected with lateral connections.

Focal Loss (FL) is an enhancement over Cross-Entropy Loss (CE) and is introduced to handle the class imbalance problem with single-stage object detection models. Single Stage models suffer from an extreme foreground-background class imbalance problem due to dense sampling of anchor boxes (possible object locations). In RetinaNet, at each pyramid layer there can be thousands of anchor boxes. Only a few will be assigned to a ground-truth object while the vast majority will be background class. These easy examples (detections with high probabilities) although resulting in small loss values can collectively overwhelm the model. Focal Loss reduces the loss contribution from easy examples and increases the importance of correcting missclassified examples. Any ANN herein, may comprise, may use, or may be based on, a method, scheme or architecture that is Graph Neural Network (GNN) that processes data represented by graph data structures that capture the dependence of graphs via message passing between the nodes of graphs, such as GraphNet, Graph Convolutional Network (GCN), Graph Attention Network (GAT), or Graph Recurrent Network (GRN).

Any ANN herein, may comprise, may use, or may be based on, a method, scheme or architecture such as MobileNet, for example MobileNetV1, MobileNetV2, or MobileNetV3, that is based on a streamlined architecture that uses depthwise separable convolutions to build light weight deep neural networks, that is specifically tailored for mobile and resource constrained environments, and improves the state-of-the-art performance of mobile models on multiple tasks and benchmarks as well as across a spectrum of different model sizes. Any ANN herein, may comprise, may use, or may be based on, a method, scheme or architecture such as U-Net, which is a based on the fully convolutional network to supplement a usual contracting network by successive layers, where pooling operations are replaced by upsampling operators. These layers increase the resolution of the output, and a successive convolutional layer can then learn to assemble a precise output based on this information.

Any ANN herein, may comprise, may use, or may be based on, a method, scheme or architecture such as Visual Geometry Group (VGG) VGG-Net, such as VGG 16 and VGG 19, respectively having 16 and 19 weight layers. The VGG Net extracts the features (feature extractor) that can distinguish the objects and is used to classify unseen objects, and was invented with the purpose of enhancing classification accuracy by increasing the depth of the CNNs. There are five max pooling filters embedded between convolutional layers in order to down-sample the input representation. The stack of convolutional layers is followed by 3 fully connected layers, having 4096, 4096 and 1000 channels, respectively, and the last layer is a soft-max layer. A thorough evaluation of networks of increasing depth is using an architecture with very small (3×3) convolution filters, which shows that a significant improvement on the prior-art configurations can be achieved by pushing the depth to 16-19 weight layers.

Any object herein may include, consist of, or be part of, a landform that includes, consists of, or is part of, a shape or form of a land surface. The landform may be a natural or artificial feature the solid of surface of the Earth. Typical landforms include hills, mountains, plateaus, canyons, and valleys, as well as shoreline features such as bays and peninsulas. Landforms together make up a given terrain, and their arrangement in the landscape is known as topography. Terrain (or relief) involves the vertical and horizontal dimensions of land surface, usually expressed in terms of the elevation, slope, and orientation of terrain features. Terrain affects surface water flow and distribution. Over a large area, it can affect weather and climate patterns. Landforms are typically categorized by characteristic physical attributes such as elevation, slope, orientation, stratification, rock exposure, and soil type. Gross physical features or landforms include intuitive elements such as berms, mounds, hills, ridges, cliffs, valleys, rivers, peninsulas, volcanoes, and numerous other structural and size-scaled (e.g., ponds vs. lakes, hills vs. mountains) elements including various kinds of inland and oceanic waterbodies and sub-surface features. Artificial landforms may include man-made features, such as canals, ports and many harbors; and geographic features, such as deserts, forests, and grasslands.

The landform may be an erosion landform that is produced by erosion and weathering usually occur in coastal or fluvial environments, such as a badlands, which is a type of dry terrain where softer sedimentary rocks and clay-rich soils have been extensively eroded; a bornhardt, which is a large dome-shaped, steep-sided, bald rock; a butte, which is an isolated hill with steep, often vertical sides and a small, relatively flat top; a canyon, which is a deep ravine between cliffs; a cave, which is a natural underground space large enough for a human to enter; a cirque, which is an amphitheatre-like valley formed by glacial erosion; a cliff, which is a vertical, or near vertical, rock face of substantial height; a cryoplanation terrace, which is a formation of plains, terraces and pediments in periglacial environments; a cuesta, which is a hill or ridge with a gentle slope on one side and a steep slope on the other; a dissected plateau, which is a plateau area that has been severely eroded so that the relief is sharp; an erg, which is a broad, flat area of desert covered with wind-swept sand; an etchplain, which is a plain where the bedrock has been subject to considerable subsurface weathering; an exhumed river channel, which is a ridge of sandstone that remains when the softer flood plain mudstone is eroded away; a fjord, which is a long, narrow inlet with steep sides or cliffs, created by glacial activity; a flared slope, which is a rock-wall with a smooth transition into a concavity at the foot zone; a flatiron, which is a steeply sloping triangular landform created by the differential erosion of a steeply dipping, erosion-resistant layer of rock overlying softer strata; a gulch, which is a deep V-shaped valley formed by erosion; a gully, which is a landform created by running water eroding sharply into soil; a hogback, which is a long, narrow ridge or a series of hills with a narrow crest and steep slopes of nearly equal inclination on both flanks; a hoodoo, which is a tall, thin spire of relatively soft rock usually topped by harder rock; a homoclinal ridge, which is a ridge with a moderate sloping backslope and steeper frontslope; an inselberg (also known as Monadnock), which is an isolated rock hill or small mountain that rises abruptly from a relatively flat surrounding plain; an inverted relief, which is a landscape features that have reversed their elevation relative to other features; a lavaka, which is a type of gully, formed via groundwater sapping; a limestone pavement, which is a natural karst landform consisting of a flat, incised surface of exposed limestone; a mesa, which is an elevated area of land with a flat top and sides that are usually steep cliffs; a mushroom rock, which is a naturally occurring rock whose shape resembles a mushroom; a natural arch, which is a natural rock formation where a rock arch forms; a paleosurface, which is a surface made by erosion of considerable antiquity; a pediment, which is a very gently sloping inclined bedrock surface; a pediplain, which is an extensive plain formed by the coalescence of pediments; a peneplain, which is a low-relief plain formed by protracted erosion; a planation surface, which is a large-scale surface that is almost flat; a potrero, which is a long mesa that at one end slopes upward to higher terrain; a ridge, which is a geological feature consisting of a chain of mountains or hills that form a continuous elevated crest for some distance; a strike ridge, which is a ridge with a moderate sloping backslope and steeper frontslope; a structural bench, which is a long, relatively narrow land bounded by distinctly steeper slopes above and below; a structural terrace, which is a step-like landform; a tepui, which is a table-top mountain or mesa; a tessellated pavement, which is a relatively flat rock surface that is subdivided into more or less regular shapes by fractures; a truncated spur, which is a ridge that descends towards a valley floor or coastline that is cut short; a tor, which is a large, free-standing rock outcrop that rises abruptly from the surrounding smooth and gentle slopes of a rounded hill summit or ridge crest; a valley, which is a low area between hills, often with a river running through it; and a wave-cut platform, which is the narrow flat area often found at the base of a sea cliff or along the shoreline of a lake, bay, or sea that was created by erosion.

The landform may be a cryogenic erosion landform, such as a cryoplanation terrace, which is a formation of plains, terraces and pediments in periglacial environments, an earth hummock; a lithalsa, which is a frost-induced raised land form in permafrost areas; a nivation hollow, which is a geomorphic processes associated with snow patches; a palsa, which is a low, often oval, frost heave occurring in polar and subpolar climates; a permafrost plateau, which is a low, often oval, frost heave occurring in polar and subpolar climates; a pingo, which is a mound of earth-covered ice; a rock glacier, which is a landform of angular rock debris frozen in interstitial ice, former “true” glaciers overlain by a layer of talus, or something in between; and a thermokarst, which is a land surface with very irregular surfaces of marshy hollows and small hummocks formed as ice-rich permafrost thaws.

The landform may be a tectonic erosion landform that is created by tectonic activity, such as an asymmetric valley, which is a valley that has steeper slopes on one side; a dome, which is a geological deformation structure; a faceted spur, which is a ridge that descends towards a valley floor or coastline that is cut short; a fault scarp, which is a small step or offset on the ground surface where one side of a fault has moved vertically with respect to the other, a graben, which is a depressed block of planetary crust bordered by parallel faults; a horst, which is a raised fault block bounded by normal faults; a mid-ocean ridge, which is an underwater mountain system formed by plate tectonic spreading; a mud volcano, which is a landform created by the eruption of mud or slurries, water and gases; an oceanic trench, which is a long and narrow depressions of the sea floor; a pull-apart basin, which is a structural basin where two overlapping faults or a fault bend creates an area of crustal extension which causes the basin to subside; a rift valley, which is a linear lowland created by a tectonic rift or fault; and a sand boil, which is a cone of sand formed by the ejection of sand onto a surface from a central point by water under pressure

The landform may be a Karst landform that is formed from the dissolution of soluble rocks, such as an abime, which is a vertical shaft in karst terrain that may be very deep and usually opens into a network of subterranean passages; a calanque, which is a narrow, steep-walled inlet on the Mediterranean coast; a cave, which is a natural underground space large enough for a human to enter; a cenote, which is a natural pit, or sinkhole, that exposes groundwater underneath; a foiba, which is a type of deep natural sinkhole; a Karst fenster, which is an unroofed portion of a cavern which reveals part of a subterranean river; a mogote, which is a steep-sided residual hill of limestone, marble, or dolomite on a flat plain; a polje, which is a type of large flat plain found in karstic geological regions; a scowle, which is a landscape feature that ranges from amorphous shallow pits to irregular labyrinthine hollows up to several meters deep; and a sinkhole, which is a depression or hole in the ground caused by collapse of the surface into an existing void space

The landform may be a mountain and glacial landform that is created by the action of glaciers, such as an arete, which is a narrow ridge of rock which separates two valleys; a cirque, which is an amphitheatre-like valley formed by glacial erosion; a col, which is the lowest point on a mountain ridge between two peaks; a crevasse, which is a deep crack, or fracture, in an ice sheet or glacier; a corrie, which is an amphitheatre-like valley formed by glacial erosion or cwm; a cove, which is a small valley in the Appalachian Mountains between two ridge lines; a dirt cone, which is a depositional glacial feature of ice or snow with an insulating layer of dirt; a drumlin, which is an elongated hill formed by the action of glacial ice on the substrate and drumlin field; an esker, which is a long, winding ridge of stratified sand and gravel associated with former glaciers; a fjord, which is a long, narrow inlet with steep sides or cliffs, created by glacial activity; a fluvial terrace, which is an elongated terraces that flank the sides of floodplains and river valleys; a flyggberg, which is an isolated rock hill or small mountain that rises abruptly from a relatively flat surrounding plain; a glacier, which is a persistent body of ice that is moving under its own weight; a glacier cave, which is a cave formed within the ice of a glacier; a glacier foreland, which is the region between the current leading edge of the glacier and the moraines of latest maximum; a hanging valley, which is a tributary valley that meets the main valley above the valley floor; a nill, which is a landform that extends above the surrounding terrain; an inselberg, also known as monadnock, which is an isolated rock hill or small mountain that rises abruptly from a relatively flat surrounding plain; a kame, which is a mound formed on a retreating glacier and deposited on land; a kame delta, which is a landform formed by a stream of melt water flowing through or around a glacier and depositing sediments in a proglacial lake; a kettle, which is a depression/hole in an outwash plain formed by retreating glaciers or draining floodwaters; a moraine, which is a glacially formed accumulation of unconsolidated debris; a rogen moraine, also known as Ribbed moraines, which is a landform of ridges deposited by a glacier or ice sheet transverse to ice flow; a moulin, which is a shaft within a glacier or ice sheet which water enters from the surface; a mountain, which is a large landform that rises fairly steeply above the surrounding land over a limited area; a mountain pass, which is a route through a mountain range or over a ridge; a mountain range, which is a geographic area containing several geologically related mountains; a nunatak, which is an exposed, often rocky element of a ridge, mountain, or peak not covered with ice or snow within an ice field or glacier; a proglacial lake, which is a lake formed either by the damming action of a moraine during the retreat of a melting glacier, a glacial ice dam, or by meltwater trapped against an ice sheet; a pyramidal peak, also known as Glacial horn, which is an angular, sharply pointed mountainous peak; an outwash fan, which is a fan-shaped body of sediments deposited by braided streams from a melting glacier; an outwash plain, which is a plain formed from glacier sediment that was transported by meltwater; a rift valley, which is a linear lowland created by a tectonic rift or fault; a sandur, which is a plain formed from glacier sediment that was transported by meltwater; a side valley, which is a valley with a tributary to a larger river; a summit, which is a point on a surface that is higher in elevation than all points immediately adjacent to it, in topography; a trim line, which is a clear line on the side of a valley marking the most recent highest extent of the glacier; a truncated spur, which is a ridge that descends towards a valley floor or coastline that is cut short; a tunnel valley, which is an U-shaped valley originally cut by water under the glacial ice near the margin of continental ice sheets; a valley, which is a low area between hills, often with a river running through it; and an U-shaped valley, which is valleys formed by glacial scouring.

The landform may be a volcanic landform, such as a caldera, which is a cauldron-like volcanic feature formed by the emptying of a magma chamber; a cinder cone, which is a steep conical hill of loose pyroclastic fragments around a volcanic vent; a complex volcano, which is a landform of more than one related volcanic center; a cryptodome, which is a roughly circular protrusion from slowly extruded viscous volcanic lava; a cryovolcano, which is a type of volcano that erupts volatiles such as water, ammonia or methane, instead of molten rock; a diatreme, which is a volcanic pipe formed by a gaseous explosion; a dike, which is a sheet of rock that is formed in a fracture of a pre-existing rock body; a fissure vent, which is a linear volcanic vent through which lava erupts; a geyser, which is a hot spring characterized by intermittent discharge of water ejected turbulently and accompanied by steam; a guyot, which is an isolated, flat-topped underwater volcano mountain; a hornito, which is a conical structures built up by lava ejected through an opening in the crust of a lava flow; a kipuka, which is an area of land surrounded by one or more younger lava flows; a lava, which is a molten rock expelled by a volcano during an eruption; a lava dome, which is a roughly circular protrusion from slowly extruded viscous volcanic lava; a lava coulee, which is a roughly circular protrusion from slowly extruded viscous volcanic lava; a lava field, also known as lava plain; a lava lake, which is a molten lava contained in a volcanic crater; a lava spine, which is a vertically growing monolith of viscous lava that is slowly forced from a volcanic vent, such as those growing on a lava dome; a lava tube, which is a natural conduit through which lava flows beneath the solid surface; a maar, which is a low-relief volcanic crater; a malpais, which is a rough and barren landscape of relict and largely uneroded lava fields; a mamelon, which is a rock formation created by eruption of relatively thick or stiff lava through a narrow vent; a mid-ocean ridge, which is an underwater mountain system formed by plate tectonic spreading; a pit crater, which is a depression formed by a sinking or collapse of the surface lying above a void or empty chamber; a pyroclastic shield, which is a shield volcano formed mostly of pyroclastic and highly explosive eruptions; a resurgent dome, which is a dome formed by swelling or rising of a caldera floor due to movement in the magma chamber beneath it; a rootless cone, also known as pseudocrater; a seamount, which is a mountain rising from the ocean seafloor that does not reach to the water's surface; a shield volcano, which is a low profile volcano usually formed almost entirely of fluid lava flows; a stratovolcano, which is a tall, conical volcano built up by many layers of hardened lava and other ejecta; a somma volcano, which is a volcanic caldera that has been partially filled by a new central cone; a spatter cone, which is a landform of ejecta from a volcanic vent piled up in a conical shape; a volcanic crater lake, which is a lake formed within a volcanic crater; a subglacial mound, which is a volcano formed when lava erupts beneath a thick glacier or ice sheet; a submarine volcano, which is an underwater vents or fissures in the Earth's surface from which magma can erupt; a supervolcano, which is a volcano that has erupted 1000 cubic Km in a single eruption; a tuff cone, which is a landform of ejecta from a volcanic vent piled up in a conical shape; a tuya, which is a flat-topped, steep-sided volcano formed when lava erupts through a thick glacier or ice sheet; a volcanic cone, which is a landform of ejecta from a volcanic vent piled up in a conical shape; a volcanic crater, which is a roughly circular depression in the ground caused by volcanic activity; a volcanic dam, which is a natural dam produced directly or indirectly by volcanism; a volcanic field, which is an area of the Earth's crust prone to localized volcanic activity; a volcanic group, which is a collection of related volcanoes or volcanic landforms; a volcanic island, which is an island of volcanic origin; a volcanic plateau, which is a plateau produced by volcanic activity; a volcanic plug, which is a volcanic object created when magma hardens within a vent on an active volcano; and a volcano, which is a rupture in the crust of a planetary-mass object that allows hot lava, volcanic ash, and gases to escape from a magma chamber below the surface.

The landform may be a slope-based landform, such as a bluff, which is a vertical, or near vertical, rock face of substantial height; a butte, which is an isolated hill with steep, often vertical sides and a small, relatively flat top; a cliff, which is a vertical, or near vertical, rock face of substantial height; a col, which is the lowest point on a mountain ridge between two peaks; a cuesta, which is a hill or ridge with a gentle slope on one side and a steep slope on the other; a dale, which is a low area between hills, often with a river running through it; a defile, which is a narrow pass or gorge between mountains or hills; a dell, which is a small secluded hollow; a doab, also known as interfluve, which is a land between two converging, or confluent, rivers; a draw, which is a terrain feature formed by two parallel ridges or spurs with low ground in between; an escarpment, also known as scarp, which is a steep slope or cliff separating two relatively level regions; a flat landform, which is a relatively level surface of land within a region of greater relief; a gully, which is a landform created by running water eroding sharply into soil; a hill, which is a landform that extends above the surrounding terrain; a hillock, also known as knoll, which is a small hill; a mesa, which is an elevated area of land with a flat top and sides that are usually steep cliffs; a mountain pass, which is a route through a mountain range or over a ridge; a plain, which is an extensive flat region that generally does not vary much in elevation; a plateau, which is an area of a highland, usually of relatively flat terrain; a ravine, which is a small valley, which is often the product of streamcutting erosion; a ridge, which is a geological feature consisting of a chain of mountains or hills that form a continuous elevated crest for some distance; a rock shelter, which is a shallow cave-like opening at the base of a bluff or cliff; a saddle; a scree, which is a broken rock fragments at the base of steep rock faces, that has accumulated through periodic rockfall; a solifluction lobes and sheets; a strath, which is a large valley; a summit, which is a point on a surface that is higher in elevation than all points immediately adjacent to it, in topography; a terrace, which is a step-like landform; a terracette, which is a ridge on a hillside formed when saturated soil particles expand, then contract as they dry, causing them to move slowly downhill; a vale; a valley, which is a low area between hills, often with a river running through it; and a valley shoulder.

Any object herein may include, consist of, or be part of, a natural or an artificial body of water that is any significant accumulation of water, generally on a surface. Such bodies include oceans, seas, and lakes, as well as smaller pools of water such as ponds, wetlands, or puddles. A body of water includes still or contained water, as well as rivers, streams, canals, and other geographical features where water moves from one place to another.

Bodies of water that are navigable are known as waterways. Some bodies of water collect and move water, such as rivers and streams, and others primarily hold water, such as lakes and oceans. Any object herein may include, consist of, or be part of, a natural waterway (such as rivers, estuaries, and straits) or an artificial (reservoirs, canals, and locks) waterway. A waterway is any navigable body of water. Examples of bodies of water include a bay, which is an area of water bordered by land on three sides, similar to, but smaller than a gulf; a bight, which is a large and often only slightly receding bay, or a bend in any geographical feature; a bourn, which is a brook or stream, or small, seasonal stream; a brook, which is a small stream, such as a creek; a brooklet, which is a small brook; a canal, which is an artificial waterway, usually connected to (and sometimes connecting) existing lakes, rivers, or oceans; a channel, which is a the physical confine of a river, slough or ocean strait consisting of a bed and banks; a cove, which is a coastal landform, typically a circular or round inlet with a narrow entrance, or a sheltered bay; a delta, which is the location where a river flows into an ocean, sea, estuary, lake, or reservoir; a distributary or distributary channel, which is a stream that branches off and flows away from the main stream channel; a drainage basin, which is a region of land where water from rain or snowmelt drains downhill into another body of water, such as a river, lake, or reservoir; a draw, which is a usually dry creek bed or gulch that temporarily fills with water after a heavy rain, or seasonally; an estuary, which is a semi-enclosed coastal body of water with one or more rivers or streams flowing into it, and with a free connection to the open sea; a fjord, which is a narrow inlet of the sea between cliffs or steep slopes; a glacier, which is a large collection of ice or a frozen river that moves slowly down a mountain; a glacial pothole, which is a giant kettle; a gulf, which is a part of a lake or ocean that extends so that it is surrounded by land on three sides, similar to, but larger than, a bay; a harbor, which is an artificial or naturally occurring body of water where ships are stored or may shelter from the ocean weather and currents; an impoundment, which is an artificially-created body of water, by damming a source, often used for flood control, as a drinking water supply (reservoir), recreation, ornamentation (artificial pond), or other purpose or combination of purposes; an inlet, which is a body of water, usually seawater, which has characteristics of one or more of the following: bay, cove, estuary, firth, fjord, geo, sea loch, or sound; a kettle (or kettle lake), which is a shallow, sediment-filled body of water formed by retreating glaciers or draining floodwaters; a lagoon, which is a body of comparatively shallow salt or brackish water separated from the deeper sea by a shallow or exposed sandbank, coral reef, or similar feature; a lake, which is a body of water, usually freshwater, of relatively large size contained on a body of land; a lick, which is a small watercourse or an ephemeral stream; a mangrove swamp, which is a saline coastal habitat of mangrove trees and shrubs; a marsh, which is a wetland featuring grasses, rushes, reeds, typhas, sedges, and other herbaceous plants (possibly with low-growing woody plants) in a context of shallow water; a mere, which is a lake or body of water that is broad in relation to its depth; a mill pond, which is a reservoir built to provide flowing water to a watermill; a moat, which is a deep, broad trench, either dry or filled with water, surrounding and protecting a structure, installation, or town; an ocean, which is a major body of salty water that, in totality, covers about 71% of the earth's surface; an oxbow lake, which is an U-shaped lake formed when a wide meander from the mainstream of a river is cut off to create a lake; a phytotelma, which is a small, discrete body of water held by some plants; a pool, which is a small body of water such as a swimming pool, reflecting pool, pond, or puddle; a pond, which is a body of water smaller than a lake, especially those of artificial origin; a puddle, which is a small accumulation of water on a surface, usually the ground; a reservoir, an artificial lake or artificial pond, reservoir, which is a place to store water for various uses, especially drinking water, and can be a natural or artificial; a rill, which is a shallow channel of running water that can be either natural or man-made; a river, which is a natural waterway usually formed by water derived from either precipitation or glacial meltwater, and flows from higher ground to lower ground; a roadstead, which is a place outside a harbor where a ship can lie at anchor, and it is an enclosed area with an opening to the sea, narrower than a bay or gulf; a run, which is a small stream or part thereof, especially a smoothly flowing part of a stream; a salt marsh, which is a type of marsh that is a transitional zone between land and an area, such as a slough, bay, or estuary, with salty or brackish water; a sea, which is a large expanse of saline water connected with an ocean, or a large, usually saline; a sea loch, which is a sea inlet loch; a sea lough, which is a fjord, estuary, bay or sea inlet; a seep, which is a body of water formed by a spring; a slough, which is related to wetland or aquatic features; a source, which is the original point from which the river or stream flows; a sound, which is a large sea or ocean inlet larger than a bay, deeper than a bight, wider than a fjord, or it may identify a narrow sea or ocean channel between two bodies of land; a spring, which is a point where groundwater flows out of the ground, and is thus where the aquifer surface meets the ground surface; a strait, which is a narrow channel of water that connects two larger bodies of water, and thus lies between two land masses; a stream, which is a body of water with a detectable current, confined within a bed and banks; a streamlet (or rivulet), which is a small stream; a swamp, which is a wetland that features permanent inundation of large areas of land by shallow bodies of water, generally with a substantial number of hummocks, or dry-land protrusions; a tarn, which is a mountain lake or pool formed in a cirque excavated by a glacier; a tide pool, which is a rocky pool adjacent to an ocean and filled with seawater; a tributary or affluent, which is a stream or river that flows into the main stream (or parent) river or a lake; a vernal pool, which is a shallow, natural depression in level ground, with no permanent above-ground outlet, that holds water seasonally; a wadi (or wash), which is a usually-dry creek bed or gulch that temporarily fills with water after a heavy rain, or seasonally; and a wetland, which is a an environment at the interface between truly terrestrial ecosystems and truly aquatic systems making them different from each yet highly dependent on both.

A river is a natural flowing watercourse, usually freshwater, flowing towards an ocean, sea, lake, or another river. In some cases, a river flows into the ground and becomes dry at the end of its course without reaching another body of water. Small rivers are referred to as stream, creek, brook, rivulet, and rill. Canals are waterways channels, or artificial waterways (such as an artificial version of a river), for water conveyance, or to service water transport vehicles. They may also help with irrigation. An estuary is a partially enclosed coastal body of brackish water with one or more rivers or streams flowing into it, and with a free connection to the open sea. Estuaries form a transition zone between river environments and maritime environments known as ecotone. Estuaries are subject both to marine influences such as tides, waves, and the influx of saline water and to riverine influences such as flows of freshwater and sediment.

A lake is an area filled with water, localized in a basin, surrounded by land, apart from any river or other outlet that serves to feed or drain the lake, and are fed and drained by rivers and streams. Lakes lie on land and are not part of the ocean. Therefore, they are distinct from lagoons, and are also larger and deeper than ponds, though there are no official or scientific definitions. Lakes can be contrasted with rivers or streams, which are usually flowing. Natural lakes are generally found in mountainous areas, rift zones, and areas with ongoing glaciation. Other lakes are found in endorheic basins or along the courses of mature rivers. Many lakes are artificial and are constructed for industrial or agricultural use, for hydro-electric power generation or domestic water supply, or for aesthetic, recreational purposes, or other activities.

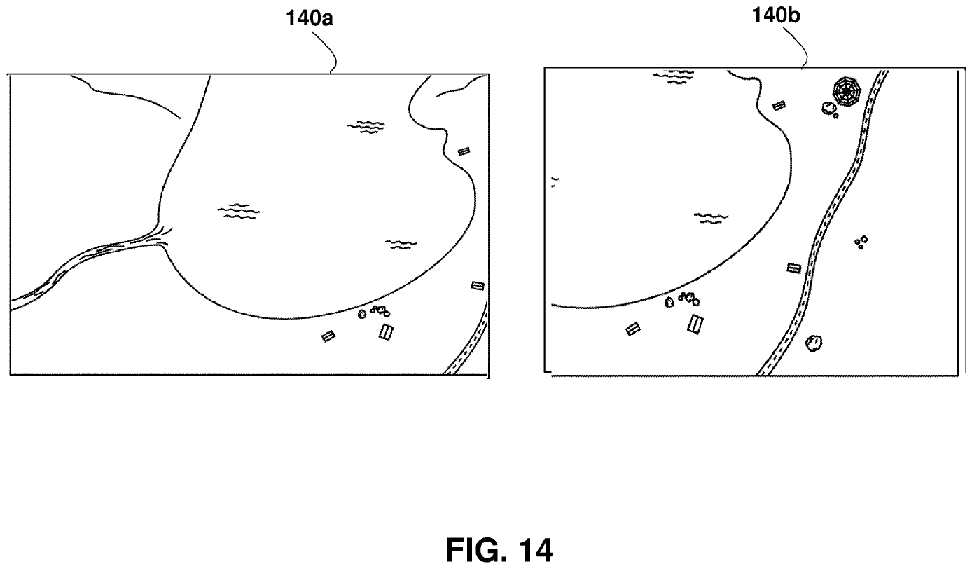

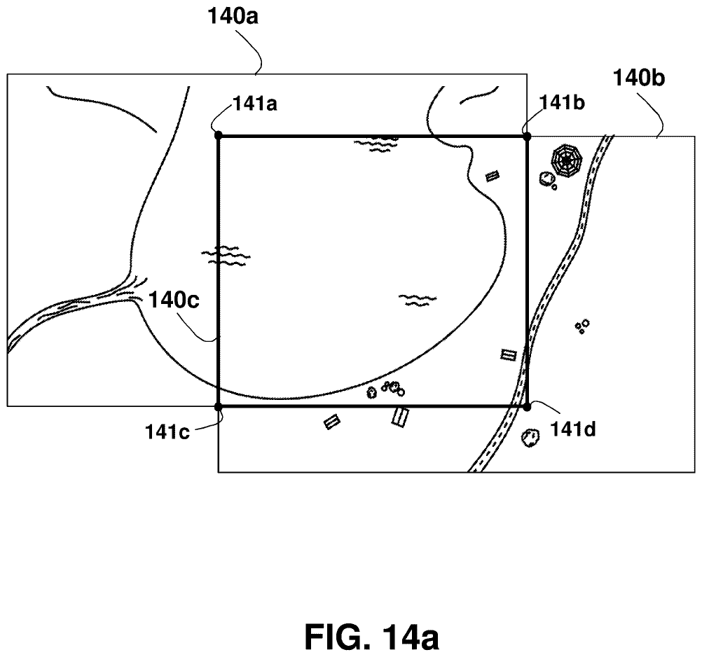

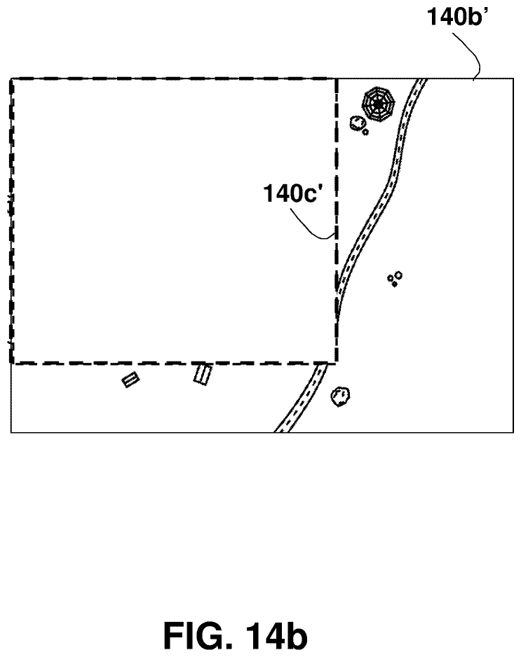

A first aerial image 140a and a second aerial image 140b, of substantially the same area that is captured as part of the aerial image 75a in FIG. 7b, are shown in FIG. 14. The first captured aerial image 140a and the second captured aerial image 140b are different, for example due to the movement of the aerial vehicle, change in the pose of the capturing camera in the aerial vehicle, or generally due to being captured at different times, by different equipment, or using different configurations. The spatial relationship between the two captured images 140a and 140b is shown in FIG. 14a. The two captured images 140a and 140b has an overlapping region shown as a square (or rectangle) 140c, that is shared by the two captured images, and may be defined by locations of four square-corners 141a. 141b, 141c, and 141d. Being a redundant part of the captured scene, the overlapping region 140c need not be sent as part of both of the two captured images 140a and 140b. In one example, a new second image 140b′ may be formed by removing the overlapping region 140c, shown as omitted part 140c′ as part of the newly formed second image 140b′. By sending the first image 140a, information about the overlapping region 140c (such as the corners coordinates 141a, 141b, 141c, and 141d), and the modified second image 140b′, the original second image 140b may be reconstructed by cropping the region 140c from the first image 140a and stitching it into the modified second image 140b′.

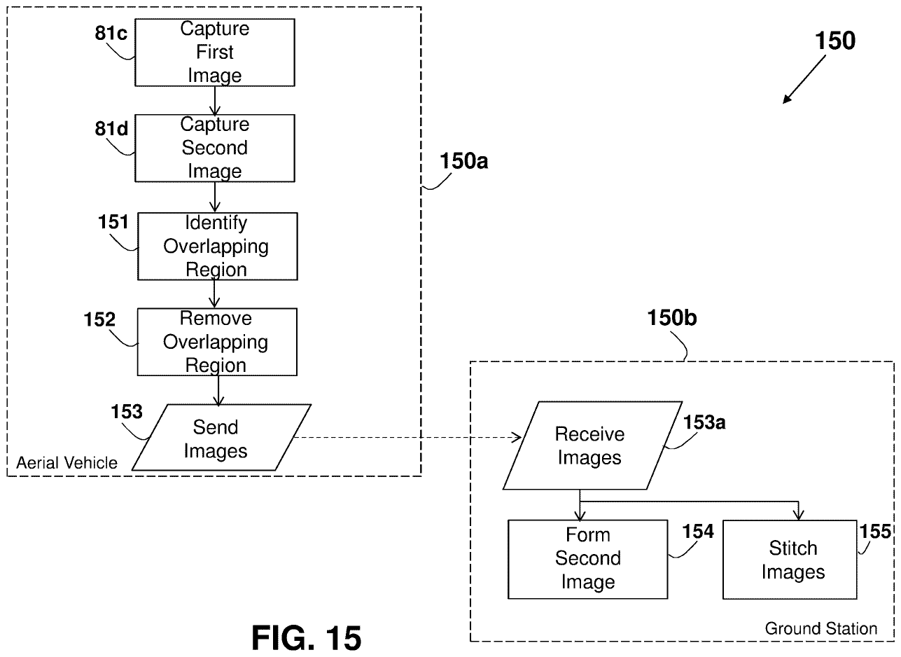

A method that may be used for saving of data sent from the aerial vehicle to the ground station, by identifying and removing redundancies in captured images, is exampled in a flow chart 150 shown in FIG. 15. The method is based on executing part of the process, shown as sub flow-chart 150a, by the aerial vehicle, and on executing another part of the process, shown as sub flow-chart 150b, in a ground station or in any location other than the aerial vehicle itself. Using an aerial vehicle on-board camera, such as the camera 10 shown in FIG. 1, the camera 34 shown in FIGS. 3 and 4, or the imaging system 55 shown in FIG. 5, a first image is captured as part of a “Capture First Image” step 81c, and a second image is captured as part of a “Capture Second Image” step 81d, each may be similar to, identical to, or different from, the “Capture Image” step 81 shown as part of the flow chart 80a in FIG. 8. In one example, the first image 140a shown in FIG. 14 may be captured as part of a “Capture First Image” step 81c, and the second image 140b shown in FIG. 14 may be captured as part of a “Capture Second Image” step 81d.

The two captured images may be captured by the same system, such as the same aerial vehicle and the same camera on-board the aerial vehicle, but at different times, such as part of consecutive captured images in period capturing scheme. For example, the first and second images may be part of two different frames extracted from a video data by a video camera in the aerial vehicle, such as according to the “Capture Video” step 81a and the “Extract Frame” step 81b that are part of the flow-chart 80d shown in FIG. 8a. Alternatively or in addition, the first and second images may be captured along the movement of the aerial vehicle, may be different due to Earth rotation, may be captured using different poses of the same camera, or may be captured by two different cameras (such as in the same time). on the same aerial vehicle. Alternatively or in addition, the first and second images may be captured using different aerial vehicles. The camera may be an optical-based imaging video camera that is operative to capture images or scenes in a visible or non-visible spectrum, or may equally use a LiDAR camera or scanner, as well as thermal camera or Synthetic Aperture Radar (SAR), as a substitute to the still or video camera 34.

The camera may be an optical-based imaging video camera that is operative to capture images or scenes in a visible or non-visible spectrum, or may equally use a LiDAR camera or scanner, as well as thermal camera or Synthetic Aperture Radar (SAR), as a substitute to the still or video camera 34. In one example, the aerial vehicle on-board camera comprises a scanner, and the image is captured as part of the “Capture Image” step 81 using a scanning system that employs a sensor with a narrow field of view (i.e., IFOV) that sweeps over the terrain to build up and produce a two-dimensional image of the surface. Such a scanning system that is used to collect data over a variety of different wavelength ranges is called a MultiSpectral Scanner (MSS), and is the most commonly used scanning system. There are two main modes or methods of scanning employed to acquire multispectral image data-across-track scanning, and along-track scanning.

As part of an “Identify Overlapping Region” step 151, a region that is part of both the first and second captured images is identified. For example, the region 140c that is shared by both the first image 140a and the second image 140b, as shown in FIG. 14a, may be identified. The region identification may be defined or represented by the corners, edges, or lines that defines the region in the first or second image, such as the corners coordinates 141a, 141b, 141c, and 141d of the region 140c as shown in FIG. 14a.

The area or region identified as part of the “Identify Overlapping Region” step 151 may be of any shape. In one example, the region may be a polygon that is described by a finite number of straight line segments connected to form a closed polygonal chain (or polygonal circuit). The segments of a polygonal circuit are called its edges or sides, and the points where two edges meet are the polygon's vertices (singular: vertex) or corners. For example, the polygon may be a triangle having 3 sides, a quadrilateral having 4 sides (such as a square or a rectangle), a pentagon having 5 sides, or a hexagon having 6 sides. The polygon may be Equiangular where all corner angles are equal, may be Equilateral where all edges are of the same length, may be Regular (both equilateral and equiangular), may be Cyclic where all corners lie on a single circle, called the circumcircle, may be Tangential, where all sides are tangent to an inscribed circle, may be Isogonal or vertex-transitive, where all corners lie within the same symmetry orbit. The polygon is also cyclic and equiangular, or may be Isotoxal or edge-transitive where all sides lie within the same symmetry orbit. Similarly, the shape of the cropped area may be a circular or ellipsoid based.

The size of the area or region that is identified as part of the “Identify Overlapping Region” step 151 may be more than 0.01%, 0.02%, 0.05%, 0.1%, 0.2%, 0.5%, 1%, 2%, 5%, 10%, 20%, or 50% of the size of the area of the entire first or second captured image. Further, the size of the area or region that is identified as part of the “Identify Overlapping Region” step 151 may be less than 0.02%, 0.05%, 0.1%, 0.2%, 0.5%, 1%, 2%, 5%, 10%, 20%, 50%, or 75% of the size of the area of the whole of the captured first or second image.

The overlapped region that is detected and identified as part of the “Identify Overlapping Region” step 151 may be cropped or removed from the second image as part of a “Remove Overlapping Region” step 152. This is exampled by the image 140b′ shown in FIG. 14b, where the region 140c′ is cropped from the second image 140b. The entire of the first image (such as the image 140a) and the cropped second image (such as the image 140b′) may be sent from the capturing vehicle, such as the aerial vehicle, to the ground station, as part of a “Send Images” step 153, and received by the ground station as part of a “Receive Images” step 153a. In one example, the location or coordinates of the overlapping region in the first image is sent by the aerial vehicle to the ground station as part of the “Send Images” step 153. Since the overlapping region, such as the region 140c in the example of FIG. 14a, is sent only once (as part of the first image, such as part of the first image 140a), rather than being sent twice as part of each of the first and second images, the total data to be sent is reduced, thus making more efficient use of the communication bandwidth between the aerial device and the ground station, thus allowing the use of lower bandwidth, or faster transmission for a specified available bandwidth.

In one example, the entire captured second image, such as the image 140b in FIG. 14, may be reconstructed in the ground station as part of a “Form Second Image” step 154. The identified overlapping region, such as the region 140c in the example of FIG. 14a, may be cropped or extracted from the first image (such as the first image 140a), for example using the information of the region location or coordinates, and stitched to supplemented to the cropped second image to form the originally captured second image. Alternatively or in addition, the information of the region location or coordinates may be used to stitch the first image and the cropped second image to form a combined image, such as shown in FIG. 14a, as part of a “Stitch Images” step 155.

In one example, the overlapped region that is detected and identified as part of the “Identify Overlapping Region” step 151 using Digital Image Correlation (DIC) techniques, that rely on finding the maximum of the correlation array between pixel intensity array subsets on the two compared first and second images. The DIC may be based on phase correlation that is used to find the estimate the relative translative offset between the compared first and second images, and may be based on frequency-domain representation of the images, usually calculated by Fast Fourier Transform (FFT). Such phase correlation exploits the shift property of Fourier transforms to map spatial domain translocations to frequency domain linear functions. The image correlation may be based on techniques described in a book by Michael A. Sutton, Jean-José Orteu, and Hubert W. Schreier Published 2009 [ISBN: 978-0-387-78746-6; c-ISBN: 978-0-387-78747-3. DOI: 10.1007/978-0-387-78747-3] and entitled: “Image Correlation for Shape, Motion and Deformation Measurements Basic Concepts, Theory and Applications”, which is incorporated in its entirety for all purposes as if fully set forth herein.

The “Identify Overlapping Region” step 151 may use, or may be based on, intensity-based and feature-based algorithm. One of the images is referred to as the moving or source and the others are referred to as the target, fixed or sensed images. Intensity-based methods compare intensity patterns in images via correlation metrics, while feature-based methods find correspondence between image features such as points, lines, and contours. Intensity-based methods register entire images or sub-images. If sub-images are registered, centers of corresponding sub images are treated as corresponding feature points. Feature-based methods establish a correspondence between a number of especially distinct points in images. Knowing the correspondence between a number of points in images, a geometrical transformation is then determined to map the target image to the reference images, thereby establishing point-by-point correspondence between the reference and target images. Methods combining intensity-based and feature-based information may be equally used.

Any Digital Image Correlation (DIC) technique herein may use any of the techniques described herein, and typically include spatial or frequency domain methods. Spatial methods operate in the image domain, matching intensity patterns or features in images. Some of the feature matching algorithms are outgrowths of traditional techniques for performing manual image registration, in which an operator chooses corresponding Control Points (CP) in images. When the number of control points exceeds the minimum required to define the appropriate transformation model, iterative algorithms like RANSAC can be used to robustly estimate the parameters of a particular transformation type (e.g., affine) for registration of the images.

In one example, small patches between rectified images are compared. A small window is passed over a number of positions in one image. Each position is checked to see how well it compares with the same location in the other image. Several nearby locations are compared for objects in one image which may not be at exactly the same image-location in the other image. It is possible that there is no fit that is good enough. This may mean that the feature is not present in both images, it has moved farther than your search accounted for, it has changed too much, or is being hidden by other parts of the image.

Frequency-domain methods find the transformation parameters for registration of the images while working in the transform domain. Such methods work for simple transformations, such as translation, rotation, and scaling. Applying the phase correlation method to a pair of images produces a third image which contains a single peak. The location of this peak corresponds to the relative translation between the images. Unlike many spatial-domain algorithms, the phase correlation method is resilient to noise, occlusions, and other defects typical of medical or satellite images. Additionally, the phase correlation uses the fast Fourier transform to compute the cross-correlation between the two images, generally resulting in large performance gains. The method can be extended to determine rotation and scaling differences between two images by first converting the images to log-polar coordinates. Due to properties of the Fourier transform, the rotation and scaling parameters can be determined in a manner invariant to translation.

Any correlation herein may be based on, or may use, an improved digital image-correlation system that has been designed with practicality and efficiency as the major considerations, described in an article by T. J. Keating, P. R. Wolf, and F. L. Scarpace published 1975 in Photogrammetric Engineering and Remote Sensing 41(8): 993-1002, (1975, and entitled “An Improved Method of Digital Image Correlation”, which is incorporated in its entirety for all purposes as if fully set forth herein. The imagery is represented within the computer as discrete density values spatially located using a scanning microdensitometer. The system is designed to better use the inherent geometric relationships between the image planes and object space in searching for conjugate imagery on overlapping photographs. Initially, two-dimensional density difference algorithms and enlarged search areas are used to correlate passpoint imagery needed to compute the relative orientation parameters of the photographic system. The epipolar geometric relationships for the stereopair are then calculated and used to better estimate the respective locations of conjugate imagery. Searching for corresponding imagery along epipolar lines, which contain only x-parallax, reduces search time significantly and improves the chances for successful correlation. Elevations are simply interpolated from match-point locations which determine the amount of image point x-parallax along these lines. The horizontal position of final object space coordinates are then determined independent of any residual y-parallax contaminating the system.

Any correlation herein may use, or may be based on, an image registration system and method for matching images having fundamentally different characteristics that is described in U.S. Pat. No. 10,445,616 to TOM et al. entitled: “Enhanced phase correlation for image registration”, which is incorporated in its entirety for all purposes as if fully set forth herein. One exemplary feature of the system and method includes the use of an enhanced phase correlation method combined with a coarse sensor model to hypothesize and match a custom match metric to determine a best solution. The system and method may be operated on a non-transitory computer-readable medium storing a plurality of instructions which when executed by one or more processors causes the one or more processors to perform the image registration method utilizing the enhanced phase correlation.

The “correspondence problem” refers to the problem of ascertaining which parts of one image correspond to which parts of another image, where differences are due to movement of the camera, the elapse of time, and/or movement of objects in the photos. In the case of two or more images of the same 3D scene, taken from different points of view, the correspondence problem refers to the task of finding a set of points in one image which can be identified as the same points in another image. In one example, points or features in one image are matched with the points or features in another image, thus establishing corresponding points or corresponding features, also known as ‘homologous points’ or ‘homologous features’. The images can be taken from a different point of view, at different times, or with objects in the scene in general motion relative to the camera(s). The correspondence problem may occur in a stereo situation when two images of the same scene are used, or can be generalised to the N-view correspondence problem. In the latter case, the images may come from either N different cameras photographing at the same time or from one camera which is moving relative to the scene. The problem is made more difficult when the objects in the scene are in motion relative to the camera(s). There are two basic ways to find the correspondences between two images: Correlation-based-checking if one location in one image looks/seems like another in another image, and Feature-based-finding features in the image and seeing if the layout of a subset of features is similar in the two images. To avoid the aperture problem a good feature should have local variation in two directions. The “Identify Overlapping Region” step 151 may use, or may be based on, any solution or techniques that is used to solve the “correspondence problem”.

In one example, the identifying of the overlapping region as part of the “Identify Overlapping Region” step 151 uses, or is based on, identifying or finding a set of points in the first image which can be identified as the same points in the second image. The corresponding points may define the region, such as including all matching point in the region, or using the matched point to define the perimeter of the region, such as the using the matching points as the region corners or edges of a polygon that defines the overlapping region.

The identified points may include, or be based on, the features in the images. As an example, the “Identify N Features” step 82 shown as part of the flow charts 80a, 80d, 90a, and 90d in the respective FIGS. 8, 8a, 9, and 9a may be applied to both the first and second images, and the locations of the corresponding matching features in both images are used to identify the overlapping region.

While some of the examples herein refer to images captured by a camera (or any other sensor) that is part of, mounted in, or attached to, a vehicle that may be an aerial vehicle, any method, flow-chart, step, or process herein may equally apply to capturing and/or processing of images captured by a camera (or any other sensor) that is not part of, mounted in, or attached to, a vehicle, such as any stationary device. While some of the examples here refer to images of Earth surface, such as captured by a camera in an aerial vehicle, any method, flow-chart, step, or process herein may equally apply to capturing and/or processing of any non-surface Earth images, or any images in general. Further, while some of the examples here refer to images of Earth surface, such as captured by a camera in an aerial vehicle, any method, flow-chart, step, or process herein, may equally apply to capturing and/or processing of any surface of any astronomical object or celestial object, which is a naturally occurring physical entity, association, or structure that exists in the observable universe. Typically, such an astronomical body or celestial body may be a single, tightly bound, contiguous entity. Examples of astronomical objects include planetary systems, star clusters, nebulae, and galaxies, while asteroids, moons, planets, and stars are astronomical bodies. A comet may be identified as both body and object: It is a body when referring to the frozen nucleus of ice and dust, and an object when describing the entire comet with its diffuse coma and tail.

The sending by the aerial vehicle of the features and descriptors as part of the “Send Features Descriptors and Image Locations” step 84, and the corresponding reception by the ground station as part of a “Receive Descriptors and Locations” step 85, may be over a wireless network. The aerial vehicle may comprise a wireless transceiver or modem connected to the antenna 45, such as the wireless transceiver 44, and similarly the ground station may use a mating wireless transceiver or modem and an antenna for communicating over the wireless network.

In one example, the wireless network may be using, may be according to, may be compatible with, or may be based on, a Near Field Communication (NFC) using passive or active communication mode, may use the 13.56 MHz frequency band, data rate may be 106 Kb/s, 212 Kb/s, or 424 Kb/s, the modulation may be Amplitude-Shift-Keying (ASK), and may further be according to, compatible with, or based on, ISO/IEC 18092, ECMA-340, ISO/IEC 21481, or ECMA-352. In this scenario, the wireless transceiver may be an NFC modem or transceiver, and the antennas may be an NFC antenna. Alternatively or in addition, the wireless network may be using, may be according to, may be compatible with, or may be based on, a Personal Area Network (PAN) that may be according to, or based on, Bluetooth™ or IEEE 802.15.1-2005 standards that may be, the wireless transceiver may be a PAN modem, and the antenna may be a PAN antenna. In one example, the Bluetooth is a Bluetooth Low-Energy (BLE) standard. Further, the PAN may be a wireless control network according to, or based on, Zigbee™ or Z-Wave™ standards, such as IEEE 802.15.4-2003. Alternatively or in addition, the wireless network may be using, may be according to, may be compatible with, or may be based on, an analog Frequency Modulation (FM) over license-free band such as the LPD433 standard that uses frequencies with the ITU region 1 ISM band of 433.050 MHz to 434.790 MHz, the wireless transceiver may be an LPD433 modem, and the antenna may be an LPD433 antenna.

Alternatively or in addition, the wireless network may be using, may be according to, may be compatible with, or may be based on, a Wireless Local Area Network (WLAN) that may be according to, or based on, IEEE 802.11a, IEEE 802.11b, IEEE 802.11g, IEEE 802.11n, or IEEE 802.11ac standards, the wireless transceiver may be a WLAN modem, and the antenna may be a WLAN antenna.

Alternatively or in addition, the wireless network may be using, may be according to, may be compatible with, or may be based on, a wireless broadband network or a Wireless Wide Area Network (WWAN), the wireless transceiver may be a WWAN modem, and the antenna may be a WWAN antenna. The WWAN may be a WiMAX network such as according to, or based on, IEEE 802.16-2009, the wireless transceiver may be a WiMAX modem, and the antenna may be a WiMAX antenna. Alternatively or in addition, the WWAN may be a cellular telephone network, the wireless transceiver may be a cellular modem, and the antenna may be a cellular antenna. The WWAN may be a Third Generation (3G) network and may use UMTS W-CDMA, UMTS HSPA, UMTS TDD, CDMA2000 1×RTT, CDMA2000 EV-DO, or GSM EDGE-Evolution. The cellular telephone network may be a Fourth Generation (4G) network and may use HSPA+, Mobile WiMAX, LTE, LTE-Advanced, MBWA, or may be based on IEEE 802.20-2008. Alternatively or in addition, the wireless network may be using, may be using licensed or an unlicensed radio frequency band, such as the Industrial, Scientific and Medical (ISM) radio band.

Alternatively or in addition, the wireless network may use a Dedicated Short-Range Communication (DSRC), that may be according to, compatible with, or based on, European Committee for Standardization (CEN) EN 12253:2004, EN 12795:2002, EN 12834:2002, EN 13372:2004, or EN ISO 14906:2004 standard, or may be according to, compatible with, or based on, IEEE 802.11p, IEEE 1609.1-2006, IEEE 1609.2, IEEE 1609.3, IEEE 1609.4, or IEEE1609.5.

In one example, the UAV, such as the quadcopter 30a, transmits the captured video using a protocol that is based on, or uses, MISB ST 0601 standard, which is an MPEG2 transport stream for encapsulating H.264 video stream and KLV (Key-Length-Value) encoded telemetries stream, where the telemetries describe, among others, the location and orientation of the aircraft and a camera installed on it producing the video. The standard MISB ST 0601.15, published 28 Feb. 2019 by the Motion Imagery Standards Board and entitled: “UAS Datalink Local Set” defines the Unmanned Air System (UAS) Datalink Local Set (LS) for UAS platforms. The UAS Datalink LS is typically produced on-board a UAS airborne platform, encapsulated within a MPEG-2 Transport container along with compressed Motion Imagery, and transmitted over a wireless Datalink for dissemination. The UAS Datalink LS is a bandwidth-efficient, extensible Key-Length-Value (KLV) metadata Local Set conforming to SMPTE ST 336.

In one example, the aerial vehicle is a satellite. In such a case, the wireless network comprises, or consists of, a satellite link, for communication between the satellite and the ground station, that may use X band (8 to 12 GHZ), Ku band (12 to 18 GHZ), or Ka band (27 to 40 GHz), and may use a modulation scheme such as Binary phase-shift keying (BPSK), Quadrature phase-shift keying (QPSK), Offset quadrature phase-shift keying (OQPSK), 8PSK, or Quadrature amplitude modulation (QAM), especially 16QAM.

Any apparatus herein, which may be any of the systems, devices, modules, or functionalities described herein, may be integrated with a smartphone. The integration may be by being enclosed in the same housing, sharing a power source (such as a battery), using the same processor, or any other integration functionality. In one example, the functionality of any apparatus herein, which may be any of the systems, devices, modules, or functionalities described here, is used to improve, to control, or otherwise be used by the smartphone. In one example, a measured or calculated value by any of the systems, devices, modules, or functionalities described herein, is output to the smartphone device or functionality to be used therein. Alternatively or in addition, any of the systems, devices, modules, or functionalities described herein is used as a sensor for the smartphone device or functionality.

Any part of, or the whole of, any of the methods described herein may be provided as part of, or used as, an Application Programming Interface (API), defined as an intermediary software serving as the interface allowing the interaction and data sharing between an application software and the application platform, across which few or all services are provided, and commonly used to expose or use a specific software functionality, while protecting the rest of the application. The API may be based on, or according to, Portable Operating System Interface (POSIX) standard, defining the API along with command line shells and utility interfaces for software compatibility with variants of Unix and other operating systems, such as POSIX.1-2008 that is simultaneously IEEE STD. 1003.1™—2008 entitled: “Standard for Information Technology-Portable Operating System Interface (POSIX®) Description”, and The Open Group Technical Standard Base Specifications, Issue 7, IEEE STD. 1003.1™, 2013 Edition.

Any device herein may serve as a client device in the meaning of client/server architecture, commonly initiating requests for receiving services, functionalities, and resources, from other devices (servers or clients). Each of the these devices may further employ, store, integrate, or operate a client-oriented (or end-point dedicated) operating system, such as Microsoft Windows® (including the variants: Windows 7, Windows XP, Windows 8, and Windows 8.1, available from Microsoft Corporation, headquartered in Redmond, Washington, U.S.A.), Linux, and Google Chrome OS available from Google Inc. headquartered in Mountain View, California, U.S.A., Further, each of the these devices may further employ, store, integrate, or operate a mobile operating system such as Android (available from Google Inc. and includes variants such as version 2.2 (Froyo), version 2.3 (Gingerbread), version 4.0 (Ice Cream Sandwich), Version 4.2 (Jelly Bean), and version 4.4 (KitKat), iOS (available from Apple Inc., and includes variants such as versions 3-7), Windows® Phone (available from Microsoft Corporation and includes variants such as version 7, version 8, or version 9), or Blackberry® operating system (available from BlackBerry Ltd., headquartered in Waterloo, Ontario, Canada). Alternatively or in addition, each of the devices that are not denoted herein as servers may equally function as a server in the meaning of client/server architecture. Any one of the servers herein may be a web server using Hyper Text Transfer Protocol (HTTP) that responds to HTTP requests via the Internet, and any request herein may be an HTTP request.

The steps described herein may be sequential, and performed in the described order. For example, in a case where a step is performed in response to another step, or upon completion of another step, the steps are executed one after the other. However, in case where two or more steps are not explicitly described as being sequentially executed, these steps may be executed in any order or may be simultaneously performed. Two or more steps may be executed by two different network elements, or in the same network element, and may be executed in parallel using multiprocessing or multitasking.

A ‘nominal’ value herein refers to a designed, expected, or target value. In practice, a real or actual value is used, obtained, or exists, which varies within a tolerance from the nominal value, typically without significantly affecting functioning. Common tolerances are 20%, 15%, 10%, 5%, or 1% around the nominal value.

Discussions herein utilizing terms such as, for example, “processing,” “computing,” “calculating.” “determining.” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Throughout the description and claims of this specification, the word “couple”, and variations of that word such as “coupling”, “coupled”, and “couplable”, refers to an electrical connection (such as a copper wire or soldered connection), a logical connection (such as through logical devices of a semiconductor device), a virtual connection (such as through randomly assigned memory locations of a memory device) or any other suitable direct or indirect connections (including combination or series of connections), for example for allowing the transfer of power, signal, or data, as well as connections formed through intervening devices or elements.

The arrangements and methods described herein may be implemented using hardware, software or a combination of both. The term “integration” or “software integration” or any other reference to the integration of two programs or processes herein refers to software components (e.g., programs, modules, functions, processes etc.) that are (directly or via another component) combined, working or functioning together or form a whole, commonly for sharing a common purpose or a set of objectives. Such software integration can take the form of sharing the same program code, exchanging data, being managed by the same manager program, executed by the same processor, stored on the same medium, sharing the same GUI or other user interface, sharing peripheral hardware (such as a monitor, printer, keyboard and memory), sharing data or a database, or being part of a single package. The term “integration” or “hardware integration” or integration of hardware components herein refers to hardware components that are (directly or via another component) combined, working or functioning together or form a whole, commonly for sharing a common purpose or set of objectives. Such hardware integration can take the form of sharing the same power source (or power supply) or sharing other resources, exchanging data or control (e.g., by communicating), being managed by the same manager, physically connected or attached, sharing peripheral hardware connection (such as a monitor, printer, keyboard and memory), being part of a single package or mounted in a single enclosure (or any other physical collocating), sharing a communication port, or used or controlled with the same software or hardware. The term “integration” herein refers (as applicable) to a software integration, a hardware integration, or any combination thereof.

The term “port” refers to a place of access to a device, electrical circuit or network, where energy or signal may be supplied or withdrawn. The term “interface” of a networked device refers to a physical interface, a logical interface (e.g., a portion of a physical interface or sometimes referred to in the industry as a sub-interface—for example, such as, but not limited to a particular VLAN associated with a network interface), and/or a virtual interface (e.g., traffic grouped together based on some characteristic—for example, such as, but not limited to, a tunnel interface). As used herein, the term “independent” relating to two (or more) elements, processes, or functionalities, refers to a scenario where one does not affect nor preclude the other. For example, independent communication such as over a pair of independent data routes means that communication over one data route does not affect nor preclude the communication over the other data routes.

The term “processor” is meant to include any integrated circuit or other electronic device (or collection of devices) capable of performing an operation on at least one instruction including, without limitation, Reduced Instruction Set Core (RISC) processors, CISC microprocessors, Microcontroller Units (MCUs), CISC-based Central Processing Units (CPUs), and Digital Signal Processors (DSPs). The hardware of such devices may be integrated onto a single substrate (e.g., silicon “die”), or distributed among two or more substrates. Furthermore, various functional aspects of the processor may be implemented solely as software or firmware associated with the processor.

A non-limiting example of a processor may be 80186 or 80188 available from Intel Corporation located at Santa-Clara, California, USA. The 80186 and its detailed memory connections are described in the manual “80186/80188 High-Integration 16-Bit Microprocessors” by Intel Corporation, which is incorporated in its entirety for all purposes as if fully set forth herein. Other non-limiting example of a processor may be MC68360 available from Motorola Inc. located at Schaumburg, Illinois, USA. The MC68360 and its detailed memory connections are described in the manual “MC68360 Quad Integrated Communications Controller—User's Manual” by Motorola, Inc., which is incorporated in its entirety for all purposes as if fully set forth herein. While exampled above regarding an address bus having an 8-bit width, other widths of address buses are commonly used, such as the 16-bit, 32-bit and 64-bit. Similarly, while exampled above regarding a data bus having an 8-bit width, other widths of data buses are commonly used, such as 16-bit, 32-bit and 64-bit width. In one example, the processor consists of, comprises, or is part of, Tiva™ TM4C123GH6PM Microcontroller available from Texas Instruments Incorporated (Headquartered in Dallas, Texas, U.S.A.), described in a data sheet published 2015 by Texas Instruments Incorporated [DS-TM4C123GH6PM-15842.2741, SPMS376E, Revision 15842.2741 June 2014], entitled: “Tiva™ TM4C123GH6PM Microcontroller—Data Sheet”, which is incorporated in its entirety for all purposes as if fully set forth herein, and is part of Texas Instrument's Tiva™ C Series microcontrollers family that provide designers a high-performance ARM® Cortex™-M-based architecture with a broad set of integration capabilities and a strong ecosystem of software and development tools. Targeting performance and flexibility, the Tiva™ C Series architecture offers an 80 MHz Cortex-M with FPU, a variety of integrated memories and multiple programmable GPIO. Tiva™ C Series devices offer consumers compelling cost-effective solutions by integrating application-specific peripherals and providing a comprehensive library of software tools which minimize board costs and design-cycle time. Offering quicker time-to-market and cost savings, the Tiva™ C Series microcontrollers are the leading choice in high-performance 32-bit applications. Targeting performance and flexibility, the Tiva™ C Series architecture offers an 80 MHz Cortex-M with FPU, a variety of integrated memories and multiple programmable GPIO. Tiva™ C Series devices offer consumers compelling cost-effective solutions.

The terms “memory” and “storage” are used interchangeably herein and refer to any physical component that can retain or store information (that can be later retrieved) such as digital data on a temporary or permanent basis, typically for use in a computer or other digital electronic device. A memory can store computer programs or any other sequence of computer readable instructions, or data, such as files, text, numbers, audio and video, as well as any other form of information represented as a string or structure of bits or bytes. The physical means of storing information may be electrostatic, ferroelectric, magnetic, acoustic, optical, chemical, electronic, electrical, or mechanical. A memory may be in a form of an Integrated Circuit (IC, a.k.a. chip or microchip). Alternatively or in addition, a memory may be in the form of a packaged functional assembly of electronic components (module). Such module may be based on a Printed Circuit Board (PCB) such as PC Card according to Personal Computer Memory Card International Association (PCMCIA) PCMCIA 2.0 standard, or a Single In-line Memory Module (SIMM) or a Dual In-line Memory Module (DIMM), standardized under the JEDEC JESD-21C standard. Further, a memory may be in the form of a separately rigidly enclosed box such as an external Hard-Disk Drive (HDD). Capacity of a memory is commonly featured in bytes (B), where the prefix ‘K’ is used to denote kilo=2¹⁰=1024¹=1024, the prefix ‘M’ is used to denote mega=2²⁰=1024²=1,048,576, the prefix ‘G’ is used to denote Giga=2³⁰=1024³=1,073,741,824, and the prefix ‘T’ is used to denote tera=2⁴⁰=1024⁴=1,099,511,627,776.

As used herein, the term “Integrated Circuit” (IC) shall include any type of integrated device of any function where the electronic circuit is manufactured by the patterned diffusion of trace elements into the surface of a thin substrate of semiconductor material (e.g., Silicon), whether single or multiple die, or small or large scale of integration, and irrespective of process or base materials (including, without limitation Si, SiGe, CMOS and GAs) including, without limitation, applications specific integrated circuits (ASICs), field programmable gate arrays (FPGAs), digital processors (e.g., DSPs, CISC microprocessors, or RISC processors), so-called “system-on-a-chip” (SoC) devices, memory (e.g., DRAM, SRAM, flash memory, ROM), mixed-signal devices, and analog ICs.

The circuits in an IC are typically contained in a silicon piece or in a semiconductor wafer, and commonly packaged as a unit. The solid-state circuits commonly include interconnected active and passive devices, diffused into a single silicon chip. Integrated circuits can be classified into analog, digital and mixed signal (both analog and digital on the same chip). Digital integrated circuits commonly contain many of logic gates, flip-flops, multiplexers, and other circuits in a few square millimeters. The small size of these circuits allows high speed, low power dissipation, and reduced manufacturing cost compared with board-level integration. Further, a multi-chip module (MCM) may be used, where multiple integrated circuits (ICs), the semiconductor dies, or other discrete components are packaged onto a unifying substrate, facilitating their use as a single component (as though a larger IC).

The term “computer-readable medium” (or “machine-readable medium”) as used herein is an extensible term that refers to any medium or any memory, that participates in providing instructions to a processor for execution, or any mechanism for storing or transmitting information in a form readable by a machine (e.g., a computer). Such a medium may store computer-executable instructions to be executed by a processing element and/or software, and data that is manipulated by a processing element and/or software, and may take many forms, including but not limited to, non-volatile medium, volatile medium, and transmission medium. Transmission media includes coaxial cables, copper wire and fiber optics. Transmission media can also take the form of acoustic or light waves, such as those generated during radio-wave and infrared data communications, or other form of propagating signals (e.g., carrier waves, infrared signals, digital signals, etc.). Common forms of computer-readable media include, for example, a floppy disk, a flexible disk, hard disk, magnetic tape, or any other magnetic medium, a CD-ROM, any other optical medium, punch-cards, paper-tape, any other physical medium with patterns of holes, a RAM, a PROM, and EPROM, a FLASH-EPROM, any other memory chip or cartridge, a carrier wave as described hereinafter, or any other medium from which a computer can read.

The term “computer” is used generically herein to describe any number of computers, including, but not limited to personal computers, embedded processing elements and systems, software, ASICs, chips, workstations, mainframes, etc. Any computer herein may consist of, or be part of, a handheld computer, including any portable computer that is small enough to be held and operated while holding in one hand or fit into a pocket. Such a device, also referred to as a mobile device, typically has a display screen with touch input and/or miniature keyboard. Non-limiting examples of such devices include Digital Still Camera (DSC), Digital video Camera (DVC or digital camcorder), Personal Digital Assistant (PDA), and mobile phones and Smartphones. The mobile devices may combine video, audio and advanced communication capabilities, such as PAN and WLAN. A mobile phone (also known as a cellular phone, cell phone and a hand phone) is a device which can make and receive telephone calls over a radio link whilst moving around a wide geographic area, by connecting to a cellular network provided by a mobile network operator. The calls are to and from the public telephone network, which includes other mobiles and fixed-line phones across the world. The Smartphones may combine the functions of a personal digital assistant (PDA), and may serve as portable media players and camera phones with high-resolution touch-screens, web browsers that can access, and properly display, standard web pages rather than just mobile-optimized sites, GPS navigation, Wi-Fi and mobile broadband access. In addition to telephony, the Smartphones may support a wide variety of other services such as text messaging, MMS, email, Internet access, short-range wireless communications (infrared, Bluetooth), business applications, gaming and photography.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a cellular handset, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Arca Network (PAN), a Wireless PAN (WPAN), devices and/or networks operating substantially in accordance with existing IEEE 802.11, 802.11a, 802.11b, 802.11g, 802.11k, 802.11n, 802.11r, 802.16, 802.16d, 802.16c, 802.20, 802.21 standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

As used herein, the terms “program”, “programmable”, and “computer program” are meant to include any sequence or human or machine cognizable steps, which perform a function. Such programs are not inherently related to any particular computer or other apparatus, and may be rendered in virtually any programming language or environment, including, for example, C/C++, Fortran, COBOL, PASCAL, assembly language, markup languages (e.g., HTML, SGML, XML, VoXML), and the likes, as well as object-oriented environments such as the Common Object Request Broker Architecture (CORBA), Java™ (including J2ME, Java Beans, etc.) and the like, as well as in firmware or other implementations. Generally, program modules include routines, programs, objects, components, data structures, etc., that perform particular tasks or implement particular abstract data types.

The terms “task” and “process” are used generically herein to describe any type of running programs, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of reading the value, processing the value: the value must be obtained prior to processing it, although some of the associated processing may be performed prior to, concurrently with, and/or after the read operation). Where certain process steps are described in a particular order or where alphabetic and/or alphanumeric labels are used to identify certain steps, the embodiments of the invention are not limited to any particular order of carrying out such steps. In particular, the labels are used merely for convenient identification of steps, and are not intended to imply, specify or require a particular order for carrying out such steps. Furthermore, other embodiments may use more or less steps than those discussed herein. The invention may also be practiced in distributed computing environments where tasks are performed by remote processing devices that are linked through a communications network. In a distributed computing environment, program modules may be located in both local and remote memory storage devices.

Operating system. An Operating System (OS) is software that manages computer hardware resources and provides common services for computer programs. The operating system is an essential component of any system software in a computer system, and most application programs usually require an operating system to function. For hardware functions such as input/output and memory allocation, the operating system acts as an intermediary between programs and the computer hardware, although the application code is usually executed directly by the hardware and will frequently make a system call to an OS function or be interrupted by it. Common features typically supported by operating systems include process management, interrupts handling, memory management, file system, device drivers, networking (such as TCP/IP and UDP), and Input/Output (I/O) handling. Examples of popular modern operating systems include Android, BSD, iOS, Linux, OS X, QNX, Microsoft Windows, Windows Phone, and IBM z/OS.

Any software or firmware herein may comprise an operating system that may be a mobile operating system. The mobile operating system may consist of, may comprise, may be according to, or may be based on, Android version 2.2 (Froyo), Android version 2.3 (Gingerbread), Android version 4.0 (Ice Cream Sandwich), Android Version 4.2 (Jelly Bean), Android version 4.4 (KitKat)), Apple iOS version 3, Apple iOS version 4, Apple iOS version 5, Apple iOS version 6, Apple iOS version 7, Microsoft Windows® Phone version 7, Microsoft Windows® Phone version 8, Microsoft Windows® Phone version 9, or Blackberry® operating system. Any Operating System (OS) herein, such as any server or client operating system, may consists of, include, or be based on a real-time operating system (RTOS), such as FrecRTOS, SafeRTOS, QNX, VxWorks, or Micro-Controller Operating Systems (μC/OS).

Any apparatus herein, may be a client device that may typically function as a client in the meaning of client/server architecture, commonly initiating requests for receiving services, functionalities, and resources, from other devices (servers or clients). Each of the these devices may further employ, store, integrate, or operate a client-oriented (or end-point dedicated) operating system, such as Microsoft Windows® (including the variants: Windows 7, Windows XP, Windows 8, and Windows 8.1, available from Microsoft Corporation, headquartered in Redmond, Washington, U.S.A.), Linux, and Google Chrome OS available from Google Inc. headquartered in Mountain View, California, U.S.A., Further, each of the these devices may further employ, store, integrate, or operate a mobile operating system such as Android (available from Google Inc. and includes variants such as version 2.2 (Froyo), version 2.3 (Gingerbread), version 4.0 (Ice Cream Sandwich), Version 4.2 (Jelly Bean), and version 4.4 (KitKat), iOS (available from Apple Inc., and includes variants such as versions 3-7), Windows® Phone (available from Microsoft Corporation and includes variants such as version 7, version 8, or version 9), or Blackberry® operating system (available from BlackBerry Ltd., headquartered in Waterloo, Ontario, Canada). Alternatively or in addition, each of the devices that are not denoted herein as a server, may equally function as a server in the meaning of client/server architecture. Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure.

All publications, standards, patents, and patent applications cited in this specification are incorporated herein by reference as if each individual publication, patent, or patent application were specifically and individually indicated to be incorporated by reference and set forth in its entirety herein.

1. A method for geosynchronization, for use with a ground station that wirelessly communicates with an aerial vehicle that includes a camera that is positioned to capture images of the Earth surface, further for use with multiple features descriptor sets and a plurality of geosynchronized reference images, the method comprising:
capturing, by the camera in the aerial vehicle, an image of an Earth surface;
identifying, in the aerial vehicle, using the multiple features descriptor sets, N (N>1) features in the captured image;
associating, in the aerial vehicle, for each of the N identified features, a location ({Xᵢ; Yᵢ} where i=1, 2, . . . N), in the captured image and respective descriptor set;
sending, by the aerial vehicle to the ground station over the wireless communication, the locations in the captured image and the descriptors set for each of the identified features, without sending of the captured image;
receiving, by ground station from the aerial vehicle over the wireless communication, the locations in the captured image and the descriptors set for each of the identified features;
selecting, in the ground station, a first reference image from the plurality of geosynchronized reference images;
identifying, in the ground station, using the received descriptors sets, each of the identified features in the selected reference image;
associating, in the ground station, a geographical location ({AXᵢ; AYᵢ} where i=1, 2, . . . . N) for each of the identified features; and
calculating, in the ground station, a mapping function for mapping any location {X;Y} in the captured image to a respective geographical location {AX;AY}.

2. The method according to claim 1, wherein N is at least 2, 3, 4, 5, 6, 7, 8, 10, 12, 15, 20, 25, 30, 50, 80, 100, 120, 150, 200, 500, 1,000, 2,000, 5,000, or 10,000 features.

3. The method according to claim 2, wherein N is less than 3, 4, 5, 8, 10, 12, 15, 20, 25, 30, 50, 80, 100, 120, 150, 200, 500, 1,000, 2,000, 5,000, 10,000 or 20,000 features.

4. The method according to claim 1, wherein the multiple features descriptor sets are stored in a memory in the aerial vehicle.

5. The method according to claim 4, wherein the memory is a non-volatile memory.

6. The method according to claim 1, wherein the plurality of geosynchronized reference images is stored in a memory in the ground station.

7. The method according to claim 6, wherein the memory is a non-volatile memory.

8. The method according to claim 1, wherein at least one of, most of, or all of, the geographical location or position on Earth are represented as Latitude and Longitude values, according to World Geodetic System (WGS) 84 standard, or are using Universal Transverse Mercator (UTM) zones.

9. The method according to claim 1, further comprising determining, the location of the aerial vehicle when the image was captured, using the calculated mapping function.

10. The method according to claim 1, wherein the identifying of the feature, in the captured image or in the selected reference image, is based on, or uses, identifying a feature of an object in the image.

11. The method according to claim 10, wherein the feature comprises, consists of, or is part of, shape, size, texture, boundaries, or color, of the object.

12. The method according to claim 1, wherein the identifying of the feature in the captured image or in the selected reference image, is based on, or uses, a same or similar feature detection scheme, algorithm, or process.

13. The method according to claim 1, wherein the identifying of the feature in the captured image or in the selected reference image, is based on, or uses, different feature detection schemes, algorithms, or processes.

14. The method according to claim 1, wherein at least one of, or each one of, the multiple descriptor sets, comprises a respective shape, color, texture, motion, or any combination thereof.

15. The method according to claim 14, wherein at least one of, or each one of, the multiple descriptor sets, comprises a general information descriptor or a specific domain information descriptor.

16. The method according to claim 14, wherein at least one of, or each one of, the multiple descriptor sets, uses, is according to., compatible with, or based on, Moving Picture Experts Group (MPEG)-7 (MPEG-7) standard ISO/IEC 15938 (Multimedia content description interface).

17. The method according to claim 14, wherein the color descriptor in at least one of, or each one of, the multiple descriptor sets, uses, is according to, is compatible with, or based on, Dominant color descriptor (DCD), Scalable color descriptor (SCD), Color structure descriptor (CSD), Color layout descriptor (CLD), Group of frame (GoF) or group-of-pictures (GoP), or any combination thereof.

18. The method according to claim 14, wherein the texture descriptor in at least one of, or each one of, the multiple descriptor sets, uses, is according to, is compatible with, or based on, Homogeneous texture descriptor (HTD), Texture browsing descriptor (TBD), Edge histogram descriptor (EHD), or any combination thereof.

19. The method according to claim 14, wherein the shape descriptor in at least one of, or each one of, the multiple descriptor sets, uses, is according to, is compatible with, or based on, Region-based shape descriptor (RSD), Contour-based shape descriptor (CSD), 3-D shape descriptor (3-D SD), or any combination thereof.

20. The method according to claim 14, wherein the motion descriptor in at least one of, or each one of, the multiple descriptor sets, uses, is according to, is compatible with, or based on, Motion activity descriptor (MAD), Camera motion descriptor (CMD), Motion trajectory descriptor (MTD), Warping and parametric motion descriptor (WMD and PMD), or any combination thereof.

21. The method according to claim 14, wherein the location descriptor in at least one of, or each one of, the multiple descriptor sets, uses, is according to, is compatible with, or based on, Region Locator Descriptor (RLD), Spatio Temporal Locator Descriptor (STLD), or any combination thereof.

22. The method according to claim 1, wherein the plurality of reference images are stored in a database in the ground station.

23. The method according to claim 1, wherein the geosunchronization of the plurality of reference images or the associating of the geographical locations comprises, is based on, or uses, a Geographic Information System (GIS).

24. The method according to claim 23, wherein the GIS comprises, is based on, or uses, a United States Geological Survey's (USGS) survey reference points and georeferenced images, city public works databases, Continuously Operating Reference Stations (CORS), or any combination thereof.

25. The method according to claim 1, wherein the plurality of reference images is stored in a database located externally to the ground station.

26. The method according to claim 25, further comprising receiving, over the Internet, part of, or all of, the reference images.

27. The method according to claim 26, wherein the receiving of the reference images is part of a service that is provided by any commercially available satellite imagery software.

28. The method according to claim 1, wherein the calculating comprises constructing the mapping function using curve fitting.

29. The method according to claim 28, wherein the curve fitting is based on, or comprises, interpolation, smoothing, or any combination thereof.

30. The method according to claim 28, wherein the curve fitting is based on, or comprises, least squares, or wherein the curve fitting is based on, or comprises, a mapping function that is a first, second, or third degree, polynomial function.

31-205. (canceled)
